(19) United States
(12) Patent Application Publication
(10) Pub. No.: US 2026/0169271 A1
(43) Pub. Date: Jun. 18, 2026

(54) VARIABLE MAGNIFICATION OPTICAL SYSTEM AND IMAGING APPARATUS

(71) Applicant: FUJIFILM Corporation, Tokyo (JP)

(72) Inventors: Ukyo TOMIOKA, Saitama (JP); Takashi KUNUGISE, Saitama (JP)

(73) Assignee: FUJIFILM Corporation, Tokyo (JP)

(21) Appl. No.: 19/413,949

(22) Filed: Dec. 9, 2025

(30) Foreign Application Priority Data
Dec. 16, 2024 (JP) 2024-220265
May 20, 2025 (JP) 2025-084354

(51) Int. Cl. G02B 13/00; G02B 15/14

(52) U.S. Cl. CPC G02B 13/009; G02B 13/006; G02B 15/1451

(57) ABSTRACT

A variable magnification optical system consists of, in order from an object side to an image side, a first lens group having positive refractive power, an intermediate group, and a subsequent group. The intermediate group consists of three or fewer lens groups including an M1 lens group having negative refractive power and disposed closest to the object side, and an Mr lens group having negative refractive power and disposed closest to the image side. An R1 lens group having positive refractive power is disposed closest to the object side in the subsequent group. During changing magnification, the first lens group remains stationary. In a case where a focal length of the M1 lens group is denoted by fM1, and a focal length of the first lens group is denoted by f1, the variable magnification optical system satisfies a conditional expression represented by 0.05<(−fM1)/f1<0.8.

### CROSS-REFERENCE TO RELATED APPLICATIONS

This application claims priority from Japanese Patent Application No. 2024-220265, filed on Dec. 16, 2024, and Japanese Patent Application No. 2025-084354, filed on May 20, 2025, the entire disclosure of which is incorporated herein by reference.

### BACKGROUND OF THE INVENTION

### Technical Field

The disclosed technology relates to a variable magnification optical system and an imaging apparatus.

### Related Art

In the related art, the optical system according to JP2015-018155A has been proposed as an optical system that can be applied to an imaging apparatus such as a surveillance camera and a digital camera.

### SUMMARY

There is demand for a variable magnification optical system in which various types of aberration are favorably corrected in the whole magnification range while achieving a high zoom ratio. A level of such demand is increasing year by year.

The present disclosure provides a variable magnification optical system in which various types of aberration are favorably corrected in the whole magnification range while achieving a high zoom ratio, and an imaging apparatus comprising the variable magnification optical system.

According to an aspect of the present disclosure, there is provided a variable magnification optical system consisting of, in order from an object side to an image side, a first lens group having positive refractive power, an intermediate group, and a subsequent group, in which an M1 lens group having negative refractive power is disposed closest to the object side in the intermediate group, an Mr lens group having negative refractive power is disposed closest to the image side in the intermediate group, the intermediate group consists of three or fewer lens groups having refractive power, including the M1 lens group and the Mr lens group, an R1 lens group having positive refractive power is disposed closest to the object side in the subsequent group, during changing magnification, the first lens group remains stationary with respect to an image plane, and all spacings between adjacent lens groups change, and Conditional Expression (1) is satisfied, which is represented by

$$0.05 < ( - fM 1 ) / f 1 < 0.8 . \qquad ( 1 )$$

A focal length of the M1 lens group is denoted by fM1, and a focal length of the first lens group is denoted by f1.

In a case where a focal length of the R1 lens group is denoted by fR1, it is preferable that the variable magnification optical system of the aspect satisfies Conditional Expression (2) represented by

$$0.05 < fR 1 / f 1 < 0.85 . \qquad ( 2 )$$

In a case where a focal length of the Mr lens group is denoted by fMr, it is preferable that the variable magnification optical system of the aspect satisfies Conditional Expression (3) represented by

$$0.8 < fMr / fM 1 < 7. \qquad ( 3 )$$

In a case where a distance on an optical axis from a surface closest to the object side in the first lens group to a surface closest to the image side in the first lens group is denoted by DG1, and a distance on the optical axis from the surface closest to the object side in the first lens group to a surface closest to the image side in the subsequent group in a state where an infinite distance object is in focus at a wide angle end is denoted by Dsum, it is preferable that the variable magnification optical system of the aspect satisfies Conditional Expression (4) represented by

$$0.012 < DG 1 / Dsum < 0.25 . \qquad ( 4 )$$

In a case where a focal length of a whole variable magnification optical system in a state where an infinite distance object is in focus at a wide angle end is denoted by fw, it is preferable that the variable magnification optical system of the aspect satisfies Conditional Expression (5) represented by

$$0.08 < fw / f 1 < 0.3 . \qquad ( 5 )$$

In a case where a focal length of a whole variable magnification optical system in a state where an infinite distance object is in focus at a wide angle end is denoted by fw, it is preferable that the variable magnification optical system of the aspect satisfies Conditional Expression (6) represented by

$$- 3 < fw / fM 1 < - 0.2 . \qquad ( 6 )$$

In a case where a focal length of a whole variable magnification optical system in a state where an infinite distance object is in focus at a wide angle end is denoted by fw, and a focal length of the R1 lens group is denoted by fR1, it is preferable that the variable magnification optical system of the aspect satisfies Conditional Expression (7) represented by

$$0.1 < fw / fR 1 < 1.4 . \qquad ( 7 )$$

In a case where a focal length of a whole variable magnification optical system in a state where an infinite distance object is in focus at a wide angle end is denoted by fw, and a focal length of the whole variable magnification optical system in a state where the infinite distance object is in focus at a telephoto end is denoted by ft, it is preferable that the variable magnification optical system of the aspect satisfies Conditional Expression (8) represented by

$$0.6 < f 1 / {( fw \times f t )}^{1 / 2} < 4. \qquad ( 8 )$$

In a case where a focal length of a whole variable magnification optical system in a state where an infinite distance object is in focus at a wide angle end is denoted by fw, and a focal length of the whole variable magnification optical system in a state where the infinite distance object is in focus at a telephoto end is denoted by ft, it is preferable that the variable magnification optical system of the aspect satisfies Conditional Expression (9) represented by

$$9 < f t / fw < 60. \qquad ( 9 )$$

In a configuration in which the subsequent group includes a vibration-proof group that moves in a direction intersecting with an optical axis during image shake correction, in a case where a focal length of a whole variable magnification optical system in a state where an infinite distance object is in focus at a wide angle end is denoted by fw, and a focal length of the vibration-proof group is denoted by fois, it is preferable that the variable magnification optical system of the aspect satisfies Conditional Expression (10) represented by

$$0.1 < fw / \vert fois \vert < 1.5 . \qquad ( 10 )$$

In the configuration in which the subsequent group includes the vibration-proof group, in a case where a focal length of the whole variable magnification optical system in a state where the infinite distance object is in focus at a telephoto end is denoted by ft, a maximum half angle of view in a state where the infinite distance object is in focus at the wide angle end is denoted by ow, and a maximum half angle of view in a state where the infinite distance object is in focus at the telephoto end is denoted by ωt, it is preferable that the variable magnification optical system of the aspect satisfies Conditional Expression (11) represented by

$$0.6 < ( f w \times tan ω w ) / ( f t \times tan ω t ) < 0 \text{.98} . \qquad ( 11 )$$

In a case where a refractive index at a d line for a lens included in the variable magnification optical system is denoted by Nd, and an Abbe number based on the d line for the lens included in the variable magnification optical system is denoted by vd, it is preferable that the variable magnification optical system of the aspect includes at least one specific lens that is a lens satisfying Conditional Expressions (12) and (13) represented by

$$2.435 < Nd + 0.01425 \times v d < 2.75 , and \qquad ( 12 )$$

$$15 < v d < 39. \qquad ( 13 )$$

In a case where a partial dispersion ratio between a g line and an F line for the lens included in the variable magnification optical system is denoted by θgF, it is preferable that the specific lens satisfies Conditional Expression (14) represented by

$$0.65 < θ gF + 0.00316 \times v d < 0 \text{.85} . \qquad ( 14 )$$

In a case where a maximum effective diameter of a specific lens having the maximum effective diameter among the specific lenses included in the variable magnification optical system is denoted by EDL, a focal length of a whole variable magnification optical system in a state where an infinite distance object is in focus at a telephoto end is denoted by ft, and a maximum half angle of view in a state where the infinite distance object is in focus at the telephoto end is denoted by ωt, it is preferable that the variable magnification optical system of the aspect satisfies Conditional Expression (15) represented by

$$0.1 < EDL / ( 2 \times f t \times tan ω t ) < 2. \qquad ( 15 )$$

It is preferable that the intermediate group includes at least one specific lens.

It is preferable that the subsequent group includes at least one specific lens.

In a configuration in which the variable magnification optical system includes at least one cemented lens, it is preferable that the at least one cemented lens of the variable magnification optical system includes the specific lens.

The intermediate group may be configured to consist of three lens groups.

The M1 lens group may be configured to include two or more positive lenses and three or more negative lenses.

According to another aspect of the present disclosure, there is provided an imaging apparatus comprising the variable magnification optical system of the aspect.

In the present specification, the terms “consist of” and “consisting of” mean that a lens substantially not having refractive power, an optical element other than a lens, such as a stop, a filter, and a cover glass, a mechanism part such as a lens flange, a lens barrel, an imaging element, and a camera shake correction mechanism, and the like may be included in addition to the illustrated constituents.

In the present specification, the term “group having positive refractive power” means that the whole group has positive refractive power. Similarly, the term “group having negative refractive power” means that the whole group has negative refractive power. The terms “lens having positive refractive power” and “positive lens” are synonymous with each other. The terms “lens having negative refractive power” and “negative lens” are synonymous with each other. In the present specification, the terms “lens group”, “vibration-proof group”, and “focus group” are not limited to being configured to consist of a plurality of lenses and may be configured to consist of only one lens.

The number of lenses in the present specification is the number of lenses as constituents. For example, the number of lenses in a cemented lens in which a plurality of single lenses formed of different materials are cemented is represented by the number of single lenses constituting the cemented lens. A compound aspherical lens (a lens functioning as one aspherical lens as a whole composed of a spherical lens and an aspherical surface-shaped film formed on the spherical lens that are integrated with each other) is not regarded as a cemented lens and is treated as one lens. Unless otherwise specified, a sign of refractive power and a surface shape related to a lens including an aspherical surface in a paraxial region are used.

In the present specification, the term “focal length” used in the conditional expressions is a paraxial focal length. Unless otherwise specified, the term “distance on the optical axis” used in the conditional expressions is a geometrical distance. Unless otherwise specified, values used in the conditional expressions are values based on the d line in a state where the infinite distance object is in focus.

The terms “d line”, “C line”, “F line”, and “g line” according to the present specification are bright lines. A wavelength of the d line is 587.56 nanometers (nm). A wavelength of the C line is 656.27 nanometers (nm). A wavelength of the F line is 486.13 nanometers (nm). A wavelength of the g line is 435.84 nanometers (nm).

According to the present disclosure, a variable magnification optical system in which various types of aberration are favorably corrected in the whole magnification range while achieving a high zoom ratio, and an imaging apparatus comprising the variable magnification optical system can be provided.

### BRIEF DESCRIPTION OF THE DRAWINGS

FIG. 1 is a diagram corresponding to a variable magnification optical system of Example 1 and showing a cross-sectional view of a configuration and a moving trajectory of a variable magnification optical system according to one embodiment.

FIG. 2 is a cross-sectional view of a configuration of the variable magnification optical system in FIG. 1 at a wide angle end for describing symbols of conditional expressions.

FIG. 3 is a diagram for describing an effective diameter.

FIG. 4 is each aberration diagram of the variable magnification optical system of Example 1.

FIG. 5 is a diagram showing a cross-sectional view of a configuration and a moving trajectory of a variable magnification optical system of Example 2.

FIG. 6 is each aberration diagram of the variable magnification optical system of Example 2.

FIG. 7 is a diagram showing a cross-sectional view of a configuration and a moving trajectory of a variable magnification optical system of Example 3.

FIG. 8 is each aberration diagram of the variable magnification optical system of Example 3.

FIG. 9 is a diagram showing a cross-sectional view of a configuration and a moving trajectory of a variable magnification optical system of Example 4.

FIG. 10 is each aberration diagram of the variable magnification optical system of Example 4.

FIG. 11 is a diagram showing a cross-sectional view of a configuration and a moving trajectory of a variable magnification optical system of Example 5.

FIG. 12 is each aberration diagram of the variable magnification optical system of Example 5.

FIG. 13 is a diagram showing a cross-sectional view of a configuration and a moving trajectory of a variable magnification optical system of Example 6.

FIG. 14 is each aberration diagram of the variable magnification optical system of Example 6.

FIG. 15 is a diagram showing a cross-sectional view of a configuration and a moving trajectory of a variable magnification optical system of Example 7.

FIG. 16 is each aberration diagram of the variable magnification optical system of Example 7.

FIG. 17 is a diagram showing a cross-sectional view of a configuration and a moving trajectory of a variable magnification optical system of Example 8.

FIG. 18 is each aberration diagram of the variable magnification optical system of Example 8.

FIG. 19 is a diagram showing a cross-sectional view of a configuration and a moving trajectory of a variable magnification optical system of Example 9.

FIG. 20 is each aberration diagram of the variable magnification optical system of Example 9.

FIG. 21 is a diagram showing a cross-sectional view of a configuration and a moving trajectory of a variable magnification optical system of Example 10.

FIG. 22 is each aberration diagram of the variable magnification optical system of Example 10.

FIG. 23 is a diagram showing a cross-sectional view of a configuration and a moving trajectory of a variable magnification optical system of Example 11.

FIG. 24 is each aberration diagram of the variable magnification optical system of Example 11.

FIG. 25 is a diagram showing a cross-sectional view of a configuration and a moving trajectory of a variable magnification optical system of Example 12.

FIG. 26 is each aberration diagram of the variable magnification optical system of Example 12.

FIG. 27 is a diagram showing a cross-sectional view of a configuration and a moving trajectory of a variable magnification optical system of Example 13.

FIG. 28 is each aberration diagram of the variable magnification optical system of Example 13.

FIG. 29 is a diagram showing a cross-sectional view of a configuration and a moving trajectory of a variable magnification optical system of Example 14.

FIG. 30 is each aberration diagram of the variable magnification optical system of Example 14.

FIG. 31 is a diagram showing a cross-sectional view of a configuration and a moving trajectory of a variable magnification optical system of Example 15.

FIG. 32 is each aberration diagram of the variable magnification optical system of Example 15.

FIG. 33 is a diagram showing a cross-sectional view of a configuration and a moving trajectory of a variable magnification optical system of Example 16.

FIG. 34 is each aberration diagram of the variable magnification optical system of Example 16.

FIG. 35 is a diagram showing a cross-sectional view of a configuration and a moving trajectory of a variable magnification optical system of Example 17.

FIG. 36 is each aberration diagram of the variable magnification optical system of Example 17.

FIG. 37 is a diagram showing a cross-sectional view of a configuration and a moving trajectory of a variable magnification optical system of Example 18.

FIG. 38 is each aberration diagram of the variable magnification optical system of Example 18.

FIG. 39 is a diagram showing a cross-sectional view of a configuration and a moving trajectory of a variable magnification optical system of Example 19.

FIG. 40 is each aberration diagram of the variable magnification optical system of Example 19.

FIG. 41 is a diagram showing a cross-sectional view of a configuration and a moving trajectory of a variable magnification optical system of Example 20.

FIG. 42 is each aberration diagram of the variable magnification optical system of Example 20.

FIG. 43 is a diagram showing a cross-sectional view of a configuration and a moving trajectory of a variable magnification optical system of Example 21.

FIG. 44 is each aberration diagram of the variable magnification optical system of Example 21.

FIG. 45 is a diagram showing a cross-sectional view of a configuration and a moving trajectory of a variable magnification optical system of Example 22.

FIG. 46 is each aberration diagram of the variable magnification optical system of Example 22.

FIG. 47 is a diagram showing a cross-sectional view of a configuration and a moving trajectory of a variable magnification optical system of Example 23.

FIG. 48 is each aberration diagram of the variable magnification optical system of Example 23.

FIG. 49 is a diagram showing a cross-sectional view of a configuration and a moving trajectory of a variable magnification optical system of Example 24.

FIG. 50 is each aberration diagram of the variable magnification optical system of Example 24.

FIG. 51 is a diagram showing a cross-sectional view of a configuration and a moving trajectory of a variable magnification optical system of Example 25.

FIG. 52 is each aberration diagram of the variable magnification optical system of Example 25.

FIG. 53 is a diagram showing a cross-sectional view of a configuration and a moving trajectory of a variable magnification optical system of Example 26.

FIG. 54 is each aberration diagram of the variable magnification optical system of Example 26.

FIG. 55 is a diagram showing a cross-sectional view of a configuration and a moving trajectory of a variable magnification optical system of Example 27.

FIG. 56 is each aberration diagram of the variable magnification optical system of Example 27.

FIG. 57 is a diagram showing a cross-sectional view of a configuration and a moving trajectory of a variable magnification optical system of Example 28.

FIG. 58 is each aberration diagram of the variable magnification optical system of Example 28.

FIG. 59 is a diagram showing a cross-sectional view of a configuration and a moving trajectory of a variable magnification optical system of Example 29.

FIG. 60 is each aberration diagram of the variable magnification optical system of Example 29.

FIG. 61 is a diagram showing a cross-sectional view of a configuration and a moving trajectory of a variable magnification optical system of Example 30.

FIG. 62 is each aberration diagram of the variable magnification optical system of Example 30.

FIG. 63 is a diagram showing a cross-sectional view of a configuration and a moving trajectory of a variable magnification optical system of Example 31.

FIG. 64 is each aberration diagram of the variable magnification optical system of Example 31.

FIG. 65 is a diagram showing a cross-sectional view of a configuration and a moving trajectory of a variable magnification optical system of Example 32.

FIG. 66 is each aberration diagram of the variable magnification optical system of Example 32.

FIG. 67 is a schematic configuration diagram of an imaging apparatus according to one embodiment.

### DETAILED DESCRIPTION

Hereinafter, an embodiment of the present disclosure will be described with reference to the drawings.

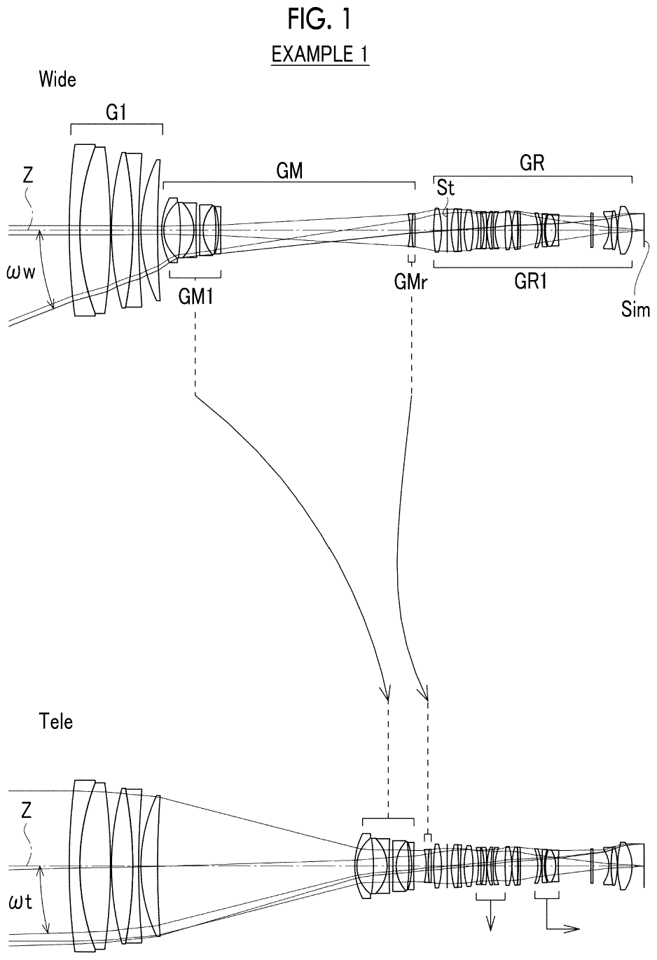

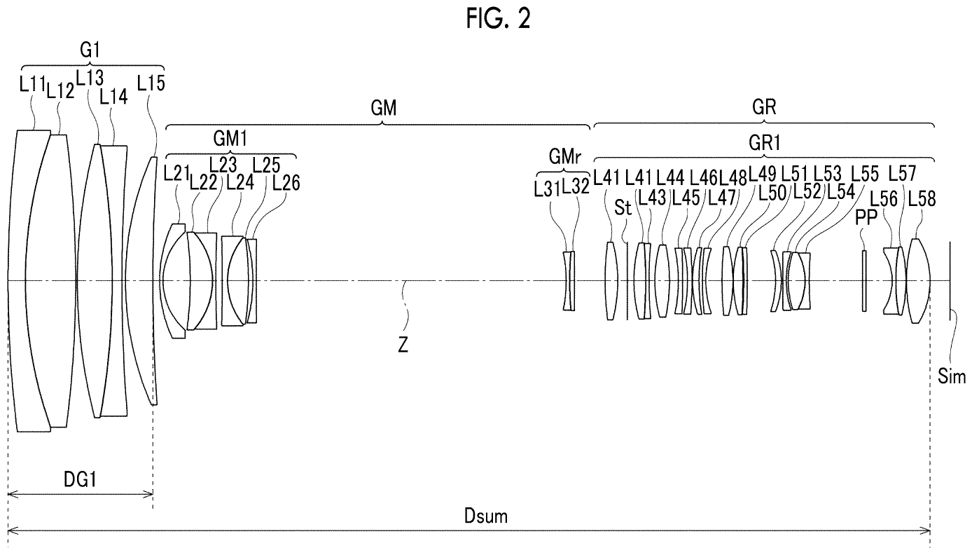

FIG. 1 shows a cross-sectional view of a configuration and luminous fluxes and a moving trajectory of a variable magnification optical system according to one embodiment of the present disclosure. In FIG. 1, a wide angle end state is shown in an upper part labeled “Wide”, and a telephoto end state is shown in a lower part labeled “Tele”. As the luminous fluxes, FIG. 1 shows an on-axis luminous flux and a luminous flux of a maximum half angle of view ow at a wide angle end and an on-axis luminous flux and a luminous flux of a maximum half angle of view ωt at a telephoto end. FIG. 2 shows a cross-sectional view of a configuration of the variable magnification optical system in FIG. 1 at the wide angle end. In FIGS. 1 and 2, a left side is an object side, a right side is an image side, and a state where an infinite distance object is in focus is shown. Examples shown in FIGS. 1 and 2 correspond to a variable magnification optical system of Example 1 described later. Hereinafter, FIG. 1 will be mainly referred to for description, and FIG. 2 will be referred to, as necessary.

The variable magnification optical system of the present disclosure consists of, in order from the object side to the image side along an optical axis Z, a first lens group G1 having positive refractive power, an intermediate group GM, and a subsequent group GR. An M1 lens group GM1 having negative refractive power is disposed closest to the object side in the intermediate group GM. An Mr lens group GMr having negative refractive power is disposed closest to the image side in the intermediate group GM. The intermediate group GM consists of three or fewer lens groups having refractive power, including the M1 lens group GM1 and the Mr lens group GMr. That is, the intermediate group GM consists of two or three lens groups having refractive power. An R1 lens group GR1 having positive refractive power is disposed closest to the object side in the subsequent group GR. During changing magnification, the first lens group remains stationary with respect to an image plane Sim, and all spacings between adjacent lens groups change. The above configuration provides an advantage in favorably correcting various types of aberration in the whole magnification range while achieving a high zoom ratio.

Providing the first lens group closest to the object side with positive refractive power provides an advantage in size reduction and can reduce a height of a ray incident on the intermediate group GM and thus, provides an advantage in reducing fluctuation of aberration during changing the magnification. Including two lens groups having negative refractive power in the intermediate group GM provides an advantage in achieving compatibility between favorable aberration correction and a high zoom ratio in the whole magnification range. Providing the lens group closest to the object side in the subsequent group GR with positive refractive power provides an advantage in size reduction. Causing the first lens group closest to the object side to remain stationary during changing the magnification provides an advantage in reducing fluctuation of a centroid during changing the magnification.

In the present specification, one lens group is a group of which a spacing with respect to an adjacent group in an optical axis direction changes during changing the magnification. During changing the magnification, a spacing between adjacent lenses does not change in one lens group. That is, the term “lens group” means a part constituting the variable magnification optical system and including at least one lens divided by an air spacing that changes during changing the magnification. During changing the magnification, each lens group moves or remains stationary in lens group units. The term “lens group” may include a constituent, other than a lens, not having refractive power, for example, an aperture stop St.

For example, as shown by a detailed configuration in FIG. 2, each group of the variable magnification optical system in FIG. 1 is configured as follows. The first lens group G1 consists of, in order from the object side to the image side, five lenses including lenses L11 to L15. The intermediate group GM consists of, in order from the object side to the image side, two lens groups including the M1 lens group GM1 and the Mr lens group GMr. The M1 lens group GM1 consists of, in order from the object side to the image side, six lenses including lenses L21 to L26. The Mr lens group GMr consists of, in order from the object side to the image side, two lenses including lenses L31 and L32. The subsequent group GR consists of one lens group that is the R1 lens group GR1. The R1 lens group GR1 consists of, in order from the object side to the image side, a lens L41, the aperture stop St, lenses L42 to L55, an optical member PP, and lenses L56 to L58. The aperture stop St shown in FIGS. 1 and 2 does not show a size or a shape and shows a position in the optical axis direction. The optical member PP is a parallel flat plate-shaped member not having refractive power, such as various filters. The variable magnification optical system of the present disclosure can also be configured not to include the optical member PP.

In the example in FIG. 1, during changing the magnification, the first lens group G1 and the R1 lens group GR1 remain stationary with respect to the image plane Sim, and the M1 lens group GM1 and the Mr lens group GMr move along the optical axis Z by changing a spacing with respect to each other. In FIG. 1, a schematic moving trajectory during changing the magnification from the wide angle end to the telephoto end is shown between the upper part and the lower part of FIG. 1 by solid line arrows for each lens group that moves during changing the magnification.

The first lens group G1 may be configured to include two cemented lenses, in each of which a negative lens and a positive lens are cemented. Doing so provides an advantage in correcting chromatic aberration. The first lens group G1 may be configured to further include one positive lens in addition to the two cemented lenses. Doing so provides an advantage in correcting spherical aberration.

It is preferable that the M1 lens group GM1 includes two or more positive lenses and three or more negative lenses. Doing so provides an advantage in reducing fluctuation of aberration during changing the magnification.

The Mr lens group GMr may be configured to consist of a cemented lens in which a negative lens and a positive lens are cemented. Doing so provides an advantage in reducing fluctuation of chromatic aberration during changing the magnification.

It is preferable that a lens surface closest to the object side in the subsequent group GR and a lens surface closest to the image side in the subsequent group GR remain stationary with respect to the image plane Sim during changing the magnification. Doing so provides an advantage in simplifying a mechanism.

The subsequent group GR may be configured to include the aperture stop St. Doing so provides an advantage in reducing a size of the subsequent group GR.

It is preferable that the subsequent group GR includes a vibration-proof group that moves in a direction intersecting with the optical axis Z during image shake correction. Disposing the vibration-proof group in the subsequent group GR facilitates reduction of a diameter of the vibration-proof group and thus, provides an advantage in size reduction. In the present specification, the term “image shake correction” will be referred to as “vibration-proofing”.

For example, the vibration-proof group of the variable magnification optical system in FIG. 1 consists of the lenses L45 to L48 shown in FIG. 2. In the lower part of FIG. 1, a bracket with a downward arrow is given below the lenses constituting the vibration-proof group. While the vibration-proof group functions in the whole magnification range including the wide angle end state, the bracket and the arrow are given in only the lower part of FIG. 1 to avoid complication of the drawing. The above illustration method related to the vibration-proof group is the same for the drawings of other examples.

The variable magnification optical system may be configured to include a focus group that moves along the optical axis Z during focusing. In the example in FIG. 1, the subsequent group GR includes the focus group. Disposing the focus group in the subsequent group GR facilitates reduction of a diameter of the focus group and thus, provides an advantage in size reduction.

For example, the focus group of the variable magnification optical system in FIG. 1 consists of the lenses L52 to L55 shown in FIG. 2. In the lower part of FIG. 1, a bracket with an arrow in a left-to-right direction is given below the lenses constituting the focus group, and the arrow in the left-to-right direction shows a direction in which the focus group moves during focusing from the infinite distance object to a nearest object. While the focus group functions in the whole magnification range including the wide angle end state, the bracket and the arrow are given in only the lower part of FIG. 1 to avoid complication of the drawing. The above illustration method related to the focus group also applies to the drawings of other examples.

Next, preferable configurations of the variable magnification optical system of the present disclosure related to the conditional expressions will be described. In the following description of the conditional expressions, to avoid redundancy, duplicate descriptions of symbols will be omitted using the same symbols for the same definitions. Hereinafter, to avoid redundancy, the “variable magnification optical system of the present disclosure” will be simply referred to as the “variable magnification optical system”.

It is preferable that the variable magnification optical system satisfies Conditional Expression (1). A focal length of the M1 lens group GM1 is denoted by fM1. A focal length of the first lens group G1 is denoted by f1. Ensuring that a corresponding value of Conditional Expression (1) is not less than or equal to its lower limit value can increase the refractive power of the first lens group G1 and thus, provides an advantage in reducing an optical total length. Ensuring that the corresponding value of Conditional Expression (1) is not greater than or equal to its upper limit value provides an advantage in maintaining a magnification changing effect of the M1 lens group GM1 and thus, provides an advantage in achieving a high zoom ratio. In addition, ensuring that the corresponding value of Conditional Expression (1) is not greater than or equal to its upper limit value provides an advantage in reducing a moving amount of the M1 lens group GM1 during changing the magnification and thus, provides an advantage in size reduction.

$$0.05 < ( - fM 1 ) / f 1 < 0.8 \qquad ( 1 )$$

To obtain more favorable characteristics, the lower limit value of Conditional Expression (1) is more preferably 0.08, further preferably 0.1, further preferably 0.12, further preferably 0.14, further preferably 0.16, further preferably 0.18, further preferably 0.2, further preferably 0.21, and further preferably 0.22. To obtain more favorable characteristics, the upper limit value of Conditional Expression (1) is more preferably 0.75, further preferably 0.7, further preferably 0.65, further preferably 0.6, further preferably 0.55, further preferably 0.5, further preferably 0.45, further preferably 0.4, and further preferably 0.35.

In a case where a focal length of the R1 lens group GR1 is denoted by fR1, it is preferable that the variable magnification optical system satisfies Conditional Expression (2). Ensuring that a corresponding value of Conditional Expression (2) is not less than or equal to its lower limit value prevents an excessive decrease in the refractive power of the first lens group G1 and thus, provides an advantage in reducing the optical total length. Ensuring that the corresponding value of Conditional Expression (2) is not greater than or equal to its upper limit value prevents an excessive increase in the refractive power of the first lens group G1 and thus, provides an advantage in reducing fluctuation of aberration during changing the magnification.

$$0.05 < fR 1 / f 1 < 0.85 \qquad ( 2 )$$

To obtain more favorable characteristics, the lower limit value of Conditional Expression (2) is more preferably 0.07, further preferably 0.09, further preferably 0.11, further preferably 0.13, further preferably 0.15, further preferably 0.16, further preferably 0.17, further preferably 0.18, and further preferably 0.185. To obtain more favorable characteristics, the upper limit value of Conditional Expression (2) is more preferably 0.8, further preferably 0.75, further preferably 0.7, further preferably 0.65, further preferably 0.6, further preferably 0.55, further preferably 0.45, further preferably 0.4, and further preferably 0.35.

In a case where a focal length of the Mr lens group GMr is denoted by fMr, it is preferable that the variable magnification optical system satisfies Conditional Expression (3). Ensuring that a corresponding value of Conditional Expression (3) is not less than or equal to its lower limit value prevents an excessive decrease in the refractive power of the M1 lens group GM1 and thus, facilitates reduction of the moving amount of the M1 lens group GM1 during changing the magnification. This provides an advantage in reducing the optical total length. Ensuring that the corresponding value of Conditional Expression (3) is not greater than or equal to its upper limit value prevents an excessive increase in the refractive power of the M1 lens group GM1 and thus, can reduce overcorrection of spherical aberration on a telephoto side. This provides an advantage in achieving high optical performance.

$$0.8 < fMr / fM 1 < 7 \qquad ( 3 )$$

To obtain more favorable characteristics, the lower limit value of Conditional Expression (3) is more preferably 0.95, further preferably 1.1, further preferably 1.25, further preferably 1.4, further preferably 1.55, further preferably 1.7, further preferably 1.8, further preferably 1.9, and further preferably 2. To obtain more favorable characteristics, the upper limit value of Conditional Expression (3) is more preferably 6, further preferably 5.5, further preferably 5, further preferably 4.5, further preferably 4.25, further preferably 4, further preferably 3.75, further preferably 3.5, and further preferably 3.25.

It is preferable that the variable magnification optical system satisfies Conditional Expression (4). A distance on the optical axis from a surface closest to the object side in the first lens group to a surface closest to the image side in the first lens group is denoted by DG1. A distance on the optical axis from the surface closest to the object side in the first lens group G1 to a surface closest to the image side in the subsequent group GR in a state where the infinite distance object is in focus at the wide angle end is denoted by Dsum. For example, FIG. 2 shows the distance DG1 and the distance Dsum. The distance DG1 corresponds to a thickness of the first lens group G1 on the optical axis. Ensuring that a corresponding value of Conditional Expression (4) is not less than or equal to its lower limit value prevents an excessive decrease in a thickness of the first lens group G1 and thus, provides an advantage in correcting chromatic aberration and astigmatism. Ensuring that the corresponding value of Conditional Expression (4) is not greater than or equal to its upper limit value can reduce an excessive increase in a weight of the first lens group G1 and thus, can reduce an excessive increase in a weight of the whole optical system.

$$0.012 < DG 1 / Dsum < 0.25 \qquad ( 4 )$$

To obtain more favorable characteristics, the lower limit value of Conditional Expression (4) is more preferably 0.014, further preferably 0.016, further preferably 0.018, further preferably 0.02, further preferably 0.022, further preferably 0.024, further preferably 0.026, further preferably 0.028, and further preferably 0.03. To obtain more favorable characteristics, the upper limit value of Conditional Expression (4) is more preferably 0.24, further preferably 0.23, further preferably 0.22, further preferably 0.21, further preferably 0.2, further preferably 0.19, further preferably 0.18, further preferably 0.17, and further preferably 0.16.

It is preferable that the variable magnification optical system satisfies Conditional Expression (5). A focal length of the variable magnification optical system in a state where the infinite distance object is in focus at the wide angle end is denoted by fw. Ensuring that a corresponding value of Conditional Expression (5) is not less than or equal to its lower limit value provides an advantage in reducing the optical total length. Ensuring that the corresponding value of Conditional Expression (5) is not greater than or equal to its upper limit value provides an advantage in securing an angle of view at the wide angle end.

$$0.08 < fw / f 1 < 0.3 \qquad ( 5 )$$

To obtain more favorable characteristics, the lower limit value of Conditional Expression (5) is more preferably 0.085, further preferably 0.09, further preferably 0.095, further preferably 0.1, further preferably 0.105, and further preferably 0.11. To obtain more favorable characteristics, the upper limit value of Conditional Expression (5) is more preferably 0.22, further preferably 0.2, further preferably 0.18, further preferably 0.17, further preferably 0.16, and further preferably 0.15.

It is preferable that the variable magnification optical system satisfies Conditional Expression (6). Ensuring that a corresponding value of Conditional Expression (6) is not less than or equal to its lower limit value prevents an excessive increase in the negative refractive power of the M1 lens group GM1 and thus, can reduce an increase in a diameter of a luminous flux incident on the intermediate group GM and a group closer to the image side with respect to the intermediate group GM. This provides an advantage in size reduction. Ensuring that the corresponding value of Conditional Expression (6) is not greater than or equal to its upper limit value prevents an excessive decrease in the negative refractive power of the M1 lens group GM1 and thus, provides an advantage in achieving a high zoom ratio.

$$- 3 < fw / fM 1 < - 0.2 \qquad ( 6 )$$

To obtain more favorable characteristics, the lower limit value of Conditional Expression (6) is more preferably −2.5, further preferably −2, further preferably −1.8, further preferably −1.6, further preferably −1.4, further preferably −1.3, further preferably −1.2, further preferably −1.1, and further preferably −1.05. To obtain more favorable characteristics, the upper limit value of Conditional Expression (6) is more preferably −0.3, further preferably −0.4, further preferably −0.45, further preferably −0.5, further preferably −0.6, further preferably −0.64, further preferably −0.67, further preferably −0.7, and further preferably −0.73.

It is preferable that the variable magnification optical system satisfies Conditional Expression (7). Ensuring that a corresponding value of Conditional Expression (7) is not less than or equal to its lower limit value provides an advantage in reducing fluctuation of spherical aberration during changing the magnification. Ensuring that the corresponding value of Conditional Expression (7) is not greater than or equal to its upper limit value can reduce overcorrection of spherical aberration particularly at the wide angle end.

$$0.1 < fw / fR 1 < 1.4 \qquad ( 7 )$$

To obtain more favorable characteristics, the lower limit value of Conditional Expression (7) is more preferably 0.2, further preferably 0.25, further preferably 0.3, further preferably 0.35, further preferably 0.37, further preferably 0.39, further preferably 0.41, further preferably 0.43, and further preferably 0.45. To obtain more favorable characteristics, the upper limit value of Conditional Expression (7) is more preferably 1.3, further preferably 1.2, further preferably 1.1, further preferably 1, further preferably 0.95, further preferably 0.9, further preferably 0.85, further preferably 0.83, and further preferably 0.81.

It is preferable that the variable magnification optical system satisfies Conditional Expression (8). A focal length of the whole variable magnification optical system in a state where the infinite distance object is in focus at the telephoto end is denoted by ft. Ensuring that a corresponding value of Conditional Expression (8) is not less than or equal to its lower limit value prevents an excessive increase in the refractive power of the first lens group G1 and thus, provides an advantage in reducing fluctuation of aberration during changing the magnification. Ensuring that a corresponding value of Conditional Expression (8) is not greater than or equal to its upper limit value prevents an excessive decrease in the refractive power of the first lens group G1 and thus, provides an advantage in reducing the optical total length.

$$0.6 < f 1 / {( fw \times ft )}^{1 / 2} < 4 \qquad ( 8 )$$

To obtain more favorable characteristics, the lower limit value of Conditional Expression (8) is more preferably 0.9, further preferably 1.2, further preferably 1.4, further preferably 1.55, further preferably 1.65, and further preferably 1.75. To obtain more favorable characteristics, the upper limit value of Conditional Expression (8) is more preferably 3.5, further preferably 3, further preferably 2.9, further preferably 2.8, further preferably 2.5, and further preferably 2.3.

It is preferable that the variable magnification optical system satisfies Conditional Expression (9). Ensuring that a corresponding value of Conditional Expression (9) is not less than or equal to its lower limit value prevents an excessive decrease in the zoom ratio and thus, can sufficiently exhibit value of the variable magnification optical system. Ensuring that the corresponding value of Conditional Expression (9) is not greater than or equal to its upper limit value prevents an excessive increase in the zoom ratio and thus, can prevent an excessive increase in a moving amount of a lens group. This provides an advantage in reducing a size of the whole optical system.

$$9 < ft / fw < 60 \qquad ( 9 )$$

To obtain more favorable characteristics, the lower limit value of Conditional Expression (9) is more preferably 11, further preferably 13, further preferably 15, further preferably 17, further preferably 18, and further preferably 19. To obtain more favorable characteristics, the upper limit value of Conditional Expression (9) is more preferably 50, further preferably 40, further preferably 30, further preferably 25, further preferably 22, and further preferably 20.

In a configuration in which the subsequent group GR includes the vibration-proof group that moves in a direction intersecting with the optical axis Z during image shake correction, it is preferable that the variable magnification optical system satisfies Conditional Expression (10). A focal length of the vibration-proof group is denoted by fois. Ensuring that a corresponding value of Conditional Expression (10) is not less than or equal to its lower limit value can reduce the moving amount of the vibration-proof group during image shake correction and thus, can reduce a size of the whole variable magnification optical system and a size of a vibration-proof unit (that is, the vibration-proof group and a mechanism that moves the vibration-proof group). Ensuring that the corresponding value of Conditional Expression (10) is not greater than or equal to its upper limit value prevents an excessive increase in refractive power of the vibration-proof group and thus, can reduce fluctuation of aberration during image shake correction.

$$0.1 < fw / \vert fois \vert < 1.5 \qquad ( 10 )$$

To obtain more favorable characteristics, the lower limit value of Conditional Expression (10) is more preferably 0.2, further preferably 0.3, further preferably 0.4, further preferably 0.5, further preferably 0.6, and further preferably 0.7. To obtain more favorable characteristics, the upper limit value of Conditional Expression (10) is more preferably 1.1, further preferably 1, further preferably 0.95, further preferably 0.9, further preferably 0.85, and further preferably 0.8.

In a configuration in which the subsequent group GR includes the vibration-proof group, it is preferable that the variable magnification optical system satisfies Conditional Expression (11). A maximum half angle of view in a state where the infinite distance object is in focus at the wide angle end is denoted by ww. A maximum half angle of view in a state where the infinite distance object is in focus at the telephoto end is denoted by ωt. For example, FIG. 1 shows the maximum half angle of view ow and the maximum half angle of view ωt. Conditional Expression (11) is an expression in which movement of an imaging element disposed on the image plane Sim in a direction perpendicular to the optical axis Z for vibration-proofing (that is, image shake correction) is taken into consideration. In Conditional Expression (11), (fw×tan ωw)/(ft×tan ωt) corresponds to a ratio of a size of an image circle at the wide angle end to a size of the image circle at the telephoto end. It is preferable that a vibration-proofing correction angle is substantially constant in the whole magnification range. Thus, it is preferable to change the size of the image circle between the wide angle end and the telephoto end as in Conditional Expression (11). In a case where the vibration-proofing correction angle is constant, a moving amount necessary for moving the imaging element in a direction perpendicular to the optical axis Z for vibration-proofing is increased in proportion to the focal length of the variable magnification optical system. Ensuring that a corresponding value of Conditional Expression (11) is not greater than or equal to its upper limit value can set the image circle at the telephoto end to be larger than the image circle at the wide angle end and thus, facilitates securing of the necessary moving amount of the imaging element within the image circle during vibration-proofing particularly at the telephoto end. Ensuring that the corresponding value of Conditional Expression (11) is not less than or equal to its lower limit value can prevent an excessive increase in a size of the imaging element.

$$0.6 < ( fw \times tan ω w ) / ( ft \times tan ω t ) < 0.98 \qquad ( 11 )$$

To obtain more favorable characteristics, the lower limit value of Conditional Expression (11) is more preferably 0.65, further preferably 0.68, and further preferably 0.7. To obtain more favorable characteristics, the upper limit value of Conditional Expression (11) is more preferably 0.91, further preferably 0.85, and further preferably 0.8.

It is preferable that the variable magnification optical system satisfies Conditional Expression (16). An average value of Abbe numbers based on a d line for all positive lenses of the first lens group G1 is denoted by v1pave. Ensuring that a corresponding value of Conditional Expression (16) is not less than or equal to its lower limit value provides an advantage in correcting axial chromatic aberration particularly at the telephoto end. Ensuring that the corresponding value of Conditional Expression (16) is not greater than or equal to its upper limit value provides an advantage in correcting various types of aberration other than chromatic aberration.

$$70 < v 1 pave < 97 \qquad ( 16 )$$

To obtain more favorable characteristics, the lower limit value of Conditional Expression (16) is more preferably 78 and further preferably 86. To obtain more favorable characteristics, the upper limit value of Conditional Expression (16) is more preferably 95 and further preferably 93.

It is preferable that the variable magnification optical system satisfies Conditional Expression (20). Ensuring that a corresponding value of Conditional Expression (20) is not less than or equal to its lower limit value can reduce an excessive increase in an angle of incidence of an off-axis chief ray on the image plane Sim and provides an advantage in reducing fluctuation of aberration during changing the magnification. Ensuring that the corresponding value of Conditional Expression (20) is not greater than or equal to its upper limit value provides an advantage in reducing spherical aberration at the telephoto end.

$$0.1 < ( - fMr ) / fR 1 < 5 \qquad ( 20 )$$

To obtain more favorable characteristics, the lower limit value of Conditional Expression (20) is more preferably 0.3, further preferably 0.5, further preferably 0.7, further preferably 0.9, further preferably 1.1, and further preferably 1.3. To obtain more favorable characteristics, the upper limit value of Conditional Expression (20) is more preferably 4, further preferably 3, further preferably 2.5, further preferably 2.1, further preferably 1.8, and further preferably 1.5.

It is preferable that the variable magnification optical system includes at least one specific lens described below. The specific lens is defined as a lens satisfying Conditional Expressions (12) and (13). A refractive index at a d line for a lens included in the variable magnification optical system is denoted by Nd. An Abbe number based on the d line for the lens included in the variable magnification optical system is denoted by vd.

$$2.435 < Nd + 0.01425 \times vd < 2.75 \qquad ( 12 )$$

$$15 < vd < 39 \qquad ( 13 )$$

A material of the specific lens may be, for example, glass. Optical glass satisfying Conditional Expressions (12) and (13) and a method of manufacturing the optical glass are described in p.40 to 42 of the manuscript of the 49th Optical Symposium (duration: Jun. 20 and 21, 2024, host: The Optical Society of Japan, a general incorporated association).

Ensuring that a corresponding value of Conditional Expression (12) is not less than or equal to its lower limit value provides an advantage in favorably performing correction of spherical aberration and correction of chromatic aberration. Ensuring that the corresponding value of Conditional Expression (12) is not greater than or equal to its upper limit value can reduce an increase in difficulty of correcting field curvature.

To obtain more favorable characteristics, the lower limit value of Conditional Expression (12) is more preferably 2.445, further preferably 2.455, further preferably 2.468, further preferably 2.48, further preferably 2.49, further preferably 2.5, further preferably 2.51, and further preferably 2.52. To obtain more favorable characteristics, the upper limit value of Conditional Expression (12) is more preferably 2.74, further preferably 2.73, further preferably 2.72, further preferably 2.71, further preferably 2.7, further preferably 2.69, further preferably 2.68, and further preferably 2.67.

Ensuring that a corresponding value of Conditional Expression (13) is not less than or equal to its lower limit value can favorably correct a second-order spectrum in addition to first-order achromatization in correcting chromatic aberration. Ensuring that the corresponding value of Conditional Expression (13) is not greater than or equal to its upper limit value can favorably correct the second-order spectrum more reliably.

To obtain more favorable characteristics, the lower limit value of Conditional Expression (13) is more preferably 15.5, further preferably 16, further preferably 16.5, further preferably 16.8, further preferably 17.1, and further preferably 17.3. To obtain more favorable characteristics, the upper limit value of Conditional Expression (13) is more preferably 37, further preferably 35, further preferably 33, further preferably 32, further preferably 31, and further preferably 30.

In a case where a partial dispersion ratio between a g line and an F line for the lens included in the variable magnification optical system is denoted by θgF, it is preferable that the specific lens satisfies Conditional Expression (14).

$$0.65 < θ gF + 0.00316 \times vd < 0.85 \qquad ( 14 )$$

In a case where refractive indices at a g line, an F line, and a C line for a lens are denoted by Ng, NF, and NC, respectively, and a partial dispersion ratio between the g line and the F line for the lens is denoted by θgF, θgF is defined by the following expression.

$$θ gF = ( Ng - NF ) / ( NF - NC )$$

Ensuring that a corresponding value of Conditional Expression (14) is not less than or equal to its lower limit value can favorably correct the second-order spectrum in addition to the first-order achromatization in correcting chromatic aberration. Ensuring that the corresponding value of Conditional Expression (14) is not greater than or equal to its upper limit value can favorably correct the second-order spectrum more reliably.

To obtain more favorable characteristics, the lower limit value of Conditional Expression (14) is more preferably 0.67, further preferably 0.675, further preferably 0.68, further preferably 0.683, further preferably 0.689, and further preferably 0.692. To obtain more favorable characteristics, the upper limit value of Conditional Expression (14) is more preferably 0.8, further preferably 0.78, further preferably 0.76, further preferably 0.74, further preferably 0.73, and further preferably 0.725.

It is preferable that the intermediate group GM includes at least one specific lens. Doing so provides an advantage in reducing fluctuation of chromatic aberration during changing the magnification. It is preferable that the specific lens included in the intermediate group GM satisfies Conditional Expression (14).

Particularly, it is preferable that the Mr lens group GMr includes at least one specific lens. Doing so provides an advantage in reducing fluctuation of chromatic aberration during changing the magnification. It is preferable that the specific lens included in the Mr lens group GMr satisfies Conditional Expression (14).

It is preferable that the subsequent group GR includes at least one specific lens. Doing so provides an advantage in reducing particularly axial chromatic aberration. It is preferable that the specific lens included in the subsequent group GR satisfies Conditional Expression (14).

It is preferable that the variable magnification optical system includes at least one cemented lens, and the at least one cemented lens of the variable magnification optical system includes the specific lens. Adopting the specific lens as a lens constituting the cemented lens provides an advantage in reducing chromatic aberration. It is preferable that the specific lens included in the cemented lens satisfies Conditional Expression (14).

In a configuration in which the variable magnification optical system includes the specific lens, it is preferable that the variable magnification optical system satisfies Conditional Expression (15). A maximum effective diameter of the specific lens having the maximum effective diameter among the specific lenses included in the variable magnification optical system is denoted by EDL. That is, the larger of an effective diameter of a surface on the object side or an effective diameter of a surface on the image side of the specific lens having the maximum effective diameter is denoted by EDL. Ensuring that a corresponding value of Conditional Expression (15) is not less than or equal to its lower limit value prevents an excessive decrease in a diameter of the specific lens and thus, facilitates correction of lateral chromatic aberration. Ensuring that the corresponding value of Conditional Expression (15) is not greater than or equal to its upper limit value prevents an excessive increase in the diameter of the specific lens and thus, can reduce an increase in difficulty of manufacturing the specific lens.

$$0.1 < EDL / ( 2 \times ft \times tan ω t ) < 2 \qquad ( 15 )$$

To obtain more favorable characteristics, the lower limit value of Conditional Expression (15) is more preferably 0.2, further preferably 0.3, further preferably 0.36, further preferably 0.39, further preferably 0.41, and further preferably 0.43. To obtain more favorable characteristics, the upper limit value of Conditional Expression (15) is more preferably 1.8, further preferably 1.6, further preferably 1.4, further preferably 1.2, further preferably 1, and further preferably 0.95.

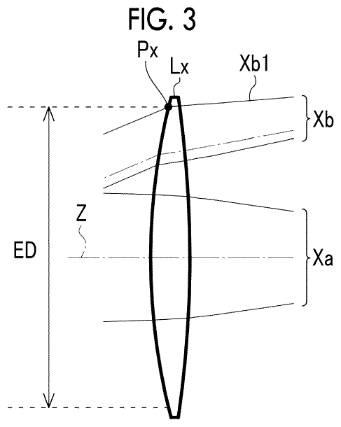

The term “effective diameter” will be described with reference to FIG. 3. FIG. 3 is a diagram for description and shows a configuration in a cross section including the optical axis Z. In FIG. 3, a left side is the object side, and a right side is the image side. FIG. 3 shows an on-axis luminous flux Xa and an off-axis luminous flux Xb that pass through a lens Lx. In the example in FIG. 3, a ray Xb1 that is an upper ray of the off-axis luminous flux Xb is a ray passing through the outermost side. The term “outer side” means an outer side in a diameter direction centered on the optical axis Z, that is, a side away from the optical axis Z. In the present specification, an effective diameter ED is twice a distance from a position Px of an intersection between the ray passing through the outermost side and a lens surface to the optical axis Z. While the upper ray of the off-axis luminous flux Xb is the ray passing through the outermost side in the example in FIG. 3, which ray will be the ray passing through the outermost side varies depending on the optical system.

Various modifications can be made to the variable magnification optical system of the present disclosure without departing from the gist of the disclosed technology. For example, the number of lens groups included in the intermediate group GM and the number of lens groups included in the subsequent group GR may be different from those in the example in FIG. 1. The numbers of lenses included in each lens group, the vibration-proof group, and the focus group may be different from those in the example in FIG. 1. While FIG. 1 shows an example in which the variable magnification optical system is a zoom lens, the variable magnification optical system of the present disclosure may be a varifocal lens.

For example, the intermediate group GM may be configured to consist of three lens groups. Doing so provides an advantage in reducing fluctuation of aberration during changing the magnification.

More specifically, the intermediate group GM may be configured to consist of, in order from the object side to the image side, the M1 lens group GM1 having negative refractive power, an M2p lens group having positive refractive power, and the Mr lens group GMr having negative refractive power. In a configuration in which the intermediate group GM consists of the M1 lens group GM1, the M2p lens group, and the Mr lens group GMr, it is preferable that the variable magnification optical system satisfies Conditional Expression (19). A focal length of the M2p lens group is denoted by fM2p. Ensuring that a corresponding value of Conditional Expression (19) is not less than or equal to its lower limit value provides an advantage in reducing fluctuation of aberration during changing the magnification. Ensuring that the corresponding value of Conditional Expression (19) is not greater than or equal to its upper limit value provides an advantage in reducing spherical aberration at the telephoto end.

$$0.3 < fM 2 p / ( - fMr ) < 5 \qquad ( 19 )$$

To obtain more favorable characteristics, the lower limit value of Conditional Expression (19) is more preferably 0.7, further preferably 1, further preferably 1.2, further preferably 1.4, further preferably 1.6, and further preferably 1.8. To obtain more favorable characteristics, the upper limit value of Conditional Expression (19) is more preferably 4.5, further preferably 4, further preferably 3.8, further preferably 3.6, further preferably 3.4, and further preferably 3.2.

Alternatively, the intermediate group GM may be configured to consist of, in order from the object side to the image side, the M1 lens group having negative refractive power, an M2n lens group having negative refractive power, and the Mr lens group GMr having negative refractive power. In a configuration in which the intermediate group GM consists of the M1 lens group GM1, the M2n lens group, and the Mr lens group GMr, it is preferable that the variable magnification optical system satisfies Conditional Expression (21). A focal length of the M2n lens group is denoted by fM2n. Ensuring that a corresponding value of Conditional Expression (21) is not less than or equal to its lower limit value prevents an excessive decrease in the negative refractive power of the M1 lens group GM1 and thus, provides an advantage in achieving a high zoom ratio. Ensuring that the corresponding value of Conditional Expression (21) is not greater than or equal to its upper limit value prevents an excessive decrease in the negative refractive power of the M2n lens group and thus, can distribute negative refractive power between the M1 lens group GM1 and the M2n lens group in a well-balanced manner. This provides an advantage in reducing fluctuation of aberration during changing the magnification.

$$1 < fM 2 n / fM 1 < 20 \qquad ( 21 )$$

To obtain more favorable characteristics, the lower limit value of Conditional Expression (21) is more preferably 1.2, further preferably 1.3, further preferably 1.4, further preferably 1.5, further preferably 1.6, and further preferably 1.7. To obtain more favorable characteristics, the upper limit value of Conditional Expression (21) is more preferably 10, further preferably 7, further preferably 4, further preferably 3.5, further preferably 3.3, and further preferably 3.

The subsequent group GR may be configured to include at least one lens group having negative refractive power. In a configuration in which the subsequent group GR includes at least one lens group having negative refractive power, it is preferable that the variable magnification optical system satisfies Conditional Expression (17). A focal length of a lens group having negative refractive power closest to the object side among the lens groups having negative refractive power and included in the subsequent group GR is denoted by fRnf. Ensuring that a corresponding value of Conditional Expression (17) is not less than or equal to its lower limit value provides an advantage in reducing fluctuation of aberration during changing the magnification. Ensuring that the corresponding value of Conditional Expression (17) is not greater than or equal to its upper limit value provides an advantage in reducing spherical aberration at the telephoto end.

$$0.1 < fR 1 / ( - fRnf ) < 5 \qquad ( 17 )$$

To obtain more favorable characteristics, the lower limit value of Conditional Expression (17) is more preferably 0.2, further preferably 0.3, further preferably 0.35, further preferably 0.4, further preferably 0.45, and further preferably 0.5. To obtain more favorable characteristics, the upper limit value of Conditional Expression (17) is more preferably 4, further preferably 3, further preferably 2, further preferably 1.5, further preferably 1, and further preferably 0.8.

The subsequent group GR may be configured to include at least two lens groups having negative refractive power. In a configuration in which the subsequent group GR includes at least two lens groups having negative refractive power, it is preferable that the variable magnification optical system satisfies Conditional Expression (18). A focal length of a lens group having negative refractive power closest to the image side among the lens groups having negative refractive power and included in the subsequent group GR is denoted by fRnr. Ensuring that a corresponding value of Conditional Expression (18) is not less than or equal to its lower limit value provides an advantage in preventing overcorrection of aberration during changing the magnification. Ensuring that the corresponding value of Conditional Expression (18) is not greater than or equal to its upper limit value can reduce an excessive increase in the angle of incidence of the off-axis chief ray on the image plane Sim.

$$0.01 < fR 1 / ( - fRnr ) < 0.5 \qquad ( 18 )$$

To obtain more favorable characteristics, the lower limit value of Conditional Expression (18) is more preferably 0.012, further preferably 0.014, further preferably 0.016, further preferably 0.018, further preferably 0.02, and further preferably 0.022. To obtain more favorable characteristics, the upper limit value of Conditional Expression (18) is more preferably 0.4, further preferably 0.3, further preferably 0.25, further preferably 0.2, further preferably 0.15, and further preferably 0.1.

The above preferable configurations and available configurations including the configurations related to the conditional expressions can be used in any combination thereof without contradiction and are preferably appropriately selected and adopted in accordance with required specifications.

For example, in a preferable aspect of the present disclosure, the variable magnification optical system consists of, in order from the object side to the image side, the first lens group G1 having positive refractive power, the intermediate group GM, and the subsequent group GR, in which the M1 lens group GM1 having negative refractive power is disposed closest to the object side in the intermediate group GM, the Mr lens group GMr having negative refractive power is disposed closest to the image side in the intermediate group GM, the intermediate group GM consists of three or fewer lens groups having refractive power, including the M1 lens group GM1 and the Mr lens group GMr, the R1 lens group GR1 having positive refractive power is disposed closest to the object side in the subsequent group GR, during changing the magnification, the first lens group G1 remains stationary with respect to the image plane Sim, and all spacings between adjacent lens groups change, and Conditional Expression (1) is satisfied.

Next, examples of the variable magnification optical system of the present disclosure will be described with reference to the drawings. Reference numerals given to each group in the cross-sectional views of each example are independently used for each example to avoid complication of description and the drawings caused by an increasing number of digits of the reference numerals. Accordingly, a common reference numeral given in the drawings of different examples does not necessarily indicate a common configuration.

### Example 1

A configuration and a moving trajectory of the variable magnification optical system of Example 1 are shown in FIG. 1, and its illustration method and configuration are described above. Thus, duplicate descriptions will be partially omitted. The variable magnification optical system of Example 1 consists of, in order from the object side to the image side, the first lens group G1 having positive refractive power, the intermediate group GM, and the subsequent group GR. The intermediate group GM consists of, in order from the object side to the image side, two lens groups including the M1 lens group GM1 having negative refractive power and the Mr lens group GMr having negative refractive power. The subsequent group GR consists of one lens group that is the R1 lens group GR1 having positive refractive power.

During changing the magnification from the wide angle end to the telephoto end, the first lens group G1 and the R1 lens group GR1 remain stationary with respect to the image plane Sim, and other lens groups move along the optical axis Z by changing a spacing with respect to an adjacent lens group. The vibration-proof group consists of four lenses that are fifth to eighth lenses in the R1 lens group GR1 from the object side. The focus group consists of four lenses that are twelfth to fifteenth lenses in the R1 lens group GR1 from the object side. During focusing from the infinite distance object to the nearest object, the focus group moves to the image side.

For the variable magnification optical system of Example 1, Tables 1A and 1B show basic lens data, and Table 2 shows specifications and variable surface spacings. The basic lens data is divided and shown in two tables to avoid one lengthy table.

The table of the basic lens data is described as follows. A column of “Sn” shows surface numbers in a case where a surface closest to the object side is set as a first surface, and the number is increased by one at a time to the image side. A column of “R” shows a curvature radius of each surface. A column of “D” shows a surface spacing on the optical axis between each surface and a surface adjacent to each surface on the image side. A column of “Nd” shows a refractive index at a d line for each constituent. A column of “vd” shows an Abbe number based on the d line for each constituent. A column of “θgF” shows a partial dispersion ratio between a g line and an F line for each constituent. A column of “Material” shows a material name and a manufacturer name of each constituent with a period therebetween. Here, the manufacturer name is schematically shown as follows, including the tables of the examples described later. “HOYA” indicates HOYA Corporation. “OHARA” indicates OHARA INC. “HIKARI” indicates HIKARI GLASS Co., Ltd. “SCHOTT” indicates SCHOTT AG. “SUMITA” indicates Sumita Optical Industries Ltd. “CDGM” indicates Chengdu Guangming Guangdian Co., Ltd. “NHG” indicates Hubei New Huaguang Information Materials Co., Ltd. A column of “ED” shows an effective diameter of each surface.

In the table of the basic lens data, a sign of the curvature radius of a surface having a convex shape facing the object side is positive, and a sign of the curvature radius of a surface having a convex shape facing the image side is negative. A field of the surface number of a surface corresponding to the aperture stop St shows the surface number and a text (St). A value in a lowermost field of the column of D in the table is a spacing between a surface closest to the image side in the table and the image plane Sim. A symbol DD [ ] is used for the variable surface spacings during changing the magnification. A surface number on the object side of the spacing is given within [ ] in the column of the surface spacing.

Table 2 shows a zoom ratio Zr, a focal length f, a back focus Bf, an open F-number FNo., a maximum full angle of view 2ω, and the variable surface spacings based on a d line. In a case where the variable magnification optical system is a zoom lens, the zoom ratio is synonymous with a zoom magnification. Here, [°] in a field of 2ω indicates that 2ω is in degree units. Table 2 shows each value in the wide angle end state, a middle focal length state, and the telephoto end state in columns labeled “Wide”, “Middle”, and “Tele”, respectively.

In the data of each table, a degree unit is used for angles, and a millimeter unit is used for lengths. However, since the optical system can also be proportionally enlarged or proportionally reduced to be used, other appropriate units can also be used. Each table below shows numerical values rounded to predetermined digits.

TABLE 1A
Example 1

| Sn | R | D | Nd | vd | θgF | Material | ED |
|---|---|---|---|---|---|---|---|
| 1 | 372.3159 | 5.1493 | 1.56732 | 42.84 | 0.57436 | E-FL6.HOYA | 90.00 |
| 2 | 131.1159 | 14.9275 | 1.49700 | 81.61 | 0.53887 | FCD1.HOYA | 87.26 |
| 3 | −341.4615 | 0.4850 | | | | | 86.04 |
| 4 | 165.1160 | 10.3673 | 1.49700 | 81.61 | 0.53887 | FCD1.HOYA | 81.61 |
| 5 | −233.1475 | 2.8609 | 1.80420 | 46.50 | 0.55727 | TAF3D.HOYA | 80.71 |
| 6 | 501.1608 | 1.0772 | | | | | 77.84 |
| 7 | 93.1554 | 8.1280 | 1.49700 | 81.61 | 0.53887 | FCD1.HOYA | 74.00 |
| 8 | 558.1485 | DD[8] | | | | | 73.30 |
| 9 | 40.0200 | 1.0009 | 1.83481 | 42.74 | 0.56490 | S-LAH55VS.OHARA | 34.00 |
| 10 | 19.5338 | 8.0733 | | | | | 29.31 |
| 11 | −110.4559 | 6.5930 | 1.84666 | 23.78 | 0.61923 | FDS90-SG.HOYA | 28.65 |
| 12 | −21.7256 | 1.0100 | 1.80610 | 40.73 | 0.56719 | NBFD 13.HOYA | 28.64 |
| 13 | 392.1701 | 1.9069 | | | | | 27.18 |
| 14 | −465.7950 | 1.5668 | 1.72342 | 37.99 | 0.58202 | BAFD8.HOYA | 26.68 |
| 15 | 20.1790 | 6.1944 | 1.96300 | 24.11 | 0.62126 | S-TIH57.OHARA | 25.58 |
| 16 | −89.7087 | 1.3181 | | | | | 25.34 |
| 17 | −45.4324 | 1.0020 | 2.10420 | 17.02 | 0.66311 | E-FDS3-W.HOYA | 24.80 |
| 18 | 792.5616 | DD[18] | | | | | 24.45 |
| 19 | −40.9856 | 1.0102 | 1.83400 | 37.16 | 0.57759 | S-LAH60.OHARA | 16.57 |
| 20 | 87.1175 | 1.4606 | 1.98613 | 16.48 | 0.66558 | FDS16-W.HOYA | 17.24 |
| 21 | −984.3986 | DD[21] | | | | | 17.49 |
| 22 | 83.9121 | 3.7708 | 1.49700 | 81.61 | 0.53887 | FCD1.HOYA | 22.81 |
| 23 | −46.0610 | 2.8061 | | | | | 23.01 |
| 24 (St) | ∞ | 2.0000 | | | | | 22.72 |
| 25 | 43.2815 | 3.4696 | 1.49700 | 81.61 | 0.53887 | FCD1.HOYA | 22.58 |
| 26 | −141.9748 | 1.0112 | 1.53996 | 59.46 | 0.54418 | S-BAL12.OHARA | 22.27 |
| 27 | 127.2942 | 1.7371 | | | | | 21.91 |
| 28 | 41.0867 | 4.3221 | 1.49700 | 81.61 | 0.53887 | FCD1.HOYA | 21.38 |
| 29 | −53.0986 | 2.6245 | | | | | 20.80 |

TABLE 1B
Example 1

| Sn | R | D | Nd | vd | θgF | Material | ED |
|---|---|---|---|---|---|---|---|
| 30 | −45.5822 | 1.2517 | 1.92119 | 23.96 | 0.62025 | FDS24-W.HOYA | 19.46 |
| 31 | −281.0218 | 1.5171 | | | | | 19.37 |
| 32 | −40.0825 | 1.3037 | 1.70154 | 41.15 | 0.57704 | BAFD7.HOYA | 19.29 |
| 33 | −123.0141 | 0.1579 | | | | | 19.54 |
| 34 | 32.3849 | 1.9218 | 1.49700 | 81.61 | 0.53887 | FCD1.HOYA | 19.73 |
| 35 | 63.3059 | 1.0002 | | | | | 19.55 |
| 36 | 87.2906 | 1.0001 | 1.65160 | 58.40 | 0.53973 | LAC7.HOYA | 19.50 |
| 37 | 28.5287 | 4.8303 | | | | | 19.22 |
| 38 | 103.9854 | 3.2360 | 1.54072 | 47.20 | 0.56784 | E-FEL2.HOYA | 20.20 |
| 39 | −41.6111 | 0.1042 | | | | | 20.36 |
| 40 | 35.0857 | 2.8246 | 1.58144 | 40.89 | 0.57680 | E-FL5.HOYA | 20.06 |
| 41 | −200.4665 | 0.3217 | | | | | 19.74 |
| 42 | −106.6433 | 1.0002 | 1.98613 | 16.48 | 0.66558 | FDS16-W.HOYA | 19.68 |
| 43 | −270.5849 | 8.4105 | | | | | 19.48 |
| 44 | −28.6079 | 1.7123 | 1.84666 | 23.78 | 0.62054 | S-TIH53.OHARA | 17.91 |
| 45 | −23.9889 | 0.4336 | | | | | 18.17 |
| 46 | 691.5788 | 1.0248 | 1.69100 | 54.82 | 0.54499 | S-LAL9.OHARA | 17.34 |
| 47 | 26.4541 | 0.5759 | | | | | 16.81 |
| 48 | 26.9125 | 5.0098 | 1.62004 | 36.30 | 0.58729 | E-F2.HOYA | 16.85 |
| 49 | −17.5043 | 1.2447 | 1.83481 | 42.72 | 0.56514 | TAFD5F.HOYA | 16.53 |
| 50 | 117.0272 | 15.8359 | | | | | 16.36 |
| 51 | ∞ | 1.0000 | 1.51680 | 64.20 | 0.53430 | BSC7.HOYA | 16.84 |
| 52 | ∞ | 7.7881 | | | | | 16.86 |
| 53 | −15.6499 | 1.0564 | 1.83400 | 37.16 | 0.57759 | S-LAH60.OHARA | 17.02 |
| 54 | 56.1107 | 3.0258 | 1.65253 | 39.48 | 0.57318 | NBFD38.HOYA | 19.59 |
| 55 | −41.5637 | 0.1524 | | | | | 20.23 |
| 56 | 48.2509 | 7.0182 | 1.49700 | 81.61 | 0.53887 | FCD1.HOYA | 22.50 |
| 57 | −24.4729 | 5.8979 | | | | | 23.43 |

TABLE 2
Example 1

| | Wide | Middle | Tele |
|---|---|---|---|
| Zr | 1.0 | 6.6 | 19.3 |
| f | 20.12 | 132.32 | 388.23 |
| Bf | 5.8979 | 5.8979 | 5.8979 |
| FNo. | 4.12 | 4.12 | 4.92 |
| 2ω [°] | 46.0 | 8.2 | 3.4 |
| DD[8] | 2.0069 | 77.8086 | 95.6702 |
| DD[18] | 91.8529 | 9.3698 | 6.0760 |
| DD[21] | 9.0682 | 15.7496 | 1.1817 |

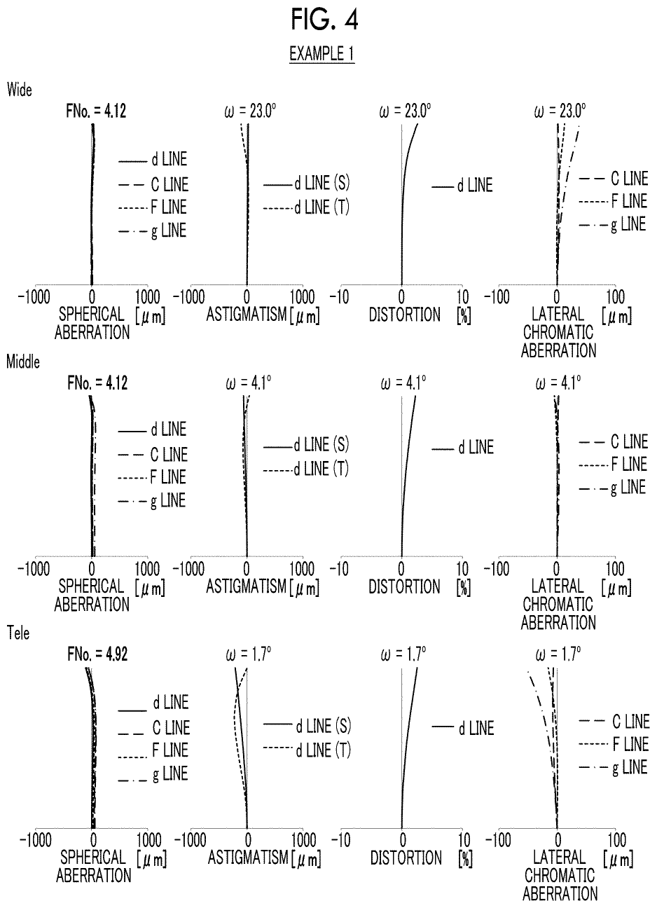

FIG. 4 shows each aberration diagram of the variable magnification optical system of Example 1 in a state where the infinite distance object is in focus. FIG. 4 shows, in order from the left, spherical aberration, astigmatism, distortion, and lateral chromatic aberration. In FIG. 4, an upper part labeled “Wide” shows aberration in the wide angle end state, a middle part labeled “Middle” shows aberration in the middle focal length state, and a lower part labeled “Tele” shows aberration in the telephoto end state. In the spherical aberration diagram, aberration on a d line, a C line, an F line, and a g line is shown by a solid line, a long broken line, a short broken line, and a dot dash line, respectively. In the astigmatism diagram, aberration on a d line in a sagittal direction is shown by a solid line, and aberration on a d line in a tangential direction is shown by a short broken line. In the distortion diagram, aberration on a d line is shown by a solid line. In the lateral chromatic aberration diagram, aberration on a C line, an F line, and a g line is shown by a long broken line, a short broken line, and a dot dash line, respectively. In the spherical aberration diagram, a value of the open F-number is shown after FNo.=. In other aberration diagrams, a value of the maximum half angle of view is shown after ω=.

Symbols, meanings, description methods, and illustration methods of each data related to Example 1 are basically the same for the following examples unless otherwise specified. Thus, duplicate descriptions will be omitted below.

### Example 2

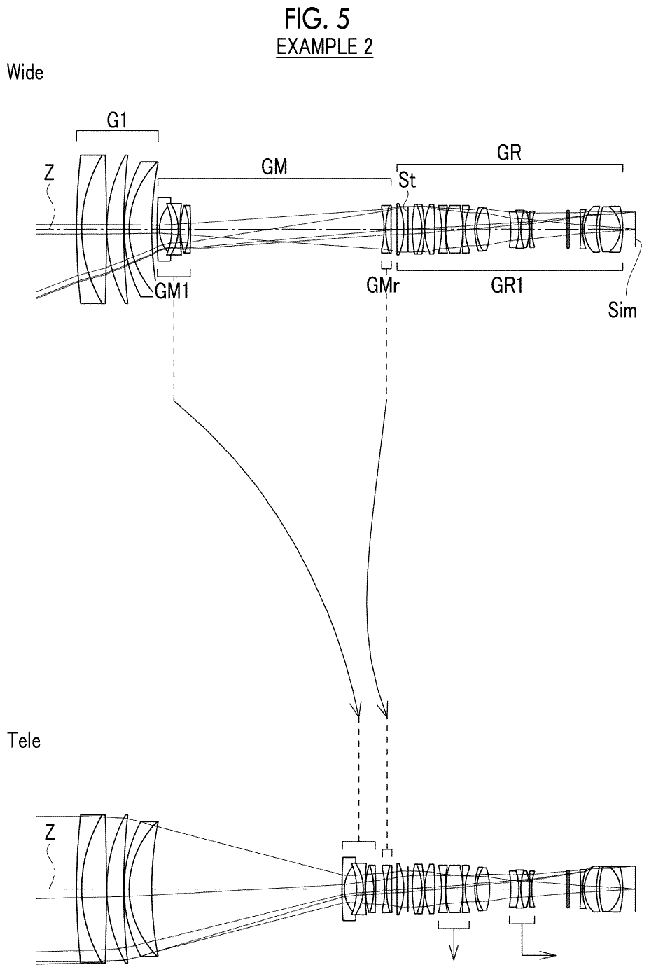

A configuration and a moving trajectory of a variable magnification optical system of Example 2 are shown in FIG. 5. The variable magnification optical system of Example 2 consists of, in order from the object side to the image side, the first lens group G1 having positive refractive power, the intermediate group GM, and the subsequent group GR. The intermediate group GM consists of, in order from the object side to the image side, two lens groups including the M1 lens group GM1 having negative refractive power and the Mr lens group GMr having negative refractive power. The subsequent group GR consists of one lens group that is the R1 lens group GR1 having positive refractive power.

During changing the magnification from the wide angle end to the telephoto end, the first lens group G1 and the R1 lens group GR1 remain stationary with respect to the image plane Sim, and other lens groups move along the optical axis Z by changing a spacing with respect to an adjacent lens group. The vibration-proof group consists of three lenses that are fifth to seventh lenses in the R1 lens group GR1 from the object side. The focus group consists of four lenses that are tenth to thirteenth lenses in the R1 lens group GR1 from the object side. During focusing from the infinite distance object to the nearest object, the focus group moves to the image side.

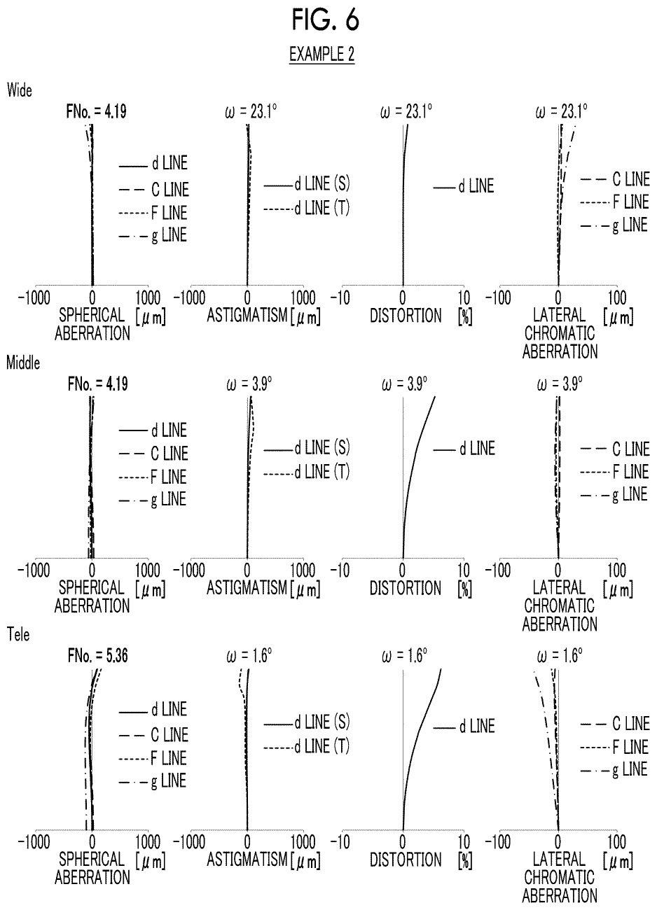

For the variable magnification optical system of Example 2, Tables 3A and 3B show basic lens data, Table 4 shows specifications and variable surface spacings, Table 5 shows aspherical coefficients, and FIG. 6 shows each aberration diagram.

In the table of the basic lens data, the surface number of an aspherical surface is marked with *, and a field of the curvature radius of the aspherical surface shows a value of a paraxial curvature radius. In Table 5, a column of Sn shows the surface number of the aspherical surface, and columns of KA and Am show numerical values of the aspherical coefficients for each aspherical surface. Here, m in Am is an integer greater than or equal to 3 and varies depending on the surface. For example, m=4, 6, 8, 10, 12, 14, 16, 18, and 20 is established for a forty-fifth surface of Example 2. Here, “E±n” (n: integer) in the numerical values of the aspherical coefficients in Table 5 means “×10^{±n}”. KA and Am are aspherical coefficients in an aspheric equation represented by the following expression.

$$Z d = C \times {h}^{2} / \{ 1 + {( 1 - KA \times {C}^{2} \times {h}^{2} )}^{1 / 2} \} + Σ A m \times {h}^{m}$$

where
Zd: a depth of the aspherical surface (a length of a perpendicular line drawn from a point on the aspherical surface at a height h to a plane that is in contact with an aspherical surface apex and that is perpendicular to the optical axis Z)
h: a height (a distance from the optical axis Z to the lens surface)
C: a reciprocal of the paraxial curvature radius
KA and Am: aspherical coefficients

Σ in the aspheric equation means a sum total related to m. The above description method related to the aspherical surface is basically the same for the following examples unless otherwise specified.

TABLE 3A
Example 2

| Sn | R | D | Nd | vd | θgF | Material | ED |
|---|---|---|---|---|---|---|---|
| 1 | 370.8101 | 2.4200 | 1.51633 | 64.06 | 0.53345 | L-BSL7.OHARA | 75.00 |
| 2 | 77.7940 | 11.5958 | 1.49700 | 81.54 | 0.53748 | S-FPL51.OHARA | 73.91 |
| 3 | −1370.1186 | 0.2000 | | | | | 73.73 |
| 4 | 84.5005 | 7.9090 | 1.49700 | 81.54 | 0.53748 | S-FPL51.OHARA | 72.19 |
| 5 | 364.2708 | 0.2000 | | | | | 71.53 |
| 6 | 78.1569 | 2.4000 | 1.88300 | 40.76 | 0.56679 | S-LAH58.OHARA | 68.20 |
| 7 | 50.6108 | 10.5908 | 1.49700 | 81.54 | 0.53748 | S-FPL51.OHARA | 64.07 |
| 8 | 192.3673 | DD[8] | | | | | 63.23 |
| 9 | 276.0956 | 1.1002 | 1.83481 | 42.72 | 0.56477 | TAFD5G.HOYA | 22.55 |
| 10 | 18.5600 | 5.8153 | | | | | 19.88 |
| 11 | −35.8551 | 3.1001 | 1.89286 | 20.36 | 0.63944 | S-NPH4.OHARA | 19.41 |
| 12 | −25.3140 | 0.8600 | 1.80400 | 46.53 | 0.55775 | S-LAH65VS.OHARA | 19.69 |
| 13 | 147.9139 | 0.2000 | | | | | 19.94 |
| 14 | 45.5355 | 3.8800 | 1.85478 | 24.80 | 0.61232 | S-NBH56.OHARA | 20.20 |
| 15 | −39.2053 | 0.8499 | 1.95203 | 26.20 | 0.61011 | NBFD265.HOYA | 20.09 |
| 16 | −279.9213 | DD[16] | | | | | 20.00 |
| 17 | −45.0199 | 0.8101 | 1.81600 | 46.62 | 0.55682 | S-LAH59.OHARA | 20.00 |
| 18 | 43.2568 | 2.4468 | 1.90200 | 25.26 | 0.61662 | J-LASFH24.HIKARI | 20.93 |
| 19 | 730.9045 | DD[19] | | | | | 21.24 |
| 20 | 8603.6074 | 3.2002 | 1.81600 | 46.62 | 0.55682 | S-LAH59.OHARA | 23.39 |
| 21 | −37.5910 | 2.0000 | | | | | 23.66 |
| 22 (St) | ∞ | 2.0100 | | | | | 23.00 |
| 23 | 70.6604 | 4.5256 | 1.49700 | 81.54 | 0.53748 | S-FPL51.OHARA | 23.21 |
| 24 | −33.0115 | 1.1000 | 1.85896 | 22.73 | 0.62844 | S-NPH5.OHARA | 23.11 |
| 25 | −67.9961 | 0.2000 | | | | | 23.32 |
| 26 | 31.0179 | 4.7226 | 1.49700 | 81.54 | 0.53748 | S-FPL51.OHARA | 23.36 |
| 27 | −181.8578 | 3.2164 | | | | | 22.83 |
| 28 | −49.1171 | 1.7029 | 1.85136 | 40.07 | 0.56879 | M-TAFD315.HOYA | 21.75 |
| 29 | 72.5133 | 0.2000 | | | | | 21.65 |

TABLE 3B
Example 2

| Sn | R | D | Nd | vd | θgF | Material | ED |
|---|---|---|---|---|---|---|---|
| 30 | 38.8975 | 8.0769 | 1.62588 | 35.72 | 0.58880 | J-F1.HIKARI | 21.85 |
| 31 | −48.7240 | 0.2126 | | | | | 21.33 |
| 32 | −174.4875 | 0.9094 | 1.83481 | 42.74 | 0.56490 | S-LAH55VS.OHARA | 20.83 |
| 33 | 28.7749 | 4.5120 | | | | | 20.26 |
| 34 | 34.9888 | 0.9000 | 1.83481 | 42.74 | 0.56490 | S-LAH55VS.OHARA | 21.59 |
| 35 | 21.4419 | 6.0604 | 1.53775 | 74.70 | 0.53936 | S-FPM3.OHARA | 21.32 |
| 36 | −39.7873 | 9.9327 | | | | | 21.43 |
| 37 | −66.6559 | 3.8782 | 1.73800 | 32.33 | 0.59005 | S-NBH53V.OHARA | 18.20 |
| 38 | −31.3987 | 0.9000 | 1.77250 | 49.60 | 0.55212 | S-LAH66.OHARA | 18.19 |
| 39 | 32.6934 | 3.9087 | 1.62205 | 41.08 | 0.56917 | S-NBM52.OHARA | 18.21 |
| 40 | −37.4933 | 0.2564 | | | | | 18.30 |
| 41 | 28448.0660 | 0.9047 | 1.49700 | 81.54 | 0.53748 | S-FPL51.OHARA | 18.00 |
| 42 | 29.3596 | 16.6265 | | | | | 17.68 |
| 43 | ∞ | 1.0000 | 1.51633 | 64.14 | 0.53531 | S-BSL7.OHARA | 18.93 |
| 44 | ∞ | 5.4999 | | | | | 18.99 |
| *45 | −94.7733 | 0.9200 | 1.80835 | 40.55 | 0.56931 | L-LAH84.OHARA | 19.43 |
| *46 | 43.1599 | 0.6784 | | | | | 19.71 |
| 47 | 17.7664 | 5.7638 | 1.59551 | 39.24 | 0.58043 | S-TIM8.OHARA | 23.20 |
| 48 | 43.5623 | 1.4127 | | | | | 22.67 |
| 49 | 43.6517 | 9.7873 | 1.60342 | 38.03 | 0.58356 | S-TIM5.OHARA | 22.71 |
| 50 | −14.9352 | 1.1999 | 1.95375 | 32.32 | 0.59015 | TAFD45.HOYA | 22.08 |
| 51 | −49.2109 | 5.9215 | 5.9215 | | | | 23.20 |

TABLE 4
Example 2

| | Wide | Middle | Tele |
|---|---|---|---|
| Zr | 1.0 | 6.6 | 19.3 |
| f | 20.37 | 133.98 | 393.09 |
| Bf | 5.9215 | 5.9215 | 5.9215 |
| FNo. | 4.19 | 4.19 | 5.36 |
| 2ω [°] | 46.2 | 7.8 | 3.2 |
| DD[8] | 2.5100 | 72.7372 | 89.2318 |
| DD[16] | 90.7070 | 11.1606 | 4.3059 |
| DD[19] | 2.8071 | 12.1263 | 2.4864 |

TABLE 5
Example 2

| Sn | 45 | 46 |
|---|---|---|
| KA | 1.0000000E+00 | 1.0000000E+00 |
| A4 | −9.5285847E−06 | 1.0418177E−05 |
| A6 | 5.0887817E−07 | 4.7571210E−07 |
| A8 | −1.6654493E−09 | −4.9613384E−10 |
| A10 | −1.4927712E−12 | −1.2514268E−11 |
| A12 | 1.8698561E−14 | −9.1298711E−14 |
| A14 | −1.5805835E−15 | 9.5410700E−16 |
| A16 | −3.0121020E−18 | 4.5503425E−18 |
| A18 | 3.0848493E−19 | −6.4715728E−20 |
| A20 | −2.0683221E−21 | −2.0604753E−22 |

### Example 3

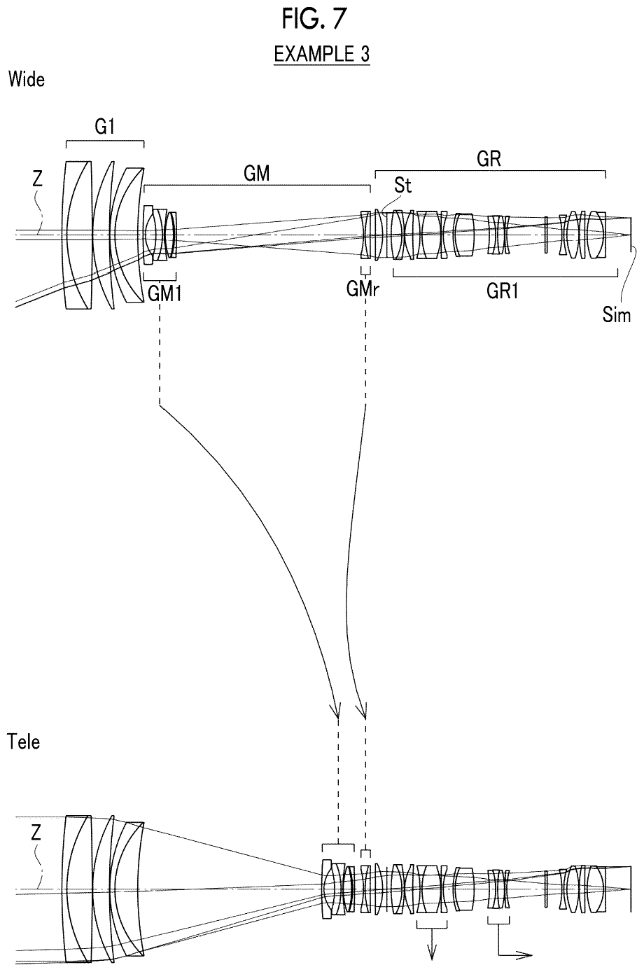

A configuration and a moving trajectory of a variable magnification optical system of Example 3 are shown in FIG. 7. The variable magnification optical system of Example 3 consists of, in order from the object side to the image side, the first lens group G1 having positive refractive power, the intermediate group GM, and the subsequent group GR. The intermediate group GM consists of, in order from the object side to the image side, two lens groups including the M1 lens group GM1 having negative refractive power and the Mr lens group GMr having negative refractive power. The subsequent group GR consists of one lens group that is the R1 lens group GR1 having positive refractive power.

During changing the magnification from the wide angle end to the telephoto end, the first lens group G1 and the R1 lens group GR1 remain stationary with respect to the image plane Sim, and other lens groups move along the optical axis Z by changing a spacing with respect to an adjacent lens group. The vibration-proof group consists of three lenses that are the fifth to seventh lenses in the R1 lens group GR1 from the object side. The focus group consists of four lenses that are the tenth to thirteenth lenses in the R1 lens group GR1 from the object side. During focusing from the infinite distance object to the nearest object, the focus group moves to the image side.

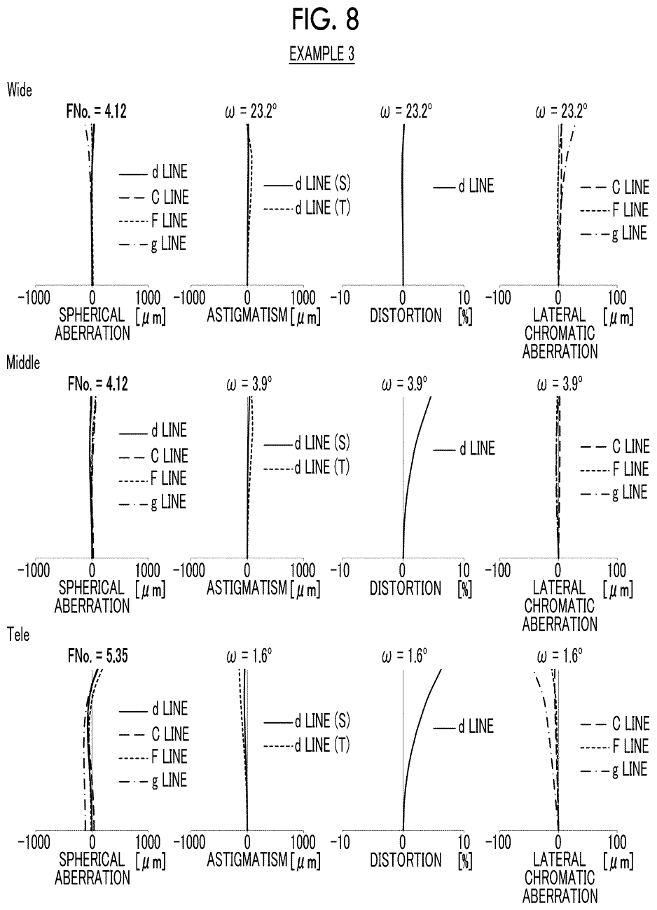

For the variable magnification optical system of Example 3, Tables 6A and 6B show basic lens data, Table 7 shows specifications and variable surface spacings, and FIG. 8 shows each aberration diagram.

TABLE 6A
Example 3

| Sn | R | D | Nd | vd | θgF | Material | ED |
|---|---|---|---|---|---|---|---|
| 1 | 350.9038 | 2.4200 | 1.51633 | 64.06 | 0.53345 | L-BSL7.OHARA | 75.00 |
| 2 | 75.2844 | 12.0000 | 1.49700 | 81.54 | 0.53748 | S-FPL51.OHARA | 73.90 |
| 3 | −1289.0960 | 0.2000 | | | | | 73.72 |
| 4 | 81.7453 | 7.9382 | 1.49700 | 81.54 | 0.53748 | S-FPL51.OHARA | 72.14 |
| 5 | 317.1394 | 0.2000 | | | | | 71.47 |
| 6 | 77.5547 | 2.4000 | 1.88300 | 40.76 | 0.56679 | S-LAH58.OHARA | 68.20 |
| 7 | 49.8650 | 10.8379 | 1.49700 | 81.54 | 0.53748 | S-FPL51.OHARA | 63.94 |
| 8 | 195.9480 | DD[8] | | | | | 63.09 |
| 9 | 216.7993 | 1.0998 | 1.81600 | 46.62 | 0.55682 | S-LAH59.OHARA | 22.22 |
| 10 | 18.1291 | 5.0224 | | | | | 19.52 |
| 11 | −41.9289 | 3.1001 | 1.89286 | 20.36 | 0.63944 | S-NPH4.OHARA | 19.15 |
| 12 | −37.6224 | 0.8598 | 1.80400 | 46.53 | 0.55775 | S-LAH65VS.OHARA | 19.29 |
| 13 | 84.4832 | 0.2002 | | | | | 19.35 |
| 14 | 38.9998 | 3.8700 | 1.85478 | 24.80 | 0.61232 | S-NBH56.OHARA | 19.55 |
| 15 | −47.9162 | 0.5999 | | | | | 19.36 |
| 16 | −39.2880 | 0.8498 | 1.91082 | 35.25 | 0.58335 | TAFD35L.HOYA | 19.11 |
| 17 | −249.4009 | DD[17] | | | | | 19.00 |
| 18 | −43.4086 | 0.8100 | 1.81600 | 46.62 | 0.55682 | S-LAH59.OHARA | 20.20 |
| 19 | 46.4264 | 2.3600 | 1.92119 | 23.96 | 0.62025 | FDS24-W.HOYA | 21.16 |
| 20 | 671.5229 | DD[20] | | | | | 21.47 |
| 21 | −5406.7820 | 3.4393 | 1.81600 | 46.62 | 0.55682 | S-LAH59.OHARA | 23.57 |
| 22 | −34.2678 | 2.0000 | | | | | 23.86 |
| 23 (St) | ∞ | 2.0100 | | | | | 23.00 |
| 24 | 63.8493 | 5.1552 | 1.49700 | 81.54 | 0.53748 | S-FPL51.OHARA | 22.89 |
| 25 | −28.4260 | 1.1000 | 1.85896 | 22.73 | 0.62844 | S-NPH5.OHARA | 22.63 |
| 26 | −62.2777 | 0.2002 | | | | | 22.76 |
| 27 | 24.8806 | 3.8212 | 1.49700 | 81.54 | 0.53748 | S-FPL51.OHARA | 22.74 |
| 28 | 207.2978 | 3.4322 | | | | | 22.28 |

TABLE 6B
Example 3

| Sn | R | D | Nd | vd | θgF | Material | ED |
|---|---|---|---|---|---|---|---|
| 29 | −48.6247 | 0.9358 | 1.90043 | 37.37 | 0.57720 | TAFD37.HOYA | 21.40 |
| 30 | 34.9132 | 8.9102 | 1.67270 | 32.10 | 0.59891 | S-TIM25.OHARA | 21.36 |
| 31 | −33.7167 | 0.2000 | | | | | 21.76 |
| 32 | 1498.1215 | 0.9747 | 1.83481 | 42.74 | 0.56490 | S-LAH55VS.OHARA | 21.04 |
| 33 | 30.3997 | 4.6562 | | | | | 20.51 |
| 34 | 40.7230 | 1.0008 | 1.83481 | 42.74 | 0.56490 | S-LAH55VS.OHARA | 21.56 |
| 35 | 28.1457 | 8.9970 | 1.53775 | 74.70 | 0.53936 | S-FPM3.OHARA | 21.36 |
| 36 | −57.4069 | 6.9258 | | | | | 21.45 |
| 37 | −63.8766 | 3.0291 | 1.69600 | 36.29 | 0.57779 | KZFS12.SCHOTT | 19.11 |
| 38 | −33.9404 | 0.9000 | 1.77250 | 49.60 | 0.55212 | S-LAH66.OHARA | 19.11 |
| 39 | 57.3538 | 3.2608 | 1.62205 | 41.08 | 0.56917 | S-NBM52.OHARA | 19.19 |
| 40 | −42.7991 | 0.2000 | | | | | 19.27 |
| 41 | 114.6333 | 0.9000 | 1.49700 | 81.54 | 0.53748 | S-FPL51.OHARA | 18.94 |
| 42 | 36.1655 | 18.1281 | | | | | 18.62 |
| 43 | ∞ | 1.0000 | 1.51633 | 64.14 | 0.53531 | S-BSL7.OHARA | 18.50 |
| 44 | ∞ | 7.0000 | | | | | 18.50 |
| 45 | −40.6165 | 0.9200 | 1.89190 | 37.13 | 0.57813 | S-LAH92.OHARA | 19.22 |
| 46 | 39.7918 | 1.4492 | | | | | 20.21 |
| 47 | 32.4934 | 5.6689 | 1.62205 | 41.08 | 0.56917 | S-NBM52.OHARA | 23.19 |
| 48 | −40.2279 | 0.2000 | | | | | 23.74 |
| 49 | 62.9794 | 2.6001 | 1.66679 | 33.12 | 0.59763 | N-SF19.SCHOTT | 24.17 |
| 50 | 805.7606 | 1.1098 | | | | | 24.05 |
| 51 | 37.6001 | 7.8240 | 1.54072 | 47.23 | 0.56511 | S-TIL2.OHARA | 23.74 |
| 52 | −21.3424 | 0.9002 | 1.88300 | 40.76 | 0.56679 | S-LAH58.OHARA | 22.98 |
| 53 | 1132.6260 | 12.1362 | | | | | 22.99 |

TABLE 7
Example 3

| | Wide | Middle | Tele |
|---|---|---|---|
| Zr | 1.0 | 6.6 | 19.3 |
| f | 20.39 | 134.16 | 393.62 |
| Bf | 12.1362 | 12.1362 | 12.1362 |
| FNo. | 4.12 | 4.12 | 5.35 |
| 2ω [°] | 46.4 | 7.8 | 3.2 |
| DD[8] | 2.5100 | 70.8374 | 86.9791 |
| DD[17] | 88.6821 | 11.1181 | 4.2235 |
| DD[20] | 2.5000 | 11.7366 | 2.4895 |

### Example 4

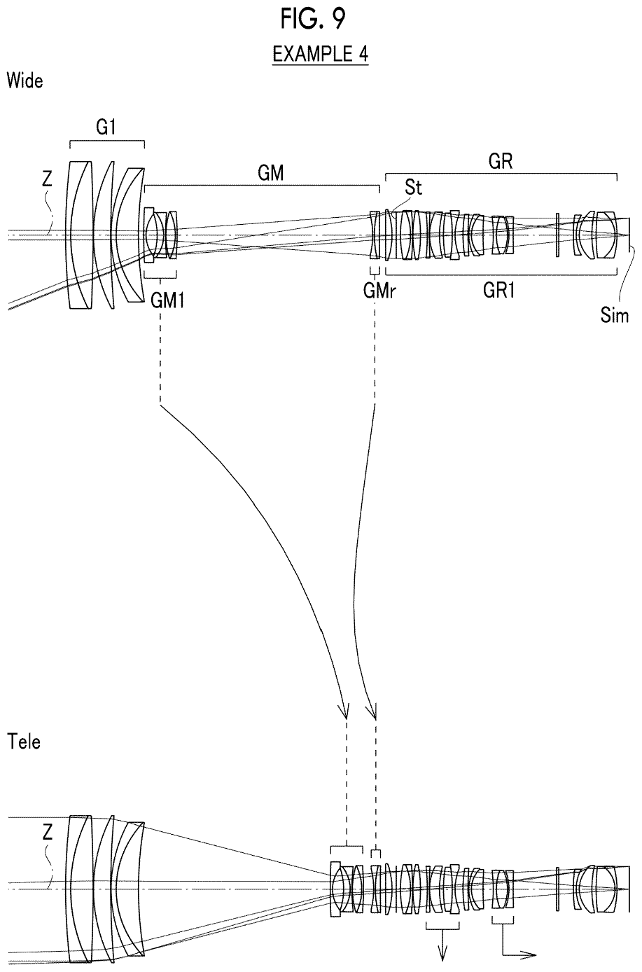

A configuration and a moving trajectory of a variable magnification optical system of Example 4 are shown in FIG. 9. The variable magnification optical system of Example 4 consists of, in order from the object side to the image side, the first lens group G1 having positive refractive power, the intermediate group GM, and the subsequent group GR. The intermediate group GM consists of, in order from the object side to the image side, two lens groups including the M1 lens group GM1 having negative refractive power and the Mr lens group GMr having negative refractive power. The subsequent group GR consists of one lens group that is the R1 lens group GR1 having positive refractive power.

During changing the magnification from the wide angle end to the telephoto end, the first lens group G1 and the R1 lens group GR1 remain stationary with respect to the image plane Sim, and other lens groups move along the optical axis Z by changing a spacing with respect to an adjacent lens group. The vibration-proof group consists of four lenses that are the fifth to eighth lenses in the R1 lens group GR1 from the object side. The focus group consists of three lenses that are the twelfth to fourteenth lenses in the R1 lens group GR1 from the object side. During focusing from the infinite distance object to the nearest object, the focus group moves to the image side.

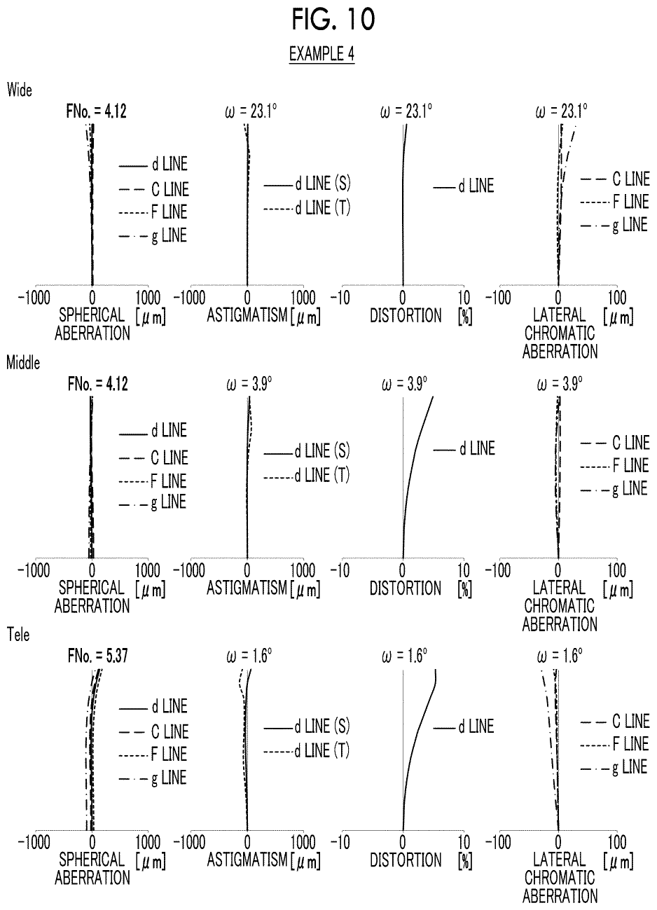

For the variable magnification optical system of Example 4, Tables 8A and 8B show basic lens data, Table 9 shows specifications and variable surface spacings, Table 10 shows aspherical coefficients, and FIG. 10 shows each aberration diagram.

TABLE 8A
Example 4

| Sn | R | D | Nd | vd | θgF | Material | ED |
|---|---|---|---|---|---|---|---|
| 1 | 337.9482 | 2.4200 | 1.51633 | 64.06 | 0.53345 | L-BSL7.OHARA | 75.00 |
| 2 | 88.5008 | 10.5946 | 1.43875 | 94.66 | 0.53402 | S-FPL55.OHARA | 73.97 |
| 3 | −868.2420 | 0.2000 | | | | | 73.83 |
| 4 | 86.0107 | 8.1498 | 1.49700 | 81.54 | 0.53748 | S-FPL51.OHARA | 72.46 |
| 5 | 448.5699 | 0.2000 | | | | | 71.83 |
| 6 | 75.4972 | 2.4000 | 1.83481 | 42.72 | 0.56477 | TAFD5G.HOYA | 68.20 |
| 7 | 51.7207 | 10.5698 | 1.43875 | 94.66 | 0.53402 | S-FPL55.OHARA | 64.40 |
| 8 | 207.2378 | DD[8] | | | | | 63.57 |
| 9 | 313.6929 | 1.0998 | 1.83481 | 42.72 | 0.56477 | TAFD5G.HOYA | 22.11 |
| 10 | 18.1617 | 5.2572 | | | | | 19.50 |
| 11 | −35.4634 | 3.1001 | 1.84666 | 23.78 | 0.62054 | S-TIH53W.OHARA | 19.21 |
| 12 | −19.7272 | 0.8600 | 1.80400 | 46.53 | 0.55775 | S-LAH65VS.OHARA | 19.43 |
| 13 | 121.5905 | 0.1999 | | | | | 19.79 |
| 14 | 43.1783 | 4.4439 | 1.80000 | 29.84 | 0.60178 | S-NBH55.OHARA | 20.09 |
| 15 | −29.7473 | 0.8501 | 1.90366 | 31.31 | 0.59481 | TAFD25.HOYA | 20.01 |
| 16 | −123.3328 | DD[16] | | | | | 20.00 |
| 17 | −46.0578 | 0.8334 | 1.81600 | 46.62 | 0.55682 | S-LAH59.OHARA | 20.60 |
| 18 | 53.8700 | 2.3602 | 1.92119 | 23.96 | 0.62025 | FDS24-W.HOYA | 21.50 |
| 19 | 1574.7586 | DD[19] | | | | | 21.83 |
| 20 | 7059053.8384 | 3.0151 | 1.81600 | 46.62 | 0.55682 | S-LAH59.OHARA | 24.00 |
| 21 | −42.5105 | 2.0000 | | | | | 24.25 |
| 22 (St) | ∞ | 2.0100 | | | | | 23.80 |
| 23 | 63.2072 | 4.8042 | 1.49700 | 81.54 | 0.53748 | S-FPL51.OHARA | 23.90 |
| 24 | −33.8744 | 0.9000 | 1.85896 | 22.73 | 0.62844 | S-NPH5.OHARA | 23.75 |
| 25 | −171.8482 | 0.2000 | | | | | 23.92 |
| 26 | 63.2003 | 3.5970 | 1.49700 | 81.54 | 0.53748 | S-FPL51.OHARA | 24.22 |
| 27 | −67.2738 | 3.1986 | | | | | 24.19 |

TABLE 8B
Example 4

| Sn | R | D | Nd | vd | θgF | Material | ED |
|---|---|---|---|---|---|---|---|
| 28 | −121.9743 | 0.9000 | 1.80400 | 46.53 | 0.55775 | S-LAH65VS.OHARA | 23.40 |
| 29 | 164.1376 | 0.2001 | | | | | 23.37 |
| 30 | 26.9823 | 4.7000 | 1.53775 | 74.70 | 0.53936 | S-FPM3.OHARA | 23.59 |
| 31 | 48.7047 | 1.8480 | | | | | 22.66 |
| 32 | 67.5438 | 4.1999 | 1.80518 | 25.42 | 0.61616 | S-TIH6.OHARA | 22.42 |
| 33 | −84.7784 | 1.3316 | 1.80400 | 46.53 | 0.55775 | S-LAH65VS.OHARA | 21.79 |
| 34 | 29.4757 | 3.7363 | | | | | 20.82 |
| 35 | 66.8026 | 2.4000 | 1.80518 | 25.42 | 0.61616 | S-TIH6.OHARA | 21.26 |
| 36 | 150.7254 | 0.4002 | | | | | 21.15 |
| 37 | 23.8544 | 1.2002 | 1.89800 | 34.00 | 0.58703 | K-LASFN22.SUMITA | 21.18 |
| 38 | 15.0623 | 5.5657 | 1.51860 | 69.89 | 0.53184 | J-PKH1.HIKARI | 20.04 |
| 39 | 253.8864 | 4.7868 | | | | | 19.75 |
| 40 | −85.7437 | 1.5000 | 1.77250 | 49.60 | 0.55212 | S-LAH66.OHARA | 18.98 |
| 41 | 28.9908 | 5.2099 | 1.57501 | 41.50 | 0.57672 | S-TIL27.OHARA | 18.95 |
| 42 | −25.9280 | 0.7135 | | | | | 19.09 |
| 43 | −28.6536 | 2.0000 | 1.49700 | 81.54 | 0.53748 | S-FPL51.OHARA | 18.75 |
| 44 | 242.4840 | 20.5978 | | | | | 18.78 |
| 45 | ∞ | 1.0000 | 1.51633 | 64.14 | 0.53531 | S-BSL7.OHARA | 19.78 |
| 46 | ∞ | 6.9999 | | | | | 19.81 |
| *47 | 97.0313 | 1.3288 | 1.80835 | 40.55 | 0.56931 | L-LAH84.OHARA | 20.40 |
| *48 | 25.0456 | 1.4436 | | | | | 20.12 |
| 49 | 16.4257 | 5.9608 | 1.53172 | 48.84 | 0.56309 | S-TIL6.OHARA | 24.18 |
| 50 | 58.5056 | 1.9961 | | | | | 23.60 |
| 51 | 100.3990 | 9.0008 | 1.53359 | 55.47 | 0.54898 | H-K12.CDGM | 23.22 |
| 52 | −14.9772 | 0.9002 | 1.90043 | 37.37 | 0.57720 | TAFD37.HOYA | 22.39 |
| 53 | −45.8678 | 5.9033 | | | | | 23.41 |

TABLE 9
Example 4

| | Wide | Middle | Tele |
|---|---|---|---|
| Zr | 1.0 | 6.6 | 19.3 |
| f | 20.37 | 134.00 | 393.16 |
| Bf | 5.9033 | 5.9033 | 5.9033 |
| FNo. | 4.12 | 4.12 | 5.37 |
| 2ω [°] | 46.2 | 7.8 | 3.2 |
| DD[8] | 2.5100 | 73.9651 | 90.6197 |
| DD[16] | 92.3948 | 10.9303 | 4.7755 |
| DD[19] | 2.9720 | 12.9814 | 2.4816 |

TABLE 10
Example 4

| Sn | 47 | 48 |
|---|---|---|
| KA | 1.0000000E+00 | 1.0000000E+00 |
| A4 | −3.9533091E−05 | −2.7879291E−05 |
| A6 | 6.6386732E−07 | 7.2111684E−07 |
| A8 | 1.1915693E−10 | 5.1181058E−10 |
| A10 | −1.2232651E−11 | −1.1009066E−11 |
| A12 | 4.8775839E−14 | −1.8832562E−13 |
| A14 | −1.9273759E−15 | 9.5984735E−16 |
| A16 | −1.1478766E−17 | 1.1142394E−17 |
| A18 | 4.4881555E−19 | −8.1625352E−20 |
| A20 | −2.3272840E−21 | −3.2917254E−22 |

### Example 5

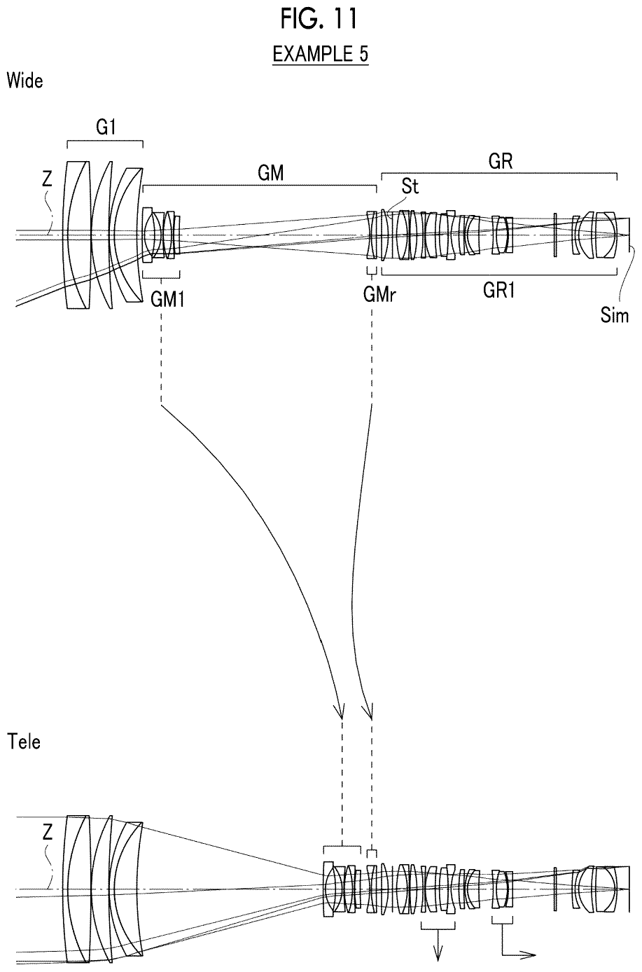

A configuration and a moving trajectory of a variable magnification optical system of Example 5 are shown in FIG. 11. The variable magnification optical system of Example 5 consists of, in order from the object side to the image side, the first lens group G1 having positive refractive power, the intermediate group GM, and the subsequent group GR. The intermediate group GM consists of, in order from the object side to the image side, two lens groups including the M1 lens group GM1 having negative refractive power and the Mr lens group GMr having negative refractive power. The subsequent group GR consists of one lens group that is the R1 lens group GR1 having positive refractive power.

During changing the magnification from the wide angle end to the telephoto end, the first lens group G1 and the R1 lens group GR1 remain stationary with respect to the image plane Sim, and other lens groups move along the optical axis Z by changing a spacing with respect to an adjacent lens group. The vibration-proof group consists of four lenses that are the fifth to eighth lenses in the R1 lens group GR1 from the object side. The focus group consists of three lenses that are the twelfth to fourteenth lenses in the R1 lens group GR1 from the object side. During focusing from the infinite distance object to the nearest object, the focus group moves to the image side.

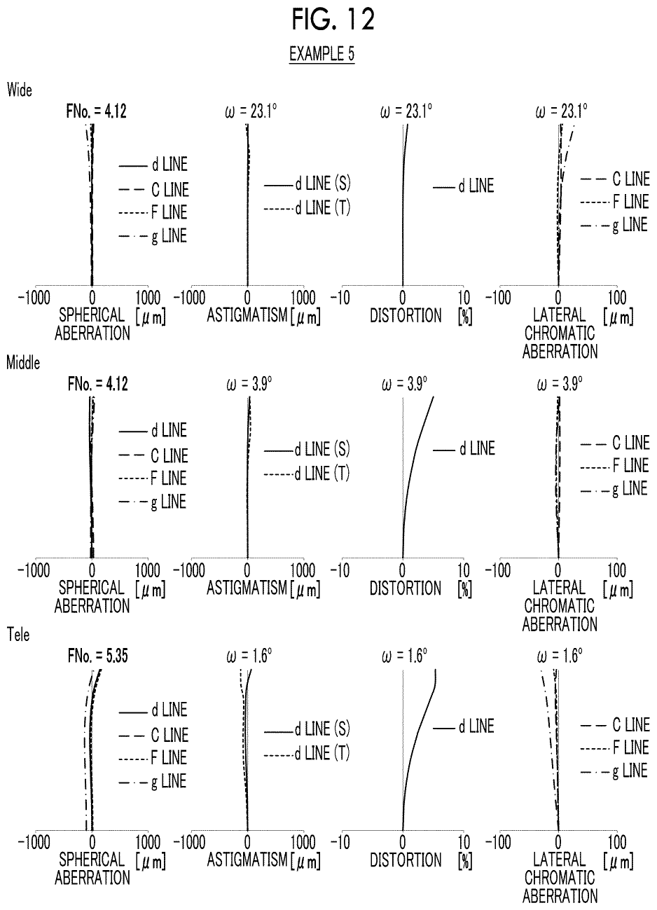

For the variable magnification optical system of Example 5, Tables 11A and 11B show basic lens data, Table 12 shows specifications and variable surface spacings, Table 13 shows aspherical coefficients, and FIG. 12 shows each aberration diagram.

TABLE 11A
Example 5

| Sn | R | D | Nd | vd | θgF | Material | ED |
|---|---|---|---|---|---|---|---|
| 1 | 322.7029 | 2.4200 | 1.51633 | 64.06 | 0.53345 | L-BSL7.OHARA | 75.00 |
| 2 | 85.0597 | 10.9886 | 1.43875 | 94.66 | 0.53402 | S-FPL55.OHARA | 73.95 |
| 3 | −851.7592 | 0.2000 | | | | | 73.82 |
| 4 | 83.9643 | 8.2890 | 1.49700 | 81.54 | 0.53748 | S-FPL51.OHARA | 72.49 |
| 5 | 422.9989 | 0.2000 | | | | | 71.84 |
| 6 | 74.6316 | 2.4000 | 1.83481 | 42.72 | 0.56477 | TAFD5G.HOYA | 68.20 |
| 7 | 51.0206 | 10.7125 | 1.43875 | 94.66 | 0.53402 | S-FPL55.OHARA | 64.29 |
| 8 | 204.5755 | DD[8] | | | | | 63.44 |
| 9 | 283.7354 | 1.1000 | 1.83481 | 42.72 | 0.56477 | TAFD5G.HOYA | 22.08 |
| 10 | 18.2502 | 4.7998 | | | | | 19.47 |
| 11 | −50.0719 | 3.1100 | 1.73800 | 32.33 | 0.59005 | S-NBH53V.OHARA | 19.17 |
| 12 | −19.8495 | 0.8498 | 1.80400 | 46.53 | 0.55775 | S-LAH65VS.OHARA | 19.17 |
| 13 | 103.3964 | 0.2077 | | | | | 19.34 |
| 14 | 41.9693 | 3.8800 | 1.85451 | 25.15 | 0.61031 | NBFD25.HOYA | 19.55 |
| 15 | −39.4066 | 0.8500 | 1.90366 | 31.31 | 0.59481 | TAFD25.HOYA | 19.40 |
| 16 | 123.5391 | 0.1998 | | | | | 19.20 |
| 17 | 65.5793 | 2.6000 | 1.78880 | 28.42 | 0.60066 | J-KZFH10.HIKARI | 19.29 |
| 18 | 193.5866 | DD[18] | | | | | 19.21 |
| 19 | −44.4025 | 0.8099 | 1.81600 | 46.62 | 0.55682 | S-LAH59.OHARA | 20.60 |
| 20 | 49.4552 | 2.3600 | 1.92119 | 23.96 | 0.62025 | FDS24-W.HOYA | 21.52 |
| 21 | 869.6934 | DD[21] | | | | | 21.84 |
| 22 | 8963.1328 | 3.1331 | 1.81600 | 46.62 | 0.55682 | S-LAH59.OHARA | 23.83 |
| 23 | −39.9640 | 2.0000 | | | | | 24.10 |
| 24 (St) | ∞ | 2.0100 | | | | | 23.60 |
| 25 | 51.8390 | 5.0775 | 1.49700 | 81.54 | 0.53748 | S-FPL51.OHARA | 23.71 |
| 26 | −33.4283 | 0.9000 | 1.85896 | 22.73 | 0.62844 | S-NPH5.OHARA | 23.52 |
| 27 | −322.3177 | 0.3103 | | | | | 23.68 |
| 28 | 104.0002 | 3.2866 | 1.49700 | 81.54 | 0.53748 | S-FPL51.OHARA | 23.78 |
| 29 | −54.1406 | 2.9327 | | | | | 23.75 |

TABLE 11B
Example 5

| Sn | R | D | Nd | vd | θgF | Material | ED |
|---|---|---|---|---|---|---|---|
| 30 | −76.9291 | 0.9000 | 1.80400 | 46.53 | 0.55775 | S-LAH65VS.OHARA | 22.86 |
| 31 | 213.1052 | 0.2001 | | | | | 22.85 |
| 32 | 28.8995 | 4.6885 | 1.52841 | 76.45 | 0.53954 | S-FPM4.OHARA | 23.01 |
| 33 | 95.3091 | 1.9847 | | | | | 22.28 |
| 34 | 65.8514 | 4.1546 | 1.84666 | 23.78 | 0.62054 | S-TIH53W.OHARA | 21.71 |
| 35 | −106.9168 | 1.4165 | 1.80400 | 46.53 | 0.55775 | S-LAH65VS.OHARA | 20.90 |
| 36 | 27.9158 | 3.6571 | | | | | 19.76 |
| 37 | 61.4712 | 2.4000 | 1.80518 | 25.42 | 0.61616 | S-TIH6.OHARA | 19.90 |
| 38 | 167.6260 | 0.5115 | | | | | 19.85 |
| 39 | 24.5742 | 1.2000 | 1.85920 | 33.02 | 0.58713 | K-GIR79.SUMITA | 19.96 |
| 40 | 14.9848 | 5.3784 | 1.55232 | 63.46 | 0.53656 | N-PSK3.SCHOTT | 19.02 |
| 41 | 117.9000 | 6.8036 | | | | | 18.67 |
| 42 | −82.6462 | 1.4998 | 1.77250 | 49.60 | 0.55212 | S-LAH66.OHARA | 17.82 |
| 43 | 29.5727 | 5.2100 | 1.57501 | 41.50 | 0.57672 | S-TIL27.OHARA | 17.88 |
| 44 | −27.0134 | 0.5061 | | | | | 18.10 |
| 45 | −31.3750 | 1.9999 | 1.49700 | 81.54 | 0.53748 | S-FPL51.OHARA | 17.90 |
| 46 | 899.7609 | 19.7429 | | | | | 17.98 |
| 47 | ∞ | 1.0000 | 1.51633 | 64.14 | 0.53531 | S-BSL7.OHARA | 18.96 |
| 48 | ∞ | 7.5001 | | | | | 18.99 |
| *49 | 96.8262 | 1.4000 | 1.80835 | 40.55 | 0.56931 | L-LAH84.OHARA | 19.40 |
| *50 | 23.4764 | 1.7275 | | | | | 19.21 |
| 51 | 16.4270 | 6.0921 | 1.54072 | 47.23 | 0.56511 | S-TIL2.OHARA | 23.71 |
| 52 | 70.1458 | 1.9814 | | | | | 23.15 |
| 53 | 147.5978 | 9.0995 | 1.54249 | 62.90 | 0.54325 | K-PG375.SUMITA | 22.78 |
| 54 | −14.6679 | 1.0108 | 1.90043 | 37.37 | 0.57720 | TAFD37.HOYA | 21.98 |
| 55 | −46.7541 | 5.8873 | | | | | 23.10 |

TABLE 12
Example 5

| | Wide | Middle | Tele |
|---|---|---|---|
| Zr | 1.0 | 6.6 | 19.3 |
| f | 20.34 | 133.79 | 392.54 |
| Bf | 5.8873 | 5.8873 | 5.8873 |
| FNo. | 4.12 | 4.12 | 5.35 |
| 2ω [°] | 46.2 | 7.8 | 3.2 |
| DD[8] | 2.5100 | 71.9119 | 88.1331 |
| DD[18] | 90.0828 | 11.2452 | 4.4718 |
| DD[21] | 2.4999 | 11.9357 | 2.4878 |

TABLE 13
Example 5

| Sn | 49 | 50 |
|---|---|---|
| KA | 1.0000000E+00 | 1.0000000E+00 |
| A4 | −3.9313379E−05 | −2.7339879E−05 |
| A6 | 6.4687867E−07 | 7.1442899E−07 |
| A8 | −1.8723538E−10 | −4.6770367E−11 |
| A10 | −1.2395999E−11 | −1.0453923E−11 |
| A12 | 5.2584660E−14 | −1.6691612E−13 |
| A14 | −1.7585049E−15 | 1.3482683E−15 |
| A16 | −7.8550283E−18 | 1.1961754E−17 |
| A18 | 4.4509576E−19 | −1.2451357E−19 |
| A20 | −2.7974620E−21 | −5.8206637E−22 |

### Example 6

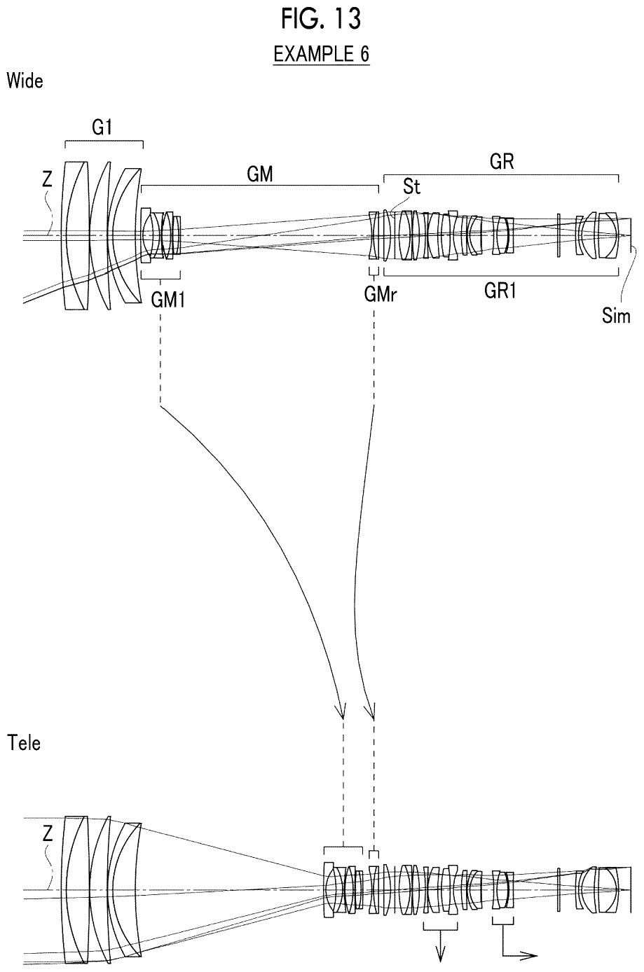

A configuration and a moving trajectory of a variable magnification optical system of Example 6 are shown in FIG. 13. The variable magnification optical system of Example 6 consists of, in order from the object side to the image side, the first lens group G1 having positive refractive power, the intermediate group GM, and the subsequent group GR. The intermediate group GM consists of, in order from the object side to the image side, two lens groups including the M1 lens group GM1 having negative refractive power and the Mr lens group GMr having negative refractive power. The subsequent group GR consists of one lens group that is the R1 lens group GR1 having positive refractive power.

During changing the magnification from the wide angle end to the telephoto end, the first lens group G1 and the R1 lens group GR1 remain stationary with respect to the image plane Sim, and other lens groups move along the optical axis Z by changing a spacing with respect to an adjacent lens group. The vibration-proof group consists of four lenses that are the fifth to eighth lenses in the R1 lens group GR1 from the object side. The focus group consists of three lenses that are the twelfth to fourteenth lenses in the R1 lens group GR1 from the object side. During focusing from the infinite distance object to the nearest object, the focus group moves to the image side.

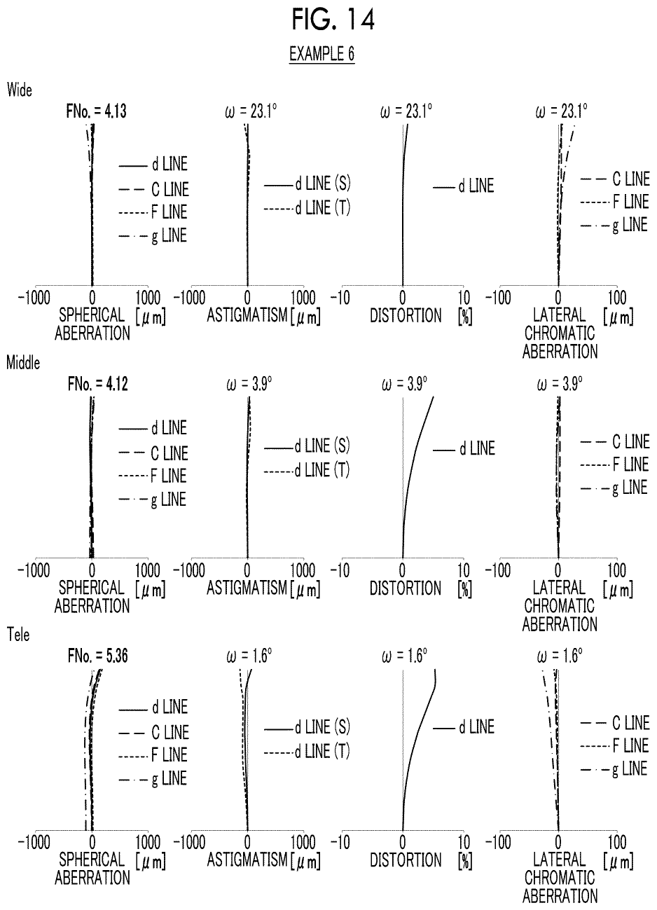

For the variable magnification optical system of Example 6, Tables 14A and 14B show basic lens data, Table 15 shows specifications and variable surface spacings, Table 16 shows aspherical coefficients, and FIG. 14 shows each aberration diagram.

TABLE 14A
Example 6

| Sn | R | D | Nd | vd | θgF | Material | ED |
|---|---|---|---|---|---|---|---|
| 1 | 357.6343 | 2.4200 | 1.51633 | 64.06 | 0.53345 | L-BSL7.OHARA | 75.00 |
| 2 | 86.5987 | 10.8920 | 1.43875 | 94.66 | 0.53402 | S-FPL55.OHARA | 73.99 |
| 3 | −786.1585 | 0.2000 | | | | | 73.86 |
| 4 | 85.0564 | 8.2860 | 1.49700 | 81.54 | 0.53748 | S-FPL51.OHARA | 72.53 |
| 5 | 453.0617 | 0.2000 | | | | | 71.89 |
| 6 | 74.0185 | 2.4000 | 1.83481 | 42.72 | 0.56477 | TAFD5G.HOYA | 68.20 |
| 7 | 51.0204 | 10.6917 | 1.43875 | 94.66 | 0.53402 | S-FPL55.OHARA | 64.34 |
| 8 | 201.9299 | DD[8] | | | | | 63.49 |
| 9 | 304.5742 | 1.0998 | 1.83481 | 42.72 | 0.56477 | TAFD5G.HOYA | 21.89 |
| 10 | 18.3607 | 4.8002 | | | | | 19.33 |
| 11 | −45.3246 | 3.1098 | 1.75520 | 27.51 | 0.61033 | S-TIH4.OHARA | 19.02 |
| 12 | −25.0843 | 0.7998 | 1.80400 | 46.53 | 0.55775 | S-LAH65VS.OHARA | 19.07 |
| 13 | 81.2556 | 0.3305 | | | | | 19.20 |
| 14 | 41.2905 | 3.8802 | 1.84934 | 25.08 | 0.61193 | J-KZFH11.HIKARI | 19.45 |
| 15 | −37.8488 | 0.8002 | 1.90200 | 25.26 | 0.61662 | J-LASFH24.HIKARI | 19.34 |
| 16 | 364.7483 | 0.2376 | | | | | 19.20 |
| 17 | 115.2264 | 2.7485 | 1.69895 | 30.13 | 0.60298 | S-TIM35.OHARA | 19.26 |
| 18 | −43.6215 | 0.7998 | 1.83481 | 42.74 | 0.56490 | S-LAH55VS.OHARA | 19.25 |
| 19 | −361.4891 | DD[19] | | | | | 19.31 |
| 20 | −44.0739 | 0.8102 | 1.81600 | 46.62 | 0.55682 | S-LAH59.OHARA | 20.80 |
| 21 | 49.8332 | 2.3601 | 1.92119 | 23.96 | 0.62025 | FDS24-W.HOYA | 21.77 |
| 22 | 953.6174 | DD[22] | | | | | 22.09 |
| 23 | 3292.3644 | 3.2176 | 1.81600 | 46.62 | 0.55682 | S-LAH59.OHARA | 24.15 |
| 24 | −39.7807 | 2.0000 | | | | | 24.43 |
| 25 (St) | ∞ | 2.0100 | | | | | 23.90 |
| 26 | 50.7860 | 5.2588 | 1.49700 | 81.54 | 0.53748 | S-FPL51.OHARA | 23.93 |
| 27 | −33.3990 | 0.9000 | 1.85896 | 22.73 | 0.62844 | S-NPH5.OHARA | 23.68 |
| 28 | −296.3600 | 0.2000 | | | | | 23.76 |

TABLE 14B
Example 6

| Sn | R | D | Nd | vd | θgF | Material | ED |
|---|---|---|---|---|---|---|---|
| 29 | 111.8039 | 3.2400 | 1.49700 | 81.54 | 0.53748 | S-FPL51.OHARA | 23.84 |
| 30 | −54.1892 | 2.9001 | | | | | 23.80 |
| 31 | −78.0518 | 0.9605 | 1.79500 | 45.31 | 0.55978 | J-LASF017.HIKARI | 22.90 |
| 32 | 172.9519 | 0.2000 | | | | | 22.87 |
| 33 | 28.3392 | 4.6998 | 1.52841 | 76.45 | 0.53954 | S-FPM4.OHARA | 23.06 |
| 34 | 87.1965 | 1.6790 | | | | | 22.33 |
| 35 | 53.6162 | 4.1998 | 1.80518 | 25.42 | 0.61616 | S-TIH6.OHARA | 21.82 |
| 36 | −91.9333 | 1.5100 | 1.80400 | 46.53 | 0.55775 | S-LAH65VS.OHARA | 21.03 |
| 37 | 26.6736 | 3.7609 | | | | | 19.75 |
| 38 | 58.6080 | 2.4000 | 1.82115 | 24.06 | 0.62375 | M-FDS910.HOYA | 19.90 |
| 39 | 138.3173 | 0.4002 | | | | | 19.82 |
| 40 | 23.1995 | 1.2596 | 1.85883 | 30.00 | 0.59793 | NBFD30.HOYA | 19.91 |
| 41 | 14.7737 | 5.1388 | 1.51633 | 64.06 | 0.53479 | K-BK7.SUMITA | 18.91 |
| 42 | 140.8609 | 5.8740 | | | | | 18.61 |
| 43 | −72.8407 | 1.4999 | 1.77250 | 49.60 | 0.55212 | S-LAH66.OHARA | 17.81 |
| 44 | 29.9332 | 5.2100 | 1.58144 | 40.75 | 0.57757 | S-TIL25.OHARA | 17.88 |
| 45 | −26.4638 | 0.4894 | | | | | 18.09 |
| 46 | −31.1308 | 2.0000 | 1.49700 | 81.54 | 0.53748 | S-FPL51.OHARA | 17.88 |
| 47 | 442.1604 | 21.0519 | | | | | 17.94 |
| 48 | ∞ | 1.0000 | 1.51633 | 64.14 | 0.53531 | S-BSL7.OHARA | 18.96 |
| 49 | ∞ | 7.5000 | | | | | 19.00 |
| *50 | 99.2810 | 1.4000 | 1.80835 | 40.55 | 0.56931 | L-LAH84.OHARA | 19.40 |
| *51 | 23.7393 | 1.4899 | | | | | 19.24 |
| 52 | 16.2089 | 5.9585 | 1.53172 | 48.84 | 0.56309 | S-TIL6.OHARA | 23.56 |
| 53 | 70.8123 | 1.9935 | | | | | 23.05 |
| 54 | 155.0622 | 8.4856 | 1.55298 | 55.07 | 0.54469 | J-KZFH4.HIKARI | 22.68 |
| 55 | −14.8058 | 1.0229 | 1.90043 | 37.37 | 0.57720 | TAFD37.HOYA | 22.00 |
| 56 | −50.8910 | 5.9301 | | | | | 23.06 |

TABLE 15
Example 6

| | Wide | Middle | Tele |
|---|---|---|---|
| Zr | 1.0 | 6.6 | 19.3 |
| f | 20.34 | 133.80 | 392.56 |
| Bf | 5.9301 | 5.9301 | 5.9301 |
| FNo. | 4.13 | 4.12 | 5.36 |
| 2ω [°] | 46.2 | 7.8 | 3.2 |
| DD[8] | 2.5100 | 72.6037 | 88.9065 |
| DD[19] | 90.6227 | 11.3313 | 4.2387 |
| DD[22] | 2.4999 | 11.6975 | 2.4874 |

TABLE 16
Example 6

| Sn | 50 | 51 |
|---|---|---|
| KA | 1.0000000E+00 | 1.0000000E+00 |
| A4 | −4.1897078E−05 | −2.9884618E−05 |
| A6 | 6.4083642E−07 | 7.5262076E−07 |
| A8 | 1.0874213E−10 | −2.8529198E−10 |
| A10 | −1.1365104E−11 | −1.0707309E−11 |
| A12 | 3.5943445E−14 | −1.2144615E−13 |
| A14 | −1.7807810E−15 | 1.5661195E−15 |
| A16 | −5.3859412E−18 | 1.0243900E−17 |
| A18 | 4.4063758E−19 | −1.5811642E−19 |
| A20 | −3.0237656E−21 | −5.9625373E−22 |

### Example 7

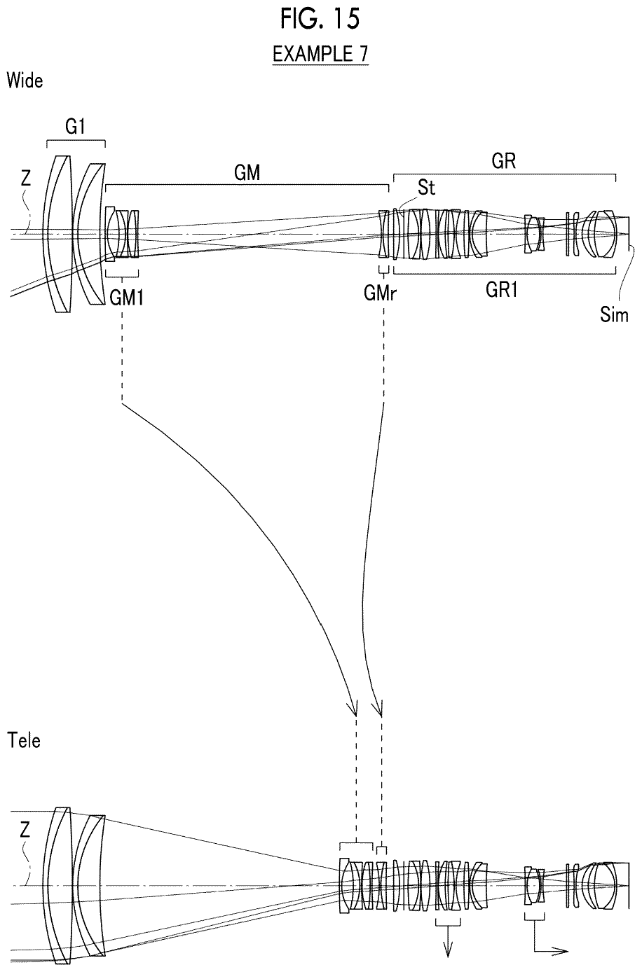

A configuration and a moving trajectory of a variable magnification optical system of Example 7 are shown in FIG. 15. The variable magnification optical system of Example 7 consists of, in order from the object side to the image side, the first lens group G1 having positive refractive power, the intermediate group GM, and the subsequent group GR. The intermediate group GM consists of, in order from the object side to the image side, two lens groups including the M1 lens group GM1 having negative refractive power and the Mr lens group GMr having negative refractive power. The subsequent group GR consists of one lens group that is the R1 lens group GR1 having positive refractive power.

During changing the magnification from the wide angle end to the telephoto end, the first lens group G1 and the R1 lens group GR1 remain stationary with respect to the image plane Sim, and other lens groups move along the optical axis Z by changing a spacing with respect to an adjacent lens group. The vibration-proof group consists of four lenses that are the fifth to eighth lenses in the R1 lens group GR1 from the object side. The focus group consists of three lenses that are the twelfth to fourteenth lenses in the R1 lens group GR1 from the object side. During focusing from the infinite distance object to the nearest object, the focus group moves to the image side.

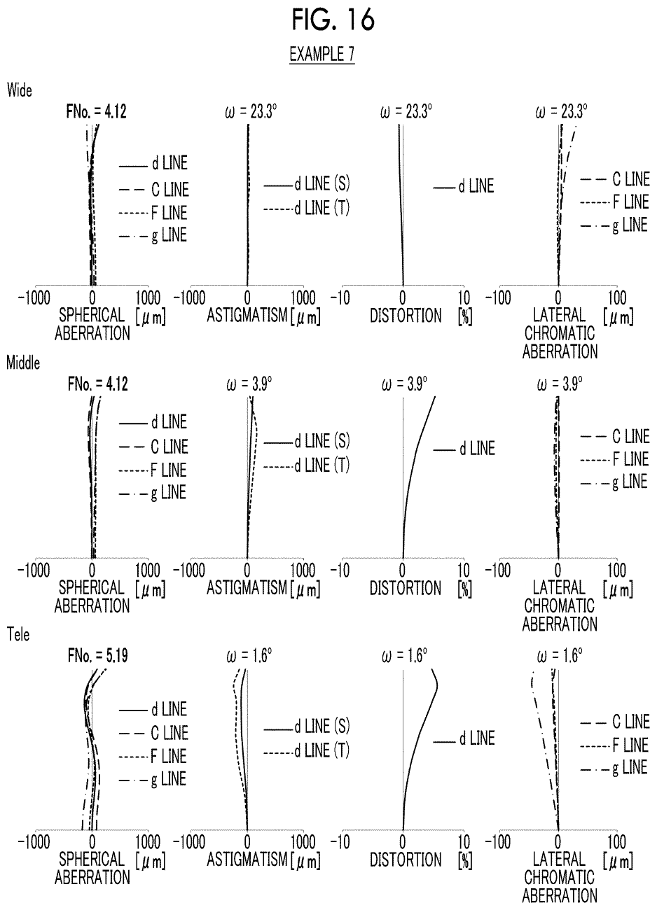

For the variable magnification optical system of Example 7, Tables 17A and 17B show basic lens data, Table 18 shows specifications and variable surface spacings, Table 19 shows aspherical coefficients, and FIG. 16 shows each aberration diagram.

TABLE 17A
Example 7

| Sn | R | D | Nd | vd | θgF | Material | ED |
|---|---|---|---|---|---|---|---|
| 1 | 131.8230 | 2.4200 | 1.51633 | 64.06 | 0.53345 | L-BSL7.OHARA | 80.00 |
| 2 | 90.9465 | 11.5704 | 1.43875 | 94.66 | 0.53402 | S-FPL55.OHARA | 78.00 |
| 3 | −722.1134 | 0.2000 | | | | | 77.35 |
| 4 | 82.2588 | 2.4000 | 1.89190 | 37.13 | 0.57813 | S-LAH92.OHARA | 72.00 |
| 5 | 59.4633 | 10.4505 | 1.49700 | 81.61 | 0.53887 | FCD1.HOYA | 68.96 |
| 6 | 253.8085 | DD[6] | | | | | 68.28 |
| *7 | 310.6096 | 1.0999 | 1.81600 | 46.62 | 0.55682 | S-LAH59.OHARA | 25.97 |
| 8 | 22.8996 | 5.5201 | | | | | 23.28 |
| 9 | −50.7272 | 3.1000 | 1.89286 | 20.36 | 0.63944 | S-NPH4.OHARA | 22.99 |
| 10 | −27.4857 | 0.8599 | 1.81600 | 46.62 | 0.55682 | S-LAH59.OHARA | 23.13 |
| 11 | 203.0536 | 0.2000 | | | | | 23.27 |
| 12 | 41.8019 | 3.8801 | 1.80000 | 29.84 | 0.60178 | S-NBH55.OHARA | 23.52 |
| 13 | −84.7777 | 0.8499 | 1.90366 | 31.31 | 0.59481 | TAFD25.HOYA | 23.29 |
| 14 | 200.0560 | DD[14] | | | | | 23.00 |
| 15 | −50.5364 | 0.8100 | 1.81600 | 46.62 | 0.55682 | S-LAH59.OHARA | 21.80 |
| 16 | 46.6447 | 2.4462 | 1.92119 | 23.96 | 0.62025 | FDS24-W.HOYA | 22.66 |
| 17 | 388.7093 | DD[17] | | | | | 22.91 |
| 18 | −6997200.7157 | 2.7999 | 1.83481 | 42.74 | 0.56490 | S-LAH55VS.OHARA | 24.91 |
| 19 | −52.2215 | 2.0000 | | | | | 25.16 |
| 20 (St) | ∞ | 2.0100 | | | | | 25.00 |
| 21 | 117.5838 | 5.0725 | 1.49700 | 81.54 | 0.53748 | S-FPL51.OHARA | 25.05 |
| 22 | −28.4914 | 0.8999 | 1.84666 | 23.78 | 0.62054 | S-TIH53 W.OHARA | 24.96 |
| 23 | −168.7501 | 0.1999 | | | | | 25.40 |
| 24 | 75.0808 | 4.2263 | 1.49700 | 81.54 | 0.53748 | S-FPL51.OHARA | 25.69 |
| 25 | −52.0106 | 2.9000 | | | | | 25.68 |
| 26 | −400.6183 | 0.8999 | 1.80400 | 46.53 | 0.55775 | S-LAH65VS.OHARA | 24.50 |
| 27 | 156.7113 | 0.1999 | | | | | 24.51 |

TABLE 17B
Example 7

| Sn | R | D | Nd | vd | θgF | Material | ED |
|---|---|---|---|---|---|---|---|
| 28 | 28.2762 | 3.2511 | 1.53775 | 74.70 | 0.53936 | S-FPM3.OHARA | 24.86 |
| 29 | 83.7740 | 1.3762 | | | | | 24.55 |
| 30 | 193.2794 | 2.8922 | 1.80518 | 25.42 | 0.61616 | S-TIH6.OHARA | 24.35 |
| 31 | −59.2524 | 0.9100 | 1.80400 | 46.53 | 0.55775 | S-LAH65VS.OHARA | 24.12 |
| 32 | 34.7002 | 3.6719 | | | | | 23.37 |
| 33 | 112.2715 | 2.3999 | 1.80518 | 25.42 | 0.61616 | S-TIH6.OHARA | 23.94 |
| 34 | −193.8715 | 0.4002 | | | | | 24.00 |
| 35 | 24.2445 | 1.1999 | 1.89800 | 34.00 | 0.58703 | K-LASFN22.SUMITA | 23.91 |
| 36 | 16.1180 | 6.6311 | 1.51860 | 69.89 | 0.53184 | J-PKH1.HIKARI | 22.51 |
| 37 | 135.9960 | 18.5007 | | | | | 21.96 |
| 38 | −196.3404 | 0.9000 | 1.77250 | 49.60 | 0.55212 | S-LAH66.OHARA | 17.44 |
| 39 | 19.0737 | 5.9100 | 1.57501 | 41.50 | 0.57672 | S-TIL27.OHARA | 17.12 |
| 40 | −22.6189 | 0.7249 | | | | | 17.14 |
| 41 | −24.3315 | 0.9000 | 1.49700 | 81.54 | 0.53748 | S-FPL51.OHARA | 16.67 |
| 42 | 51.1206 | 11.1887 | | | | | 16.48 |
| 43 | ∞ | 1.0000 | 1.51633 | 64.14 | 0.53531 | S-BSL7.OHARA | 17.16 |
| 44 | ∞ | 2.5866 | | | | | 17.20 |
| *45 | −124.2709 | 0.9200 | 1.80835 | 40.55 | 0.56931 | L-LAH84.OHARA | 17.36 |
| *46 | 43.7290 | 2.8562 | | | | | 17.33 |
| 47 | 15.3458 | 2.9658 | 1.53172 | 48.84 | 0.56309 | S-TIL6.OHARA | 23.40 |
| 48 | 19.6851 | 2.8999 | | | | | 22.93 |
| 49 | 34.2615 | 9.7140 | 1.53359 | 55.47 | 0.54898 | H-K12.CDGM | 23.13 |
| 50 | −15.1486 | 0.8999 | 1.91082 | 35.25 | 0.58224 | TAFD35.HOYA | 22.75 |
| 51 | −33.3291 | 5.8686 | | | | | 23.95 |

TABLE 18
Example 7

| | Wide | Middle | Tele |
|---|---|---|---|
| Zr | 1.0 | 6.6 | 19.3 |
| f | 20.47 | 134.62 | 394.99 |
| Bf | 5.8686 | 5.8686 | 5.8686 |
| FNo. | 4.12 | 4.12 | 5.19 |
| 2ω [°] | 46.6 | 7.8 | 3.2 |
| DD[6] | 2.5200 | 91.5899 | 113.4799 |
| DD[14] | 115.3999 | 16.2265 | 3.4161 |
| DD[17] | 2.5689 | 12.6724 | 3.5928 |

TABLE 19
Example 7

| Sn | 7 | 45 | 46 |
|---|---|---|---|
| KA | 1.0000000E+00 | 1.0000000E+00 | 1.0000000E+00 |
| A4 | −3.5304723E−06 | −5.2443022E−05 | −2.4216190E−05 |
| A6 | 6.6179750E−08 | 1.2094924E−06 | 1.2466221E−06 |
| A8 | −1.1482642E−09 | 2.3955139E−10 | 2.7074529E−09 |
| A10 | 1.0383539E−11 | 1.6645913E−11 | −4.9869545E−11 |
| A12 | −4.3824460E−14 | −1.8444046E−13 | −3.9152800E−13 |
| A14 | 4.1760023E−17 | −1.3051464E−14 | 9.3008684E−15 |
| A16 | 1.5891528E−19 | 6.0885326E−18 | −6.2777671E−17 |
| A18 | 2.5284033E−22 | 1.7058010E−18 | −4.4905026E−19 |
| A20 | −2.0004958E−24 | −7.3713659E−21 | 3.0085838E−21 |

### Example 8

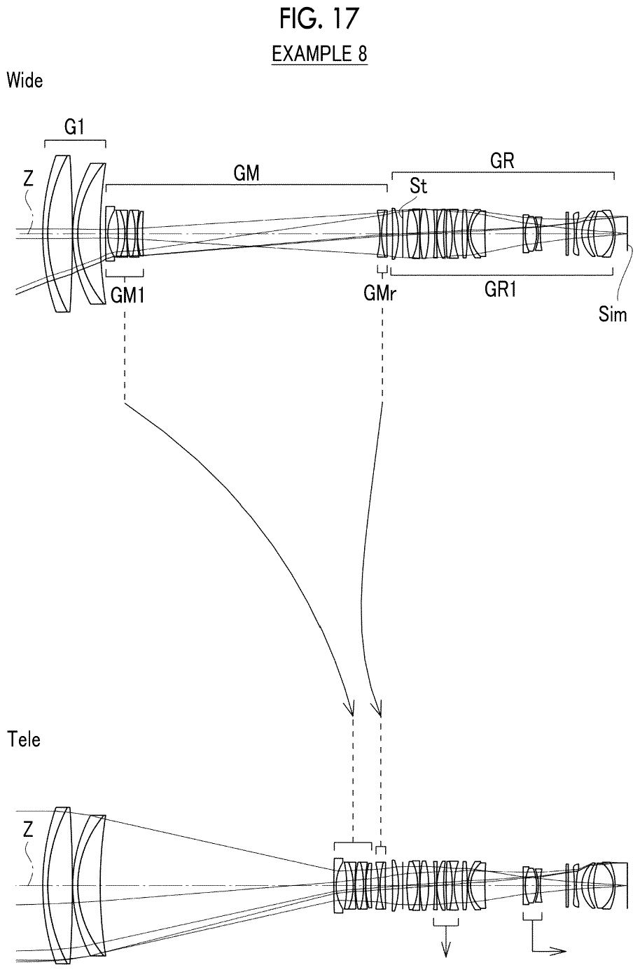

A configuration and a moving trajectory of a variable magnification optical system of Example 8 are shown in FIG. 17. The variable magnification optical system of Example 8 consists of, in order from the object side to the image side, the first lens group G1 having positive refractive power, the intermediate group GM, and the subsequent group GR. The intermediate group GM consists of, in order from the object side to the image side, two lens groups including the M1 lens group GM1 having negative refractive power and the Mr lens group GMr having negative refractive power. The subsequent group GR consists of one lens group that is the R1 lens group GR1 having positive refractive power.

During changing the magnification from the wide angle end to the telephoto end, the first lens group G1 and the R1 lens group GR1 remain stationary with respect to the image plane Sim, and other lens groups move along the optical axis Z by changing a spacing with respect to an adjacent lens group. The vibration-proof group consists of four lenses that are the fifth to eighth lenses in the R1 lens group GR1 from the object side. The focus group consists of three lenses that are the twelfth to fourteenth lenses in the R1 lens group GR1 from the object side. During focusing from the infinite distance object to the nearest object, the focus group moves to the image side.

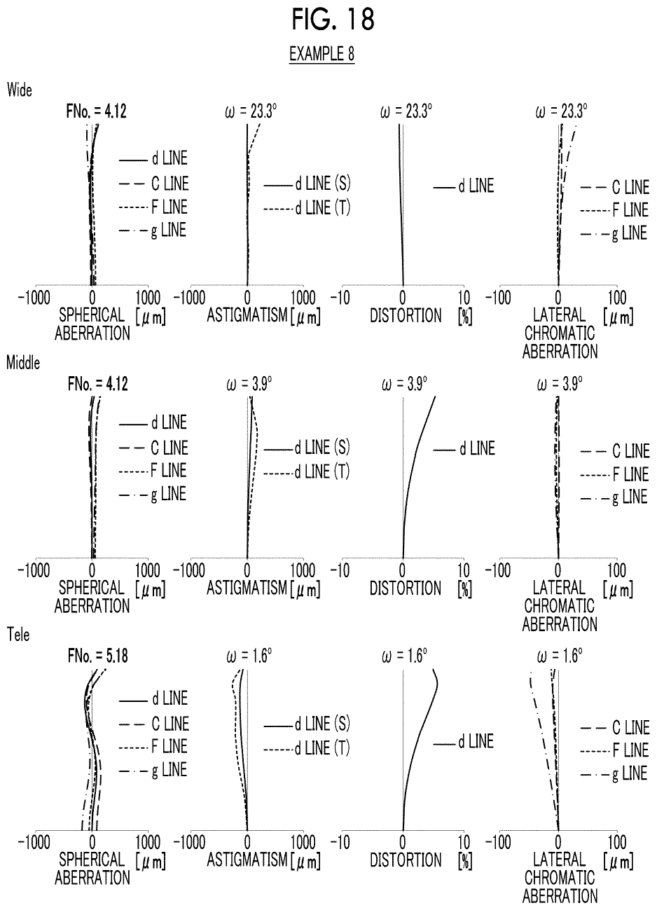

For the variable magnification optical system of Example 8, Tables 20A and 20B show basic lens data, Table 21 shows specifications and variable surface spacings, Table 22 shows aspherical coefficients, and FIG. 18 shows each aberration diagram.

TABLE 20A
Example 8

| Sn | R | D | Nd | vd | θgF | Material | ED |
|---|---|---|---|---|---|---|---|
| 1 | 130.2518 | 2.4200 | 1.51633 | 64.06 | 0.53345 | L-BSL7.OHARA | 80.00 |
| 2 | 90.5429 | 11.6772 | 1.43875 | 94.66 | 0.53402 | S-FPL55.OHARA | 78.00 |
| 3 | −695.3985 | 0.2000 | | | | | 77.33 |
| 4 | 80.8916 | 2.4000 | 1.89190 | 37.13 | 0.57813 | S-LAH92.OHARA | 72.00 |
| 5 | 58.4026 | 10.6415 | 1.49700 | 81.61 | 0.53887 | FCD1.HOYA | 68.86 |
| 6 | 249.5119 | DD[6] | | | | | 68.16 |
| *7 | 311.8764 | 1.0999 | 1.81600 | 46.62 | 0.55682 | S-LAH59.OHARA | 25.98 |
| 8 | 24.0255 | 5.0548 | | | | | 23.37 |
| 9 | −63.5740 | 3.0999 | 1.85896 | 22.73 | 0.62844 | S-NPH5.OHARA | 23.03 |
| 10 | −32.8006 | 0.8599 | 1.84850 | 43.79 | 0.56197 | J-LASFH22.HIKARI | 23.02 |
| 11 | 163.9697 | 0.2000 | | | | | 22.97 |
| 12 | 59.1552 | 3.8801 | 1.80000 | 29.84 | 0.60178 | S-NBH55.OHARA | 23.06 |
| 13 | −49.2897 | 0.8498 | 1.88300 | 40.76 | 0.56679 | S-LAH58.OHARA | 22.89 |
| 14 | 75.4282 | 0.2000 | | | | | 22.60 |
| 15 | 45.0917 | 2.3998 | 1.68893 | 31.07 | 0.60041 | S-TIM28.OHARA | 22.81 |
| 16 | 166.1306 | DD[16] | | | | | 22.73 |
| 17 | −50.7609 | 0.8101 | 1.81600 | 46.62 | 0.55682 | S-LAH59.OHARA | 21.80 |
| 18 | 46.8304 | 2.4284 | 1.92119 | 23.96 | 0.62025 | FDS24-W.HOYA | 22.58 |
| 19 | 392.0744 | DD[19] | | | | | 22.81 |
| 20 | −385.8368 | 2.7999 | 1.83481 | 42.74 | 0.56490 | S-LAH55VS.OHARA | 24.17 |
| 21 | −45.4806 | 2.0000 | | | | | 24.46 |
| 22 (St) | ∞ | 2.0100 | | | | | 24.24 |
| 23 | 68.5750 | 5.1576 | 1.49700 | 81.54 | 0.53748 | S-FPL51.OHARA | 24.55 |
| 24 | −32.0064 | 0.9000 | 1.84666 | 23.78 | 0.62054 | S-TIH53W.OHARA | 24.48 |
| 25 | −1836.8891 | 0.1999 | | | | | 24.89 |
| 26 | 72.8182 | 4.0569 | 1.49700 | 81.54 | 0.53748 | S-FPL51.OHARA | 25.18 |
| 27 | −56.9008 | 2.8999 | | | | | 25.22 |

TABLE 20B
Example 8

| Sn | R | D | Nd | fd | θgF | Material | ED |
|---|---|---|---|---|---|---|---|
| 28 | −144.4461 | 0.8999 | 1.80400 | 46.53 | 0.55775 | S-LAH65VS.OHARA | 24.50 |
| 29 | 240.9778 | 0.1999 | | | | | 24.61 |
| 30 | 31.0769 | 3.1424 | 1.53775 | 74.70 | 0.53936 | S-FPM3.OHARA | 25.11 |
| 31 | 100.7968 | 1.1452 | | | | | 24.88 |
| 32 | 154.3445 | 2.9870 | 1.80518 | 25.42 | 0.61616 | S-TIH6.OHARA | 24.75 |
| 33 | −62.5065 | 0.9100 | 1.80400 | 46.53 | 0.55775 | S-LAH65VS.OHARA | 24.55 |
| 34 | 37.7874 | 3.7966 | | | | | 23.93 |
| 35 | 160.5286 | 2.4000 | 1.80518 | 25.42 | 0.61616 | S-TIH6.OHARA | 24.55 |
| 36 | −138.4442 | 0.4000 | | | | | 24.66 |
| 37 | 24.5787 | 1.2000 | 1.89800 | 34.00 | 0.58703 | K-LASFN22.SUMITA | 24.64 |
| 38 | 16.6360 | 6.7792 | 1.51860 | 69.89 | 0.53184 | J-PKH1.HIKARI | 23.25 |
| 39 | 150.0895 | 18.2997 | | | | | 22.70 |
| 40 | −736.7888 | 0.9001 | 1.77250 | 49.60 | 0.55212 | S-LAH66.OHARA | 18.09 |
| 41 | 23.3474 | 5.4408 | 1.57501 | 41.50 | 0.57672 | S-TIL27.OHARA | 17.72 |
| 42 | −24.5806 | 0.8299 | | | | | 17.62 |
| 43 | −25.0327 | 0.9001 | 1.49700 | 81.54 | 0.53748 | S-FPL51.OHARA | 17.07 |
| 44 | 46.2843 | 12.3358 | | | | | 16.73 |
| 45 | ∞ | 1.0000 | 1.51633 | 64.14 | 0.53531 | S-BSL7.OHARA | 16.95 |
| 46 | ∞ | 2.9316 | | | | | 16.96 |
| *47 | −91.4023 | 0.9199 | 1.80835 | 40.55 | 0.56931 | L-LAH84.OHARA | 17.01 |
| *48 | 40.0092 | 2.6087 | | | | | 17.14 |
| 49 | 15.7630 | 3.0593 | 1.53172 | 48.84 | 0.56309 | S-TIL6.OHARA | 23.10 |
| 50 | 21.4668 | 2.6214 | | | | | 22.72 |
| 51 | 37.1288 | 9.2826 | 1.53359 | 55.47 | 0.54898 | H-K12.CDGM | 22.96 |
| 52 | −15.2847 | 0.9000 | 1.91082 | 35.25 | 0.58224 | TAFD35.HOYA | 22.72 |
| 53 | −31.6977 | 5.8772 | | | | | 23.94 |

TABLE 21
Example 8

| | Wide | Middle | Tele |
|---|---|---|---|
| Zr | 1.0 | 6.6 | 19.3 |
| f | 20.46 | 134.61 | 394.95 |
| Bf | 5.8771 | 5.8771 | 5.8771 |
| FNo. | 4.12 | 4.12 | 5.18 |
| 2ω [°] | 46.6 | 7.8 | 3.2 |
| DD[6] | 2.5200 | 89.6999 | 110.9345 |
| DD[16] | 112.7549 | 15.5101 | 3.6110 |
| DD[19] | 2.7715 | 12.8364 | 3.5009 |

TABLE 22
Example 8

| Sn | 7 | 47 | 48 |
|---|---|---|---|
| KA | 1.0000000E+00 | 1.0000000E+00 | 1.0000000E+00 |
| A4 | −3.5177448E−06 | −9.1012840E−05 | −5.8855509E−05 |
| A6 | 7.2618957E−08 | 1.2648550E−06 | 1.4288507E−06 |
| A8 | −1.2439015E−09 | 3.2469419E−09 | 4.2121920E−09 |
| A10 | 1.1158879E−11 | 3.0735959E−11 | −8.9875091E−11 |
| A12 | −4.5680527E−14 | −9.5756986E−13 | −3.3341924E−14 |
| A14 | 2.8629492E−17 | −1.9888883E−14 | 1.1203370E−14 |
| A16 | 1.9613974E−19 | 1.3145844E−16 | −2.7093988E−16 |
| A18 | 6.6213848E−22 | 1.6936934E−18 | 1.4868401E−18 |
| A20 | −3.5484985E−24 | −7.3713659E−21 | 3.0085838E−21 |

### Example 9

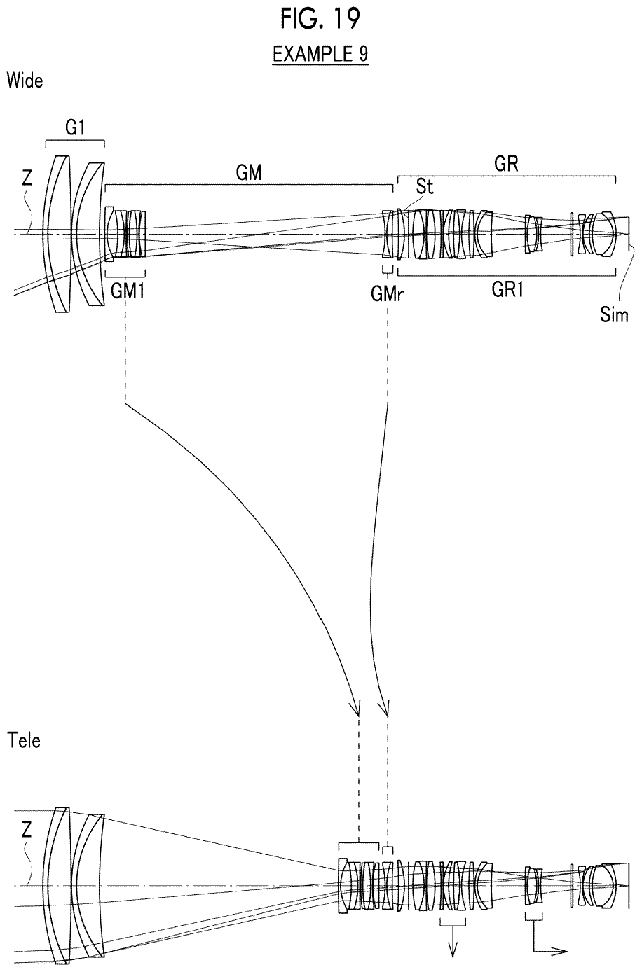

A configuration and a moving trajectory of a variable magnification optical system of Example 9 are shown in FIG. 19. The variable magnification optical system of Example 9 consists of, in order from the object side to the image side, the first lens group G1 having positive refractive power, the intermediate group GM, and the subsequent group GR. The intermediate group GM consists of, in order from the object side to the image side, two lens groups including the M1 lens group GM1 having negative refractive power and the Mr lens group GMr having negative refractive power. The subsequent group GR consists of one lens group that is the R1 lens group GR1 having positive refractive power.

During changing the magnification from the wide angle end to the telephoto end, the first lens group G1 and the R1 lens group GR1 remain stationary with respect to the image plane Sim, and other lens groups move along the optical axis Z by changing a spacing with respect to an adjacent lens group. The vibration-proof group consists of four lenses that are the fifth to eighth lenses in the R1 lens group GR1 from the object side. The focus group consists of three lenses that are the twelfth to fourteenth lenses in the R1 lens group GR1 from the object side. During focusing from the infinite distance object to the nearest object, the focus group moves to the image side.

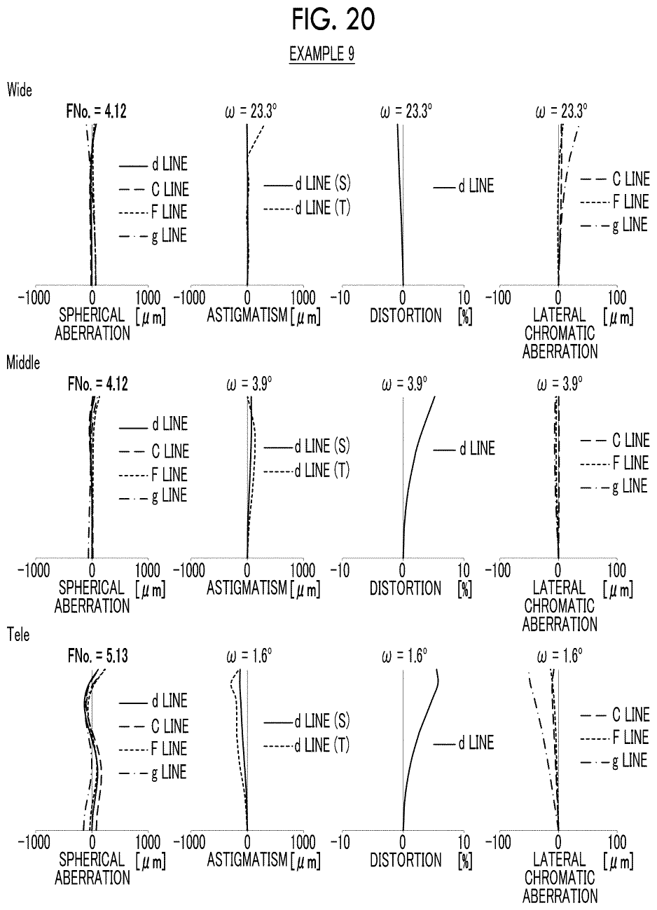

For the variable magnification optical system of Example 9, Tables 23A and 23B show basic lens data, Table 24 shows specifications and variable surface spacings, Table 25 shows aspherical coefficients, and FIG. 20 shows each aberration diagram.

TABLE 23A
Example 9

| Sn | R | D | Nd | vd | θgF | Material | ED |
|---|---|---|---|---|---|---|---|
| 1 | 132.3970 | 2.4200 | 1.51633 | 64.06 | 0.53345 | L-BSL7.OHARA | 80.00 |
| 2 | 95.5083 | 11.0051 | 1.43875 | 94.66 | 0.53402 | S-FPL55.OHARA | 78.34 |
| 3 | −853.2823 | 0.2000 | | | | | 77.77 |
| 4 | 83.9236 | 2.4000 | 1.89190 | 37.13 | 0.57813 | S-LAH92.OHARA | 73.00 |
| 5 | 60.1909 | 10.8720 | 1.49700 | 81.61 | 0.53887 | FCD1.HOYA | 69.91 |
| 6 | 289.4507 | DD[6] | | | | | 69.23 |
| *7 | 398.3513 | 1.0998 | 1.81600 | 46.62 | 0.55682 | S-LAH59.OHARA | 26.20 |
| 8 | 25.5915 | 5.0627 | | | | | 23.67 |
| 9 | −57.4555 | 3.0999 | 1.85896 | 22.73 | 0.62844 | S-NPH5.OHARA | 23.31 |
| 10 | −41.0427 | 0.8599 | 1.84850 | 43.79 | 0.56197 | J-LASFH22.HIKARI | 23.30 |
| 11 | 305.8296 | 0.5097 | | | | | 23.28 |
| 12 | 102.7206 | 1.0022 | 1.75500 | 52.32 | 0.54757 | S-LAH97.OHARA | 23.33 |
| 13 | 73.3726 | 3.7099 | 1.78472 | 25.68 | 0.61621 | S-TIH11.OHARA | 23.25 |
| 14 | −61.6566 | 0.8500 | 1.89190 | 37.13 | 0.57813 | S-LAH92.OHARA | 23.12 |
| 15 | 96.7959 | 0.1999 | | | | | 23.00 |
| 16 | 51.0769 | 2.7998 | 1.66382 | 27.35 | 0.63195 | J-SFH4.HIKARI | 23.23 |
| 17 | 2177.4425 | DD[17] | | | | | 23.18 |
| 18 | −47.7875 | 0.8100 | 1.78800 | 47.37 | 0.55598 | S-LAH64.OHARA | 21.20 |
| 19 | 38.8235 | 2.5668 | 1.90200 | 25.26 | 0.61662 | J-LASFH24HS.HIKARI | 22.11 |
| 20 | 218.9187 | DD[20] | | | | | 22.36 |
| 21 | −309.5779 | 2.8222 | 1.83481 | 42.74 | 0.56490 | S-LAH55VS.OHARA | 24.26 |
| 22 | −41.8546 | 2.0000 | | | | | 24.56 |
| 23 (St) | ∞ | 2.0100 | | | | | 24.32 |
| 24 | 56.1640 | 5.3913 | 1.49700 | 81.54 | 0.53748 | S-FPL51.OHARA | 24.57 |
| 25 | −33.0280 | 0.9001 | 1.84666 | 23.78 | 0.62054 | S-TIH53W.OHARA | 24.41 |
| 26 | 371.8015 | 0.2002 | | | | | 24.67 |
| 27 | 68.1467 | 4.0507 | 1.49700 | 81.54 | 0.53748 | S-FPL51.OHARA | 24.90 |
| 28 | −59.5305 | 2.9002 | | | | | 24.91 |

TABLE 23B
Example 9

| Sn | R | D | Nd | vd | θgF | Material | ED |
|---|---|---|---|---|---|---|---|
| 29 | −146.5815 | 0.9002 | 1.77250 | 49.60 | 0.55212 | S-LAH66.OHARA | 24.14 |
| 30 | 5043.5266 | 0.2001 | | | | | 24.24 |
| 31 | 27.3572 | 2.4553 | 1.53775 | 74.70 | 0.53936 | S-FPM3.OHARA | 24.63 |
| 32 | 45.8951 | 2.3850 | | | | | 24.32 |
| 33 | 140.4258 | 2.8299 | 1.80518 | 25.42 | 0.61616 | S-TIH6.OHARA | 24.17 |
| 34 | −68.8221 | 0.9100 | 1.80400 | 46.53 | 0.55775 | S-LAH65VS.OHARA | 23.99 |
| 35 | 37.1473 | 3.4995 | | | | | 23.44 |
| 36 | 110.8999 | 2.4095 | 1.80518 | 25.42 | 0.61616 | S-TIH6.OHARA | 24.09 |
| 37 | −176.6258 | 0.4002 | | | | | 24.17 |
| 38 | 24.1908 | 1.2000 | 1.89800 | 34.00 | 0.58703 | K-LASFN22.SUMITA | 24.15 |
| 39 | 16.4417 | 6.6575 | 1.51860 | 69.89 | 0.53184 | J-PKH1.HIKARI | 22.79 |
| 40 | 127.6681 | 16.0979 | | | | | 22.22 |
| 41 | 663.0825 | 0.9003 | 1.77250 | 49.60 | 0.55212 | S-LAH66.OHARA | 18.28 |
| 42 | 32.2840 | 4.5673 | 1.57501 | 41.50 | 0.57672 | S-TIL27.OHARA | 17.95 |
| 43 | −29.0957 | 0.8955 | | | | | 17.76 |
| 44 | −28.9282 | 0.9056 | 1.49700 | 81.54 | 0.53748 | S-FPL51.OHARA | 17.20 |
| 45 | 44.6809 | 14.3176 | | | | | 16.76 |
| 46 | ∞ | 1.0000 | 1.51633 | 64.14 | 0.53531 | S-BSL7.OHARA | 16.34 |
| 47 | ∞ | 3.5379 | | | | | 16.32 |
| *48 | −43.6001 | 0.9739 | 1.80139 | 45.45 | 0.55814 | M-TAF31.HOYA | 16.24 |
| *49 | 28.1697 | 0.3000 | | | | | 16.76 |
| 50 | 16.0800 | 2.9629 | 1.53172 | 48.84 | 0.56309 | S-TIL6.OHARA | 20.04 |
| 51 | 27.4086 | 1.4643 | | | | | 20.06 |
| 52 | 26.9827 | 9.9099 | 1.53359 | 55.47 | 0.54898 | H-K12.CDGM | 20.84 |
| 53 | −12.9728 | 1.3999 | 1.91082 | 35.25 | 0.58224 | TAFD35.HOYA | 20.82 |
| 54 | −26.6050 | 6.1586 | | | | | 22.72 |

TABLE 24
Example 9

| | Wide | Middle | Tele |
|---|---|---|---|
| Zr | 1.0 | 6.6 | 19.3 |
| f | 20.46 | 134.62 | 394.97 |
| Bf | 6.1586 | 6.1586 | 6.1586 |
| FNo. | 4.12 | 4.12 | 5.13 |
| 2ω [°] | 46.6 | 7.8 | 3.2 |
| DD[6] | 2.5200 | 91.4253 | 113.1541 |
| DD[17] | 113.6352 | 16.4055 | 3.0059 |
| DD[20] | 2.9439 | 11.2684 | 2.9392 |

TABLE 25
Example 9

| Sn | 7 | 48 | 49 |
|---|---|---|---|
| KA | 1.0000000E+00 | 1.0000000E+00 | 1.0000000E+00 |
| A4 | −3.1983188E−06 | −1.2341348E−04 | −8.3684337E−05 |
| A6 | 9.0210915E−08 | 1.4965537E−06 | 1.6936352E−06 |
| A8 | −1.7254011E−09 | 4.2690917E−09 | 4.1658674E−09 |
| A10 | 1.7109334E−11 | 1.6227663E−11 | −1.4815365E−10 |
| A12 | −7.8387319E−14 | −1.4791644E−12 | −4.3375141E−13 |
| A14 | 4.5436766E−17 | −3.5035466E−14 | 1.5460200E−14 |
| A16 | 8.1994983E−19 | 3.7056267E−16 | −1.3267980E−16 |
| A18 | −1.8450300E−21 | 2.0109096E−18 | 3.4502310E−19 |
| A20 | −6.6815630E−25 | −7.3713659E−21 | 3.0085838E−21 |

### Example 10

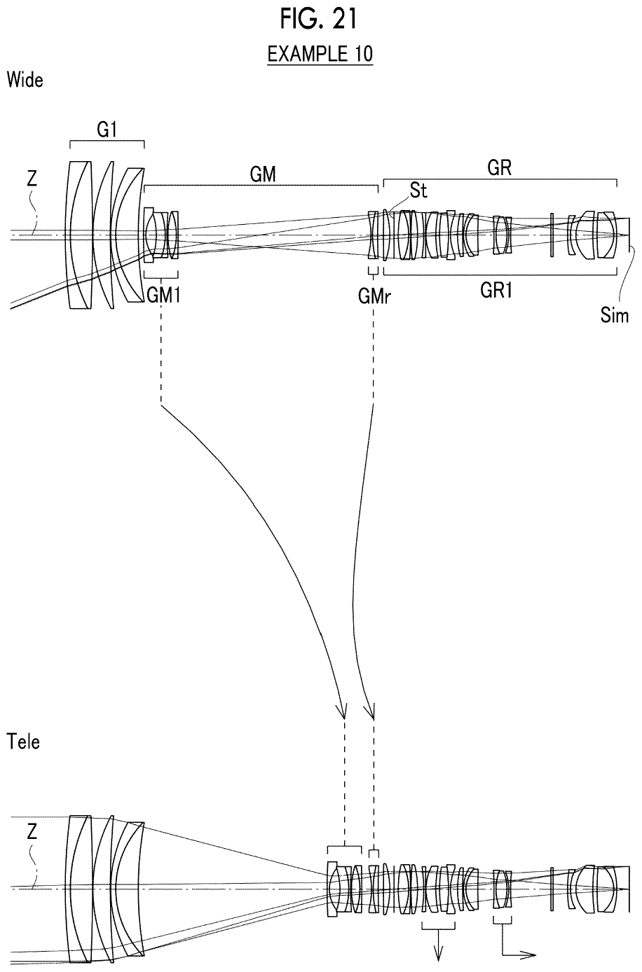

A configuration and a moving trajectory of a variable magnification optical system of Example 10 are shown in FIG. 21. The variable magnification optical system of Example 10 consists of, in order from the object side to the image side, the first lens group G1 having positive refractive power, the intermediate group GM, and the subsequent group GR. The intermediate group GM consists of, in order from the object side to the image side, two lens groups including the M1 lens group GM1 having negative refractive power and the Mr lens group GMr having negative refractive power. The subsequent group GR consists of one lens group that is the R1 lens group GR1 having positive refractive power.

During changing the magnification from the wide angle end to the telephoto end, the first lens group G1 and the R1 lens group GR1 remain stationary with respect to the image plane Sim, and other lens groups move along the optical axis Z by changing a spacing with respect to an adjacent lens group. The vibration-proof group consists of four lenses that are the fifth to eighth lenses in the R1 lens group GR1 from the object side. The focus group consists of three lenses that are the twelfth to fourteenth lenses in the R1 lens group GR1 from the object side. During focusing from the infinite distance object to the nearest object, the focus group moves to the image side.

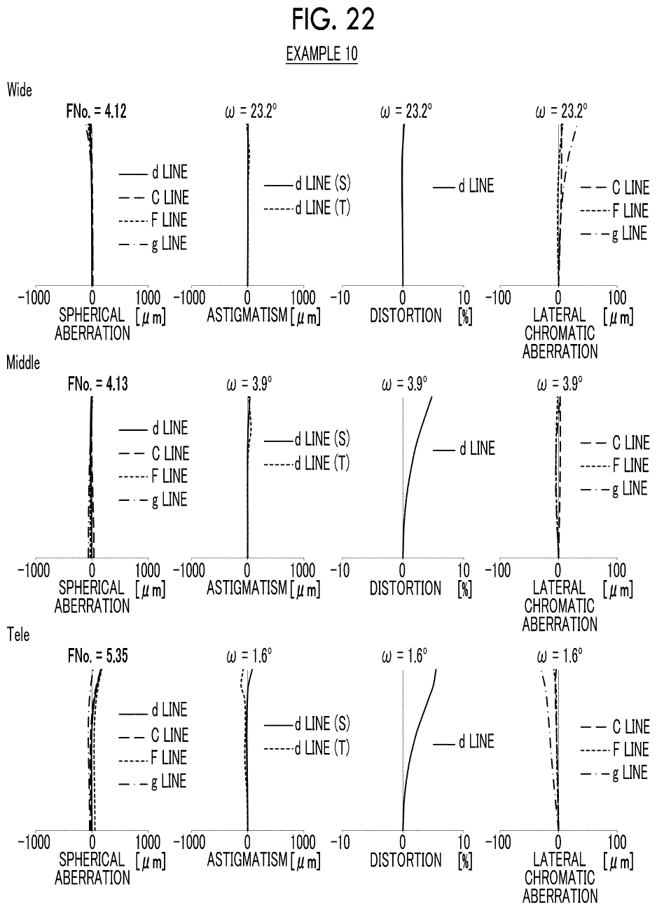

For the variable magnification optical system of Example 10, Tables 26A and 26B show basic lens data, Table 27 shows specifications and variable surface spacings, Table 28 shows aspherical coefficients, and FIG. 22 shows each aberration diagram.

The variable magnification optical system of Example 10 includes the specific lens. A lens for which any of “N231.Glass”, “N216.Glass”, or “N200.Glass” is shown in the column of Material in the table of the basic lens data is the specific lens. Notation related to the specific lens in the table of the basic lens data is the same for the examples described later.

Glass described in p.40 to 42 of the manuscript of the 49th Optical Symposium (duration: Jun. 20 and 21, 2024, host: The Optical Society of Japan, a general incorporated association) can be used as “N231.Glass”, “N216.Glass”, and “N200.Glass”.

TABLE 26A
Example 10

| Sn | R | D | Nd | vd | θgF | Material | ED |
|---|---|---|---|---|---|---|---|
| 1 | 311.1848 | 2.4200 | 1.51633 | 64.06 | 0.53345 | L-BSL7.OHARA | 75.00 |
| 2 | 89.0938 | 10.4786 | 1.43875 | 94.66 | 0.53402 | S-FPL55.OHARA | 73.98 |
| 3 | −935.6872 | 0.2000 | | | | | 73.84 |
| 4 | 85.5248 | 8.2171 | 1.49700 | 81.54 | 0.53748 | S-FPL51.OHARA | 72.50 |
| 5 | 450.4272 | 0.2000 | | | | | 71.86 |
| 6 | 75.1471 | 2.4000 | 1.83481 | 42.72 | 0.56477 | TAFD5G.HOYA | 68.20 |
| 7 | 51.1594 | 10.6649 | 1.43875 | 94.66 | 0.53402 | S-FPL55.OHARA | 64.30 |
| 8 | 204.1761 | DD[8] | | | | | 63.45 |
| 9 | 311.1399 | 1.1000 | 1.83481 | 42.72 | 0.56477 | TAFD5G.HOYA | 21.78 |
| 10 | 18.5159 | 4.9510 | | | | | 19.24 |
| 11 | −38.0558 | 4.2179 | 2.30909 | 17.89 | 0.6452 | N231.Glass | 18.91 |
| 12 | −36.9549 | 0.8600 | 1.80400 | 46.53 | 0.55775 | S-LAH65VS.OHARA | 19.55 |
| 13 | 165.4721 | 0.4317 | | | | | 19.67 |
| 14 | 44.0657 | 3.9901 | 1.85478 | 24.80 | 0.61232 | S-NBH56.OHARA | 19.91 |
| 15 | −35.9610 | 0.8499 | 2.00266 | 31.67 | 0.5851 | N200.Glass | 19.74 |
| 16 | −524.1388 | DD[16] | | | | | 19.60 |
| 17 | −44.8559 | 0.8100 | 1.77250 | 49.60 | 0.55212 | S-LAH66.OHARA | 20.50 |
| 18 | 52.6103 | 2.3600 | 1.96300 | 24.11 | 0.62126 | S-TIH57.OHARA | 21.40 |
| 19 | 298.6385 | DD[19] | | | | | 21.72 |
| 20 | 728.7195 | 3.0072 | 1.81600 | 46.62 | 0.55682 | S-LAH59.OHARA | 23.94 |
| 21 | −44.8902 | 2.0000 | | | | | 24.18 |
| 22 (St) | ∞ | 2.0100 | | | | | 23.80 |
| 23 | 60.2372 | 4.9402 | 1.49700 | 81.54 | 0.53748 | S-FPL51.OHARA | 23.83 |
| 24 | −32.8117 | 0.9002 | 1.85896 | 22.73 | 0.62844 | S-NPH5.OHARA | 23.63 |
| 25 | −180.9096 | 0.2002 | | | | | 23.80 |
| 26 | 142.5822 | 3.1182 | 1.49700 | 81.54 | 0.53748 | S-FPL51.OHARA | 23.82 |
| 27 | −54.7997 | 2.9000 | | | | | 23.77 |

TABLE 26B
Example 10

| Sn | R | D | Nd | vd | θgF | Material | ED |
|---|---|---|---|---|---|---|---|
| 28 | −79.8961 | 0.9001 | 1.80400 | 46.53 | 0.55775 | S-LAH65VS.OHARA | 22.80 |
| 29 | 691.3984 | 0.2002 | | | | | 22.95 |
| 30 | 26.9285 | 4.6445 | 1.52841 | 76.45 | 0.53954 | S-FPM4.OHARA | 23.45 |
| 31 | 62.0521 | 1.7891 | | | | | 22.79 |
| 32 | 74.3918 | 4.2000 | 1.84666 | 23.78 | 0.62054 | S-TIH53W.OHARA | 22.58 |
| 33 | −95.7616 | 0.9912 | 1.80400 | 46.53 | 0.55775 | S-LAH65VS.OHARA | 22.00 |
| 34 | 28.1245 | 3.3351 | | | | | 21.17 |
| 35 | 48.0457 | 2.4000 | 1.79631 | 22.61 | 0.64111 | J-SFH9.HIKARI | 21.80 |
| 36 | 156.1285 | 0.4086 | | | | | 21.70 |
| 37 | 23.0037 | 1.2002 | 2.16217 | 21.24 | 0.6276 | N216.Glass | 21.66 |
| 38 | 16.0019 | 5.5865 | 1.51742 | 52.43 | 0.55649 | S-NSL36.OHARA | 20.43 |
| 39 | 344.8465 | 7.6934 | | | | | 20.13 |
| 40 | −143.9165 | 0.9000 | 1.77250 | 49.60 | 0.55212 | S-LAH66.OHARA | 18.70 |
| 41 | 27.3614 | 5.2086 | 1.56732 | 42.82 | 0.57309 | S-TIL26.OHARA | 18.55 |
| 42 | −26.4164 | 0.8422 | | | | | 18.62 |
| 43 | −27.3450 | 0.9001 | 1.49700 | 81.54 | 0.53748 | S-FPL51.OHARA | 18.23 |
| 44 | 107.3786 | 19.1166 | | | | | 18.19 |
| 45 | ∞ | 1.0000 | 1.51633 | 64.14 | 0.53531 | S-BSL7.OHARA | 19.33 |
| 46 | ∞ | 6.9069 | | | | | 19.37 |
| *47 | 89.0497 | 1.3409 | 1.80835 | 40.55 | 0.56931 | L-LAH84.OHARA | 19.88 |
| *48 | 24.1432 | 2.5895 | | | | | 19.52 |
| 49 | 17.2009 | 8.0201 | 1.54814 | 45.78 | 0.56859 | S-TIL1.OHARA | 24.40 |
| 50 | 103.7012 | 2.0000 | | | | | 23.40 |
| 51 | 147.2947 | 7.9360 | 1.51742 | 52.43 | 0.55649 | S-NSL36.OHARA | 22.87 |
| 52 | −15.7159 | 1.3998 | 2.00266 | 31.67 | 0.5851 | N200.Glass | 22.12 |
| 53 | −41.0794 | 5.9858 | | | | | 23.34 |

TABLE 27
Example 10

| | Wide | Middle | Tele |
|---|---|---|---|
| Zr | 1.0 | 6.6 | 19.3 |
| f | 20.34 | 133.79 | 392.54 |
| Bf | 5.9858 | 5.9858 | 5.9858 |
| FNo. | 4.12 | 4.13 | 5.35 |
| 2ω [°] | 46.4 | 7.8 | 3.2 |
| DD[8] | 2.5100 | 72.8198 | 89.2379 |
| DD[16] | 91.0689 | 11.0741 | 4.6193 |
| DD[19] | 2.7632 | 12.4483 | 2.4850 |

TABLE 28
Example 10

| Sn | 47 | 48 |
|---|---|---|
| KA | 1.0000000E+00 | 1.0000000E+00 |
| A4 | −3.0433021E−05 | −2.1040202E−05 |
| A6 | 7.0753744E−07 | 7.1616970E−07 |
| A8 | −6.2860384E−10 | 5.8942855E−10 |
| A10 | −1.1505307E−11 | −1.5305400E−11 |
| A12 | 4.7578619E−14 | −2.1536091E−13 |
| A14 | −2.0443050E−15 | 1.1030655E−15 |
| A16 | −1.1091549E−17 | 1.2772854E−17 |
| A18 | 4.7401694E−19 | −9.3962302E−20 |
| A20 | −2.4149385E−21 | −1.6462740E−22 |

### Example 11

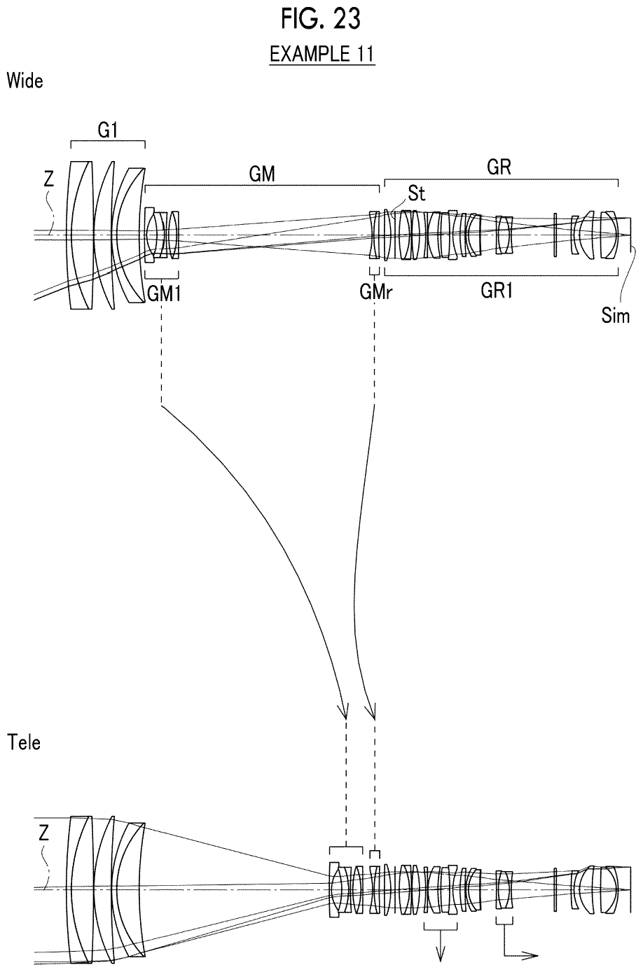

A configuration and a moving trajectory of a variable magnification optical system of Example 11 are shown in FIG. 23. The variable magnification optical system of Example 11 consists of, in order from the object side to the image side, the first lens group G1 having positive refractive power, the intermediate group GM, and the subsequent group GR. The intermediate group GM consists of, in order from the object side to the image side, two lens groups including the M1 lens group GM1 having negative refractive power and the Mr lens group GMr having negative refractive power. The subsequent group GR consists of one lens group that is the R1 lens group GR1 having positive refractive power.

During changing the magnification from the wide angle end to the telephoto end, the first lens group G1 and the R1 lens group GR1 remain stationary with respect to the image plane Sim, and other lens groups move along the optical axis Z by changing a spacing with respect to an adjacent lens group. The vibration-proof group consists of four lenses that are the fifth to eighth lenses in the R1 lens group GR1 from the object side. The focus group consists of three lenses that are the twelfth to fourteenth lenses in the R1 lens group GR1 from the object side. During focusing from the infinite distance object to the nearest object, the focus group moves to the image side.

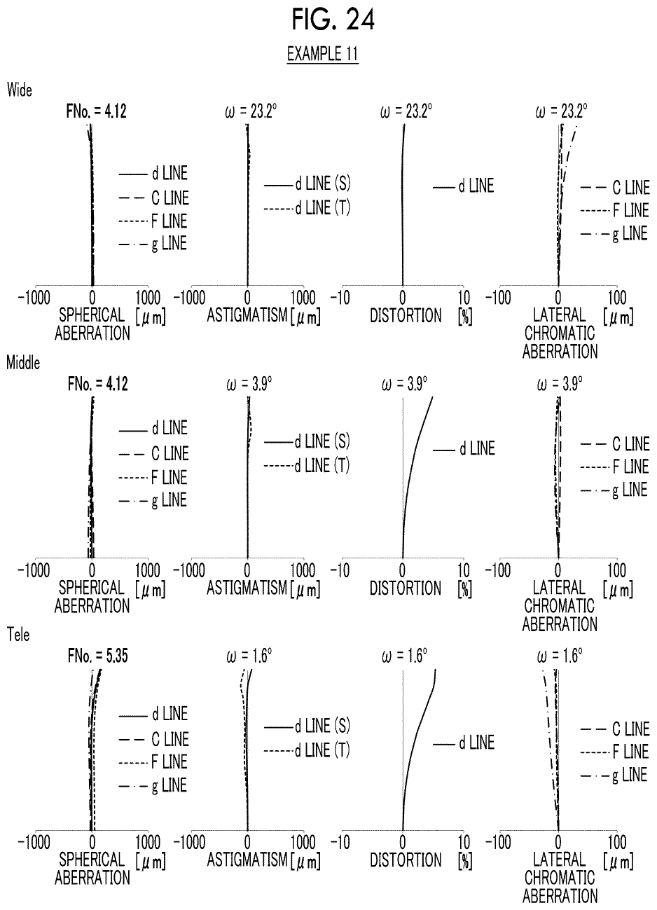

For the variable magnification optical system of Example 11, Tables 29A and 29B show basic lens data, Table 30 shows specifications and variable surface spacings, Table 31 shows aspherical coefficients, and FIG. 24 shows each aberration diagram.

TABLE 29A
Example 11

| Sn | R | D | Nd | vd | θgF | Material | ED |
|---|---|---|---|---|---|---|---|
| 1 | 329.0960 | 2.4200 | 1.51633 | 64.06 | 0.53345 | L-BSL7.OHARA | 75.00 |
| 2 | 89.3353 | 10.4600 | 1.43875 | 94.66 | 0.53402 | S-FPL55.OHARA | 73.99 |
| 3 | −926.8719 | 0.2000 | | | | | 73.85 |
| 4 | 86.4018 | 8.2174 | 1.49700 | 81.54 | 0.53748 | S-FPL51.OHARA | 72.50 |
| 5 | 479.2687 | 0.2000 | | | | | 71.87 |
| 6 | 75.2368 | 2.4000 | 1.83481 | 42.72 | 0.56477 | TAFD5G.HOYA | 68.20 |
| 7 | 51.4033 | 10.6376 | 1.43875 | 94.66 | 0.53402 | S-FPL55.OHARA | 64.35 |
| 8 | 206.4352 | DD[8] | | | | | 63.51 |
| 9 | 320.3047 | 1.0998 | 1.83481 | 42.72 | 0.56477 | TAFD5G.HOYA | 21.53 |
| 10 | 18.9030 | 4.8316 | | | | | 19.09 |
| 11 | −37.2140 | 3.2749 | 2.16217 | 21.24 | 0.6276 | N216.Glass | 18.73 |
| 12 | −34.6040 | 0.8600 | 1.79091 | 48.09 | 0.55438 | TAF48.HOYA | 19.13 |
| 13 | 153.5744 | 1.1284 | | | | | 19.22 |
| 14 | 46.2829 | 3.8799 | 1.85478 | 24.80 | 0.61232 | S-NBH56.OHARA | 19.53 |
| 15 | −35.1546 | 0.8499 | 1.95375 | 32.32 | 0.59056 | S-LAH98.OHARA | 19.36 |
| 16 | −698.3082 | DD[16] | | | | | 19.20 |
| 17 | −44.6321 | 0.8101 | 1.77250 | 49.60 | 0.55212 | S-LAH66.OHARA | 20.80 |
| 18 | 53.1153 | 2.3599 | 1.96300 | 24.11 | 0.62126 | S-TIH57.OHARA | 21.67 |
| 19 | 309.9562 | DD[19] | | | | | 21.97 |
| 20 | 799.6627 | 3.0002 | 1.81600 | 46.62 | 0.55682 | S-LAH59.OHARA | 23.91 |
| 21 | −45.2689 | 2.0000 | | | | | 24.15 |
| 22 (St) | ∞ | 2.0100 | | | | | 23.80 |
| 23 | 68.2324 | 4.8933 | 1.49700 | 81.54 | 0.53748 | S-FPL51.OHARA | 23.91 |
| 24 | −31.6809 | 0.9002 | 1.85896 | 22.73 | 0.62844 | S-NPH5.OHARA | 23.78 |
| 25 | −209.1730 | 0.2972 | | | | | 24.04 |
| 26 | 103.3663 | 3.5311 | 1.49700 | 81.54 | 0.53748 | S-FPL51.OHARA | 24.13 |
| 27 | −51.0653 | 2.9001 | | | | | 24.09 |

TABLE 29B
Example 11

| Sn | R | D | Nd | vd | θgF | Material | ED |
|---|---|---|---|---|---|---|---|
| 28 | −84.4980 | 0.9002 | 1.85280 | 39.00 | 0.57297 | K-VC90.SUMITA | 23.04 |
| 29 | −1198.0280 | 0.2000 | | | | | 23.17 |
| 30 | 26.2618 | 4.6998 | 1.49700 | 81.61 | 0.53887 | FCD1.HOYA | 23.59 |
| 31 | 59.4141 | 1.3938 | | | | | 22.87 |
| 32 | 105.4530 | 4.2000 | 1.92286 | 18.90 | 0.64960 | S-NPH2.OHARA | 22.72 |
| 33 | −137.1817 | 1.5100 | 1.80400 | 46.53 | 0.55775 | S-LAH65VS.OHARA | 22.13 |
| 34 | 29.1275 | 3.4050 | | | | | 21.28 |
| 35 | 53.0226 | 2.4002 | 1.92286 | 18.90 | 0.64960 | S-NPH2.OHARA | 21.92 |
| 36 | 151.3455 | 0.4000 | | | | | 21.79 |
| 37 | 24.0259 | 1.2001 | 2.30909 | 17.89 | 0.6452 | N231.Glass | 21.76 |
| 38 | 16.3041 | 5.3306 | 1.62004 | 36.26 | 0.58800 | S-TIM2.OHARA | 20.50 |
| 39 | 157.8543 | 7.6651 | | | | | 20.17 |
| 40 | −352.8363 | 0.9223 | 1.77250 | 49.60 | 0.55212 | S-LAH66.OHARA | 18.78 |
| 41 | 30.9648 | 5.2198 | 1.58267 | 46.60 | 0.56688 | H-BAF4.CDGM | 18.57 |
| 42 | −23.3663 | 0.9001 | 1.49700 | 81.54 | 0.53748 | S-FPL51.OHARA | 18.53 |
| 43 | 63.7284 | 20.3751 | | | | | 18.29 |
| 44 | ∞ | 1.0000 | 1.51633 | 64.14 | 0.53531 | S-BSL7.OHARA | 19.03 |
| 45 | ∞ | 6.9992 | | | | | 19.06 |
| *46 | 116.8934 | 1.3999 | 1.80835 | 40.55 | 0.56931 | L-LAH84.OHARA | 19.38 |
| *47 | 24.8978 | 2.5881 | | | | | 19.11 |
| 48 | 17.1263 | 5.9826 | 1.51823 | 58.90 | 0.54567 | S-NSL3.OHARA | 24.40 |
| 49 | 85.4910 | 3.9786 | | | | | 23.98 |
| 50 | 201.5788 | 7.4955 | 1.54814 | 45.78 | 0.56859 | S-TIL1.OHARA | 23.22 |
| 51 | −15.6873 | 0.9000 | 2.00266 | 31.67 | 0.5851 | N200.Glass | 22.81 |
| 52 | −34.1364 | 5.8786 | | | | | 23.98 |

TABLE 30
Example 11

| | Wide | Middle | Tele |
|---|---|---|---|
| Zr | 1.0 | 6.6 | 19.3 |
| f | 20.33 | 133.75 | 392.44 |
| Bf | 5.8786 | 5.8786 | 5.8786 |
| FNo. | 4.12 | 4.12 | 5.35 |
| 2ω [°] | 46.4 | 7.8 | 3.2 |
| DD[8] | 2.5100 | 73.3186 | 89.8539 |
| DD[16] | 91.7565 | 11.2879 | 4.5966 |
| DD[19] | 2.6719 | 12.3319 | 2.4878 |

TABLE 31
Example 11

| Sn | 46 | 47 |
|---|---|---|
| KA | 1.0000000E+00 | 1.0000000E+00 |
| A4 | −3.7299754E−05 | −2.3305482E−05 |
| A6 | 7.9190856E−07 | 8.0472570E−07 |
| A8 | −8.4802622E−10 | 4.3853754E−10 |
| A10 | −2.5868855E−11 | −2.3872346E−11 |
| A12 | 3.4867403E−14 | −3.3732445E−13 |
| A14 | −1.1528168E−15 | 9.9202130E−16 |
| A16 | −4.9351518E−18 | 4.4167751E−17 |
| A18 | 6.2487852E−19 | 5.7765475E−20 |
| A20 | −4.2722110E−21 | −3.0584057E−21 |

### Example 12

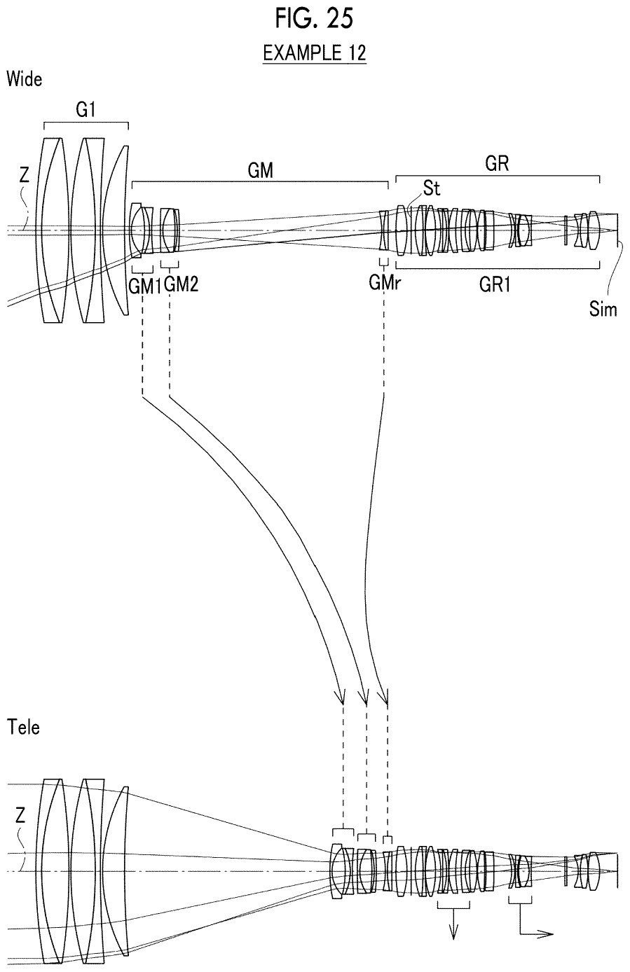

A configuration and a moving trajectory of a variable magnification optical system of Example 12 are shown in FIG. 25. The variable magnification optical system of Example 12 consists of, in order from the object side to the image side, the first lens group G1 having positive refractive power, the intermediate group GM, and the subsequent group GR. The intermediate group GM consists of, in order from the object side to the image side, three lens groups including the M1 lens group GM1 having negative refractive power, an M2 lens group GM2 having positive refractive power, and the Mr lens group GMr having negative refractive power. The M2 lens group GM2 having positive refractive power corresponds to the above M2p lens group. The subsequent group GR consists of one lens group that is the R1 lens group GR1 having positive refractive power.

During changing the magnification from the wide angle end to the telephoto end, the first lens group G1 and the R1 lens group GR1 remain stationary with respect to the image plane Sim, and other lens groups move along the optical axis Z by changing a spacing with respect to an adjacent lens group. The vibration-proof group consists of four lenses that are the fifth to eighth lenses in the R1 lens group GR1 from the object side. The focus group consists of four lenses that are the twelfth to fifteenth lenses in the R1 lens group GR1 from the object side. During focusing from the infinite distance object to the nearest object, the focus group moves to the image side.

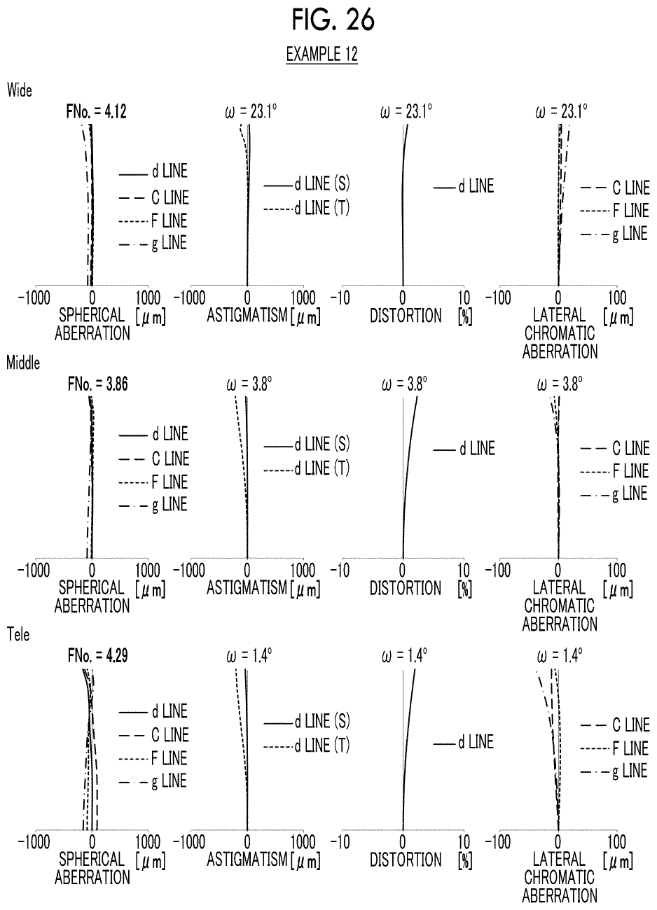

For the variable magnification optical system of Example 12, Tables 32A and 32B show basic lens data, Table 33 shows specifications and variable surface spacings, Table 34 shows aspherical coefficients, and FIG. 26 shows each aberration diagram.

TABLE 32A
Example 12

| Sn | R | D | Nd | vd | θgF | Material | ED |
|---|---|---|---|---|---|---|---|
| 1 | 291.0618 | 2.8201 | 1.57501 | 41.50 | 0.57672 | S-TIL27.OHARA | 96.00 |
| 2 | 137.1904 | 13.1643 | 1.49700 | 81.61 | 0.53887 | FCD1.HOYA | 95.07 |
| 3 | −340.5959 | 0.9420 | | | | | 94.94 |
| 4 | 194.5748 | 11.7815 | 1.49700 | 81.61 | 0.53887 | FCD1.HOYA | 92.11 |
| 5 | −249.7753 | 2.4425 | 1.83481 | 42.74 | 0.56490 | S-LAH55VS.OHARA | 91.39 |
| 6 | 621.6347 | 1.0750 | | | | | 89.62 |
| 7 | 98.5501 | 10.6140 | 1.49700 | 81.61 | 0.53887 | FCD1.HOYA | 87.00 |
| 8 | 532.8995 | DD[8] | | | | | 85.89 |
| *9 | 85.9359 | 1.0328 | 1.59271 | 66.97 | 0.53675 | MC-PCD51-70.HOYA | 28.36 |
| *10 | 18.6011 | 6.3322 | | | | | 24.09 |
| 11 | −55.6575 | 2.4476 | 1.98613 | 16.48 | 0.66558 | FDS16-W.HOYA | 23.86 |
| 12 | −29.7644 | 1.0102 | 1.80420 | 46.50 | 0.55727 | TAF3D.HOYA | 23.79 |
| 13 | 104.9390 | DD[13] | | | | | 23.19 |
| 14 | 352.8211 | 1.2102 | 1.69680 | 55.46 | 0.54260 | LAC14.HOYA | 22.88 |
| 15 | 21.2996 | 5.8113 | 1.90043 | 37.37 | 0.57668 | TAFD37A.HOYA | 22.56 |
| 16 | −87.8233 | 1.1349 | | | | | 22.19 |
| 17 | −44.4293 | 1.0002 | 2.16217 | 21.24 | 0.6276 | N216.Glass | 21.89 |
| 18 | −127.9103 | DD[18] | | | | | 21.89 |
| 19 | −46.0329 | 1.0102 | 1.83481 | 42.72 | 0.56477 | TAFD5G.HOYA | 19.28 |
| 20 | 48.1617 | 2.1485 | 1.92119 | 23.96 | 0.62025 | FDS24-W.HOYA | 20.23 |
| 21 | 2702.5994 | DD[21] | | | | | 20.52 |
| 22 | 84.1663 | 5.3466 | 1.49700 | 81.61 | 0.53887 | FCD1.HOYA | 24.85 |
| 23 | −47.5677 | 2.0002 | | | | | 25.23 |
| 24 (St) | ∞ | 2.0002 | | | | | 25.00 |
| 25 | 41.2972 | 3.7556 | 1.49700 | 81.61 | 0.53887 | FCD1.HOYA | 25.44 |
| 26 | −146.8057 | 1.0100 | 1.60562 | 43.71 | 0.57214 | S-BAM4.OHARA | 25.26 |
| 27 | 130.3792 | 0.1001 | | | | | 25.01 |
| 28 | 41.9616 | 4.9077 | 1.49700 | 81.61 | 0.53887 | FCD1.HOYA | 24.90 |
| 29 | −49.1039 | 2.5002 | | | | | 24.53 |

TABLE 32B
Example 12

| Sn | R | D | Nd | vd | θgF | Material | ED |
|---|---|---|---|---|---|---|---|
| 30 | −43.8919 | 1.0002 | 1.88100 | 40.14 | 0.57010 | TAFD33.HOYA | 22.75 |
| 31 | −272.7992 | 1.8334 | | | | | 22.56 |
| 32 | −40.4767 | 1.0002 | 1.72342 | 37.99 | 0.58202 | BAFD8.HOYA | 22.45 |
| 33 | −119.2331 | 0.1001 | | | | | 22.68 |
| 34 | 32.7958 | 3.2989 | 1.49700 | 81.61 | 0.53887 | FCD1.HOYA | 22.82 |
| 35 | 65.4443 | 2.5929 | | | | | 22.36 |
| 36 | 86.2607 | 1.9998 | 1.60738 | 56.71 | 0.54817 | BACD2.HOYA | 22.03 |
| 37 | 28.5078 | 2.1337 | | | | | 21.42 |
| *38 | 98.6159 | 3.5382 | 1.51742 | 52.15 | 0.55896 | E-CF6.HOYA | 21.55 |
| *39 | −40.8887 | 0.2947 | | | | | 21.65 |
| 40 | 35.7940 | 3.3824 | 1.59410 | 60.47 | 0.55516 | FCD600.HOYA | 21.06 |
| 41 | −193.5117 | 0.7323 | | | | | 20.54 |
| 42 | −101.4886 | 3.7496 | 2.16217 | 21.24 | 0.6276 | N216.Glass | 20.23 |
| 43 | −208.4551 | 8.5665 | | | | | 19.56 |
| 44 | −28.7211 | 1.5390 | 1.80610 | 33.27 | 0.58845 | NBFD15-W.HOYA | 17.43 |
| 45 | −23.6238 | 0.3371 | | | | | 17.58 |
| 46 | 514.3618 | 1.0002 | 1.69680 | 55.46 | 0.54260 | LAC14.HOYA | 16.66 |
| 47 | 26.2282 | 0.5755 | | | | | 16.07 |
| 48 | 27.7507 | 5.0098 | 1.62004 | 36.26 | 0.58800 | S-TIM2.OHARA | 16.07 |
| 49 | −16.4135 | 1.0002 | 1.83481 | 42.72 | 0.56477 | TAFD5G.HOYA | 15.63 |
| 50 | 113.5527 | 16.2237 | | | | | 15.39 |
| 51 | ∞ | 1.0000 | 1.51680 | 64.20 | 0.53430 | BSC7.HOYA | 15.01 |
| 52 | ∞ | 5.5053 | | | | | 14.99 |
| 53 | −16.5760 | 1.0002 | 1.87070 | 40.73 | 0.56825 | TAFD32.HOYA | 14.90 |
| 54 | 34.1705 | 3.6737 | 1.67300 | 38.26 | 0.57580 | S-NBH52V.OHARA | 16.59 |
| 55 | −41.7582 | 0.1002 | | | | | 17.56 |
| 56 | 42.9122 | 5.5638 | 1.51742 | 52.15 | 0.55896 | E-CF6.HOYA | 18.95 |
| 57 | −25.1381 | 8.6903 | | | | | 19.59 |

TABLE 33
Example 12

| | Wide | Middle | Tele |
|---|---|---|---|
| Zr | 1.0 | 6.6 | 19.3 |
| f | 20.16 | 132.59 | 389.02 |
| Bf | 8.6903 | 8.6903 | 8.6903 |
| FNo. | 4.12 | 3.86 | 4.29 |
| 2ω [°] | 46.2 | 7.6 | 2.8 |
| DD[8] | 2.2610 | 80.4546 | 98.8784 |
| DD[13] | 4.2139 | 2.8537 | 2.4239 |
| DD[18] | 97.3898 | 11.4359 | 4.3586 |
| DD[21] | 3.7510 | 12.8715 | 1.9548 |

TABLE 34
Example 12

| Sn | 9 | 10 | 38 | 39 |
|---|---|---|---|---|
| KA | 1.0000000E+00 | 1.0000000E+00 | 1.0000000E+00 | 1.0000000E+00 |
| A3 | 1.0316666E−07 | −3.4024112E−07 | −1.7089723E−07 | −8.5278486E−08 |
| A4 | −8.7106279E−06 | −7.6029261E−06 | −3.8525090E−06 | −1.7439394E−06 |
| A5 | 4.6679037E−06 | 4.0103673E−06 | −3.9294494E−07 | −2.3435493E−07 |
| A6 | −5.7140547E−07 | −1.0747662E−07 | 1.9392303E−07 | 1.0468147E−07 |
| A7 | 3.6517819E−08 | −8.3835384E−08 | −4.3600441E−08 | −2.0829840E−08 |
| A8 | −4.5537624E−09 | 1.1602178E−08 | 8.0127750E−09 | 3.9592348E−09 |
| A9 | 6.6411420E−10 | −2.2868388E−10 | −9.6142971E−10 | −4.8365866E−10 |
| A10 | −2.6056917E−11 | −3.9313883E−11 | 7.4214302E−11 | 3.7098850E−11 |
| A11 | −2.5912753E−12 | −2.2333184E−13 | −4.3155801E−12 | −2.1419271E−12 |
| A12 | 1.7104413E−13 | 3.2524373E−13 | 2.3372647E−13 | 1.1621132E−13 |
| A13 | 6.5891048E−15 | −7.1482595E−15 | −1.0975860E−14 | −5.5352210E−15 |
| A14 | −1.2813968E−16 | −2.4648718E−16 | 1.4268405E−15 | 7.1896901E−16 |
| A15 | −6.6440755E−17 | −1.8198218E−16 | −3.0201284E−16 | −1.5163835E−16 |
| A16 | 1.0766334E−18 | 2.1189785E−17 | 2.5760878E−17 | 1.3017546E−17 |
| A17 | 4.1295665E−19 | −2.5262518E−19 | 2.5102594E−20 | −3.8617697E−21 |
| A18 | −3.0719622E−20 | −7.7908323E−20 | −1.3690237E−19 | −6.7451957E−20 |
| A19 | 8.7913096E−22 | 4.7540999E−21 | 8.1253854E−21 | 4.0322332E−21 |
| A20 | −9.3199448E−24 | −8.7352356E−23 | −1.5405556E−22 | −7.6657132E−23 |

### Example 13

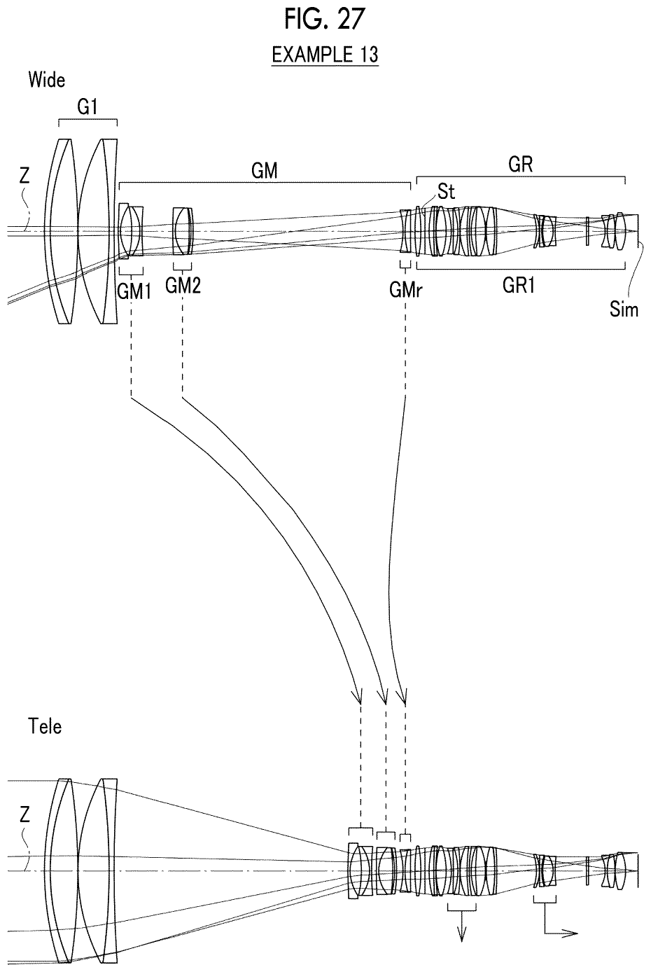

A configuration and a moving trajectory of a variable magnification optical system of Example 13 are shown in FIG. 27. The variable magnification optical system of Example 13 consists of, in order from the object side to the image side, the first lens group G1 having positive refractive power, the intermediate group GM, and the subsequent group GR. The intermediate group GM consists of, in order from the object side to the image side, three lens groups including the M1 lens group GM1 having negative refractive power, the M2 lens group GM2 having positive refractive power, and the Mr lens group GMr having negative refractive power. The M2 lens group GM2 having positive refractive power corresponds to the above M2p lens group. The subsequent group GR consists of one lens group that is the R1 lens group GR1 having positive refractive power.

During changing the magnification from the wide angle end to the telephoto end, the first lens group G1 and the R1 lens group GR1 remain stationary with respect to the image plane Sim, and other lens groups move along the optical axis Z by changing a spacing with respect to an adjacent lens group. The vibration-proof group consists of four lenses that are the fifth to eighth lenses in the R1 lens group GR1 from the object side. The focus group consists of four lenses that are the twelfth to fifteenth lenses in the R1 lens group GR1 from the object side. During focusing from the infinite distance object to the nearest object, the focus group moves to the image side.

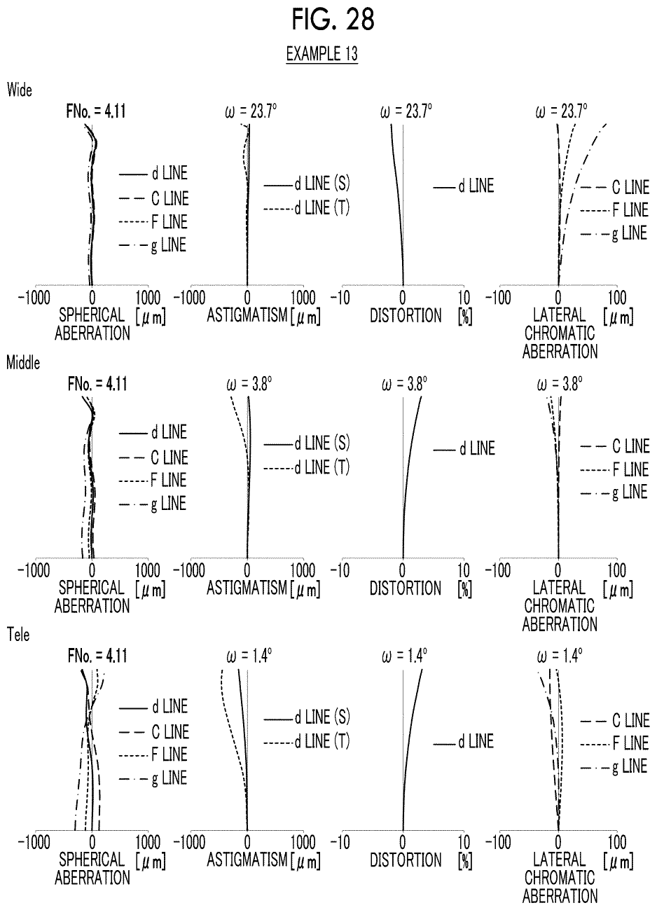

For the variable magnification optical system of Example 13, Tables 35A and 35B show basic lens data, Table 36 shows specifications and variable surface spacings, Table 37 shows aspherical coefficients, and FIG. 28 shows each aberration diagram.

TABLE 35A
Example 13

| Sn | R | D | Nd | vd | θgF | Material | ED |
|---|---|---|---|---|---|---|---|
| 1 | 169.5331 | 2.8002 | 1.69895 | 30.05 | 0.60282 | E-FD15L.HOYA | 96.00 |
| 2 | 132.7542 | 13.3405 | 1.43700 | 95.10 | 0.53364 | FCD100.HOYA | 94.87 |
| 3 | −350.4777 | 0.1002 | | | | | 94.67 |
| 4 | 109.8451 | 15.0918 | 1.49700 | 81.61 | 0.53887 | FCD1.HOYA | 90.22 |
| 5 | −386.0793 | 2.4002 | 1.83481 | 42.74 | 0.56490 | S-LAH55VS.OHARA | 88.75 |
| 6 | 766.9154 | DD[6] | | | | | 86.44 |
| *7 | 67.6342 | 1.0970 | 1.74077 | 27.79 | 0.60961 | S-TIH13.OHARA | 29.00 |
| *8 | 19.2173 | 5.4801 | | | | | 25.67 |
| 9 | −61.1649 | 3.9605 | 1.98613 | 16.48 | 0.66558 | FDS16-W.HOYA | 25.54 |
| 10 | −23.3497 | 1.0102 | 1.83400 | 37.16 | 0.57759 | S-LAH60.OHARA | 25.56 |
| 11 | 158.6611 | DD[11] | | | | | 25.07 |
| 12 | 264.2876 | 1.2101 | 1.71736 | 29.50 | 0.60404 | E-FD1L.HOYA | 24.53 |
| 13 | 19.9370 | 6.7549 | 1.80518 | 25.46 | 0.61572 | FD60-W.HOYA | 24.23 |
| 14 | −97.4053 | 0.8822 | | | | | 23.98 |
| 15 | −52.1945 | 1.0001 | 2.30909 | 17.89 | 0.6452 | N231.Glass | 23.87 |
| 16 | −90.9187 | DD[16] | | | | | 24.00 |
| 17 | −42.7525 | 1.0100 | 1.83481 | 42.74 | 0.56490 | S-LAH55VS.OHARA | 21.24 |
| 18 | 45.0373 | 2.6545 | 1.92119 | 23.96 | 0.62025 | FDS24-SW.HOYA | 22.08 |
| 19 | 1094.9334 | DD[19] | | | | | 22.33 |
| 20 | 101.7509 | 2.8412 | 1.49700 | 81.61 | 0.53887 | FCD1.HOYA | 23.59 |
| 21 | −84.0393 | 2.0002 | | | | | 23.78 |
| 22 (St) | ∞ | 2.0002 | | | | | 24.00 |
| 23 | 54.3763 | 2.2653 | 1.49700 | 81.61 | 0.53887 | FCD1.HOYA | 24.77 |
| 24 | 232.0437 | 1.0101 | 1.60562 | 43.71 | 0.57214 | S-BAM4.OHARA | 24.76 |
| 25 | 108.0992 | 0.1001 | | | | | 24.74 |
| 26 | 47.9474 | 4.8637 | 1.49700 | 81.61 | 0.53887 | FCD1.HOYA | 24.85 |
| 27 | −43.5205 | 2.5002 | | | | | 24.72 |
| 28 | −40.1828 | 1.0002 | 1.88100 | 40.14 | 0.57010 | TAFD33.HOYA | 23.57 |
| 29 | −366.5281 | 2.1999 | | | | | 23.72 |

TABLE 35B
Example 13

| Sn | R | D | Nd | νd | θgF | Material | ED |
|---|---|---|---|---|---|---|---|
| 30 | −39.0766 | 1.0002 | 1.72342 | 37.99 | 0.58202 | BAFD8.HOYA | 23.75 |
| 31 | −123.7560 | 0.1000 | | | | | 24.41 |
| 32 | 33.0701 | 3.3846 | 1.49700 | 81.61 | 0.53887 | FCD1.HOYA | 25.62 |
| 33 | 109.2331 | 1.0002 | | | | | 25.54 |
| 34 | 69.7736 | 1.0002 | 1.60738 | 56.71 | 0.54817 | BACD2.HOYA | 25.61 |
| 35 | 36.0211 | 2.1140 | | | | | 25.37 |
| *36 | 78.5173 | 4.7532 | 1.51742 | 52.15 | 0.55896 | E-CF6.HOYA | 25.51 |
| *37 | −34.9525 | 0.1002 | | | | | 25.76 |
| 38 | 44.5643 | 4.1407 | 1.59410 | 60.47 | 0.55516 | FCD600.HOYA | 24.88 |
| 39 | −81.5288 | 0.0102 | | | | | 24.39 |
| 40 | −94.7108 | 1.0002 | 2.16217 | 21.24 | 0.6276 | N216.Glass | 24.28 |
| 41 | −216.1584 | 19.1908 | | | | | 24.00 |
| 42 | −28.4060 | 1.4379 | 1.80610 | 33.27 | 0.58845 | NBFD15-W.HOYA | 17.27 |
| 43 | −22.8524 | 0.1002 | | | | | 17.37 |
| 44 | −1462.2343 | 1.0002 | 1.69680 | 55.46 | 0.54260 | LAC14.HOYA | 16.38 |
| 45 | 26.6242 | 0.5681 | | | | | 15.70 |
| 46 | 28.7012 | 5.0099 | 1.62004 | 36.26 | 0.58800 | S-TIM2.OHARA | 15.65 |
| 47 | −14.9266 | 1.0002 | 1.83481 | 42.72 | 0.56477 | TAFD5G.HOYA | 15.13 |
| 48 | 72.2573 | 15.1337 | | | | | 14.79 |
| 49 | ∞ | 1.0000 | 1.51680 | 64.20 | 0.53430 | BSC7.HOYA | 14.68 |
| 50 | ∞ | 8.0591 | | | | | 14.68 |
| 51 | −16.9038 | 1.0002 | 1.87070 | 40.73 | 0.56825 | TAFD32.HOYA | 14.63 |
| 52 | 26.9225 | 3.7765 | 1.67300 | 38.26 | 0.57580 | S-NBH52V.OHARA | 16.33 |
| 53 | −47.4271 | 0.1001 | | | | | 17.31 |
| 54 | 34.5960 | 5.0338 | 1.51742 | 52.15 | 0.55896 | E-CF6.HOYA | 18.92 |
| 55 | −26.4121 | 6.1098 | | | | | 19.36 |

TABLE 36
Example 13

| | Wide | Middle | Tele |
|---|---|---|---|
| Zr | 1.0 | 6.6 | 19.3 |
| f | 20.12 | 132.32 | 388.24 |
| Bf | 6.1098 | 6.1098 | 6.1098 |
| FNo. | 4.11 | 4.11 | 4.11 |
| 2ω [°] | 47.4 | 7.6 | 2.8 |
| DD[6] | 2.0001 | 91.9979 | 112.9994 |
| DD[11] | 14.6395 | 3.6120 | 2.2609 |
| DD[16] | 101.7097 | 14.7297 | 3.0783 |
| DD[19] | 2.1545 | 10.1642 | 2.1653 |

TABLE 37
Example 13

| Sn | 7 | 8 | 36 | 37 |
|---|---|---|---|---|
| KA | 1.0000000E+00 | 1.0000000E+00 | 1.0000000E+00 | 1.0000000E+00 |
| A3 | 2.0423888E−06 | 5.5773955E−07 | −1.8676935E−06 | −3.0615430E−06 |
| A4 | −1.3880239E−04 | −1.4479178E−04 | −9.1050553E−06 | 2.8296103E−06 |
| A5 | −6.9807572E−06 | −1.3206708E−05 | −2.0152093E−06 | −1.8952383E−06 |
| A6 | 4.4083351E−06 | 6.5992127E−06 | 4.2655701E−07 | 4.7861018E−07 |
| A7 | −3.1540102E−07 | −6.9642567E−07 | −9.1035119E−08 | −1.3764117E−07 |
| A8 | 2.8878486E−08 | 6.4498901E−08 | 2.7631496E−08 | 4.5263040E−08 |
| A9 | −9.1877583E−09 | −8.5915023E−09 | −6.4343739E−09 | −1.0578111E−08 |
| A10 | 1.1637312E−09 | 4.1005038E−10 | 9.0690516E−10 | 1.4953822E−09 |
| A11 | −6.6255051E−11 | 4.9316057E−11 | −7.2375319E−11 | −1.1969721E−10 |
| A12 | 2.3880366E−12 | −5.9860979E−12 | 3.0204765E−12 | 4.9966823E−12 |
| A13 | −6.6528140E−14 | −5.6858755E−14 | −1.0448097E−13 | −1.7113976E−13 |
| A14 | −5.9173289E−15 | 4.4504844E−14 | 8.0615238E−15 | 1.3271330E−14 |
| A15 | 5.2852875E−16 | −2.3205082E−15 | 2.8295807E−16 | 4.4934043E−16 |
| A16 | 5.0742364E−17 | −1.5838987E−17 | −1.2896467E−16 | −2.1104199E−16 |
| A17 | −8.6751859E−18 | 2.7987423E−19 | 9.2906011E−18 | 1.5269670E−17 |
| A18 | 4.8562430E−19 | 4.7014787E−19 | −2.0253820E−19 | −3.3430509E−19 |
| A19 | −1.2834616E−20 | −2.7280826E−20 | −3.3465922E−21 | −5.4664845E−21 |
| A20 | 1.3605636E−22 | 4.5589623E−22 | 1.4724204E−22 | 2.4196099E−22 |

### Example 14

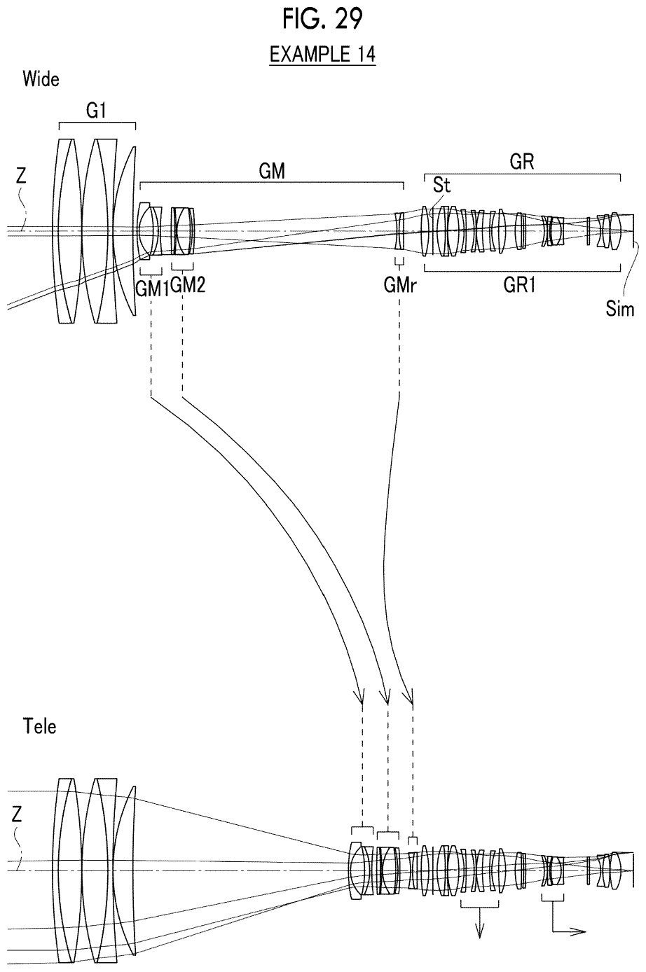

A configuration and a moving trajectory of a variable magnification optical system of Example 14 are shown in FIG. 29. The variable magnification optical system of Example 14 consists of, in order from the object side to the image side, the first lens group G1 having positive refractive power, the intermediate group GM, and the subsequent group GR. The intermediate group GM consists of, in order from the object side to the image side, three lens groups including the M1 lens group GM1 having negative refractive power, the M2 lens group GM2 having positive refractive power, and the Mr lens group GMr having negative refractive power. The M2 lens group GM2 having positive refractive power corresponds to the above M2p lens group. The subsequent group GR consists of one lens group that is the R1 lens group GR1 having positive refractive power.

During changing the magnification from the wide angle end to the telephoto end, the first lens group G1 and the R1 lens group GR1 remain stationary with respect to the image plane Sim, and other lens groups move along the optical axis Z by changing a spacing with respect to an adjacent lens group. The vibration-proof group consists of four lenses that are the fifth to eighth lenses in the R1 lens group GR1 from the object side. The focus group consists of four lenses that are the twelfth to fifteenth lenses in the R1 lens group GR1 from the object side. During focusing from the infinite distance object to the nearest object, the focus group moves to the image side.

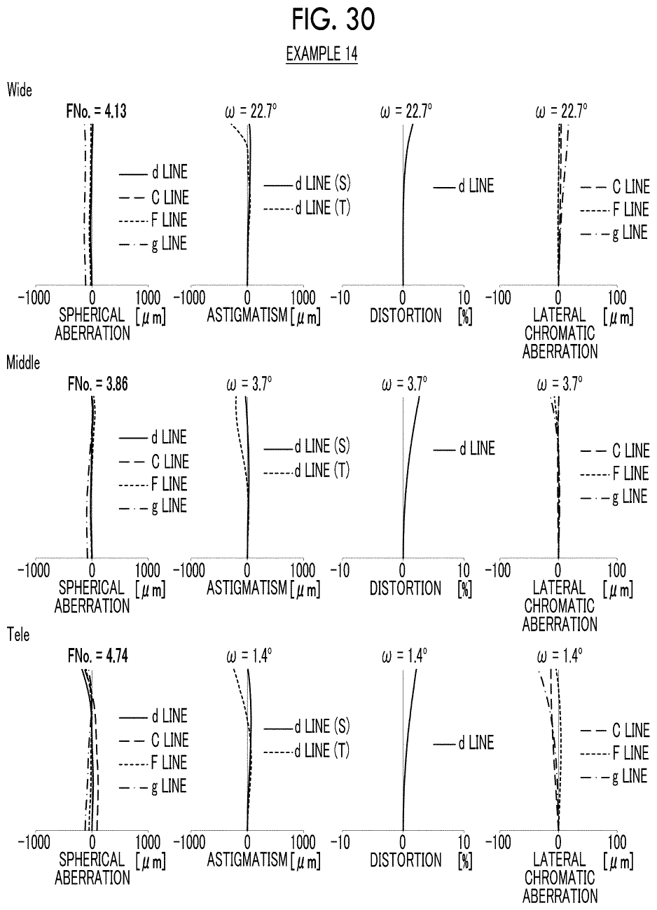

For the variable magnification optical system of Example 14, Tables 38A and 38B show basic lens data, Table 39 shows specifications and variable surface spacings, Table 40 shows aspherical coefficients, and FIG. 30 shows each aberration diagram.

TABLE 38A
Example 14

| Sn | R | D | Nd | νd | θgF | Material | ED |
|---|---|---|---|---|---|---|---|
| 1 | 364.3430 | 2.8202 | 1.57501 | 41.50 | 0.57672 | S-TIL27.OHARA | 96.00 |
| 2 | 182.2280 | 11.2893 | 1.49700 | 81.61 | 0.53887 | FCD1.HOYA | 95.37 |
| 3 | −308.3610 | 0.1002 | | | | | 95.27 |
| 4 | 187.1667 | 12.5625 | 1.49700 | 81.61 | 0.53887 | FCD1.HOYA | 92.54 |
| 5 | −224.6980 | 2.4002 | 1.83481 | 42.74 | 0.56490 | S-LAH55VS.OHARA | 91.82 |
| 6 | 575.2959 | 0.1002 | | | | | 89.96 |
| 7 | 103.4594 | 9.6058 | 1.49700 | 81.61 | 0.53887 | FCD1.HOYA | 87.90 |
| 8 | 740.0900 | DD[8] | | | | | 87.39 |
| *9 | 95.0188 | 1.0002 | 1.59271 | 66.97 | 0.53675 | MC-PCD51-70.HOYA | 29.73 |
| *10 | 19.4188 | 6.8320 | | | | | 25.26 |
| 11 | −57.6494 | 2.4520 | 1.98613 | 16.48 | 0.66558 | FDS16-W.HOYA | 25.09 |
| 12 | −31.6870 | 1.0102 | 1.79091 | 48.09 | 0.55438 | TAF48.HOYA | 25.07 |
| 13 | 109.2687 | DD[13] | | | | | 24.60 |
| 14 | 331.5399 | 1.7408 | 1.67003 | 47.20 | 0.56411 | BAF10.HOYA | 24.51 |
| 15 | −190.6686 | 0.6703 | | | | | 24.47 |
| 16 | −132.0463 | 0.4102 | 1.70154 | 41.15 | 0.57704 | BAFD7.HOYA | 24.39 |
| 17 | 22.7398 | 6.3970 | 1.91082 | 35.25 | 0.58335 | TAFD35L.HOYA | 24.33 |
| 18 | −76.6522 | 1.0053 | | | | | 24.05 |
| 19 | −49.1580 | 1.0001 | 2.16217 | 21.24 | 0.6276 | N216.Glass | 23.74 |
| 20 | −123.2382 | DD[20] | | | | | 23.76 |
| 21 | −46.1073 | 1.0115 | 1.83481 | 42.72 | 0.56477 | TAFD5G.HOYA | 18.02 |
| 22 | 48.0247 | 2.1932 | 1.92119 | 23.96 | 0.62025 | FDS24-W.HOYA | 18.82 |
| 23 | 4164.7284 | DD[23] | | | | | 19.14 |
| 24 | 90.5148 | 3.7086 | 1.49700 | 81.61 | 0.53887 | FCD1.HOYA | 24.92 |
| 25 | −50.7793 | 2.0002 | | | | | 25.11 |
| 26 (St) | ∞ | 2.0002 | | | | | 25.00 |
| 27 | 40.1835 | 4.0294 | 1.49700 | 81.61 | 0.53887 | FCD1.HOYA | 25.36 |
| 28 | −109.7705 | 1.0101 | 1.62205 | 41.08 | 0.56917 | S-NBM52.OHARA | 25.16 |
| 29 | 146.9451 | 0.1002 | | | | | 24.86 |
| 30 | 43.2792 | 5.4141 | 1.49700 | 81.61 | 0.53887 | FCD1.HOYA | 24.72 |
| 31 | −46.9303 | 2.5002 | | | | | 24.18 |

TABLE 38B
Example 14

| Sn | R | D | Nd | νd | θgF | Material | ED |
|---|---|---|---|---|---|---|---|
| 32 | −40.6929 | 1.0001 | 1.88100 | 40.14 | 0.57010 | TAFD33.HOYA | 22.34 |
| 33 | −195.8560 | 3.8797 | | | | | 22.17 |
| 34 | −40.5952 | 1.0002 | 1.72342 | 37.99 | 0.58202 | BAFD8.HOYA | 21.48 |
| 35 | −98.4035 | 0.1002 | | | | | 21.64 |
| 36 | 37.2225 | 2.8554 | 1.49700 | 81.61 | 0.53887 | FCD1.HOYA | 21.63 |
| 37 | 71.8182 | 3.5507 | | | | | 21.21 |
| 38 | 99.7042 | 1.0002 | 1.60738 | 56.71 | 0.54817 | BACD2.HOYA | 20.71 |
| 39 | 30.7987 | 3.3264 | | | | | 20.34 |
| *40 | 107.7446 | 3.3968 | 1.51742 | 52.15 | 0.55896 | E-CF6.HOYA | 20.66 |
| *41 | −37.9989 | 4.5951 | | | | | 20.76 |
| 42 | 38.0773 | 3.1025 | 1.59410 | 60.47 | 0.55516 | FCD600.HOYA | 19.07 |
| 43 | −197.1649 | 1.0306 | | | | | 18.51 |
| 44 | −95.1327 | 1.0002 | 2.16217 | 21.24 | 0.6276 | N216.Glass | 18.01 |
| 45 | −174.4934 | 8.9409 | | | | | 17.81 |
| 46 | −25.8241 | 1.5094 | 1.80610 | 33.27 | 0.58845 | NBFD15-W.HOYA | 15.65 |
| 47 | −20.9258 | 0.1002 | | | | | 15.81 |
| 48 | 419.6761 | 1.0001 | 1.69680 | 55.46 | 0.54260 | LAC14.HOYA | 15.06 |
| 49 | 24.4687 | 0.6819 | | | | | 14.51 |
| 50 | 29.4077 | 4.9435 | 1.62004 | 36.26 | 0.58800 | S-TIM2.OHARA | 14.50 |
| 51 | −13.4399 | 1.0002 | 1.83481 | 42.72 | 0.56477 | TAFD5G.HOYA | 14.07 |
| 52 | 120.4069 | 11.6203 | | | | | 13.96 |
| 53 | ∞ | 1.0000 | 1.51680 | 64.20 | 0.53430 | BSC7.HOYA | 14.32 |
| 54 | ∞ | 5.4393 | | | | | 14.35 |
| 55 | −16.3726 | 1.0002 | 1.87070 | 40.73 | 0.56825 | TAFD32.HOYA | 14.47 |
| 56 | 32.3205 | 3.4427 | 1.67300 | 38.26 | 0.57580 | S-NBH52V.OHARA | 16.19 |
| 57 | −51.9341 | 0.1002 | | | | | 17.20 |
| 58 | 40.6567 | 5.2557 | 1.51742 | 52.15 | 0.55896 | E-CF6.HOYA | 18.69 |
| 59 | −22.0443 | 6.0851 | | | | | 19.29 |

TABLE 39
Example 14

| | Wide | Middle | Tele |
|---|---|---|---|
| Zr | 1.0 | 6.6 | 19.3 |
| f | 20.40 | 134.16 | 393.63 |
| Bf | 6.0851 | 6.0851 | 6.0851 |
| FNo. | 4.13 | 3.86 | 4.74 |
| 2ω [°] | 45.4 | 7.4 | 2.8 |
| DD[8] | 2.0000 | 84.8834 | 103.9490 |
| DD[13] | 5.2128 | 2.8182 | 2.4001 |
| DD[20] | 97.6690 | 9.8415 | 5.0719 |
| DD[23] | 8.4993 | 15.8379 | 1.9602 |

TABLE 40
Example 14

| Sn | 9 | 10 | 40 | 41 |
|---|---|---|---|---|
| KA | 1.0000000E+00 | 1.0000000E+00 | 1.0000000E+00 | 1.0000000E+00 |
| A3 | −5.1650249E−07 | 6.4518671E−08 | −3.8725768E−08 | −4.2201767E−08 |
| A4 | 3.7668022E−06 | 5.0890352E−06 | 4.5383623E−07 | 2.4262097E−06 |
| A5 | 4.1231993E−06 | 5.2058030E−06 | −2.4517631E−06 | −2.2454676E−06 |
| A6 | −1.2912071E−07 | −4.9150186E−07 | 1.4545948E−07 | 1.4736852E−07 |
| A7 | −5.7403669E−08 | 3.1421133E−08 | 8.8142664E−09 | 3.9100486E−09 |
| A8 | 1.6198677E−09 | −8.5479209E−09 | −1.1931811E−10 | 2.6790160E−10 |
| A9 | 6.2998809E−10 | 1.0583888E−09 | −5.9004113E−11 | −7.7464580E−11 |
| A10 | −6.9533719E−11 | −3.3164208E−11 | −8.5921704E−12 | −4.5616609E−12 |
| A11 | 4.3425870E−12 | −5.3611559E−12 | 8.2453817E−13 | 4.0595115E−13 |
| A12 | −2.0953485E−13 | 5.6004222E−13 | 1.9669819E−14 | 3.0651652E−14 |
| A13 | 2.5600716E−15 | 1.7212699E−14 | 3.2725534E−15 | 3.8839689E−15 |
| A14 | 5.7207401E−16 | −4.4890541E−15 | −9.8010946E−16 | −1.0578002E−15 |
| A15 | −3.7987222E−17 | 1.5704755E−16 | −4.5849716E−17 | −2.7109343E−17 |
| A16 | −2.2784911E−18 | −3.8377856E−19 | 1.8330780E−17 | 1.5642194E−17 |
| A17 | 5.6598498E−19 | 2.8893027E−19 | −1.0337589E−18 | −9.0121746E−19 |
| A18 | −4.0869289E−20 | −2.7496712E−20 | −1.9352831E−20 | −1.6448535E−20 |
| A19 | 1.3553000E−21 | 7.1885328E−22 | 3.4493381E−21 | 2.9745600E−21 |
| A20 | −1.7505244E−23 | −4.7910689E−24 | −8.5531186E−23 | −7.3628374E−23 |

### Example 15

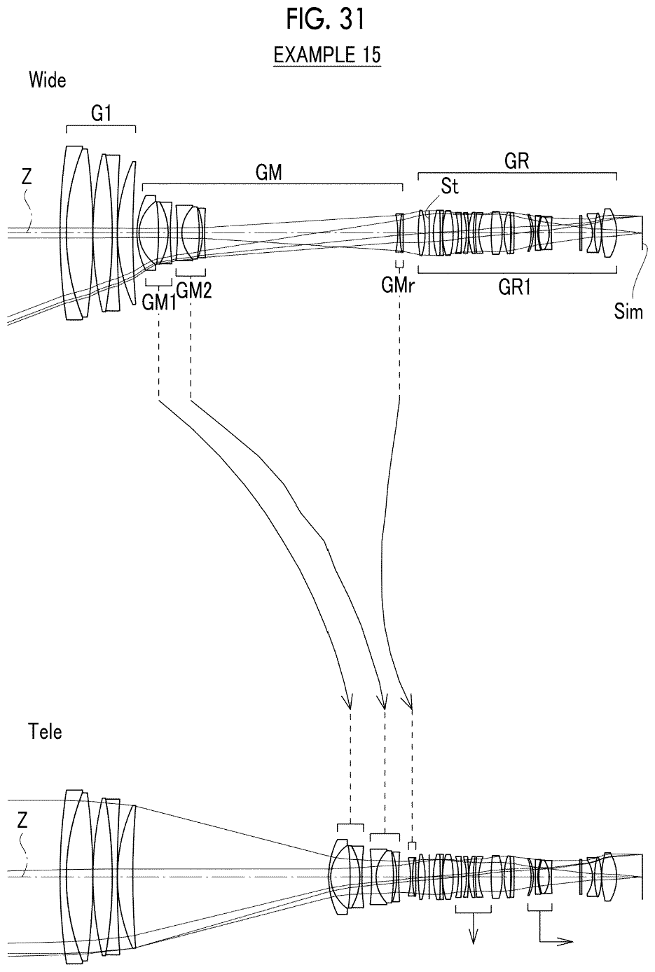

A configuration and a moving trajectory of a variable magnification optical system of Example 15 are shown in FIG. 31. The variable magnification optical system of Example 15 consists of, in order from the object side to the image side, the first lens group G1 having positive refractive power, the intermediate group GM, and the subsequent group GR. The intermediate group GM consists of, in order from the object side to the image side, three lens groups including the M1 lens group GM1 having negative refractive power, the M2 lens group GM2 having negative refractive power, and the Mr lens group GMr having negative refractive power. The M2 lens group GM2 having negative refractive power corresponds to the above M2n lens group. The subsequent group GR consists of one lens group that is the R1 lens group GR1 having positive refractive power.

During changing the magnification from the wide angle end to the telephoto end, the first lens group G1 and the R1 lens group GR1 remain stationary with respect to the image plane Sim, and other lens groups move along the optical axis Z by changing a spacing with respect to an adjacent lens group. The vibration-proof group consists of four lenses that are the fifth to eighth lenses in the R1 lens group GR1 from the object side. The focus group consists of four lenses that are the twelfth to fifteenth lenses in the R1 lens group GR1 from the object side. During focusing from the infinite distance object to the nearest object, the focus group moves to the image side.

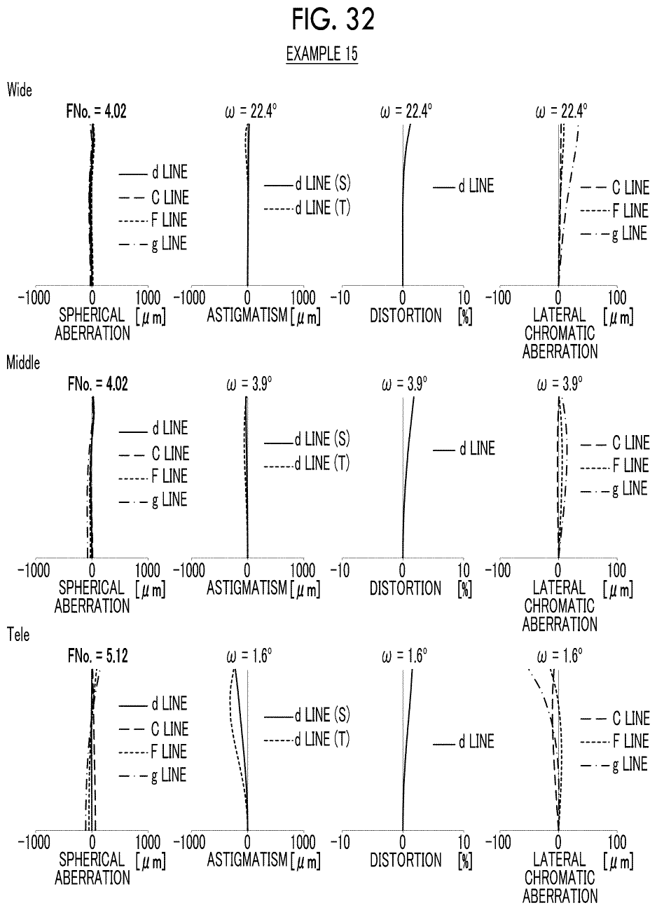

For the variable magnification optical system of Example 15, Tables 41A and 41B show basic lens data, Table 42 shows specifications and variable surface spacings, and FIG. 32 shows each aberration diagram.

TABLE 41A
Example 15

| Sn | R | D | Nd | νd | θgF | Material | ED |
|---|---|---|---|---|---|---|---|
| 1 | 330.2942 | 3.0365 | 1.57501 | 41.50 | 0.57672 | S-TIL27.OHARA | 90.00 |
| 2 | 126.3356 | 12.7246 | 1.49700 | 81.61 | 0.53887 | FCD1.HOYA | 87.06 |
| 3 | −357.5116 | 0.1001 | | | | | 86.20 |
| 4 | 186.2463 | 9.2759 | 1.49700 | 81.61 | 0.53887 | FCD1.HOYA | 81.58 |
| 5 | −257.8001 | 2.4002 | 1.79950 | 42.34 | 0.56498 | NBFD12.HOYA | 80.70 |
| 6 | 674.2371 | 0.1002 | | | | | 78.03 |
| 7 | 97.1302 | 7.3897 | 1.49700 | 81.61 | 0.53887 | FCD1.HOYA | 74.00 |
| 8 | 497.9625 | DD[8] | | | | | 73.42 |
| 9 | 46.9267 | 1.0002 | 1.51680 | 64.20 | 0.53430 | BSC7.HOYA | 38.77 |
| 10 | 20.7810 | 9.3585 | | | | | 32.71 |
| 11 | −146.9577 | 4.6274 | 1.92286 | 20.88 | 0.63900 | E-FDS1-W.HOYA | 32.31 |
| 12 | −33.9834 | 1.0102 | 1.80420 | 46.50 | 0.55727 | TAF3D.HOYA | 31.88 |
| 13 | 148.0202 | DD[13] | | | | | 29.76 |
| 14 | −155.5013 | 2.1858 | 1.71300 | 53.94 | 0.54424 | LAC8.HOYA | 28.73 |
| 15 | 20.3183 | 8.3200 | 1.90366 | 31.34 | 0.59636 | S-LAH95.OHARA | 27.04 |
| 16 | −90.8024 | 1.5517 | | | | | 26.26 |
| 17 | −42.2053 | 1.0002 | 1.92286 | 20.88 | 0.63900 | E-FDS1-W.HOYA | 25.72 |
| 18 | 188.7014 | DD[18] | | | | | 25.20 |
| 19 | −45.9964 | 1.0102 | 1.83400 | 37.16 | 0.57759 | S-LAH60.OHARA | 19.00 |
| 20 | 53.4505 | 1.5252 | 1.92286 | 20.88 | 0.63900 | E-FDS1-W.HOYA | 19.88 |
| 21 | 4001.0091 | DD[21] | | | | | 20.05 |
| 22 | 86.2488 | 3.2568 | 1.49700 | 81.61 | 0.53887 | FCD1.HOYA | 23.27 |
| 23 | −46.8524 | 2.0002 | | | | | 23.36 |
| 24 (St) | ∞ | 2.0002 | | | | | 23.00 |
| 25 | 41.8755 | 3.3156 | 1.49700 | 81.61 | 0.53887 | FCD1.HOYA | 23.53 |
| 26 | −320.2597 | 1.0102 | 1.57135 | 52.95 | 0.55544 | S-BAL3.OHARA | 23.39 |
| 27 | 129.7224 | 0.1003 | | | | | 23.23 |
| 28 | 41.7718 | 5.1207 | 1.49700 | 81.61 | 0.53887 | FCD1.HOYA | 23.18 |
| 29 | −50.8273 | 2.5002 | | | | | 22.71 |

TABLE 41B
Example 15

| Sn | R | D | Nd | νd | θgF | Material | ED |
|---|---|---|---|---|---|---|---|
| 30 | −44.0894 | 1.4997 | 1.88100 | 40.14 | 0.57010 | TAFD33.HOYA | 21.25 |
| 31 | −283.6161 | 2.3616 | | | | | 21.10 |
| 32 | −40.3199 | 1.0002 | 1.72342 | 37.99 | 0.58202 | BAFD8.HOYA | 20.89 |
| 33 | −123.0645 | 0.1001 | | | | | 21.13 |
| 34 | 32.3989 | 2.2253 | 1.49700 | 81.61 | 0.53887 | FCD1.HOYA | 21.35 |
| 35 | 63.5198 | 1.0000 | | | | | 21.13 |
| 36 | 86.1592 | 1.6705 | 1.60738 | 56.71 | 0.54817 | BACD2.HOYA | 21.06 |
| 37 | 28.0037 | 5.9146 | | | | | 20.62 |
| 38 | 98.2435 | 5.3097 | 1.51742 | 52.15 | 0.55896 | E-CF6.HOYA | 21.82 |
| 39 | −41.3192 | 0.9077 | | | | | 22.14 |
| 40 | 35.3373 | 3.1666 | 1.59410 | 60.47 | 0.55516 | FCD600.HOYA | 21.57 |
| 41 | −201.6503 | 0.3075 | | | | | 21.19 |
| 42 | −100.8475 | 1.3223 | 1.94595 | 17.98 | 0.65460 | FDS18-W.HOYA | 21.17 |
| 43 | −323.9632 | 8.2269 | | | | | 20.85 |
| 44 | −29.0477 | 1.0599 | 1.80610 | 33.27 | 0.58845 | NBFD15-W.HOYA | 19.12 |
| 45 | −24.0830 | 0.9522 | | | | | 19.24 |
| 46 | 519.1486 | 1.1822 | 1.69680 | 55.46 | 0.54260 | LAC14.HOYA | 17.99 |
| 47 | 26.7163 | 0.5077 | | | | | 17.34 |
| 48 | 26.9150 | 5.0098 | 1.62004 | 36.26 | 0.58800 | S-TIM2.OHARA | 17.36 |
| 49 | −17.0613 | 1.0002 | 1.85033 | 42.70 | 0.56458 | TAFD34.HOYA | 17.06 |
| 50 | 114.7174 | 13.6581 | | | | | 16.87 |
| 51 | ∞ | 1.0000 | 1.51680 | 64.20 | 0.53430 | BSC7.HOYA | 17.24 |
| 52 | ∞ | 5.1167 | | | | | 17.26 |
| 53 | −16.3414 | 1.0001 | 1.87070 | 40.73 | 0.56825 | TAFD32.HOYA | 17.34 |
| 54 | 39.9033 | 3.3537 | 1.67300 | 38.26 | 0.57580 | S-NBH52V.OHARA | 20.07 |
| 55 | −36.1303 | 0.1000 | | | | | 20.49 |
| 56 | 45.6250 | 7.2010 | 1.51742 | 52.15 | 0.55896 | E-CF6.HOYA | 23.01 |
| 57 | −26.5846 | 12.4020 | | | | | 23.90 |

TABLE 42
Example 15

| | Wide | Middle | Tele |
|---|---|---|---|
| Zr | 1.0 | 6.6 | 19.3 |
| f | 21.05 | 138.44 | 406.19 |
| Bf | 12.4020 | 12.4020 | 12.4020 |
| FNo. | 4.02 | 4.02 | 5.12 |
| 2ω [°] | 44.8 | 7.8 | 3.2 |
| DD[8] | 2.0002 | 76.2998 | 93.9550 |
| DD[13] | 3.4412 | 5.0520 | 4.6450 |
| DD[18] | 92.7424 | 8.3631 | 5.6676 |
| DD[21] | 7.2903 | 15.7592 | 1.2066 |

### Example 16

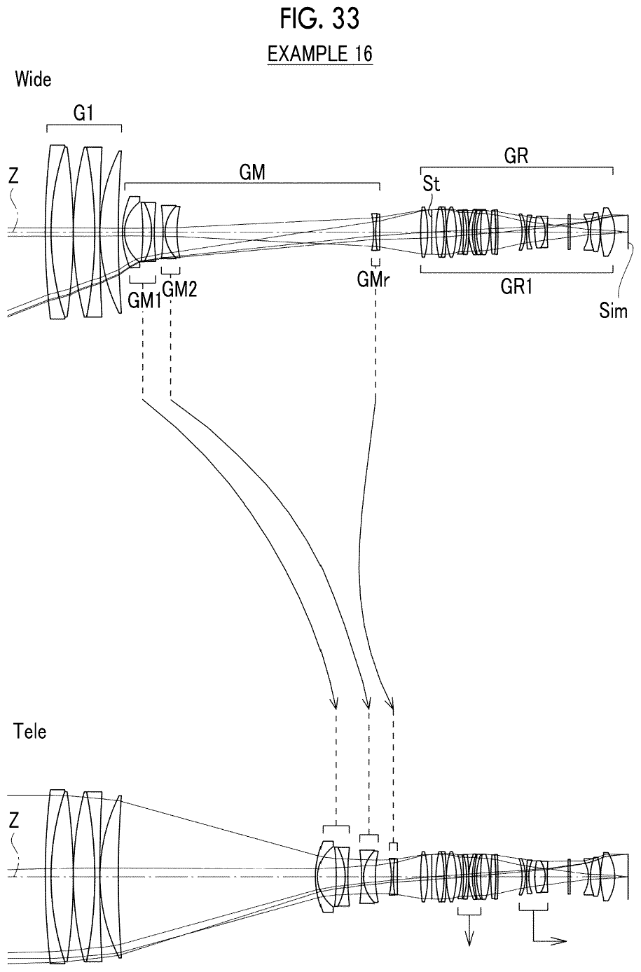

A configuration and a moving trajectory of a variable magnification optical system of Example 16 are shown in FIG. 33. The variable magnification optical system of Example 16 consists of, in order from the object side to the image side, the first lens group G1 having positive refractive power, the intermediate group GM, and the subsequent group GR. The intermediate group GM consists of, in order from the object side to the image side, three lens groups including the M1 lens group GM1 having negative refractive power, the M2 lens group GM2 having negative refractive power, and the Mr lens group GMr having negative refractive power. The M2 lens group GM2 having negative refractive power corresponds to the above M2n lens group. The subsequent group GR consists of one lens group that is the R1 lens group GR1 having positive refractive power.

During changing the magnification from the wide angle end to the telephoto end, the first lens group G1 and the R1 lens group GR1 remain stationary with respect to the image plane Sim, and other lens groups move along the optical axis Z by changing a spacing with respect to an adjacent lens group. The vibration-proof group consists of four lenses that are the fifth to eighth lenses in the R1 lens group GR1 from the object side. The focus group consists of four lenses that are the twelfth to fifteenth lenses in the R1 lens group GR1 from the object side. During focusing from the infinite distance object to the nearest object, the focus group moves to the image side.

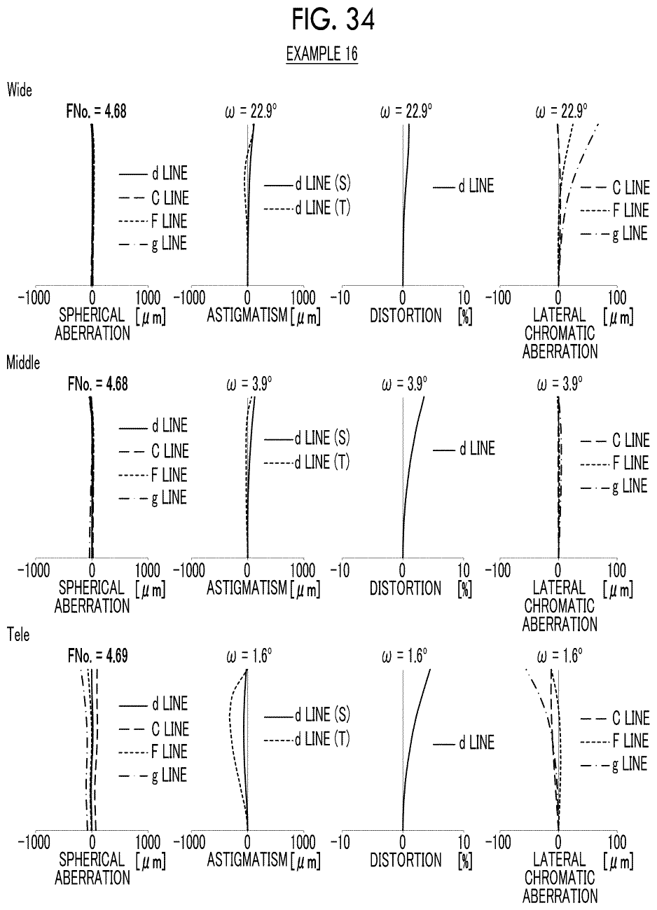

For the variable magnification optical system of Example 16, Tables 43A and 43B show basic lens data, Table 44 shows specifications and variable surface spacings, Table 45 shows aspherical coefficients, and FIG. 34 shows each aberration diagram.

TABLE 43A
Example 16

| Sn | R | D | Nd | νd | θgF | Material | ED |
|---|---|---|---|---|---|---|---|
| 1 | 408.5958 | 2.8202 | 1.61293 | 36.96 | 0.58507 | E-F3.HOYA | 90.00 |
| 2 | 150.2824 | 10.6448 | 1.49700 | 81.61 | 0.53887 | FCD1.HOYA | 88.00 |
| 3 | −328.2438 | 0.1002 | | | | | 87.95 |
| 4 | 187.5093 | 10.2813 | 1.49700 | 81.61 | 0.53887 | FCD1.HOYA | 86.30 |
| 5 | −248.1743 | 2.4002 | 1.80420 | 46.50 | 0.55727 | TAF3D.HOYA | 85.86 |
| 6 | 943.4762 | 0.1002 | | | | | 84.60 |
| 7 | 100.3247 | 8.8114 | 1.49700 | 81.61 | 0.53887 | FCD1.HOYA | 82.58 |
| 8 | 589.5639 | DD[8] | | | | | 81.96 |
| *9 | 48.1077 | 1.0002 | 1.51742 | 52.15 | 0.55896 | E-CF6.HOYA | 36.86 |
| *10 | 20.8712 | 8.7915 | | | | | 31.19 |
| 11 | −144.0837 | 4.2616 | 1.92286 | 18.90 | 0.64960 | S-NPH2.OHARA | 30.75 |
| 12 | −34.6669 | 1.2819 | 1.80610 | 40.73 | 0.56719 | NBFD13.HOYA | 30.39 |
| 13 | 151.2220 | DD[13] | | | | | 28.73 |
| 14 | −114.8983 | 1.0102 | 1.70154 | 41.15 | 0.57704 | BAFD7.HOYA | 27.54 |
| 15 | 19.6250 | 5.6816 | 1.90043 | 37.37 | 0.57668 | TAFD37A.HOYA | 26.57 |
| 16 | 62.8024 | DD[16] | | | | | 26.00 |
| 17 | −46.3619 | 1.0100 | 1.83481 | 42.74 | 0.56490 | S-LAH55VS.OHARA | 18.23 |
| 18 | 64.7863 | 1.9037 | 1.92286 | 20.88 | 0.63900 | E-FDS1-W.HOYA | 18.55 |
| 19 | 3695.9606 | DD[19] | | | | | 18.68 |
| 20 | 111.2955 | 3.3837 | 1.49700 | 81.61 | 0.53887 | FCD1.HOYA | 23.26 |
| 21 | −56.2630 | 2.0000 | | | | | 23.36 |
| 22 (St) | ∞ | 2.0002 | | | | | 23.00 |
| 23 | 59.0211 | 3.9111 | 1.49700 | 81.61 | 0.53887 | FCD1.HOYA | 23.81 |
| 24 | −63.1111 | 1.0002 | 1.90366 | 31.31 | 0.59481 | TAFD25.HOYA | 23.85 |
| 25 | −136.3201 | 0.1001 | | | | | 24.02 |
| 26 | 46.7031 | 4.7385 | 1.49700 | 81.61 | 0.53887 | FCD1.HOYA | 24.10 |
| 27 | −48.0201 | 2.5000 | | | | | 23.85 |
| 28 | −38.2704 | 1.0002 | 1.90043 | 37.37 | 0.57668 | TAFD37A.HOYA | 22.68 |
| 29 | −112.5482 | 1.4852 | | | | | 22.78 |

TABLE 43B
Example 16

| Sn | R | D | Nd | fd | θgF | Material | ED |
|---|---|---|---|---|---|---|---|
| 30 | −43.0079 | 1.0002 | 1.76634 | 35.82 | 0.57931 | S-NBH59.OHARA | 22.73 |
| 31 | −101.7973 | 0.1001 | | | | | 23.07 |
| 32 | 31.9503 | 1.6515 | 1.51742 | 52.15 | 0.55896 | E-CF6.HOYA | 23.51 |
| 33 | 37.8143 | 1.0305 | | | | | 23.29 |
| 34 | 51.7313 | 1.0001 | 1.59410 | 60.47 | 0.55516 | FCD600.HOYA | 23.33 |
| 35 | 32.9443 | 1.9444 | | | | | 23.10 |
| 36 | 93.8828 | 4.2004 | 1.51742 | 52.15 | 0.55896 | E-CF6.HOYA | 23.24 |
| 37 | −39.3605 | 0.7335 | | | | | 23.37 |
| 38 | 120.4706 | 2.3054 | 1.59410 | 60.47 | 0.55516 | FCD600.HOYA | 22.72 |
| 39 | −148.0620 | 0.1273 | | | | | 22.44 |
| 40 | −118.3314 | 1.0002 | 1.77250 | 49.62 | 0.55038 | TAF1.HOYA | 22.44 |
| 41 | −246.6112 | 11.5857 | | | | | 22.24 |
| 42 | −31.6564 | 1.6174 | 1.80610 | 33.27 | 0.58845 | NBFD15-W.HOYA | 18.68 |
| 43 | −25.0930 | 0.6398 | | | | | 18.79 |
| *44 | 251.3445 | 1.0001 | 1.69680 | 55.46 | 0.54260 | LAC14.HOYA | 17.38 |
| *45 | 26.3002 | 2.8878 | | | | | 16.61 |
| 46 | 39.9658 | 5.0100 | 1.62004 | 36.30 | 0.58729 | E-F2.HOYA | 16.47 |
| 47 | −16.4040 | 1.0000 | 1.85033 | 42.70 | 0.56458 | TAFD34.HOYA | 16.05 |
| 48 | 159.1945 | 10.0001 | | | | | 15.95 |
| 49 | ∞ | 1.0000 | 1.51680 | 64.20 | 0.53430 | BSC7.HOYA | 16.24 |
| 50 | ∞ | 8.7542 | | | | | 16.26 |
| 51 | −17.7626 | 1.0001 | 1.91082 | 35.25 | 0.58335 | TAFD35L.HOYA | 16.45 |
| 52 | 29.5746 | 4.7032 | 1.67270 | 32.17 | 0.59633 | E-FD5.HOYA | 18.73 |
| 53 | −42.9110 | 0.2070 | | | | | 20.12 |
| 54 | 45.1781 | 6.7890 | 1.51742 | 52.43 | 0.55649 | S-NSL36.OHARA | 22.56 |
| 55 | −25.7612 | 6.4583 | | | | | 23.40 |

TABLE 44
Example 16

| | Wide | Middle | Tele |
|---|---|---|---|
| Zr | 1.0 | 6.6 | 19.3 |
| f | 20.52 | 135.01 | 396.13 |
| Bf | 6.4583 | 6.4583 | 6.4583 |
| FNo. | 4.68 | 4.68 | 4.69 |
| 2ω [°] | 45.8 | 7.8 | 3.2 |
| DD[8] | 2.0000 | 77.1843 | 94.8458 |
| DD[13] | 4.2128 | 7.4221 | 6.5798 |
| DD[16] | 94.3741 | 8.6014 | 7.6699 |
| DD[19] | 19.6887 | 27.0678 | 11.1800 |

TABLE 45
Example 16

| Sn | 9 | 10 | 44 | 45 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | 8.8033732E−06 | 1.1660834E−05 | 3.3807486E−05 | 4.4667565E−05 |
| A5 | −9.3921420E−07 | −9.1500342E−07 | −6.3379271E−08 | −6.1324833E−08 |
| A6 | −1.4031945E−08 | 2.7716194E−08 | −4.0552530E−07 | −3.9235237E−07 |
| A7 | 5.3763620E−09 | −6.3419883E−09 | −9.1448304E−09 | −7.9066005E−09 |
| A8 | −2.4602010E−10 | 1.4327654E−09 | 2.1506755E−09 | 1.3830622E−09 |
| A9 | 2.8933332E−12 | −1.3276693E−10 | 5.1879705E−10 | 7.8459641E−10 |
| A10 | 4.6270506E−13 | 5.6646400E−12 | −1.2593244E−10 | −1.8776274E−10 |
| A11 | −8.0592457E−14 | 8.5322238E−14 | 1.0302208E−11 | 1.9485083E−11 |
| A12 | 4.6888988E−15 | −1.9924655E−14 | 2.5484521E−13 | −4.5231818E−13 |
| A13 | −1.5292841E−17 | 1.2023348E−16 | −9.3526765E−14 | −8.0750950E−14 |
| A14 | −1.0181849E−17 | 1.0236646E−16 | 1.1374934E−16 | 1.4441352E−15 |
| A15 | 4.1826281E−19 | −8.3363434E−18 | 1.0412074E−15 | 1.1501156E−15 |
| A16 | −1.9065322E−21 | 3.3442120E−19 | −9.4190224E−17 | −1.2464655E−16 |
| A17 | −2.2288884E−22 | −7.3756684E−21 | 3.4124175E−18 | 5.3529617E−18 |
| A18 | 3.8849012E−24 | 7.2347730E−23 | −4.4001546E−20 | −8.6321513E−20 |

### Example 17

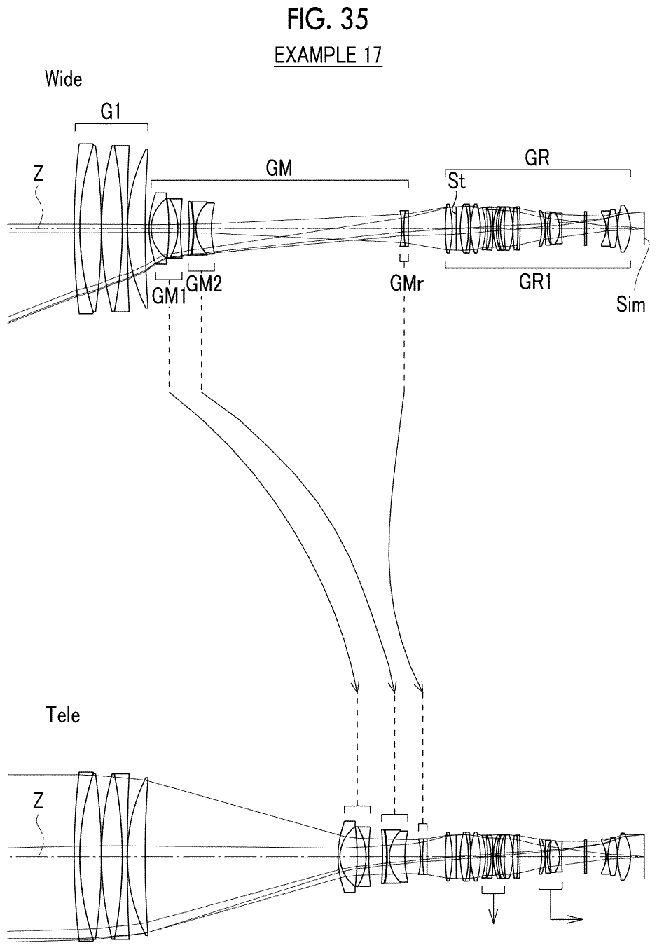

A configuration and a moving trajectory of a variable magnification optical system of Example 17 are shown in FIG. 35. The variable magnification optical system of Example 17 consists of, in order from the object side to the image side, the first lens group G1 having positive refractive power, the intermediate group GM, and the subsequent group GR. The intermediate group GM consists of, in order from the object side to the image side, three lens groups including the M1 lens group GM1 having negative refractive power, the M2 lens group GM2 having negative refractive power, and the Mr lens group GMr having negative refractive power. The M2 lens group GM2 having negative refractive power corresponds to the above M2n lens group. The subsequent group GR consists of one lens group that is the R1 lens group GR1 having positive refractive power.

During changing the magnification from the wide angle end to the telephoto end, the first lens group G1 and the R1 lens group GR1 remain stationary with respect to the image plane Sim, and other lens groups move along the optical axis Z by changing a spacing with respect to an adjacent lens group. The vibration-proof group consists of four lenses that are the fifth to eighth lenses in the R1 lens group GR1 from the object side. The focus group consists of four lenses that are the twelfth to fifteenth lenses in the R1 lens group GR1 from the object side. During focusing from the infinite distance object to the nearest object, the focus group moves to the image side.

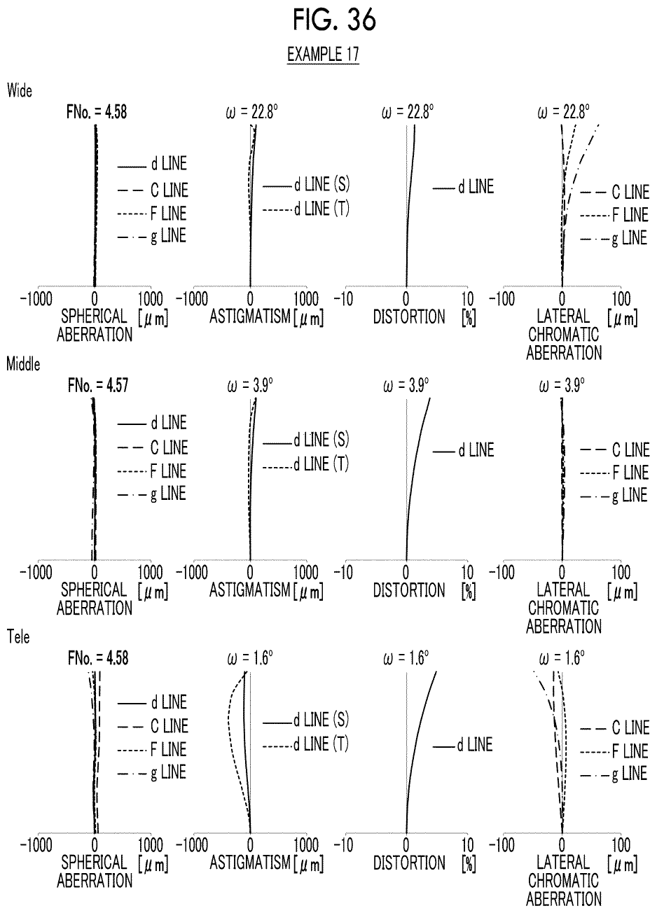

For the variable magnification optical system of Example 17, Tables 46A and 46B show basic lens data, Table 47 shows specifications and variable surface spacings, Table 48 shows aspherical coefficients, and FIG. 36 shows each aberration diagram.

TABLE 46A
Example 17

| Sn | R | D | Nd | νd | θgF | Material | ED |
|---|---|---|---|---|---|---|---|
| 1 | 412.2992 | 2.8202 | 1.61293 | 36.96 | 0.58507 | E-F3.HOYA | 90.00 |
| 2 | 149.8571 | 10.5910 | 1.49700 | 81.61 | 0.53887 | FCD1.HOYA | 88.00 |
| 3 | −335.0904 | 0.1002 | | | | | 87.95 |
| 4 | 187.8805 | 10.2587 | 1.49700 | 81.61 | 0.53887 | FCD1.HOYA | 86.37 |
| 5 | −248.6083 | 2.4002 | 1.80420 | 46.50 | 0.55727 | TAF3D.HOYA | 85.94 |
| 6 | 999.8391 | 0.1002 | | | | | 84.70 |
| 7 | 101.4514 | 8.7614 | 1.49700 | 81.61 | 0.53887 | FCD1.HOYA | 82.70 |
| 8 | 624.2141 | DD[8] | | | | | 82.11 |
| *9 | 51.4003 | 1.0001 | 1.51633 | 64.06 | 0.53345 | L-BSL7.OHARA | 37.80 |
| *10 | 20.9133 | 8.4341 | | | | | 31.91 |
| 11 | −143.6378 | 4.4239 | 1.92286 | 20.88 | 0.63900 | E-FDS1-W.HOYA | 31.86 |
| 12 | −33.1362 | 1.3199 | 1.80610 | 40.73 | 0.56719 | NBFD13.HOYA | 31.59 |
| 13 | 145.9378 | DD[13] | | | | | 29.82 |
| 14 | −213.6223 | 1.9701 | 1.51742 | 52.15 | 0.55896 | E-CF6.HOYA | 28.72 |
| 15 | −79.0482 | 0.3818 | | | | | 28.50 |
| 16 | −87.9593 | 1.0102 | 1.70154 | 41.15 | 0.57704 | BAFD7.HOYA | 28.24 |
| 17 | 19.6665 | 7.6208 | 1.90043 | 37.37 | 0.57668 | TAFD37A.HOYA | 27.14 |
| 18 | 59.7397 | DD[18] | | | | | 26.00 |
| 19 | −46.6025 | 1.0161 | 1.83481 | 42.74 | 0.56490 | S-LAH55VS.OHARA | 18.34 |
| 20 | 70.7226 | 2.1691 | 1.92286 | 20.88 | 0.63900 | E-FDS1-W.HOYA | 18.78 |
| 21 | 5321.0204 | DD[21] | | | | | 19.07 |
| 22 | 106.3580 | 3.4057 | 1.49700 | 81.61 | 0.53887 | FCD1.HOYA | 23.24 |
| 23 | −56.6096 | 2.0001 | | | | | 23.35 |
| 24 (St) | ∞ | 2.0002 | | | | | 23.00 |
| 25 | 54.1875 | 4.0516 | 1.49700 | 81.61 | 0.53887 | FCD1.HOYA | 23.86 |
| 26 | −62.5039 | 1.0002 | 1.90366 | 31.31 | 0.59481 | TAFD25.HOYA | 23.89 |
| 27 | −129.7142 | 0.1002 | | | | | 24.05 |
| 28 | 44.9115 | 4.7623 | 1.49700 | 81.61 | 0.53887 | FCD1.HOYA | 24.09 |
| 29 | −49.3396 | 2.5001 | | | | | 23.80 |

TABLE 46B
Example 17

| Sn | R | D | Nd | νd | θgF | Material | ED |
|---|---|---|---|---|---|---|---|
| 30 | −38.3951 | 1.0002 | 1.90043 | 37.37 | 0.57668 | TAFD37A.HOYA | 22.59 |
| 31 | −115.1177 | 1.4804 | | | | | 22.66 |
| 32 | −43.1563 | 1.0002 | 1.76634 | 35.82 | 0.57931 | S-NBH59.OHARA | 22.59 |
| 33 | −107.9899 | 0.1001 | | | | | 22.91 |
| 34 | 32.9146 | 1.4346 | 1.51742 | 52.15 | 0.55896 | E-CF6.HOYA | 23.28 |
| 35 | 36.8672 | 1.0632 | | | | | 23.08 |
| 36 | 51.5370 | 1.0001 | 1.59410 | 60.47 | 0.55516 | FCD600.HOYA | 23.12 |
| 37 | 33.3533 | 1.8507 | | | | | 22.92 |
| 38 | 89.1992 | 4.2982 | 1.51742 | 52.15 | 0.55896 | E-CF6.HOYA | 23.06 |
| 39 | −37.8180 | 0.1001 | | | | | 23.18 |
| 40 | 114.0971 | 2.3818 | 1.59410 | 60.47 | 0.55516 | FCD600.HOYA | 22.61 |
| 41 | −135.2843 | 0.1068 | | | | | 22.31 |
| 42 | −112.4657 | 1.0000 | 1.77250 | 49.62 | 0.55038 | TAF1.HOYA | 22.31 |
| 43 | −289.5219 | 10.6806 | | | | | 22.09 |
| 44 | −32.6119 | 1.6986 | 1.80610 | 33.27 | 0.58845 | NBFD15-W.HOYA | 18.72 |
| 45 | −24.8110 | 0.1001 | | | | | 18.81 |
| *46 | 348.9011 | 1.0002 | 1.69680 | 55.46 | 0.54260 | LAC14.HOYA | 17.61 |
| *47 | 25.9954 | 1.0657 | | | | | 16.79 |
| 48 | 38.6913 | 5.0099 | 1.62004 | 36.30 | 0.58729 | E-F2.HOYA | 16.75 |
| 49 | −16.5686 | 1.0001 | 1.85033 | 42.70 | 0.56458 | TAFD34.HOYA | 16.32 |
| 50 | 152.4503 | 11.2646 | | | | | 16.17 |
| 51 | ∞ | 1.0000 | 1.51680 | 64.20 | 0.53430 | BSC7.HOYA | 16.23 |
| 52 | ∞ | 9.5808 | | | | | 16.24 |
| 53 | −16.2345 | 1.0001 | 1.91082 | 35.25 | 0.58335 | TAFD35L.HOYA | 16.28 |
| 54 | 32.3130 | 4.7157 | 1.67270 | 32.17 | 0.59633 | E-FD5.HOYA | 18.73 |
| 55 | −38.0458 | 0.1001 | | | | | 20.17 |
| 56 | 42.4721 | 6.2859 | 1.51742 | 52.43 | 0.55649 | S-NSL36.OHARA | 22.79 |
| 57 | −26.5548 | 6.8006 | | | | | 23.42 |

TABLE 47
Example 17

| | Wide | Middle | Tele |
|---|---|---|---|
| Zr | 1.0 | 6.6 | 19.3 |
| f | 20.62 | 135.61 | 397.89 |
| Bf | 6.8006 | 6.8006 | 6.8006 |
| FNo. | 4.58 | 4.57 | 4.58 |
| 2ω [°] | 45.6 | 7.8 | 3.2 |
| DD[8] | 2.0002 | 77.4529 | 94.8919 |
| DD[13] | 4.2881 | 7.4178 | 6.8382 |
| DD[18] | 94.0051 | 8.5981 | 7.7653 |
| DD[21] | 18.2208 | 25.0453 | 9.0188 |

TABLE 48
Example 17

| Sn | 9 | 10 | 46 | 47 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | 2.1455708E−06 | 4.4850874E−06 | 2.5410628E−05 | 3.5093728E−05 |
| A5 | −6.3516604E−07 | −5.9522527E−07 | −4.4985614E−08 | −5.0160082E−08 |
| A6 | 4.1247753E−09 | 2.0324788E−08 | −2.9394329E−07 | −2.7239640E−07 |
| A7 | 3.8283836E−09 | −8.0493629E−11 | −6.1436936E−09 | −7.9095881E−09 |
| A8 | −2.2737457E−10 | 7.2172393E−11 | 1.0529186E−09 | 1.3833966E−09 |
| A9 | 3.4616124E−12 | 1.8488176E−12 | 3.8843435E−10 | 3.4917153E−10 |
| A10 | 3.3428632E−13 | −2.5620108E−13 | −8.7198297E−11 | −8.8992581E−11 |
| A11 | −6.3164930E−14 | −1.0938008E−14 | 6.4763978E−12 | 7.4635230E−12 |
| A12 | 3.9122267E−15 | 7.8215742E−16 | 3.1234227E−13 | 2.5835705E−13 |
| A13 | −2.3882064E−17 | −3.1997500E−17 | −7.1748577E−14 | −7.7072151E−14 |
| A14 | −8.5913743E−18 | 1.0928113E−18 | −8.6722174E−16 | −7.4512648E−16 |
| A15 | 4.2361000E−19 | −5.9608166E−20 | 8.9632536E−16 | 1.0511284E−15 |
| A16 | −6.1732428E−21 | 3.1548227E−21 | −7.7186480E−17 | −9.7922228E−17 |
| A17 | −6.5891192E−23 | −9.2070756E−23 | 2.7516657E−18 | 3.8491277E−18 |
| A18 | 2.0262432E−24 | 1.0811334E−24 | −3.5363275E−20 | −5.7241274E−20 |

### Example 18

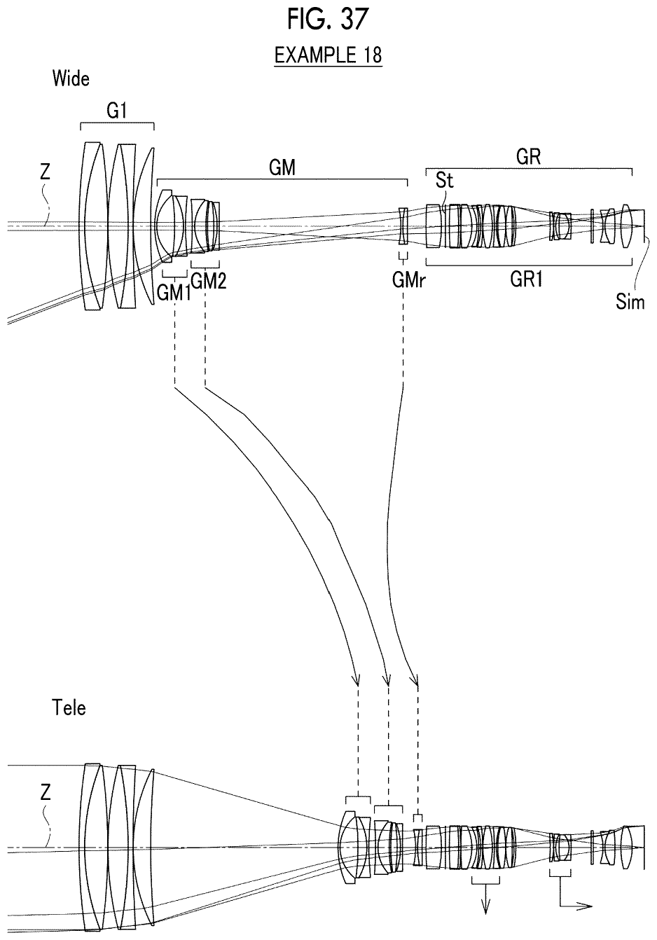

A configuration and a moving trajectory of a variable magnification optical system of Example 18 are shown in FIG. 37. The variable magnification optical system of Example 18 consists of, in order from the object side to the image side, the first lens group G1 having positive refractive power, the intermediate group GM, and the subsequent group GR. The intermediate group GM consists of, in order from the object side to the image side, three lens groups including the M1 lens group GM1 having negative refractive power, the M2 lens group GM2 having negative refractive power, and the Mr lens group GMr having negative refractive power. The M2 lens group GM2 having negative refractive power corresponds to the above M2n lens group. The subsequent group GR consists of one lens group that is the R1 lens group GR1 having positive refractive power.

During changing the magnification from the wide angle end to the telephoto end, the first lens group G1 and the R1 lens group GR1 remain stationary with respect to the image plane Sim, and other lens groups move along the optical axis Z by changing a spacing with respect to an adjacent lens group. The vibration-proof group consists of four lenses that are the fifth to eighth lenses in the R1 lens group GR1 from the object side. The focus group consists of four lenses that are the twelfth to fifteenth lenses in the R1 lens group GR1 from the object side. During focusing from the infinite distance object to the nearest object, the focus group moves to the image side.

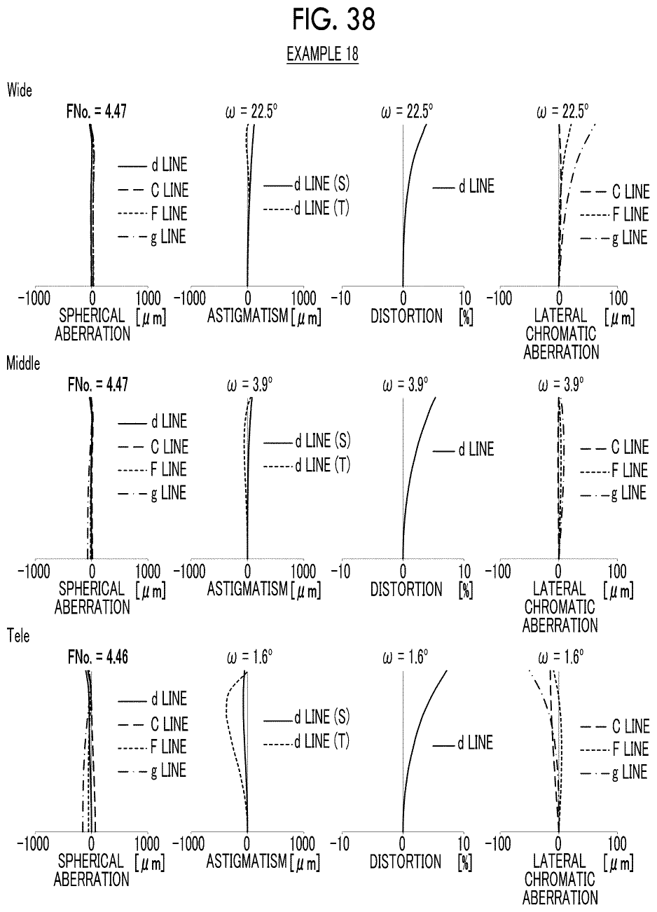

For the variable magnification optical system of Example 18, Tables 49A and 49B show basic lens data, Table 50 shows specifications and variable surface spacings, and FIG. 38 shows each aberration diagram.

TABLE 49A
Example 18

| Sn | R | D | Nd | νd | θgF | Material | ED |
|---|---|---|---|---|---|---|---|
| 1 | 329.9593 | 2.8201 | 1.57501 | 41.50 | 0.57672 | S-TIL27.OHARA | 90.00 |
| 2 | 130.3716 | 11.4701 | 1.49700 | 81.61 | 0.53887 | FCD1.HOYA | 88.00 |
| 3 | −355.0267 | 0.1001 | | | | | 87.92 |
| 4 | 190.4262 | 10.0811 | 1.49700 | 81.61 | 0.53887 | FCD1.HOYA | 86.15 |
| 5 | −254.9397 | 2.4002 | 1.79950 | 42.34 | 0.56498 | NBFD12.HOYA | 85.69 |
| 6 | 732.6910 | 0.1002 | | | | | 84.29 |
| 7 | 99.4142 | 8.7377 | 1.49700 | 81.61 | 0.53887 | FCD1.HOYA | 82.29 |
| 8 | 533.9447 | DD[8] | | | | | 81.64 |
| 9 | 50.4055 | 1.0001 | 1.51680 | 64.20 | 0.53430 | BSC7.HOYA | 38.76 |
| 10 | 22.0704 | 8.9161 | | | | | 33.03 |
| 11 | −133.1089 | 4.4401 | 1.92286 | 20.88 | 0.63900 | E-FDS1-W.HOYA | 32.61 |
| 12 | −34.9054 | 1.0101 | 1.80420 | 46.50 | 0.55727 | TAF3D.HOYA | 32.21 |
| 13 | 152.6206 | DD[13] | | | | | 30.39 |
| 14 | −172.4565 | 1.2102 | 1.71700 | 47.98 | 0.55575 | LAF3.HOYA | 28.88 |
| 15 | 21.3937 | 5.5731 | 1.89190 | 37.13 | 0.57813 | S-LAH92.OHARA | 27.29 |
| 16 | 78.8080 | 0.8002 | | | | | 26.65 |
| 17 | 96.3733 | 3.1511 | 1.90043 | 37.37 | 0.57668 | TAFD37A.HOYA | 26.44 |
| 18 | −97.4664 | 1.6616 | | | | | 26.00 |
| 19 | −40.8260 | 1.0000 | 1.91650 | 31.60 | 0.59117 | S-LAH88.OHARA | 25.53 |
| 20 | 1454.5377 | DD[20] | | | | | 25.20 |
| 21 | −45.9870 | 1.0102 | 1.83400 | 37.16 | 0.57759 | S-LAH60.OHARA | 18.91 |
| 22 | 49.2177 | 2.1991 | 1.92286 | 20.88 | 0.63900 | E-FDS1-W.HOYA | 19.32 |
| 23 | 1165.5819 | DD[23] | | | | | 19.47 |
| 24 | 204.5038 | 7.6646 | 1.49700 | 81.61 | 0.53887 | FCD1.HOYA | 22.22 |
| 25 | −64.3826 | 2.0002 | | | | | 22.99 |
| 26 (St) | ∞ | 2.0002 | | | | | 23.00 |
| 27 | 228.3557 | 4.6110 | 1.49700 | 81.61 | 0.53887 | FCD1.HOYA | 23.17 |
| 28 | −145.9915 | 1.0102 | 1.57135 | 52.95 | 0.55544 | S-BAL3.OHARA | 23.22 |
| 29 | −151.3403 | 0.1002 | | | | | 23.25 |
| 30 | 158.8847 | 5.4558 | 1.49700 | 81.61 | 0.53887 | FCD1.HOYA | 23.20 |
| 31 | −28.8417 | 2.5002 | | | | | 23.00 |

TABLE 49B
Example 18

| Sn | R | D | Nd | νd | θgF | Material | ED |
|---|---|---|---|---|---|---|---|
| 32 | −24.6663 | 1.0002 | 1.88100 | 40.14 | 0.57010 | TAFD33.HOYA | 21.71 |
| 33 | −51.4900 | 0.9300 | | | | | 22.16 |
| 34 | −38.0132 | 1.0002 | 1.72342 | 37.99 | 0.58202 | BAFD8.HOYA | 22.15 |
| 35 | −91.5228 | 0.1001 | | | | | 22.62 |
| 36 | 45.5630 | 4.7106 | 1.49700 | 81.61 | 0.53887 | FCD1.HOYA | 23.17 |
| 37 | −43.6835 | 1.0002 | | | | | 23.14 |
| 38 | −112.2925 | 1.0000 | 1.60738 | 56.71 | 0.54817 | BACD2.HOYA | 22.51 |
| 39 | 38.2097 | 0.7226 | | | | | 22.14 |
| 40 | 44.9966 | 3.8688 | 1.51742 | 52.15 | 0.55896 | E-CF6.HOYA | 22.23 |
| 41 | −65.9520 | 0.1002 | | | | | 22.15 |
| 42 | 40.0612 | 3.1853 | 1.59410 | 60.47 | 0.55516 | FCD600.HOYA | 21.50 |
| 43 | −200.7340 | 0.8523 | | | | | 20.98 |
| 44 | −49.5701 | 1.0000 | 1.94595 | 17.98 | 0.65460 | FDS18-W.HOYA | 20.97 |
| 45 | −60.3300 | 17.0993 | | | | | 20.85 |
| 46 | −98.2134 | 1.6626 | 1.80610 | 33.27 | 0.58845 | NBFD15-W.HOYA | 15.27 |
| 47 | −39.1989 | 0.1000 | | | | | 15.15 |
| 48 | 83.4091 | 1.0002 | 1.69680 | 55.46 | 0.54260 | LAC14.HOYA | 14.53 |
| 49 | 15.2187 | 1.6579 | | | | | 13.65 |
| 50 | 44.4926 | 5.0098 | 1.62004 | 36.26 | 0.58800 | S-TIM2.OHARA | 13.67 |
| 51 | −10.8539 | 1.0002 | 1.85033 | 42.70 | 0.56458 | TAFD34.HOYA | 13.46 |
| 52 | −148.6661 | 10.0002 | | | | | 13.81 |
| 53 | ∞ | 1.0000 | 1.51680 | 64.20 | 0.53430 | BSC7.HOYA | 15.08 |
| 54 | ∞ | 4.8767 | | | | | 15.16 |
| 55 | −26.4501 | 1.0001 | 1.87070 | 40.73 | 0.56825 | TAFD32.HOYA | 15.62 |
| 56 | 17.5002 | 5.0060 | 1.67300 | 38.26 | 0.57580 | S-NBH52V.OHARA | 17.19 |
| 57 | −86.7428 | 2.8946 | | | | | 18.46 |
| 58 | 47.1377 | 5.6776 | 1.51742 | 52.15 | 0.55896 | E-CF6.HOYA | 22.36 |
| 59 | −28.3815 | 6.0688 | | | | | 22.97 |

TABLE 50
Example 18

| | Wide | Middle | Tele |
|---|---|---|---|
| Zr | 1.0 | 6.6 | 19.3 |
| f | 20.39 | 134.11 | 393.50 |
| Bf | 6.0688 | 6.0688 | 6.0688 |
| FNo. | 4.47 | 4.47 | 4.46 |
| 2ω [°] | 45.0 | 7.8 | 3.2 |
| DD[8] | 2.0000 | 75.6917 | 93.1382 |
| DD[13] | 3.3652 | 3.8486 | 3.3592 |
| DD[20] | 90.3383 | 8.6227 | 6.5410 |
| DD[23] | 9.3038 | 16.8444 | 1.9689 |

### Example 19

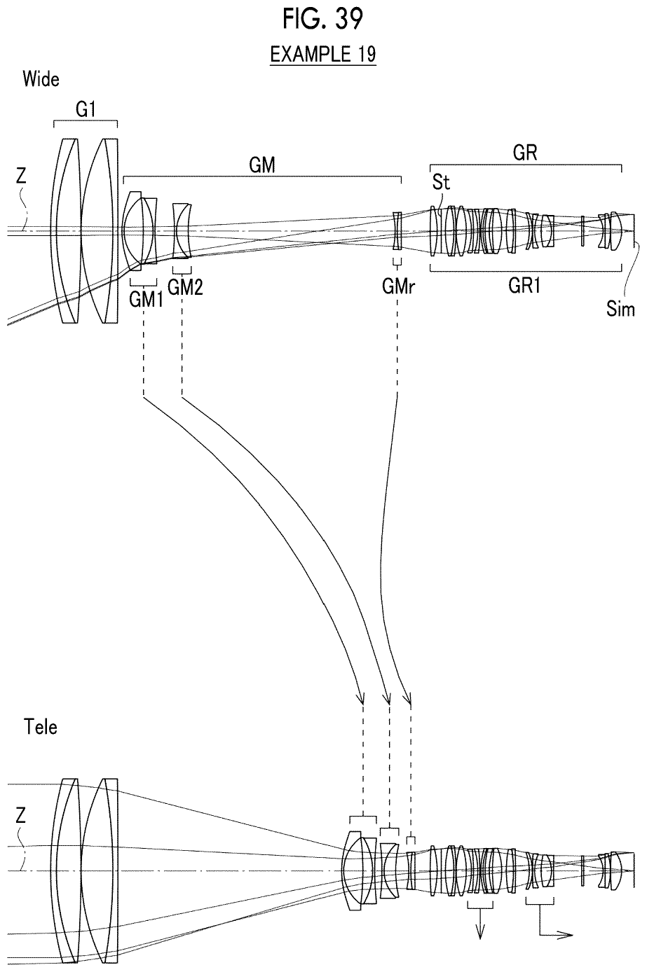

A configuration and a moving trajectory of a variable magnification optical system of Example 19 are shown in FIG. 39. The variable magnification optical system of Example 19 consists of, in order from the object side to the image side, the first lens group G1 having positive refractive power, the intermediate group GM, and the subsequent group GR. The intermediate group GM consists of, in order from the object side to the image side, three lens groups including the M1 lens group GM1 having negative refractive power, the M2 lens group GM2 having negative refractive power, and the Mr lens group GMr having negative refractive power. The M2 lens group GM2 having negative refractive power corresponds to the above M2n lens group. The subsequent group GR consists of one lens group that is the R1 lens group GR1 having positive refractive power.

During changing the magnification from the wide angle end to the telephoto end, the first lens group G1 and the R1 lens group GR1 remain stationary with respect to the image plane Sim, and other lens groups move along the optical axis Z by changing a spacing with respect to an adjacent lens group. The vibration-proof group consists of four lenses that are the fifth to eighth lenses in the R1 lens group GR1 from the object side. The focus group consists of four lenses that are the twelfth to fifteenth lenses in the R1 lens group GR1 from the object side. During focusing from the infinite distance object to the nearest object, the focus group moves to the image side.

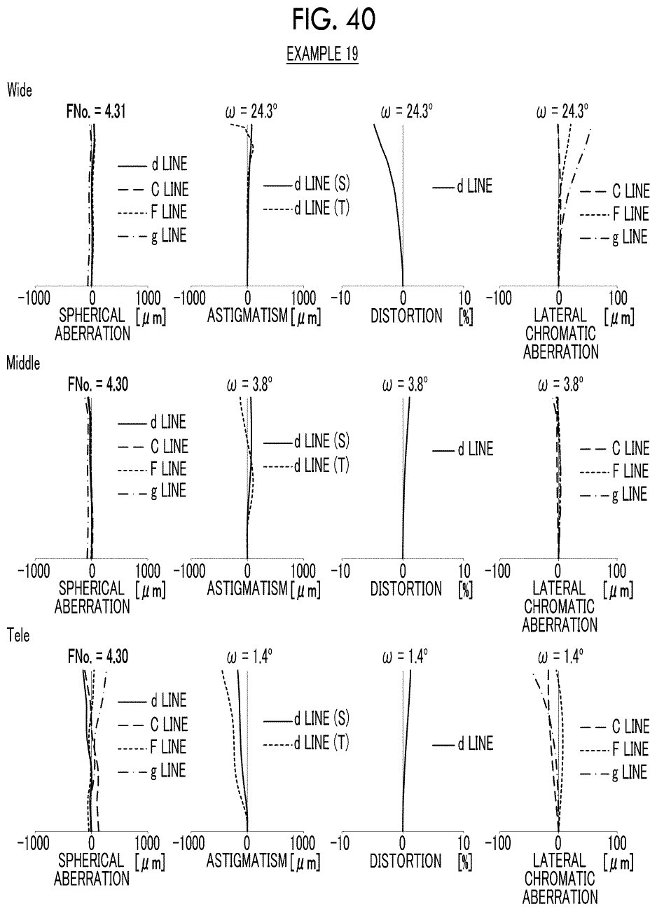

For the variable magnification optical system of Example 19, Tables 51A and 51B show basic lens data, Table 52 shows specifications and variable surface spacings, Table 53 shows aspherical coefficients, and FIG. 40 shows each aberration diagram.

TABLE 51A
Example 19

| Sn | R | D | Nd | νd | θgF | Material | ED |
|---|---|---|---|---|---|---|---|
| 1 | 199.2630 | 2.8002 | 1.72825 | 28.32 | 0.60755 | E-FD10L.HOYA | 96.00 |
| 2 | 130.8355 | 11.8788 | 1.49700 | 81.61 | 0.53887 | FCD1.HOYA | 94.76 |
| 3 | −697.3137 | 0.1001 | | | | | 94.59 |
| 4 | 115.7782 | 15.3797 | 1.49700 | 81.61 | 0.53887 | FCD1.HOYA | 91.67 |
| 5 | −299.6842 | 2.4002 | 1.80420 | 46.50 | 0.55727 | TAF3D.HOYA | 90.54 |
| 6 | −5356.6563 | DD[6] | | | | | 88.75 |
| *7 | 42.6788 | 1.0000 | 1.51742 | 52.15 | 0.55896 | E-CF6.HOYA | 41.11 |
| *8 | 21.3188 | 9.2913 | | | | | 34.58 |
| 9 | −151.0061 | 4.7162 | 1.92286 | 18.90 | 0.64960 | S-NPH2.OHARA | 34.52 |
| 10 | −35.7801 | 1.0102 | 1.80450 | 39.64 | 0.57146 | NBFD3.HOYA | 34.18 |
| 11 | 162.8524 | DD[11] | | | | | 32.12 |
| 12 | −123.6944 | 1.0102 | 1.72342 | 37.99 | 0.58202 | BAFD8.HOYA | 28.62 |
| 13 | 19.6902 | 5.6253 | 1.91082 | 35.25 | 0.58224 | TAFD35.HOYA | 27.47 |
| 14 | 63.4087 | DD[14] | | | | | 27.00 |
| 15 | −46.5922 | 1.0102 | 1.83481 | 42.74 | 0.56490 | S-LAH55VS.OHARA | 18.71 |
| 16 | 64.5072 | 1.9649 | 1.92286 | 20.88 | 0.63900 | E-FDS1-W.HOYA | 19.28 |
| 17 | 1559.3648 | DD[17] | | | | | 19.51 |
| 18 | 156.0791 | 3.3837 | 1.49700 | 81.61 | 0.53887 | FCD1.HOYA | 23.00 |
| 19 | −52.3979 | 2.0002 | | | | | 23.19 |
| 20 (St) | ∞ | 2.0001 | | | | | 23.00 |
| 21 | 53.1090 | 4.1268 | 1.49700 | 81.61 | 0.53887 | FCD1.HOYA | 23.96 |
| 22 | −59.8932 | 1.0002 | 1.90366 | 31.31 | 0.59481 | TAFD25.HOYA | 24.00 |
| 23 | −109.0224 | 0.1001 | | | | | 24.18 |
| 24 | 44.9520 | 4.8884 | 1.49700 | 81.61 | 0.53887 | FCD1.HOYA | 24.20 |
| 25 | −45.9176 | 2.5001 | | | | | 23.91 |
| 26 | −35.8386 | 1.0002 | 1.90043 | 37.37 | 0.57668 | TAFD37A.HOYA | 22.63 |
| 27 | −103.5467 | 2.0725 | | | | | 22.71 |

TABLE 51B
Example 19

| Sn | R | D | Nd | νd | θgF | Material | ED |
|---|---|---|---|---|---|---|---|
| 28 | −41.0948 | 1.0002 | 1.76634 | 35.82 | 0.57931 | S-NBH59.OHARA | 22.57 |
| 29 | −101.7107 | 0.5128 | | | | | 22.92 |
| 30 | 42.5696 | 1.0001 | 1.51742 | 52.15 | 0.55896 | E-CF6.HOYA | 23.30 |
| 31 | 36.4751 | 1.0436 | | | | | 23.17 |
| 32 | 50.1130 | 1.9998 | 1.59410 | 60.47 | 0.55516 | FCD600.HOYA | 23.27 |
| 33 | 39.4502 | 1.5671 | | | | | 23.13 |
| 34 | 94.7981 | 4.4750 | 1.51742 | 52.15 | 0.55896 | E-CF6.HOYA | 23.29 |
| 35 | −35.6565 | 2.1896 | | | | | 23.46 |
| 36 | 61.3989 | 3.4800 | 1.59410 | 60.47 | 0.55516 | FCD600.HOYA | 22.32 |
| 37 | −71.3454 | 0.0101 | | | | | 21.88 |
| 38 | −78.5884 | 1.0002 | 1.77250 | 49.62 | 0.55038 | TAF1.HOYA | 21.82 |
| 39 | −381.3167 | 6.6537 | | | | | 21.45 |
| 40 | −29.1597 | 1.4880 | 1.80610 | 33.27 | 0.58845 | NBFD15-W.HOYA | 19.07 |
| 41 | −24.7980 | 0.1002 | | | | | 19.16 |
| *42 | 579.3934 | 1.0000 | 1.69680 | 55.46 | 0.54260 | LAC14.HOYA | 17.78 |
| *43 | 24.0214 | 3.1626 | | | | | 16.77 |
| 44 | 38.1619 | 5.0100 | 1.62004 | 36.30 | 0.58729 | E-F2.HOYA | 16.57 |
| 45 | −16.0102 | 1.0000 | 1.85033 | 42.70 | 0.56458 | TAFD34.HOYA | 16.15 |
| 46 | 301.7900 | 13.5787 | | | | | 16.01 |
| 47 | ∞ | 1.0000 | 1.51680 | 64.20 | 0.53430 | BSC7.HOYA | 15.60 |
| 48 | ∞ | 9.3906 | | | | | 15.58 |
| 49 | −14.6837 | 1.0000 | 1.91082 | 35.25 | 0.58335 | TAFD35L.HOYA | 15.36 |
| 50 | −3237.3148 | 2.5363 | 1.67270 | 32.17 | 0.59633 | E-FD5.HOYA | 17.09 |
| 51 | −34.9219 | 0.1002 | | | | | 17.95 |
| 52 | 133.0390 | 5.3368 | 1.51742 | 52.43 | 0.55649 | S-NSL36.OHARA | 19.08 |
| 53 | −17.5882 | 6.0730 | | | | | 19.83 |

TABLE 52
Example 19

| | Wide | Middle | Tele |
|---|---|---|---|
| Zr | 1.0 | 6.6 | 19.3 |
| f | 20.13 | 132.41 | 388.51 |
| Bf | 6.0730 | 6.0730 | 6.0730 |
| FNo. | 4.31 | 4.30 | 4.30 |
| 2ω [°] | 48.6 | 7.6 | 2.8 |
| DD[6] | 2.0002 | 86.4672 | 108.0408 |
| DD[11] | 9.3728 | 7.5593 | 3.5165 |
| DD[14] | 99.9090 | 9.3551 | 6.3098 |
| DD[17] | 13.9603 | 21.8607 | 7.3752 |

TABLE 53
Example 19

| Sn | 7 | 8 | 42 | 43 |
|---|---|---|---|---|
| KA | 1.0000000E+00 | 1.0000000E+00 | 1.0000000E+00 | 1.0000000E+00 |
| A3 | −2.1902944E−06 | 6.1917830E−07 | −1.0281178E−07 | −5.8107531E−07 |
| A4 | −5.2219477E−05 | −6.0064698E−05 | 1.7243570E−05 | 2.2702280E−05 |
| A5 | 3.5455402E−06 | 6.3622604E−06 | 1.1680953E−05 | 1.0746567E−05 |
| A6 | −3.9861793E−07 | −8.0511471E−07 | 4.8080873E−07 | 1.1148438E−06 |
| A7 | 7.6137046E−08 | 6.5488662E−08 | −5.0419248E−07 | −6.5589830E−07 |
| A8 | −1.6555585E−11 | 7.6989322E−09 | −2.7852012E−08 | 1.6767594E−08 |
| A9 | −5.9540721E−10 | −8.5527886E−10 | 1.7026245E−08 | 6.9484217E−09 |
| A10 | 1.0218755E−11 | −4.7856288E−11 | −4.1294931E−10 | −1.3560677E−11 |
| A11 | 1.1618084E−12 | 5.9754882E−12 | −2.6213204E−10 | −4.0510773E−11 |
| A12 | 7.1125682E−14 | −4.8059239E−14 | 2.7601530E−11 | −2.5418976E−12 |
| A13 | −3.9409062E−15 | 2.8416556E−16 | −9.2642861E−15 | −3.6911096E−13 |
| A14 | −3.8648727E−16 | −5.8620386E−16 | −9.6895935E−14 | 1.1494778E−13 |
| A15 | 1.0867929E−17 | 1.1353592E−17 | −1.4543116E−14 | −3.6686956E−15 |
| A16 | 8.8811587E−19 | 1.6514685E−19 | 2.1882200E−15 | −1.1069156E−16 |
| A17 | −1.5529006E−20 | 6.1136890E−20 | 1.7058842E−16 | −3.7690822E−17 |
| A18 | −1.6146449E−21 | −5.4595510E−21 | −4.6174053E−17 | 5.3435321E−18 |
| A19 | 5.3732318E−23 | 2.2161602E−22 | 3.0347789E−18 | −2.3783983E−19 |
| A20 | −3.9808232E−25 | −3.9592279E−24 | −6.8270738E−20 | 3.7934517E−21 |

### Example 20

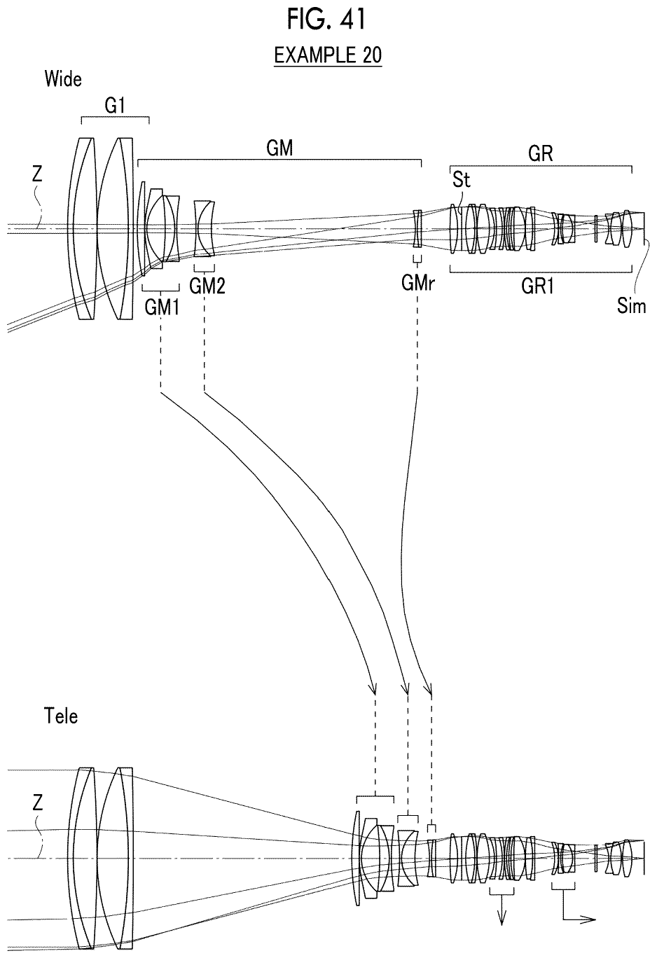

A configuration and a moving trajectory of a variable magnification optical system of Example 20 are shown in FIG. 41. The variable magnification optical system of Example 20 consists of, in order from the object side to the image side, the first lens group G1 having positive refractive power, the intermediate group GM, and the subsequent group GR. The intermediate group GM consists of, in order from the object side to the image side, three lens groups including the M1 lens group GM1 having negative refractive power, the M2 lens group GM2 having negative refractive power, and the Mr lens group GMr having negative refractive power. The M2 lens group GM2 having negative refractive power corresponds to the above M2n lens group. The subsequent group GR consists of one lens group that is the R1 lens group GR1 having positive refractive power.

During changing the magnification from the wide angle end to the telephoto end, the first lens group G1 and the R1 lens group GR1 remain stationary with respect to the image plane Sim, and other lens groups move along the optical axis Z by changing a spacing with respect to an adjacent lens group. The vibration-proof group consists of four lenses that are the fifth to eighth lenses in the R1 lens group GR1 from the object side. The focus group consists of four lenses that are the twelfth to fifteenth lenses in the R1 lens group GR1 from the object side. During focusing from the infinite distance object to the nearest object, the focus group moves to the image side.

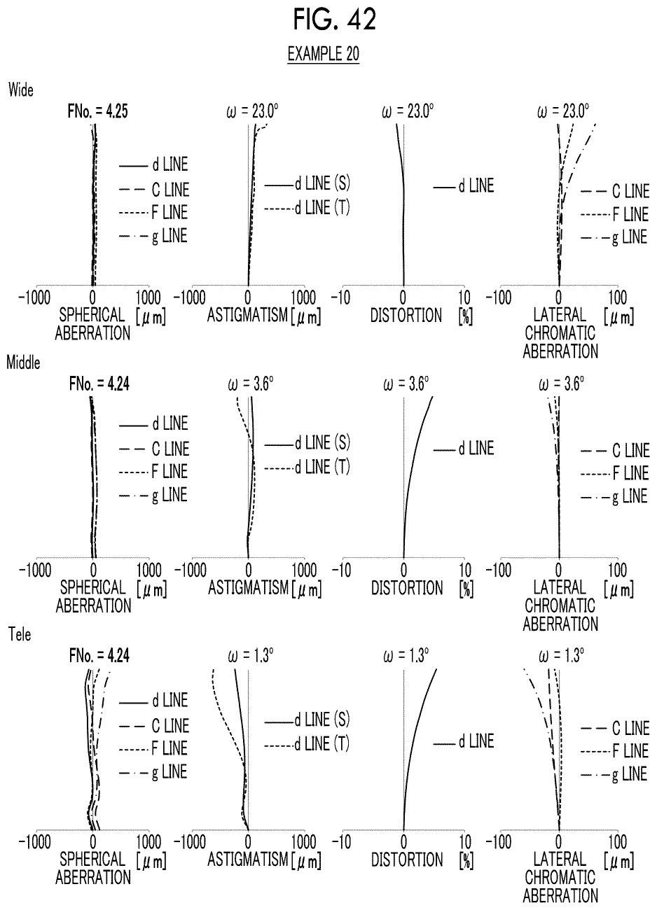

For the variable magnification optical system of Example 20, Tables 54A and 54B show basic lens data, Table 55 shows specifications and variable surface spacings, Table 56 shows aspherical coefficients, and FIG. 42 shows each aberration diagram.

TABLE 54A
Example 20

| Sn | R | D | Nd | νd | θgF | Material | ED |
|---|---|---|---|---|---|---|---|
| 1 | 204.4025 | 2.8002 | 1.72825 | 28.32 | 0.60755 | E-FD10L.HOYA | 96.00 |
| 2 | 133.6697 | 11.6154 | 1.49700 | 81.61 | 0.53887 | FCD1.HOYA | 94.82 |
| 3 | −728.8497 | 0.1001 | | | | | 94.65 |
| 4 | 118.4704 | 15.3649 | 1.49700 | 81.61 | 0.53887 | FCD1.HOYA | 91.94 |
| 5 | −281.8395 | 2.4001 | 1.80420 | 46.50 | 0.55727 | TAF3D.HOYA | 90.89 |
| 6 | −2664.8865 | DD[6] | | | | | 89.18 |
| 7 | 131.3664 | 3.5963 | 1.49700 | 81.61 | 0.53887 | FCD1.HOYA | 49.95 |
| 8 | 5720.9481 | 0.1002 | | | | | 48.58 |
| *9 | 42.7010 | 1.0134 | 1.59349 | 67.00 | 0.53667 | PCD51.HOYA | 42.29 |
| *10 | 21.2534 | 8.9920 | | | | | 35.28 |
| 11 | −149.2808 | 4.7106 | 1.92286 | 18.90 | 0.64960 | S-NPH2.OHARA | 35.02 |
| 12 | −37.3729 | 1.0102 | 1.80610 | 40.73 | 0.56719 | NBFD13.HOYA | 34.64 |
| 13 | 108.6730 | DD[13] | | | | | 32.38 |
| 14 | −124.5376 | 1.0202 | 1.72342 | 37.99 | 0.58202 | BAFD8.HOYA | 29.53 |
| 15 | 19.6260 | 6.5580 | 1.91082 | 35.25 | 0.58224 | TAFD35.HOYA | 28.57 |
| 16 | 65.0165 | DD[16] | | | | | 28.00 |
| 17 | −46.7019 | 1.0102 | 1.83481 | 42.74 | 0.56490 | S-LAH55VS.OHARA | 19.00 |
| 18 | 62.4014 | 1.9527 | 1.92286 | 20.88 | 0.63900 | E-FDS1-W.HOYA | 19.40 |
| 19 | 1632.4250 | DD[19] | | | | | 19.64 |
| 20 | 124.2989 | 3.7832 | 1.49700 | 81.61 | 0.53887 | FCD1.HOYA | 23.32 |
| 21 | −42.6786 | 2.0002 | | | | | 23.48 |
| 22 (St) | ∞ | 2.0001 | | | | | 23.00 |
| 23 | 50.6451 | 4.4639 | 1.49700 | 81.61 | 0.53887 | FCD1.HOYA | 23.70 |
| 24 | −50.8879 | 1.0002 | 1.90366 | 31.31 | 0.59481 | TAFD25.HOYA | 23.66 |
| 25 | −89.6460 | 0.1002 | | | | | 23.79 |
| 26 | 48.0725 | 6.0342 | 1.49700 | 81.61 | 0.53887 | FCD1.HOYA | 23.59 |
| 27 | −40.3509 | 2.5001 | | | | | 22.94 |
| 28 | −26.7507 | 1.0002 | 1.90043 | 37.37 | 0.57668 | TAFD37A.HOYA | 21.63 |
| 29 | −74.1023 | 2.8771 | | | | | 21.88 |

TABLE 54B
Example 20

| Sn | R | D | Nd | νd | θgF | Material | ED |
|---|---|---|---|---|---|---|---|
| 30 | −37.2561 | 1.0002 | 1.76634 | 35.82 | 0.57931 | S-NBH59.OHARA | 21.71 |
| 31 | −76.3426 | 0.1001 | | | | | 22.11 |
| 32 | 61.4671 | 1.0002 | 1.51742 | 52.15 | 0.55896 | E-CF6.HOYA | 22.42 |
| 33 | 41.2704 | 1.1180 | | | | | 22.38 |
| 34 | 68.8494 | 1.0002 | 1.59410 | 60.47 | 0.55516 | FCD600.HOYA | 22.51 |
| 35 | 47.6601 | 1.4763 | | | | | 22.57 |
| 36 | 174.5541 | 5.5552 | 1.51742 | 52.15 | 0.55896 | E-CF6.HOYA | 22.75 |
| 37 | −23.0707 | 0.1001 | | | | | 23.15 |
| 38 | 74.6427 | 3.5954 | 1.59410 | 60.47 | 0.55516 | FCD600.HOYA | 21.86 |
| 39 | −51.3304 | 0.0101 | | | | | 21.34 |
| 40 | −54.8802 | 1.0002 | 1.77250 | 49.62 | 0.55038 | TAF1.HOYA | 21.27 |
| 41 | −3542.5933 | 9.7968 | | | | | 20.77 |
| 42 | −26.4146 | 1.8495 | 1.80610 | 33.27 | 0.58845 | NBFD15-W.HOYA | 16.96 |
| 43 | −19.9041 | 0.1001 | | | | | 17.05 |
| *44 | −231.3486 | 1.0001 | 1.69680 | 55.46 | 0.54260 | LAC14.HOYA | 15.74 |
| *45 | 21.6318 | 0.8945 | | | | | 15.00 |
| 46 | 32.7937 | 5.0098 | 1.62004 | 36.30 | 0.58729 | E-F2.HOYA | 14.95 |
| 47 | −13.2311 | 1.0000 | 1.85033 | 42.70 | 0.56458 | TAFD34.HOYA | 14.47 |
| 48 | 240.1539 | 10.0002 | | | | | 14.34 |
| 49 | ∞ | 1.0000 | 1.51680 | 64.20 | 0.53430 | BSC7.HOYA | 14.13 |
| 50 | ∞ | 5.7596 | | | | | 14.12 |
| 51 | −16.0651 | 1.0002 | 1.91082 | 35.25 | 0.58335 | TAFD35L.HOYA | 14.03 |
| 52 | 24.8403 | 5.2043 | 1.67270 | 32.17 | 0.59633 | E-FD5.HOYA | 15.75 |
| 53 | −26.5515 | 0.6223 | | | | | 17.30 |
| 54 | 43.1913 | 4.5734 | 1.51742 | 52.43 | 0.55649 | S-NSL36.OHARA | 19.14 |
| 55 | −28.3970 | 6.0600 | | | | | 19.51 |

TABLE 55
Example 20

| | Wide | Middle | Tele |
|---|---|---|---|
| Zr | 1.0 | 6.6 | 19.3 |
| f | 20.62 | 135.62 | 397.91 |
| Bf | 6.0600 | 6.0600 | 6.0600 |
| FNo. | 4.25 | 4.24 | 4.24 |
| 2ω [°] | 46.0 | 7.2 | 2.6 |
| DD[6] | 2.0002 | 86.0408 | 107.2492 |
| DD[13] | 9.4344 | 7.3596 | 4.0581 |
| DD[16] | 100.0497 | 10.3425 | 7.1502 |
| DD[19] | 14.0581 | 21.7995 | 7.0849 |

TABLE 56
Example 20

| Sn | 9 | 10 | 44 | 45 |
|---|---|---|---|---|
| KA | 1.0000000E+00 | 1.0000000E+00 | 1.0000000E+00 | 1.0000000E+00 |
| A3 | 2.2526790E−05 | 7.4295664E−06 | 3.8190381E−07 | 4.3635325E−07 |
| A4 | −9.7709621E−05 | −9.0350292E−05 | 3.7527891E−05 | 6.3430514E−05 |
| A5 | 1.4042738E−05 | 1.1519958E−05 | −8.4096508E−06 | −1.1446611E−05 |
| A6 | −2.0686132E−06 | −1.9287578E−06 | 9.2817367E−07 | 3.6217024E−07 |
| A7 | 1.7449659E−07 | 2.4737298E−07 | −1.8675906E−07 | 3.3707174E−07 |
| A8 | 1.4229687E−08 | −7.2116835E−09 | −6.7282441E−08 | −2.0008977E−07 |
| A9 | −3.7574238E−09 | −7.0848907E−10 | 1.8282581E−08 | 3.1619683E−08 |
| A10 | 2.4467717E−10 | 1.8889822E−11 | −1.0806570E−09 | −1.5761498E−09 |
| A11 | −4.3092045E−12 | 2.1048297E−12 | 1.1364817E−11 | 1.4300106E−10 |
| A12 | −1.2033092E−13 | −6.8960083E−14 | −8.4090601E−12 | −3.8847708E−11 |
| A13 | 2.9587015E−15 | 4.0354860E−15 | 3.2463407E−13 | −7.9916981E−13 |
| A14 | −4.0958251E−17 | −3.8121847E−16 | 1.0098100E−13 | 9.8368095E−13 |
| A15 | 6.6648391E−18 | 6.6021058E−18 | 6.9848523E−15 | −4.0041162E−14 |
| A16 | 3.3724672E−19 | 8.0075670E−20 | −2.6145390E−15 | −9.4232152E−15 |
| A17 | −5.8391111E−20 | −1.0743060E−20 | 4.6303841E−17 | 1.9091154E−16 |
| A18 | 2.9153312E−21 | 2.1050593E−22 | 2.3756821E−17 | 1.6596923E−16 |
| A19 | −7.5330464E−23 | 6.9841626E−23 | −2.0537097E−18 | −1.6444592E−17 |
| A20 | 8.4093331E−25 | −2.5627559E−24 | 5.3267274E−20 | 4.8163688E−19 |

### Example 21

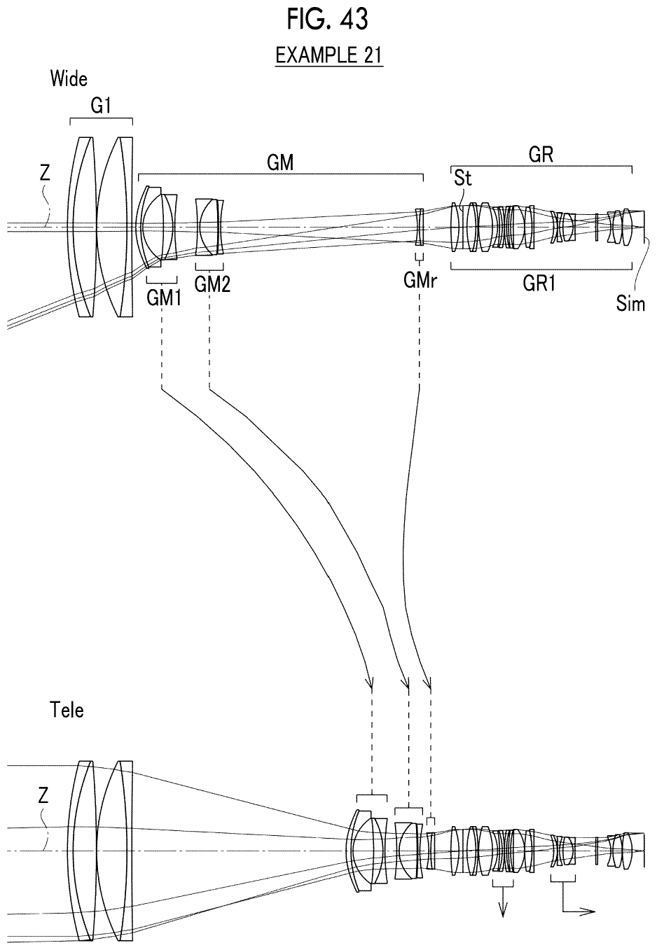

A configuration and a moving trajectory of a variable magnification optical system of Example 21 are shown in FIG. 43. The variable magnification optical system of Example 21 consists of, in order from the object side to the image side, the first lens group G1 having positive refractive power, the intermediate group GM, and the subsequent group GR. The intermediate group GM consists of, in order from the object side to the image side, three lens groups including the M1 lens group GM1 having negative refractive power, the M2 lens group GM2 having negative refractive power, and the Mr lens group GMr having negative refractive power. The M2 lens group GM2 having negative refractive power corresponds to the above M2n lens group. The subsequent group GR consists of one lens group that is the R1 lens group GR1 having positive refractive power.

During changing the magnification from the wide angle end to the telephoto end, the first lens group G1 and the R1 lens group GR1 remain stationary with respect to the image plane Sim, and other lens groups move along the optical axis Z by changing a spacing with respect to an adjacent lens group. The vibration-proof group consists of four lenses that are the fifth to eighth lenses in the R1 lens group GR1 from the object side. The focus group consists of four lenses that are the twelfth to fifteenth lenses in the R1 lens group GR1 from the object side. During focusing from the infinite distance object to the nearest object, the focus group moves to the image side.

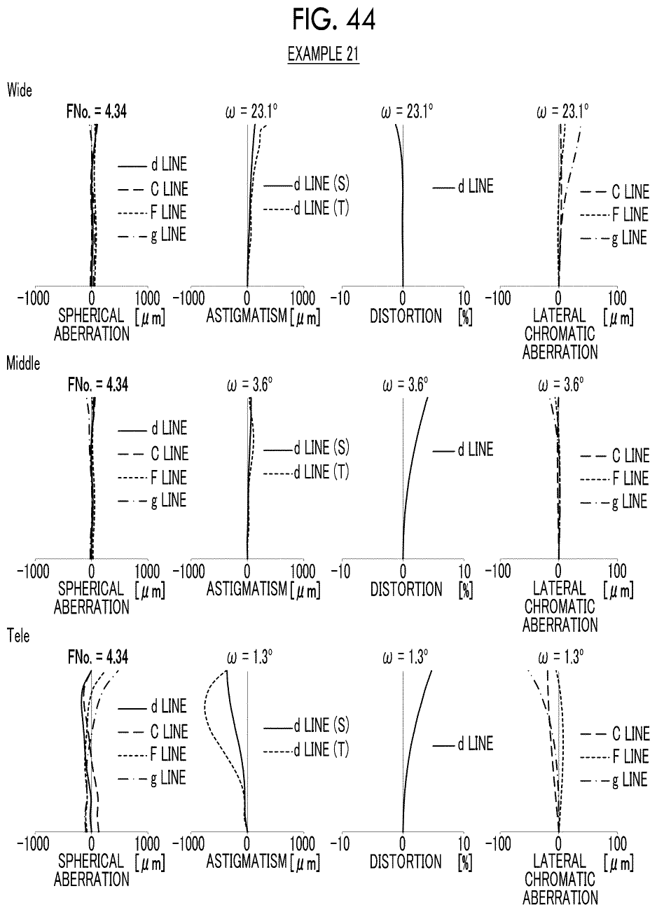

For the variable magnification optical system of Example 21, Tables 57A and 57B show basic lens data, Table 58 shows specifications and variable surface spacings, Table 59 shows aspherical coefficients, and FIG. 44 shows each aberration diagram.

TABLE 57A
Example 21

| Sn | R | D | Nd | νd | θgF | Material | ED |
|---|---|---|---|---|---|---|---|
| 1 | 199.5559 | 2.8002 | 1.72825 | 28.32 | 0.60590 | E-FD10.HOYA | 96.00 |
| 2 | 136.2830 | 11.6104 | 1.49700 | 81.61 | 0.53887 | FCD1.HOYA | 94.85 |
| 3 | −631.6277 | 0.1002 | | | | | 94.68 |
| 4 | 113.7749 | 15.0778 | 1.49700 | 81.61 | 0.53887 | FCD1.HOYA | 91.56 |
| 5 | −340.4446 | 2.4002 | 1.79952 | 42.22 | 0.56727 | S-LAH52.OHARA | 90.42 |
| 6 | 2932.5566 | DD[6] | | | | | 88.50 |
| *7 | 42.7332 | 2.4692 | 1.54814 | 45.78 | 0.56859 | S-TIL1.OHARA | 44.05 |
| 8 | 59.3904 | 1.0001 | 1.60311 | 60.64 | 0.54148 | S-BSM14.OHARA | 42.66 |
| 9 | 21.8173 | 10.2403 | | | | | 35.22 |
| 10 | −161.1956 | 4.6388 | 1.92286 | 18.90 | 0.64960 | S-NPH2.OHARA | 35.00 |
| 11 | −38.7136 | 1.0102 | 1.80610 | 40.93 | 0.57019 | S-LAH53.OHARA | 34.70 |
| 12 | 131.1448 | DD[12] | | | | | 32.96 |
| 13 | −123.0923 | 1.1948 | 1.72047 | 34.71 | 0.58350 | S-NBH8.OHARA | 30.12 |
| 14 | 20.6105 | 8.9042 | 1.90525 | 35.04 | 0.58486 | S-LAH93.OHARA | 29.52 |
| 15 | −212.2675 | 0.3872 | | | | | 28.98 |
| 16 | −212.7637 | 1.0002 | 1.88300 | 40.80 | 0.56557 | TAFD30.HOYA | 28.73 |
| 17 | 73.4002 | DD[17] | | | | | 28.00 |
| 18 | −47.1368 | 1.0102 | 1.83481 | 42.74 | 0.56490 | S-LAH55VS.OHARA | 19.00 |
| 19 | 68.5956 | 1.8963 | 1.92286 | 20.88 | 0.63900 | E-FDS1-W.HOYA | 19.38 |
| 20 | 3412.5094 | DD[20] | | | | | 19.54 |
| 21 | 117.8963 | 3.9693 | 1.49700 | 81.61 | 0.53887 | FCD1.HOYA | 23.36 |
| 22 | −41.8674 | 2.0001 | | | | | 23.53 |
| 23 (St) | ∞ | 2.0001 | | | | | 23.00 |
| 24 | 49.6805 | 4.4642 | 1.49700 | 81.61 | 0.53887 | FCD1.HOYA | 23.65 |
| 25 | −51.3803 | 1.0001 | 1.90366 | 31.31 | 0.59481 | TAFD25.HOYA | 23.59 |
| 26 | −84.6833 | 0.3526 | | | | | 23.69 |
| 27 | 47.7851 | 6.8800 | 1.49700 | 81.61 | 0.53887 | FCD1.HOYA | 23.37 |
| 28 | −39.2309 | 2.5001 | | | | | 22.44 |

TABLE 57B
Example 21

| Sn | R | D | Nd | νd | θgF | Material | ED |
|---|---|---|---|---|---|---|---|
| 29 | −24.3437 | 1.0002 | 1.90043 | 37.37 | 0.57668 | TAFD37A.HOYA | 21.16 |
| 30 | −68.3433 | 1.3648 | | | | | 21.48 |
| 31 | −35.9719 | 1.0002 | 1.76634 | 35.82 | 0.57931 | S-NBH59.OHARA | 21.45 |
| 32 | −69.9823 | 0.1001 | | | | | 21.87 |
| 33 | 68.3461 | 1.0001 | 1.51742 | 52.15 | 0.55896 | E-CF6.HOYA | 22.20 |
| 34 | 43.9841 | 1.0151 | | | | | 22.21 |
| 35 | 77.4650 | 1.0002 | 1.59410 | 60.47 | 0.55516 | FCD600.HOYA | 22.32 |
| 36 | 51.1306 | 1.3303 | | | | | 22.42 |
| 37 | 248.6747 | 5.6211 | 1.51742 | 52.15 | 0.55896 | E-CF6.HOYA | 22.55 |
| 38 | −21.4448 | 0.1001 | | | | | 23.00 |
| 39 | 79.1413 | 3.5486 | 1.59410 | 60.47 | 0.55516 | FCD600.HOYA | 21.59 |
| 40 | −48.5214 | 0.0545 | | | | | 21.08 |
| 41 | −49.9102 | 1.0026 | 1.77250 | 49.62 | 0.55038 | TAF1.HOYA | 20.99 |
| 42 | 5922.8721 | 9.7625 | | | | | 20.48 |
| 43 | −25.1163 | 1.7775 | 1.80610 | 33.27 | 0.58845 | NBFD15-W.HOYA | 16.92 |
| 44 | −18.8978 | 0.1001 | | | | | 17.03 |
| *45 | −204.5885 | 1.0001 | 1.69680 | 55.46 | 0.54260 | LAC14.HOYA | 15.58 |
| *46 | 21.3557 | 1.7273 | | | | | 14.79 |
| 47 | 32.5412 | 5.0098 | 1.62004 | 36.30 | 0.58729 | E-F2.HOYA | 14.69 |
| 48 | −12.5171 | 1.0002 | 1.85033 | 42.70 | 0.56458 | TAFD34.HOYA | 14.24 |
| 49 | 227.8159 | 10.2379 | | | | | 14.18 |
| 50 | ∞ | 1.0000 | 1.51680 | 64.20 | 0.53430 | BSC7.HOYA | 14.37 |
| 51 | ∞ | 6.5255 | | | | | 14.38 |
| 52 | −16.9453 | 1.0000 | 1.91082 | 35.25 | 0.58335 | TAFD35L.HOYA | 14.47 |
| 53 | 25.8082 | 4.6183 | 1.67270 | 32.17 | 0.59633 | E-FD5.HOYA | 16.23 |
| 54 | −29.1774 | 0.1002 | | | | | 17.48 |
| 55 | 49.3691 | 4.8474 | 1.51742 | 52.43 | 0.55649 | S-NSL36.OHARA | 19.00 |
| 56 | −23.6156 | 6.0563 | | | | | 19.47 |

TABLE 58
Example 21

| | Wide | Middle | Tele |
|---|---|---|---|
| Zr | 1.0 | 6.6 | 19.3 |
| f | 20.54 | 135.09 | 396.36 |
| Bf | 6.0563 | 6.0563 | 6.0563 |
| FNo. | 4.34 | 4.34 | 4.34 |
| 2ω [°] | 46.2 | 7.2 | 2.6 |
| DD[6] | 2.0002 | 85.6128 | 106.1172 |
| DD[12] | 11.2483 | 7.0179 | 5.8480 |
| DD[17] | 97.4809 | 10.2205 | 4.3790 |
| DD[20] | 13.7279 | 21.6062 | 8.1130 |

TABLE 59
Example 21

| Sn | 7 | 45 | 46 |
|---|---|---|---|
| KA | 1.0000000E+00 | 1.0000000E+00 | 1.0000000E+00 |
| A3 | 7.5938028E−06 | 8.9664650E−07 | 7.2502018E−07 |
| A4 | −8.7960806E−06 | 7.1508175E−05 | 1.0229038E−04 |
| A5 | 2.6930067E−06 | 1.4612203E−05 | 1.1300906E−05 |
| A6 | −5.2771868E−07 | −2.4387882E−06 | −1.6961299E−06 |
| A7 | 5.6974879E−08 | −9.7466749E−07 | −7.0203778E−07 |
| A8 | −3.5025931E−09 | 8.9539713E−08 | −1.1342396E−07 |
| A9 | 1.1406057E−10 | 9.6176798E−09 | 5.4669180E−08 |
| A10 | −7.2140844E−13 | 1.5439500E−09 | −3.9547268E−09 |
| A11 | −2.6704341E−14 | −5.2704631E−10 | 8.4347556E−11 |
| A12 | −1.1964639E−14 | 1.1852215E−11 | −5.8050458E−11 |
| A13 | 7.7455167E−16 | 1.9893816E−12 | 3.9790319E−12 |
| A14 | 2.9152342E−17 | 2.9373571E−13 | 1.0009385E−12 |
| A15 | −2.5790650E−18 | −3.8140841E−14 | −9.8272511E−14 |
| A16 | −4.3991914E−20 | −1.4702964E−15 | −2.1887894E−15 |
| A17 | 2.0623649E−21 | 1.3060773E−16 | −6.0540302E−16 |
| A18 | 3.4398989E−22 | 2.9578685E−17 | 2.3909223E−16 |
| A19 | −1.8166137E−23 | −3.1585365E−18 | −2.0290842E−17 |
| A20 | 2.5188327E−25 | 8.8511948E−20 | 5.6443454E−19 |

### Example 22

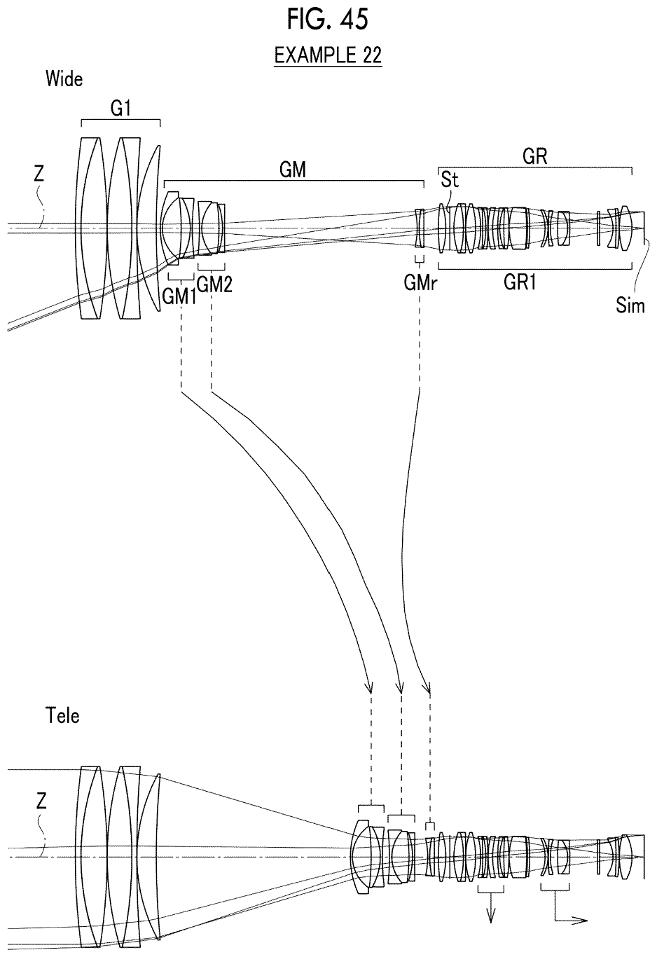

A configuration and a moving trajectory of a variable magnification optical system of Example 22 are shown in FIG. 45. The variable magnification optical system of Example 22 consists of, in order from the object side to the image side, the first lens group G1 having positive refractive power, the intermediate group GM, and the subsequent group GR. The intermediate group GM consists of, in order from the object side to the image side, three lens groups including the M1 lens group GM1 having negative refractive power, the M2 lens group GM2 having negative refractive power, and the Mr lens group GMr having negative refractive power. The M2 lens group GM2 having negative refractive power corresponds to the above M2n lens group. The subsequent group GR consists of one lens group that is the R1 lens group GR1 having positive refractive power.

During changing the magnification from the wide angle end to the telephoto end, the first lens group G1 and the R1 lens group GR1 remain stationary with respect to the image plane Sim, and other lens groups move along the optical axis Z by changing a spacing with respect to an adjacent lens group. The vibration-proof group consists of four lenses that are the fifth to eighth lenses in the R1 lens group GR1 from the object side. The focus group consists of four lenses that are the twelfth to fifteenth lenses in the R1 lens group GR1 from the object side. During focusing from the infinite distance object to the nearest object, the focus group moves to the image side.

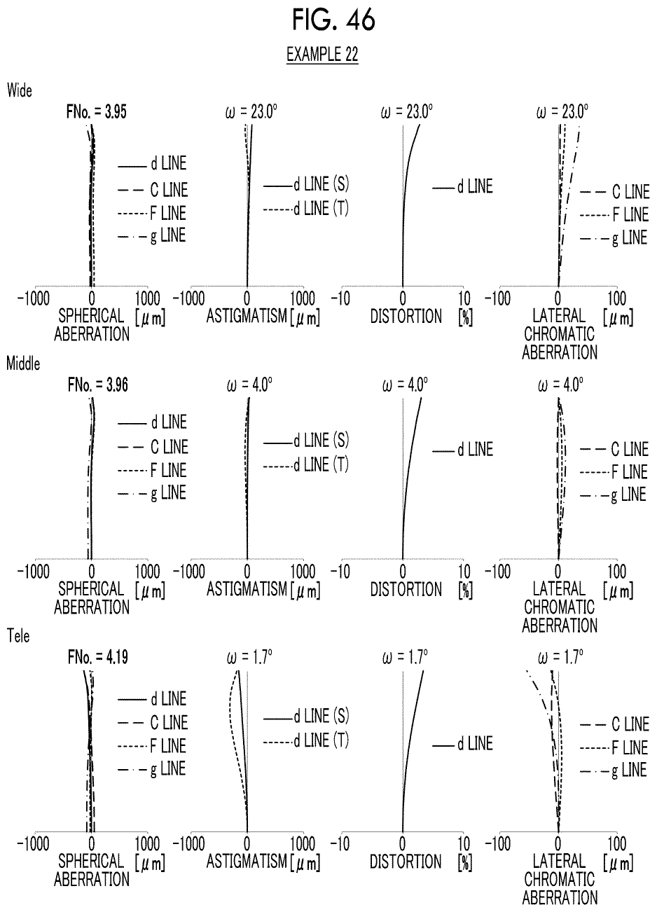

For the variable magnification optical system of Example 22, Tables 60A and 60B show basic lens data, Table 61 shows specifications and variable surface spacings, and FIG. 46 shows each aberration diagram.

TABLE 60A
Example 22

| Sn | R | D | Nd | νd | θgF | Material | ED |
|---|---|---|---|---|---|---|---|
| 1 | 385.4864 | 2.8201 | 1.57501 | 41.50 | 0.57672 | S-TIL27.OHARA | 96.00 |
| 2 | 144.7276 | 12.8282 | 1.49700 | 81.61 | 0.53887 | FCD1.HOYA | 95.24 |
| 3 | −327.2991 | 0.1001 | | | | | 95.15 |
| 4 | 185.6579 | 12.1400 | 1.49700 | 81.61 | 0.53887 | FCD1.HOYA | 92.80 |
| 5 | −246.8745 | 2.4001 | 1.79950 | 42.34 | 0.56498 | NBFD12.HOYA | 92.15 |
| 6 | 654.4400 | 0.1002 | | | | | 90.40 |
| 7 | 98.3425 | 9.5553 | 1.49700 | 81.61 | 0.53887 | FCD1.HOYA | 88.00 |
| 8 | 500.9716 | DD[8] | | | | | 87.46 |
| 9 | 50.3442 | 1.0036 | 1.51680 | 64.20 | 0.53430 | BSC7.HOYA | 38.94 |
| 10 | 20.7387 | 9.2527 | | | | | 32.53 |
| 11 | −140.5835 | 4.4851 | 1.92286 | 20.88 | 0.63900 | E-FDS1-W.HOYA | 32.16 |
| 12 | −34.2210 | 1.0102 | 1.80420 | 46.50 | 0.55727 | TAF3D.HOYA | 31.72 |
| 13 | 133.4565 | DD[13] | | | | | 29.54 |
| 14 | −150.5256 | 1.2102 | 1.71300 | 53.94 | 0.54424 | LAC8.HOYA | 28.52 |
| 15 | 21.4900 | 8.4367 | 1.90366 | 31.34 | 0.59636 | S-LAH95.OHARA | 27.12 |
| 16 | −99.6929 | 1.7455 | | | | | 26.18 |
| 17 | −41.6001 | 1.0002 | 1.92286 | 20.88 | 0.63900 | E-FDS1-W.HOYA | 25.59 |
| 18 | 589.8947 | DD[18] | | | | | 25.20 |
| 19 | −46.2285 | 1.0101 | 1.83400 | 37.16 | 0.57759 | S-LAH60.OHARA | 19.00 |
| 20 | 52.4528 | 2.2619 | 1.92286 | 20.88 | 0.63900 | E-FDS1-W.HOYA | 19.94 |
| 21 | 2759.0559 | DD[21] | | | | | 20.31 |
| 22 | 107.2951 | 3.6384 | 1.49700 | 81.61 | 0.53887 | FCD1.HOYA | 23.06 |
| 23 | −49.1565 | 2.0002 | | | | | 23.24 |
| 24 (St) | ∞ | 2.0002 | | | | | 23.00 |
| 25 | 41.2380 | 4.7470 | 1.49700 | 81.61 | 0.53887 | FCD1.HOYA | 23.95 |
| 26 | −55.3400 | 1.0100 | 1.60342 | 38.03 | 0.58356 | S-TIM5.OHARA | 23.88 |
| 27 | −977.1704 | 0.1001 | | | | | 23.87 |
| 28 | 42.4053 | 4.8402 | 1.49700 | 81.61 | 0.53887 | FCD1.HOYA | 23.82 |
| 29 | −50.4962 | 2.5001 | | | | | 23.46 |

TABLE 60B
Example 22

| Sn | R | D | Nd | νd | θgF | Material | ED |
|---|---|---|---|---|---|---|---|
| 30 | −46.9359 | 1.0000 | 1.87070 | 40.73 | 0.56825 | TAFD32.HOYA | 21.94 |
| 31 | −217.7032 | 1.5859 | | | | | 21.81 |
| 32 | −43.7971 | 1.0002 | 1.72342 | 37.99 | 0.58202 | BAFD8.HOYA | 21.70 |
| 33 | −108.8883 | 0.1001 | | | | | 21.87 |
| 34 | 47.6581 | 2.2238 | 1.49700 | 81.61 | 0.53887 | FCD1.HOYA | 21.89 |
| 35 | 44.4754 | 2.5222 | | | | | 21.55 |
| 36 | 78.6715 | 1.0002 | 1.60738 | 56.71 | 0.54817 | BACD2.HOYA | 21.60 |
| 37 | 30.8544 | 1.9850 | | | | | 21.41 |
| 38 | 137.0815 | 2.5502 | 1.48749 | 70.44 | 0.53062 | FC5.HOYA | 21.57 |
| 39 | −75.1001 | 0.1002 | | | | | 21.78 |
| 40 | 35.0185 | 8.6039 | 1.51633 | 64.14 | 0.53531 | S-BSL7.OHARA | 22.04 |
| 41 | −109.2827 | 0.3945 | | | | | 21.02 |
| 42 | −103.8317 | 1.1240 | 2.16217 | 21.24 | 0.6276 | N216.Glass | 20.89 |
| 43 | −98.9218 | 7.5946 | | | | | 20.85 |
| 44 | −23.8674 | 1.4518 | 1.80610 | 33.27 | 0.58845 | NBFD15-W.HOYA | 19.36 |
| 45 | −21.6730 | 0.1586 | | | | | 19.66 |
| 46 | 117.5854 | 1.0000 | 1.69680 | 55.46 | 0.54260 | LAC14.HOYA | 18.62 |
| 47 | 32.8699 | 3.5397 | | | | | 18.10 |
| 48 | 83.8705 | 5.0098 | 1.62004 | 36.26 | 0.58800 | S-TIM2.OHARA | 17.89 |
| 49 | −15.5622 | 1.0003 | 1.85033 | 42.70 | 0.56458 | TAFD34.HOYA | 17.66 |
| 50 | −159.2005 | 13.7272 | | | | | 17.88 |
| 51 | ∞ | 1.0000 | 1.51680 | 64.20 | 0.53430 | BSC7.HOYA | 18.13 |
| 52 | ∞ | 6.5969 | | | | | 18.14 |
| 53 | −17.7410 | 1.5033 | 1.87070 | 40.73 | 0.56825 | TAFD32.HOYA | 18.21 |
| 54 | −169.6361 | 1.5169 | 1.67300 | 38.26 | 0.57580 | S-NBH52V.OHARA | 20.24 |
| 55 | −82.5639 | 0.1001 | | | | | 20.92 |
| 56 | 42.5963 | 6.2419 | 1.51742 | 52.15 | 0.55896 | E-CF6.HOYA | 22.90 |
| 57 | −26.9134 | 6.0623 | | | | | 23.51 |

TABLE 61
Example 22

| | Wide | Middle | Tele |
|---|---|---|---|
| Zr | 1.0 | 6.6 | 19.3 |
| f | 20.10 | 132.25 | 388.02 |
| Bf | 6.0623 | 6.0623 | 6.0623 |
| FNo. | 3.95 | 3.96 | 4.19 |
| 2ω [°] | 46.0 | 8.0 | 3.4 |
| DD[8] | 2.0002 | 77.5822 | 95.4407 |
| DD[13] | 3.4963 | 3.4899 | 3.4878 |
| DD[18] | 94.7339 | 10.8324 | 6.5015 |
| DD[21] | 7.1865 | 15.5124 | 1.9868 |

### Example 23

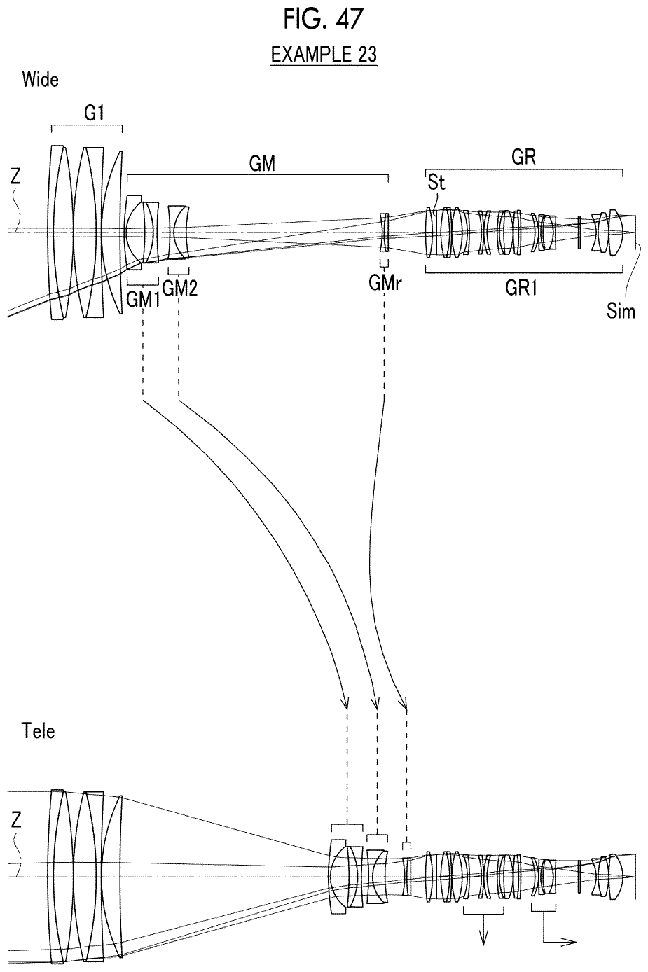

A configuration and a moving trajectory of a variable magnification optical system of Example 23 are shown in FIG. 47. The variable magnification optical system of Example 23 consists of, in order from the object side to the image side, the first lens group G1 having positive refractive power, the intermediate group GM, and the subsequent group GR. The intermediate group GM consists of, in order from the object side to the image side, three lens groups including the M1 lens group GM1 having negative refractive power, the M2 lens group GM2 having negative refractive power, and the Mr lens group GMr having negative refractive power. The M2 lens group GM2 having negative refractive power corresponds to the above M2n lens group. The subsequent group GR consists of one lens group that is the R1 lens group GR1 having positive refractive power.

During changing the magnification from the wide angle end to the telephoto end, the first lens group G1 and the R1 lens group GR1 remain stationary with respect to the image plane Sim, and other lens groups move along the optical axis Z by changing a spacing with respect to an adjacent lens group. The vibration-proof group consists of four lenses that are the fifth to eighth lenses in the R1 lens group GR1 from the object side. The focus group consists of four lenses that are the twelfth to fifteenth lenses in the R1 lens group GR1 from the object side. During focusing from the infinite distance object to the nearest object, the focus group moves to the image side.

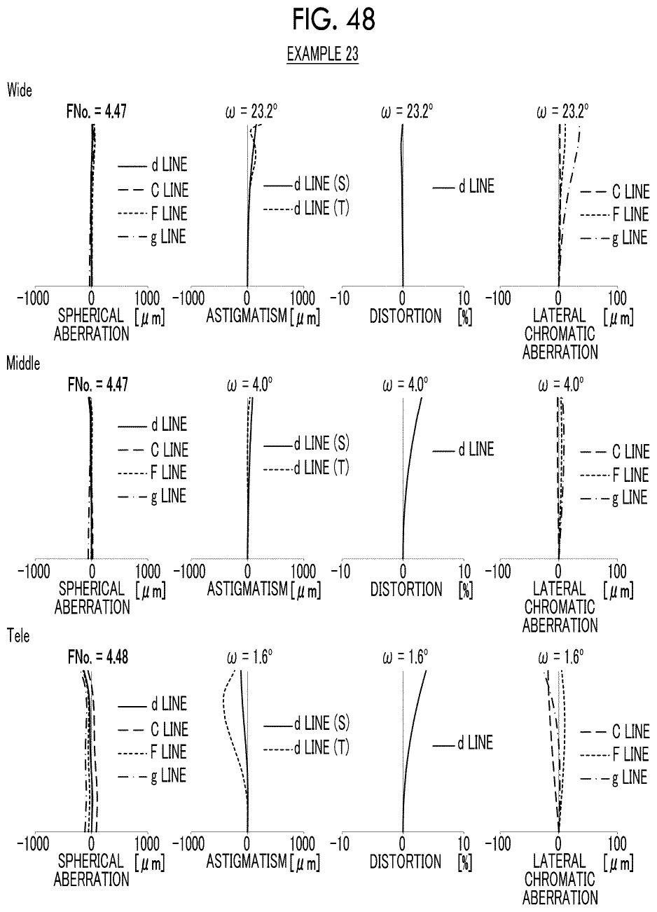

For the variable magnification optical system of Example 23, Tables 62A and 62B show basic lens data, Table 63 shows specifications and variable surface spacings, Table 64 shows aspherical coefficients, and FIG. 48 shows each aberration diagram.

TABLE 62A
Example 23

| Sn | R | D | Nd | νd | θgF | Material | ED |
|---|---|---|---|---|---|---|---|
| 1 | 538.8435 | 2.8202 | 1.61293 | 36.96 | 0.58507 | E-F3.HOYA | 90.00 |
| 2 | 206.3121 | 9.4763 | 1.49700 | 81.61 | 0.53887 | FCD1.HOYA | 88.00 |
| 3 | −266.3959 | 0.1001 | | | | | 87.96 |
| 4 | 196.2090 | 10.9794 | 1.49700 | 81.61 | 0.53887 | FCD1.HOYA | 86.09 |
| 5 | −199.3022 | 2.4002 | 1.80420 | 46.50 | 0.55727 | TAF3D.HOYA | 85.63 |
| 6 | 869.8954 | 0.1002 | | | | | 84.29 |
| 7 | 103.4676 | 8.8838 | 1.49700 | 81.61 | 0.53887 | FCD1.HOYA | 82.59 |
| 8 | 813.7874 | DD[8] | | | | | 82.02 |
| *9 | 96.2984 | 1.0002 | 1.51742 | 52.15 | 0.55896 | E-CF6.HOYA | 38.42 |
| *10 | 20.9115 | 8.9292 | | | | | 31.70 |
| 11 | −145.2241 | 4.1221 | 2.16217 | 21.24 | 0.6276 | N216.Glass | 31.41 |
| 12 | −36.5678 | 1.8241 | 1.76634 | 35.82 | 0.57931 | S-NBH59.OHARA | 31.31 |
| 13 | 159.8068 | DD[13] | | | | | 29.47 |
| 14 | −115.7310 | 1.9005 | 1.70154 | 41.15 | 0.57704 | BAFD7.HOYA | 27.61 |
| 15 | 19.0894 | 5.9484 | 1.90043 | 37.37 | 0.57668 | TAFD37A.HOYA | 26.57 |
| 16 | 65.9352 | DD[16] | | | | | 26.00 |
| 17 | −46.4369 | 1.0102 | 1.83481 | 42.74 | 0.56490 | S-LAH55VS.OHARA | 18.91 |
| 18 | 65.1778 | 1.9313 | 1.92286 | 20.88 | 0.63900 | E-FDS1-W.HOYA | 19.48 |
| 19 | 4779.8801 | DD[19] | | | | | 19.70 |
| 20 | 108.9643 | 3.3416 | 1.49700 | 81.61 | 0.53887 | FCD1.HOYA | 23.23 |
| 21 | −57.8833 | 2.0002 | | | | | 23.33 |
| 22 (St) | ∞ | 2.0002 | | | | | 23.00 |
| 23 | 52.7506 | 4.2232 | 1.49700 | 81.61 | 0.53887 | FCD1.HOYA | 23.92 |
| 24 | −56.7772 | 1.0002 | 1.90366 | 31.31 | 0.59481 | TAFD25.HOYA | 23.96 |
| 25 | −117.0515 | 0.1001 | | | | | 24.14 |
| 26 | 46.8839 | 4.9614 | 1.49700 | 81.61 | 0.53887 | FCD1.HOYA | 24.19 |
| 27 | −42.7096 | 2.5000 | | | | | 23.92 |
| 28 | −34.6634 | 1.0002 | 1.90043 | 37.37 | 0.57668 | TAFD37A.HOYA | 22.60 |
| 29 | −89.8376 | 5.7987 | | | | | 22.71 |

TABLE 62B
Example 23

| Sn | R | D | Nd | νd | θgF | Material | ED |
|---|---|---|---|---|---|---|---|
| 30 | −43.5057 | 1.0002 | 1.76634 | 35.82 | 0.57931 | S-NBH59.OHARA | 22.03 |
| 31 | −80.1052 | 0.1002 | | | | | 22.28 |
| 32 | 37.8024 | 1.6162 | 1.51742 | 52.15 | 0.55896 | E-CF6.HOYA | 22.41 |
| 33 | 36.8445 | 4.8564 | | | | | 22.13 |
| 34 | 61.9782 | 1.0002 | 1.59410 | 60.47 | 0.55516 | FCD600.HOYA | 22.37 |
| 35 | 30.7653 | 2.1157 | | | | | 22.16 |
| 36 | 109.9175 | 4.4900 | 1.51742 | 52.15 | 0.55896 | E-CF6.HOYA | 22.35 |
| 37 | −31.9816 | 0.1002 | | | | | 22.60 |
| 38 | 100.5993 | 2.5335 | 1.59410 | 60.47 | 0.55516 | FCD600.HOYA | 22.06 |
| 39 | −118.8745 | 0.0765 | | | | | 21.77 |
| 40 | −105.1694 | 1.0002 | 1.77250 | 49.62 | 0.55038 | TAF1.HOYA | 21.76 |
| 41 | −213.6884 | 6.8277 | | | | | 21.57 |
| 42 | −28.5776 | 1.7149 | 1.80610 | 33.27 | 0.58845 | NBFD15-W.HOYA | 19.66 |
| 43 | −22.8983 | 0.1001 | | | | | 19.83 |
| *44 | 1303.6784 | 1.0002 | 1.69680 | 55.46 | 0.54260 | LAC14.HOYA | 18.41 |
| *45 | 27.4269 | 1.0107 | | | | | 17.55 |
| 46 | 36.8769 | 5.0099 | 1.62004 | 36.30 | 0.58729 | E-F2.HOYA | 17.53 |
| 47 | −18.7448 | 1.0001 | 1.85033 | 42.70 | 0.56458 | TAFD34.HOYA | 17.13 |
| 48 | 179.3508 | 10.9765 | | | | | 16.96 |
| 49 | ∞ | 1.0000 | 1.51680 | 64.20 | 0.53430 | BSC7.HOYA | 16.79 |
| 50 | ∞ | 7.6104 | | | | | 16.77 |
| 51 | −18.4486 | 1.0001 | 2.00266 | 31.67 | 0.5851 | N200.Glass | 16.68 |
| 52 | 31.8346 | 5.0205 | 1.64769 | 33.84 | 0.59243 | E-FD2.HOYA | 18.83 |
| 53 | −34.5720 | 0.1000 | | | | | 20.43 |
| 54 | 87.8174 | 6.7225 | 1.51742 | 52.43 | 0.55649 | S-NSL36.OHARA | 22.53 |
| 55 | −20.0294 | 6.0764 | | | | | 23.52 |

TABLE 63
Example 23

| | Wide | Middle | Tele |
|---|---|---|---|
| Zr | 1.0 | 6.6 | 19.3 |
| f | 20.50 | 134.88 | 395.74 |
| Bf | 6.0764 | 6.0764 | 6.0764 |
| FNo. | 4.47 | 4.47 | 4.48 |
| 2ω [°] | 46.4 | 8.0 | 3.2 |
| DD[8] | 2.0002 | 81.1180 | 99.9717 |
| DD[13] | 6.1663 | 6.5323 | 3.4933 |
| DD[16] | 93.9578 | 8.1609 | 9.4756 |
| DD[19] | 17.9127 | 24.2258 | 7.0963 |

TABLE 64
Example 23

| Sn | 9 | 10 | 44 | 45 |
|---|---|---|---|---|
| KA | 1.0000000E+00 | 1.0000000E+00 | 1.0000000E+00 | 1.0000000E+00 |
| A3 | −3.1519138E−08 | 2.9423605E−07 | −8.3423190E−08 | 3.4699299E−08 |
| A4 | −1.8046713E−05 | −1.5322018E−05 | 2.8024131E−05 | 4.1167580E−05 |
| A5 | 1.9040162E−06 | 1.9809563E−06 | −2.1049759E−07 | 8.3953032E−08 |
| A6 | −1.9196718E−08 | −9.6085730E−08 | −3.1429757E−07 | −4.4342064E−07 |
| A7 | −5.8807804E−09 | 1.8811135E−08 | −3.0938408E−08 | 1.0737342E−08 |
| A8 | 1.9812122E−11 | −3.7596552E−09 | 5.9722191E−09 | 1.6695274E−09 |
| A9 | 2.4228176E−11 | 4.0695589E−10 | 5.1000796E−10 | −1.9428720E−10 |
| A10 | −4.5509754E−13 | −2.7068880E−11 | −2.4913669E−10 | 4.0853737E−11 |
| A11 | −1.0057263E−13 | 8.8965789E−13 | 4.0429177E−11 | 1.0143335E−12 |
| A12 | 7.3390074E−15 | 7.7507389E−15 | −4.3569313E−12 | −1.0386953E−12 |
| A13 | −3.7699697E−17 | −9.9874821E−16 | 4.2432486E−13 | 4.2110469E−14 |
| A14 | −1.0287451E−17 | −1.9937092E−17 | −3.3209916E−14 | 1.4148490E−14 |
| A15 | −2.5433508E−19 | 1.6911255E−18 | 1.1910957E−16 | −1.4153109E−15 |
| A16 | 3.6134496E−20 | −5.2312960E−19 | 2.5541149E−16 | −3.3817156E−17 |
| A17 | 8.4710573E−22 | 9.6299864E−20 | −1.1845161E−17 | 6.7064921E−18 |
| A18 | −1.5166852E−22 | −6.9644864E−21 | −1.3703422E−18 | 3.9436476E−19 |
| A19 | 5.0546217E−24 | 2.2883656E−22 | 1.4518972E−19 | −6.5531760E−20 |
| A20 | −5.6343900E−26 | −2.8965811E−24 | −3.8876208E−21 | 2.0248377E−21 |

### Example 24

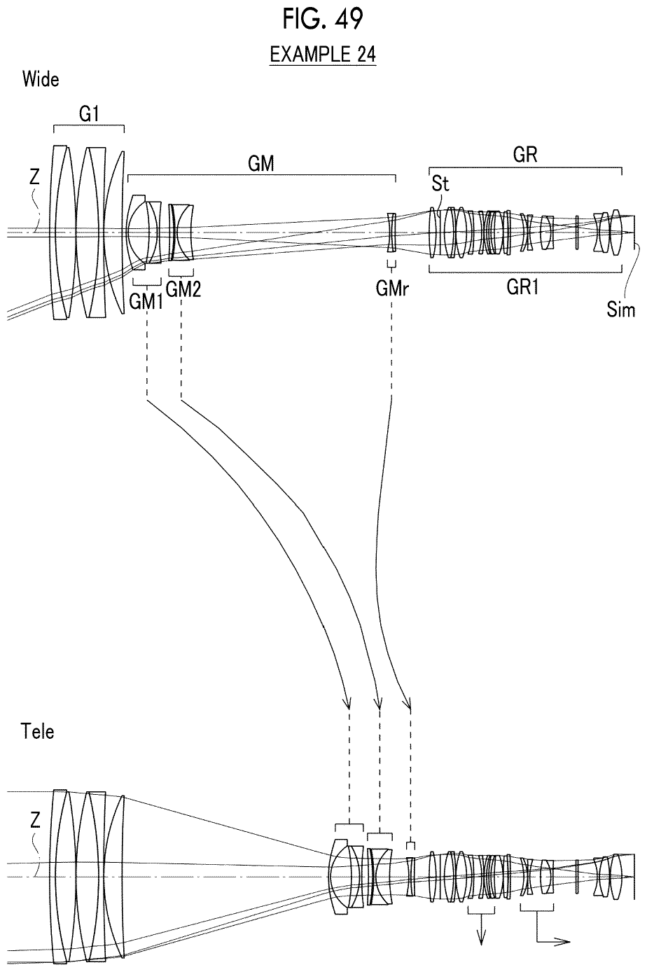

A configuration and a moving trajectory of a variable magnification optical system of Example 24 are shown in FIG. 49. The variable magnification optical system of Example 24 consists of, in order from the object side to the image side, the first lens group G1 having positive refractive power, the intermediate group GM, and the subsequent group GR. The intermediate group GM consists of, in order from the object side to the image side, three lens groups including the M1 lens group GM1 having negative refractive power, the M2 lens group GM2 having negative refractive power, and the Mr lens group GMr having negative refractive power. The M2 lens group GM2 having negative refractive power corresponds to the above M2n lens group. The subsequent group GR consists of one lens group that is the R1 lens group GR1 having positive refractive power.

During changing the magnification from the wide angle end to the telephoto end, the first lens group G1 and the R1 lens group GR1 remain stationary with respect to the image plane Sim, and other lens groups move along the optical axis Z by changing a spacing with respect to an adjacent lens group. The vibration-proof group consists of four lenses that are the fifth to eighth lenses in the R1 lens group GR1 from the object side. The focus group consists of four lenses that are the twelfth to fifteenth lenses in the R1 lens group GR1 from the object side. During focusing from the infinite distance object to the nearest object, the focus group moves to the image side.

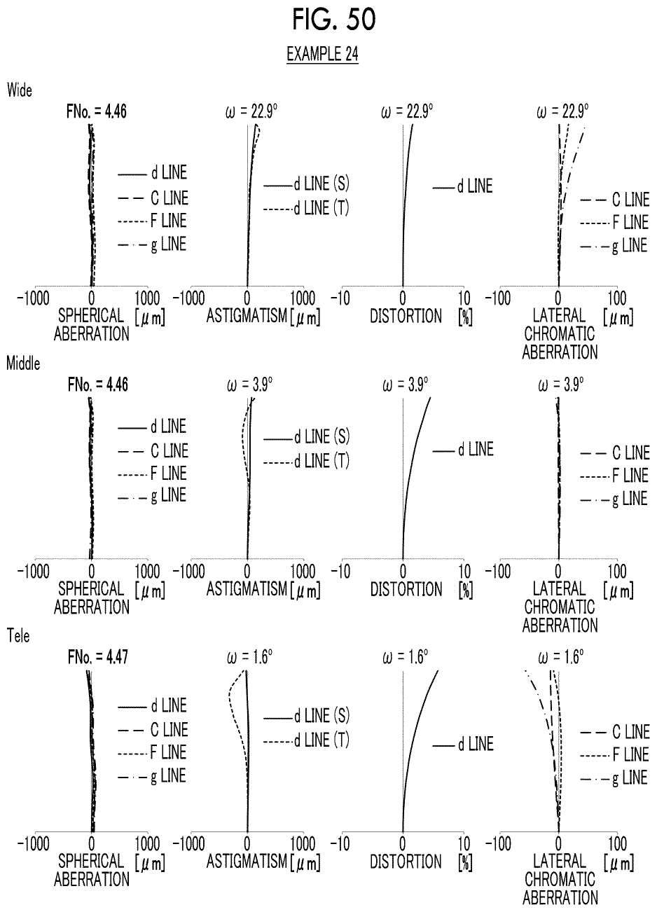

For the variable magnification optical system of Example 24, Tables 65A and 65B show basic lens data, Table 66 shows specifications and variable surface spacings, Table 67 shows aspherical coefficients, and FIG. 50 shows each aberration diagram.

TABLE 65A
Example 24

| Sn | R | D | Nd | νd | θgF | Material | ED |
|---|---|---|---|---|---|---|---|
| 1 | 510.1077 | 2.8202 | 1.61293 | 36.96 | 0.58507 | E-F3.HOYA | 90.00 |
| 2 | 181.8069 | 9.8192 | 1.49700 | 81.61 | 0.53887 | FCD1.HOYA | 88.00 |
| 3 | −292.8270 | 0.1002 | | | | | 87.96 |
| 4 | 192.7002 | 10.8299 | 1.49700 | 81.61 | 0.53887 | FCD1.HOYA | 86.28 |
| 5 | −211.0510 | 2.4002 | 1.80420 | 46.50 | 0.55727 | TAF3D.HOYA | 85.84 |
| 6 | 1044.5268 | 0.1002 | | | | | 84.59 |
| 7 | 105.5613 | 8.7410 | 1.49700 | 81.61 | 0.53887 | FCD1.HOYA | 82.82 |
| 8 | 831.8552 | DD[8] | | | | | 82.26 |
| *9 | 53.6945 | 1.0002 | 1.51633 | 64.06 | 0.53345 | L-BSL7.OHARA | 38.65 |
| *10 | 20.4335 | 10.0364 | | | | | 32.09 |
| 11 | −85.1159 | 3.9276 | 2.16217 | 21.24 | 0.6276 | N216.Glass | 31.84 |
| 12 | −33.7273 | 1.0100 | 1.80420 | 46.50 | 0.55727 | TAF3D.HOYA | 31.80 |
| 13 | 150.6693 | DD[13] | | | | | 30.33 |
| 14 | −228.7537 | 1.9604 | 1.54814 | 45.82 | 0.57004 | E-FEL1.HOYA | 29.22 |
| 15 | −87.0280 | 0.6228 | | | | | 29.04 |
| 16 | −82.0873 | 1.0102 | 1.72342 | 37.99 | 0.58202 | BAFD8.HOYA | 28.80 |
| 17 | 19.8653 | 6.5809 | 1.90043 | 37.37 | 0.57668 | TAFD37A.HOYA | 28.10 |
| 18 | 79.2144 | DD[18] | | | | | 27.60 |
| 19 | −46.9685 | 1.0102 | 1.83400 | 37.34 | 0.57908 | NBFD10.HOYA | 18.93 |
| 20 | 71.4292 | 1.6495 | 2.30909 | 17.89 | 0.6452 | N231.Glass | 19.50 |
| 21 | 233.5546 | DD[21] | | | | | 19.63 |
| 22 | 102.7642 | 3.3029 | 1.49700 | 81.61 | 0.53887 | FCD1.HOYA | 23.20 |
| 23 | −61.5947 | 2.0002 | | | | | 23.30 |
| 24 (St) | ∞ | 2.0002 | | | | | 23.00 |
| 25 | 44.1849 | 4.4562 | 1.49700 | 81.61 | 0.53887 | FCD1.HOYA | 24.05 |
| 26 | −61.1429 | 1.0002 | 2.00266 | 31.67 | 0.5851 | N200.Glass | 24.04 |
| 27 | −112.3838 | 0.1001 | | | | | 24.19 |
| 28 | 42.7678 | 5.1257 | 1.49700 | 81.61 | 0.53887 | FCD1.HOYA | 24.15 |
| 29 | −45.3862 | 2.5001 | | | | | 23.78 |

TABLE 65B
Example 24

| Sn | R | D | Nd | νd | θgF | Material | ED |
|---|---|---|---|---|---|---|---|
| 30 | −35.7062 | 1.0002 | 1.90043 | 37.37 | 0.57668 | TAFD37A.HOYA | 22.34 |
| 31 | −100.3888 | 3.8038 | | | | | 22.37 |
| 32 | −41.5362 | 1.0002 | 1.76634 | 35.82 | 0.57931 | S-NBH59.OHARA | 21.85 |
| 33 | −96.9619 | 0.1002 | | | | | 22.10 |
| 34 | 36.4417 | 1.2031 | 1.51742 | 52.15 | 0.55896 | E-CF6.HOYA | 22.26 |
| 35 | 37.6245 | 1.0992 | | | | | 22.07 |
| 36 | 56.8268 | 1.0001 | 1.59410 | 60.47 | 0.55516 | FCD600.HOYA | 22.09 |
| 37 | 34.1829 | 1.6675 | | | | | 21.90 |
| 38 | 88.7047 | 4.1690 | 1.51742 | 52.15 | 0.55896 | E-CF6.HOYA | 22.02 |
| 39 | −35.9554 | 0.1002 | | | | | 22.12 |
| 40 | 120.3408 | 2.2599 | 1.59410 | 60.47 | 0.55516 | FCD600.HOYA | 21.54 |
| 41 | −131.7308 | 0.1769 | | | | | 21.24 |
| 42 | −96.0096 | 1.0000 | 1.77250 | 49.62 | 0.55038 | TAF1.HOYA | 21.23 |
| 43 | −315.7134 | 6.4341 | | | | | 21.01 |
| 44 | −30.4468 | 1.8020 | 1.80610 | 33.27 | 0.58845 | NBFD15-W.HOYA | 19.32 |
| 45 | −22.9900 | 0.1002 | | | | | 19.47 |
| *46 | 315.2909 | 1.0001 | 1.69680 | 55.46 | 0.54260 | LAC14.HOYA | 18.19 |
| *47 | 26.2209 | 5.1570 | | | | | 17.53 |
| 48 | 42.5406 | 5.0100 | 1.62004 | 36.30 | 0.58729 | E-F2.HOYA | 17.22 |
| 49 | −17.1920 | 1.0001 | 1.85033 | 42.70 | 0.56458 | TAFD34.HOYA | 16.84 |
| 50 | 147.2110 | 11.0459 | | | | | 16.75 |
| 51 | ∞ | 1.0000 | 1.51680 | 64.20 | 0.53430 | BSC7.HOYA | 17.25 |
| 52 | ∞ | 9.2856 | | | | | 17.28 |
| 53 | −23.2704 | 1.0001 | 1.91082 | 35.25 | 0.58335 | TAFD35L.HOYA | 17.63 |
| 54 | 27.4996 | 4.8271 | 1.67270 | 32.17 | 0.59633 | E-FD5.HOYA | 19.47 |
| 55 | −50.6846 | 0.3842 | | | | | 20.66 |
| 56 | 38.7175 | 5.5707 | 1.51742 | 52.43 | 0.55649 | S-NSL36.OHARA | 23.01 |
| 57 | −35.8343 | 6.0624 | | | | | 23.42 |

TABLE 66
Example 24

| | Wide | Middle | Tele |
|---|---|---|---|
| Zr | 1.0 | 6.6 | 19.3 |
| f | 20.48 | 134.68 | 395.17 |
| Bf | 6.0624 | 6.0624 | 6.0624 |
| FNo. | 4.46 | 4.46 | 4.47 |
| 2ω [°] | 45.8 | 7.8 | 3.2 |
| DD[8] | 2.0002 | 80.4508 | 99.0326 |
| DD[13] | 4.9630 | 7.3488 | 3.2290 |
| DD[18] | 95.3332 | 7.5471 | 9.2279 |
| DD[21] | 16.3328 | 23.2826 | 7.1397 |

TABLE 67
Example 24

| Sn | 9 | 10 | 46 | 47 |
|---|---|---|---|---|
| KA | 1.0000000E+00 | 1.0000000E+00 | 1.0000000E+00 | 1.0000000E+00 |
| A3 | −3.3874392E−07 | −8.6751265E−07 | −6.2871535E−07 | 1.5720416E−06 |
| A4 | −1.4036338E−05 | −1.1429594E−05 | −5.4233373E−05 | −4.2184767E−05 |
| A5 | 6.6145299E−07 | −1.8377369E−07 | −3.4849374E−06 | −3.5724855E−06 |
| A6 | 2.1932421E−07 | 7.3686448E−07 | 3.2064253E−06 | 1.9382082E−06 |
| A7 | −8.5427074E−09 | −1.3862973E−07 | −4.1307748E−07 | 2.5036436E−07 |
| A8 | −1.2715957E−09 | 1.5358535E−08 | −8.3744363E−09 | −1.2305724E−07 |
| A9 | −2.2472028E−11 | −8.6342201E−10 | 4.3913742E−09 | 6.2170809E−09 |
| A10 | 8.4642881E−12 | 6.6691824E−12 | −3.7785188E−10 | 9.8160937E−10 |
| A11 | 1.3628445E−13 | −1.0602195E−12 | 4.0376326E−11 | 1.2083026E−11 |
| A12 | −1.9768956E−14 | 2.2208739E−13 | −4.0888029E−13 | −2.1298129E−11 |
| A13 | −8.5087570E−16 | 7.4948398E−15 | −5.4622234E−13 | 5.1405012E−13 |
| A14 | −1.2569753E−19 | −1.4578066E−15 | 1.3535174E−14 | 1.5249950E−13 |
| A15 | 5.2381990E−18 | −1.3787071E−17 | 3.4567343E−15 | 2.7462290E−15 |
| A16 | −7.4311651E−20 | 4.2664381E−18 | 3.3876806E−16 | −2.4253592E−15 |
| A17 | −6.5364161E−21 | 2.0970759E−20 | −8.0898257E−17 | 1.6727680E−16 |
| A18 | 8.3773914E−23 | −1.0212440E−20 | 2.8808250E−18 | −1.7844283E−18 |
| A19 | 5.5724737E−24 | 2.8454583E−22 | 1.1594031E−19 | −1.9480655E−19 |
| A20 | −1.0980094E−25 | −2.2650814E−24 | −6.4533856E−21 | 5.5739742E−21 |

### Example 25

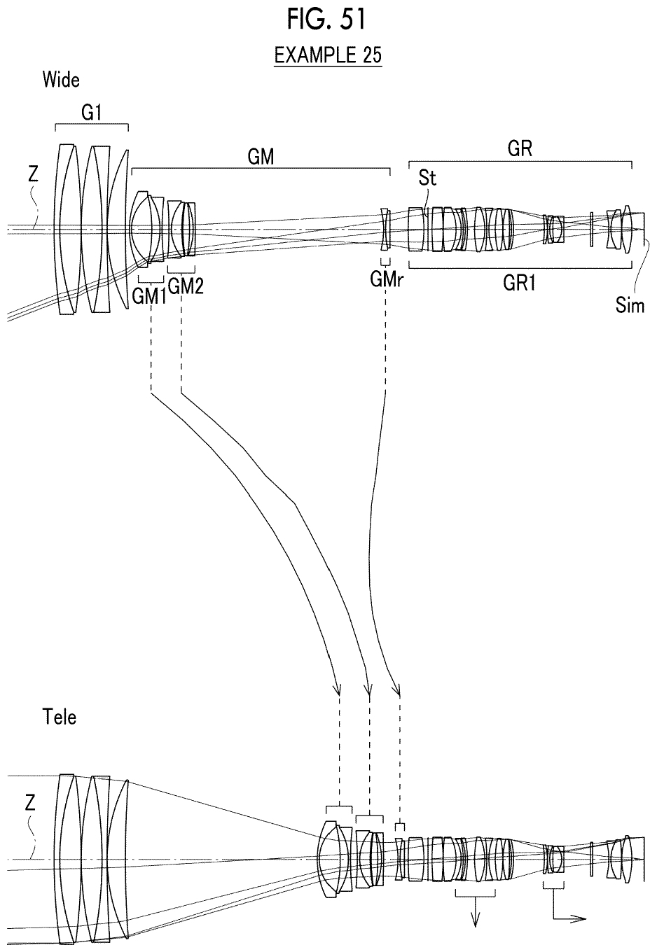

A configuration and a moving trajectory of a variable magnification optical system of Example 25 are shown in FIG. 51. The variable magnification optical system of Example 25 consists of, in order from the object side to the image side, the first lens group G1 having positive refractive power, the intermediate group GM, and the subsequent group GR. The intermediate group GM consists of, in order from the object side to the image side, three lens groups including the M1 lens group GM1 having negative refractive power, the M2 lens group GM2 having negative refractive power, and the Mr lens group GMr having negative refractive power. The M2 lens group GM2 having negative refractive power corresponds to the above M2n lens group. The subsequent group GR consists of one lens group that is the R1 lens group GR1 having positive refractive power.

During changing the magnification from the wide angle end to the telephoto end, the first lens group G1 and the R1 lens group GR1 remain stationary with respect to the image plane Sim, and other lens groups move along the optical axis Z by changing a spacing with respect to an adjacent lens group. The vibration-proof group consists of four lenses that are fourth to seventh lenses in the R1 lens group GR1 from the object side. The focus group consists of four lenses that are eleventh to fourteenth lenses in the R1 lens group GR1 from the object side. During focusing from the infinite distance object to the nearest object, the focus group moves to the image side.

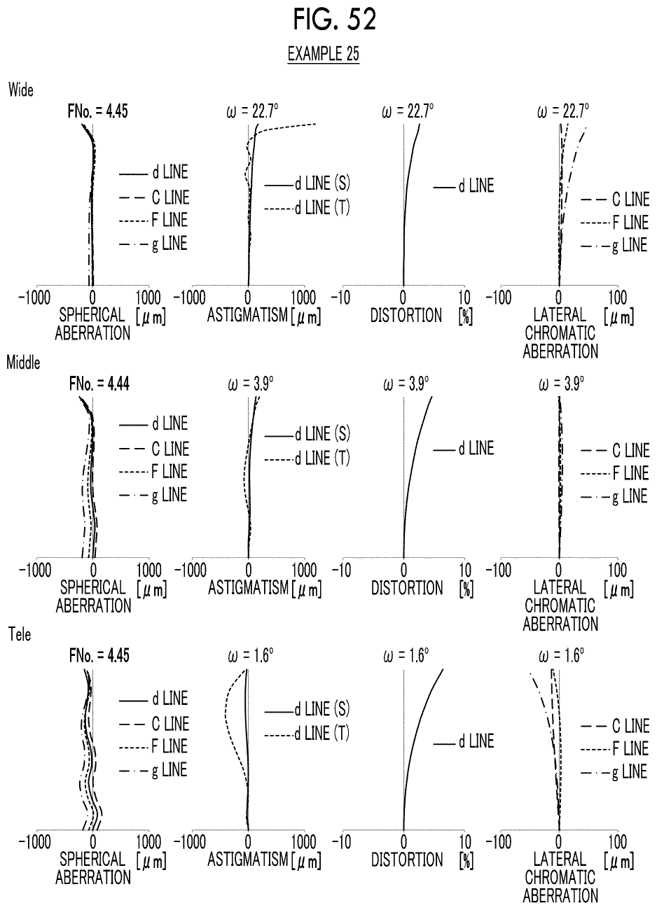

For the variable magnification optical system of Example 25, Tables 68A and 68B show basic lens data, Table 69 shows specifications and variable surface spacings, Table 70 shows aspherical coefficients, and FIG. 52 shows each aberration diagram.

TABLE 68A
Example 25

| Sn | R | D | Nd | νd | θgF | Material | ED |
|---|---|---|---|---|---|---|---|
| 1 | 347.5221 | 2.8201 | 1.57501 | 41.50 | 0.57672 | S-TIL27.OHARA | 90.00 |
| 2 | 144.0262 | 10.4234 | 1.49700 | 81.61 | 0.53887 | FCD1.HOYA | 88.00 |
| 3 | −373.7442 | 0.1001 | | | | | 87.94 |
| 4 | 190.6344 | 10.2302 | 1.49700 | 81.61 | 0.53887 | FCD1.HOYA | 86.27 |
| 5 | −235.7596 | 2.4002 | 1.79950 | 42.34 | 0.56498 | NBFD12.HOYA | 85.87 |
| 6 | 704.1592 | 0.1002 | | | | | 84.48 |
| 7 | 98.4438 | 8.9028 | 1.49700 | 81.61 | 0.53887 | FCD1.HOYA | 82.63 |
| 8 | 613.9204 | DD[8] | | | | | 82.09 |
| 9 | 48.8549 | 1.0001 | 1.51633 | 64.06 | 0.53345 | L-BSL7.OHARA | 40.32 |
| 10 | 22.5183 | 10.0025 | | | | | 34.33 |
| *11 | −82.9953 | 4.0183 | 2.16217 | 21.24 | 0.6276 | N216.Glass | 34.09 |
| 12 | −34.4868 | 1.0102 | 1.80420 | 46.50 | 0.55727 | TAF3D.HOYA | 33.91 |
| 13 | 160.6475 | DD[13] | | | | | 31.41 |
| 14 | −183.3581 | 1.2102 | 1.71300 | 53.94 | 0.54424 | LAC8.HOYA | 30.28 |
| 15 | 23.7543 | 5.0948 | 1.88100 | 40.14 | 0.57010 | TAFD33.HOYA | 28.60 |
| 16 | 79.2319 | 0.5449 | | | | | 28.05 |
| 17 | 96.2049 | 3.2411 | 1.90043 | 37.37 | 0.57668 | TAFD37A.HOYA | 27.94 |
| 18 | −97.5811 | 1.7998 | | | | | 27.53 |
| *19 | −40.3393 | 1.0000 | 2.00266 | 31.67 | 0.5851 | N200.Glass | 27.15 |
| *20 | −649.4761 | DD[20] | | | | | 27.00 |
| 21 | −46.0942 | 1.0102 | 1.83400 | 37.34 | 0.57908 | NBFD10.HOYA | 19.11 |
| 22 | 50.7784 | 2.1171 | 1.92286 | 20.88 | 0.63900 | E-FDS1-W.HOYA | 19.56 |
| 23 | 1110.9017 | DD[23] | | | | | 19.72 |
| 24 | 143.5269 | 7.7197 | 1.49700 | 81.61 | 0.53887 | FCD1.HOYA | 22.32 |
| 25 | −69.8308 | 2.0001 | | | | | 23.01 |
| 26 (St) | ∞ | 2.0002 | | | | | 23.00 |
| 27 | 152.6174 | 5.3613 | 1.49700 | 81.61 | 0.53887 | FCD1.HOYA | 23.26 |
| 28 | −133.9297 | 0.1002 | | | | | 23.38 |
| 29 | 110.6252 | 6.3437 | 1.49700 | 81.61 | 0.53887 | FCD1.HOYA | 23.33 |
| 30 | −27.7612 | 2.5000 | | | | | 23.00 |

TABLE 68B
Example 25

| Sn | R | D | Nd | νd | θgF | Material | ED |
|---|---|---|---|---|---|---|---|
| 31 | −21.9802 | 1.0002 | 1.88100 | 40.14 | 0.57010 | TAFD33.HOYA | 21.49 |
| 32 | −46.6658 | 1.0282 | | | | | 22.01 |
| 33 | −33.4968 | 1.0002 | 1.72342 | 37.99 | 0.58202 | BAFD8.HOYA | 22.00 |
| 34 | −58.6754 | 3.5412 | | | | | 22.48 |
| 35 | 61.0192 | 5.0000 | 1.49700 | 81.61 | 0.53887 | FCD1.HOYA | 23.61 |
| 36 | −30.9291 | 1.0002 | | | | | 23.60 |
| 37 | −89.9733 | 1.0000 | 1.60738 | 56.71 | 0.54817 | BACD2.HOYA | 22.43 |
| 38 | 32.7249 | 3.1617 | | | | | 21.81 |
| 39 | 53.9740 | 3.7029 | 1.51742 | 52.15 | 0.55896 | E-CF6.HOYA | 22.18 |
| 40 | −55.8885 | 0.1002 | | | | | 22.11 |
| 41 | 42.8968 | 3.1522 | 1.59410 | 60.47 | 0.55516 | FCD600.HOYA | 21.39 |
| 42 | −113.3146 | 0.9879 | | | | | 20.90 |
| 43 | −40.1581 | 1.0001 | 2.30909 | 17.89 | 0.6452 | N231.Glass | 20.83 |
| 44 | −44.5798 | 15.0955 | | | | | 20.85 |
| 45 | −53.2912 | 1.5469 | 1.80610 | 33.27 | 0.58845 | NBFD15-W.HOYA | 15.23 |
| 46 | −32.1834 | 0.1002 | | | | | 15.15 |
| 47 | 100.0073 | 1.0002 | 1.69680 | 55.46 | 0.54260 | LAC14.HOYA | 14.47 |
| 48 | 16.3429 | 1.5747 | | | | | 13.64 |
| 49 | 69.6669 | 4.3472 | 1.62004 | 36.26 | 0.58800 | S-TIM2.OHARA | 13.63 |
| 50 | −11.7798 | 1.0002 | 1.85033 | 42.70 | 0.56458 | TAFD34.HOYA | 13.48 |
| 51 | 560.5221 | 13.1621 | | | | | 13.81 |
| 52 | ∞ | 1.0000 | 1.51680 | 64.20 | 0.53430 | BSC7.HOYA | 16.58 |
| 53 | ∞ | 7.9439 | | | | | 16.72 |
| 54 | −41.8695 | 1.0002 | 1.87070 | 40.73 | 0.56825 | TAFD32.HOYA | 18.19 |
| 55 | 20.2678 | 5.2124 | 1.67300 | 38.26 | 0.57580 | S-NBH52V.OHARA | 19.64 |
| 56 | −90.9765 | 0.1002 | | | | | 20.72 |
| 57 | 35.2538 | 4.9685 | 1.51742 | 52.15 | 0.55896 | E-CF6.HOYA | 22.58 |
| 58 | −47.8058 | 6.0838 | | | | | 22.93 |

TABLE 69
Example 25

| | Wide | Middle | Tele |
|---|---|---|---|
| Zr | 1.0 | 6.6 | 19.3 |
| f | 20.43 | 134.37 | 394.26 |
| Bf | 6.0838 | 6.0838 | 6.0838 |
| FNo. | 4.45 | 4.44 | 4.45 |
| 2ω [°] | 45.4 | 7.8 | 3.2 |
| DD[8] | 2.0002 | 76.3135 | 94.1560 |
| DD[13] | 3.3657 | 5.1342 | 3.3275 |
| DD[20] | 92.1579 | 8.3022 | 7.1085 |

TABLE 70
Example 25

| Sn | 11 | 19 | 20 |
|---|---|---|---|
| KA | 1.0000000E+00 | 1.0000000E+00 | 1.0000000E+00 |
| A3 | −2.7245593E−07 | 2.3756845E−06 | −1.4721584E−05 |
| A4 | 2.6603265E−06 | 4.4372571E−06 | 6.8634045E−05 |
| A5 | −9.3848582E−07 | 3.1350311E−05 | −3.2615114E−05 |
| A6 | 7.7168939E−08 | −2.5947258E−05 | 5.3504288E−06 |
| A7 | 1.6126298E−08 | 8.1959396E−06 | −5.2206860E−07 |
| A8 | −2.9799121E−09 | −1.3961308E−06 | 4.8954319E−08 |
| A9 | 1.0390948E−10 | 1.3131873E−07 | −4.4721473E−09 |
| A10 | 3.4245696E−12 | −4.9452658E−09 | 2.0710999E−10 |
| A11 | 2.0918530E−13 | −2.1804105E−10 | 1.6015874E−11 |
| A12 | −1.5424243E−14 | 2.8312552E−11 | −3.0316935E−12 |
| A13 | −2.5811759E−15 | −8.9405419E−13 | 8.1307567E−14 |
| A14 | 7.6474635E−17 | 3.1029376E−14 | 1.1077404E−14 |
| A15 | 5.4496253E−18 | −2.9293963E−15 | −1.9722056E−16 |
| A16 | 1.2454534E−19 | −1.4732928E−16 | −4.5942559E−17 |
| A17 | −2.0130644E−20 | 5.2602407E−17 | −1.8576035E−18 |
| A18 | 4.3601655E−22 | −4.7775231E−18 | 2.7741036E−19 |
| A19 | −2.6460412E−23 | 2.1162862E−19 | 1.7725941E−21 |
| A20 | 9.5357027E−25 | −3.8010330E−21 | −3.8665087E−22 |

### Example 26

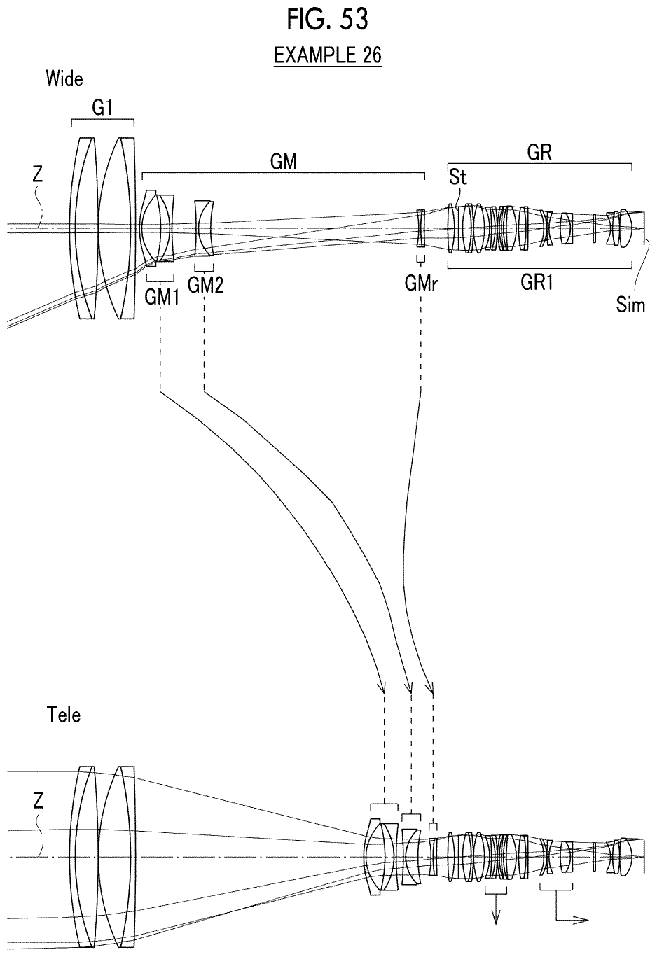

A configuration and a moving trajectory of a variable magnification optical system of Example 26 are shown in FIG. 53. The variable magnification optical system of Example 26 consists of, in order from the object side to the image side, the first lens group G1 having positive refractive power, the intermediate group GM, and the subsequent group GR. The intermediate group GM consists of, in order from the object side to the image side, three lens groups including the M1 lens group GM1 having negative refractive power, the M2 lens group GM2 having negative refractive power, and the Mr lens group GMr having negative refractive power. The M2 lens group GM2 having negative refractive power corresponds to the above M2n lens group. The subsequent group GR consists of one lens group that is the R1 lens group GR1 having positive refractive power.

During changing the magnification from the wide angle end to the telephoto end, the first lens group G1 and the R1 lens group GR1 remain stationary with respect to the image plane Sim, and other lens groups move along the optical axis Z by changing a spacing with respect to an adjacent lens group. The vibration-proof group consists of four lenses that are the fifth to eighth lenses in the R1 lens group GR1 from the object side. The focus group consists of four lenses that are the twelfth to fifteenth lenses in the R1 lens group GR1 from the object side. During focusing from the infinite distance object to the nearest object, the focus group moves to the image side.

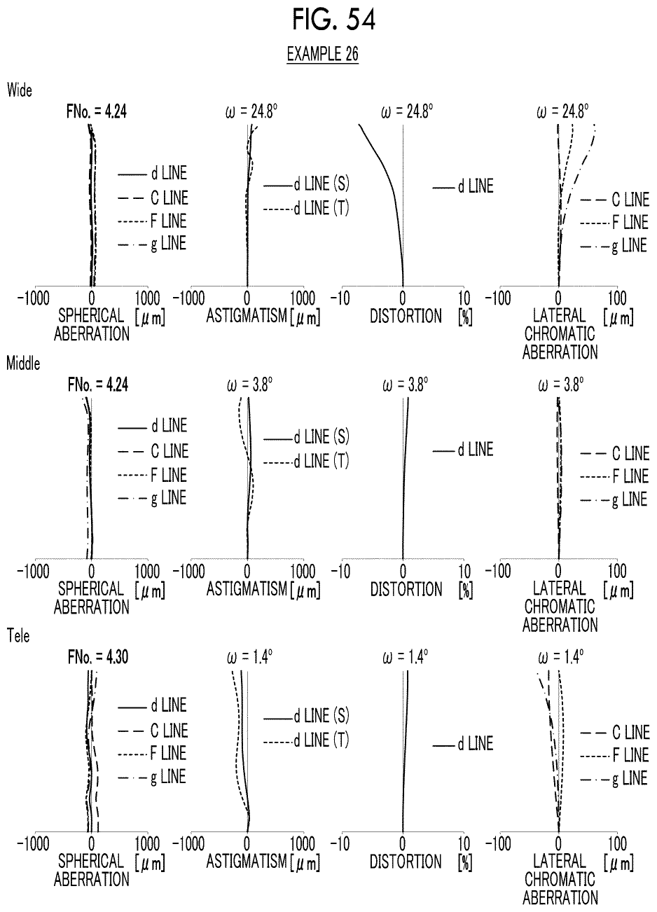

For the variable magnification optical system of Example 26, Tables 71A and 71B show basic lens data, Table 72 shows specifications and variable surface spacings, Table 73 shows aspherical coefficients, and FIG. 54 shows each aberration diagram.

TABLE 71A
Example 26

| Sn | R | D | Nd | νd | θgF | Material | ED |
|---|---|---|---|---|---|---|---|
| 1 | 230.4407 | 2.8001 | 1.72825 | 28.32 | 0.60755 | E-FD10L.HOYA | 96.00 |
| 2 | 143.1856 | 11.3052 | 1.49700 | 81.61 | 0.53887 | FCD1.HOYA | 94.93 |
| 3 | −596.9488 | 0.1001 | | | | | 94.79 |
| 4 | 120.6997 | 15.9494 | 1.49700 | 81.61 | 0.53887 | FCD1.HOYA | 92.14 |
| 5 | −236.8351 | 2.4000 | 1.75500 | 52.32 | 0.54737 | TAC6.HOYA | 91.12 |
| 6 | −1569.7052 | DD[6] | | | | | 89.27 |
| *7 | 44.7820 | 1.0986 | 1.67270 | 32.17 | 0.59633 | E-FD5.HOYA | 40.41 |
| *8 | 24.6641 | 9.3517 | | | | | 35.60 |
| 9 | −78.2292 | 4.4914 | 2.30909 | 17.89 | 0.6452 | N231.Glass | 35.33 |
| 10 | −33.4379 | 1.0802 | 1.88300 | 40.80 | 0.56557 | TAFD30.HOYA | 35.33 |
| 11 | 160.9108 | DD[11] | | | | | 33.29 |
| 12 | −161.7948 | 1.2011 | 1.72342 | 37.99 | 0.58202 | BAFD8.HOYA | 29.48 |
| 13 | 21.0308 | 5.9880 | 1.90043 | 37.37 | 0.57668 | TAFD37A.HOYA | 28.50 |
| 14 | 71.8919 | DD[14] | | | | | 28.00 |
| 15 | −49.2967 | 1.0102 | 1.83481 | 42.74 | 0.56490 | S-LAH55VS.OHARA | 19.00 |
| 16 | 65.7084 | 1.7371 | 2.16217 | 21.24 | 0.6276 | N216.Glass | 19.61 |
| 17 | 251.7863 | DD[17] | | | | | 19.78 |
| 18 | 132.6533 | 3.2758 | 1.49700 | 81.61 | 0.53887 | FCD1.HOYA | 23.01 |
| 19 | −54.8153 | 2.0002 | | | | | 23.18 |
| 20 (St) | ∞ | 2.0002 | | | | | 23.00 |
| 21 | 48.7417 | 4.3230 | 1.49700 | 81.61 | 0.53887 | FCD1.HOYA | 24.03 |
| 22 | −58.0145 | 1.0002 | 1.91082 | 35.25 | 0.58335 | TAFD35L.HOYA | 24.06 |
| 23 | −105.9378 | 0.1001 | | | | | 24.23 |
| 24 | 42.6770 | 5.3994 | 1.49700 | 81.61 | 0.53887 | FCD1.HOYA | 24.22 |
| 25 | −40.6225 | 2.5001 | | | | | 23.86 |
| 26 | −30.5597 | 1.0002 | 1.90043 | 37.37 | 0.57668 | TAFD37A.HOYA | 22.44 |
| 27 | −94.9267 | 1.7510 | | | | | 22.60 |

TABLE 71B
Example 26

| Sn | R | D | Nd | νd | θgF | Material | ED |
|---|---|---|---|---|---|---|---|
| 28 | −38.8255 | 1.0002 | 1.76634 | 35.82 | 0.57931 | S-NBH59.OHARA | 22.53 |
| 29 | −90.9805 | 0.1001 | | | | | 22.94 |
| 30 | 47.2230 | 1.0002 | 1.51742 | 52.15 | 0.55896 | E-CF6.HOYA | 23.35 |
| 31 | 40.0213 | 1.0031 | | | | | 23.27 |
| 32 | 56.5090 | 1.0001 | 1.59410 | 60.47 | 0.55516 | FCD600.HOYA | 23.39 |
| 33 | 43.1991 | 1.4937 | | | | | 23.36 |
| 34 | 110.6209 | 4.8345 | 1.51742 | 52.15 | 0.55896 | E-CF6.HOYA | 23.53 |
| 35 | −30.9076 | 1.1773 | | | | | 23.77 |
| 36 | 66.2606 | 3.6181 | 1.59410 | 60.47 | 0.55516 | FCD600.HOYA | 22.71 |
| 37 | −61.9025 | 0.0178 | | | | | 22.26 |
| 38 | −66.4668 | 1.0002 | 1.77250 | 49.62 | 0.55038 | TAF1.HOYA | 22.19 |
| 39 | −414.1142 | 7.7754 | | | | | 21.80 |
| 40 | −25.2129 | 1.4799 | 1.80610 | 33.27 | 0.58845 | NBFD15-W.HOYA | 19.12 |
| 41 | −21.9556 | 0.1002 | | | | | 19.28 |
| *42 | 499.5889 | 1.0001 | 1.69680 | 55.46 | 0.54260 | LAC14.HOYA | 17.69 |
| *43 | 24.3192 | 5.5489 | | | | | 16.67 |
| 44 | 36.0259 | 5.0100 | 1.62004 | 36.30 | 0.58729 | E-F2.HOYA | 16.33 |
| 45 | −15.8208 | 1.0000 | 1.85033 | 42.70 | 0.56458 | TAFD34.HOYA | 15.91 |
| 46 | 682.3396 | 10.3342 | | | | | 15.78 |
| 47 | ∞ | 1.0000 | 1.51680 | 64.20 | 0.53430 | BSC7.HOYA | 15.21 |
| 48 | ∞ | 7.4703 | | | | | 15.17 |
| 49 | −15.3268 | 1.0000 | 1.91082 | 35.25 | 0.58335 | TAFD35L.HOYA | 14.86 |
| 50 | 36.1270 | 3.4540 | 1.67270 | 32.17 | 0.59633 | E-FD5.HOYA | 16.75 |
| 51 | −49.0183 | 0.1001 | | | | | 17.81 |
| 52 | 74.4857 | 6.0287 | 1.51742 | 52.43 | 0.55649 | S-NSL36.OHARA | 19.09 |
| 53 | −16.6621 | 6.0576 | | | | | 19.97 |

TABLE 72
Example 26

| | Wide | Middle | Tele |
|---|---|---|---|
| Zr | 1.0 | 6.6 | 19.3 |
| f | 20.24 | 133.13 | 390.62 |
| Bf | 6.0576 | 6.0576 | 6.0576 |
| FNo. | 4.24 | 4.24 | 4.30 |
| 2ω [°] | 49.6 | 7.6 | 2.8 |
| DD[6] | 2.0002 | 89.7211 | 112.3353 |
| DD[11] | 11.8866 | 10.5448 | 3.5133 |
| DD[14] | 102.3731 | 7.4561 | 6.4768 |
| DD[17] | 11.5870 | 20.1249 | 5.5215 |

TABLE 73
Example 26

| Sn | 7 | 8 | 42 | 43 |
|---|---|---|---|---|
| KA | 1.0000000E+00 | 1.0000000E+00 | 1.0000000E+00 | 1.0000000E+00 |
| A3 | −2.6540324E−06 | 7.2871716E−06 | −7.8244304E−08 | −5.1132292E−07 |
| A4 | −4.6509292E−05 | −6.1401168E−05 | 3.5093671E−05 | 4.5122761E−05 |
| A5 | 4.5212754E−06 | 1.1332121E−05 | 1.1307032E−05 | 1.0176331E−05 |
| A6 | −4.5749528E−07 | −1.9383520E−06 | 1.7555973E−07 | 8.7775299E−07 |
| A7 | 7.2501032E−08 | 2.4756094E−07 | −4.7189241E−07 | −5.9990262E−07 |
| A8 | 1.3277050E−10 | −9.8449674E−09 | −2.2498439E−08 | 1.3255322E−08 |
| A9 | −6.2176193E−10 | −3.6012828E−10 | 1.5546336E−08 | 6.6680453E−09 |
| A10 | 1.3019214E−11 | 1.8048533E−11 | −3.4569807E−10 | 5.0417357E−11 |
| A11 | 1.2890995E−12 | −1.3424942E−12 | −2.5120785E−10 | −5.2927135E−11 |
| A12 | 4.8823072E−14 | 2.3730666E−13 | 2.6000068E−11 | −1.3672554E−12 |
| A13 | −3.7727987E−15 | −2.6267186E−15 | 2.0495497E−14 | −3.0588377E−13 |
| A14 | −3.5290941E−16 | −6.7985541E−16 | −8.8314249E−14 | 9.8622521E−14 |
| A15 | 1.2691915E−17 | 5.1121852E−18 | −1.4156614E−14 | −3.0871982E−15 |
| A16 | 7.5394443E−19 | 1.6656366E−18 | 2.0184974E−15 | −9.5899395E−17 |
| A17 | −2.1037368E−20 | −3.2807451E−20 | 1.6805754E−16 | −3.6314133E−17 |
| A18 | −1.1393730E−21 | −3.5752954E−21 | −4.3629618E−17 | 5.1179863E−18 |
| A19 | 4.5418230E−23 | 2.4446297E−22 | 2.8404201E−18 | −2.3339625E−19 |
| A20 | −3.8771590E−25 | −4.8716100E−24 | −6.3585270E−20 | 3.8956316E−21 |

### Example 27

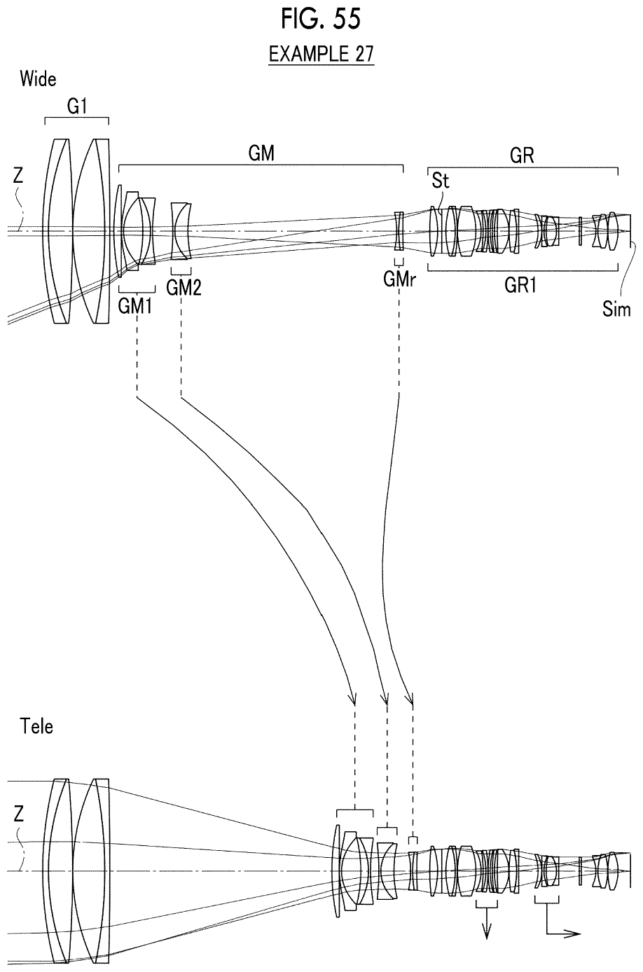

A configuration and a moving trajectory of a variable magnification optical system of Example 27 are shown in FIG. 55. The variable magnification optical system of Example 27 consists of, in order from the object side to the image side, the first lens group G1 having positive refractive power, the intermediate group GM, and the subsequent group GR. The intermediate group GM consists of, in order from the object side to the image side, three lens groups including the M1 lens group GM1 having negative refractive power, the M2 lens group GM2 having negative refractive power, and the Mr lens group GMr having negative refractive power. The M2 lens group GM2 having negative refractive power corresponds to the above M2n lens group. The subsequent group GR consists of one lens group that is the R1 lens group GR1 having positive refractive power.

During changing the magnification from the wide angle end to the telephoto end, the first lens group G1 and the R1 lens group GR1 remain stationary with respect to the image plane Sim, and other lens groups move along the optical axis Z by changing a spacing with respect to an adjacent lens group. The vibration-proof group consists of four lenses that are the fifth to eighth lenses in the R1 lens group GR1 from the object side. The focus group consists of four lenses that are the twelfth to fifteenth lenses in the R1 lens group GR1 from the object side. During focusing from the infinite distance object to the nearest object, the focus group moves to the image side.

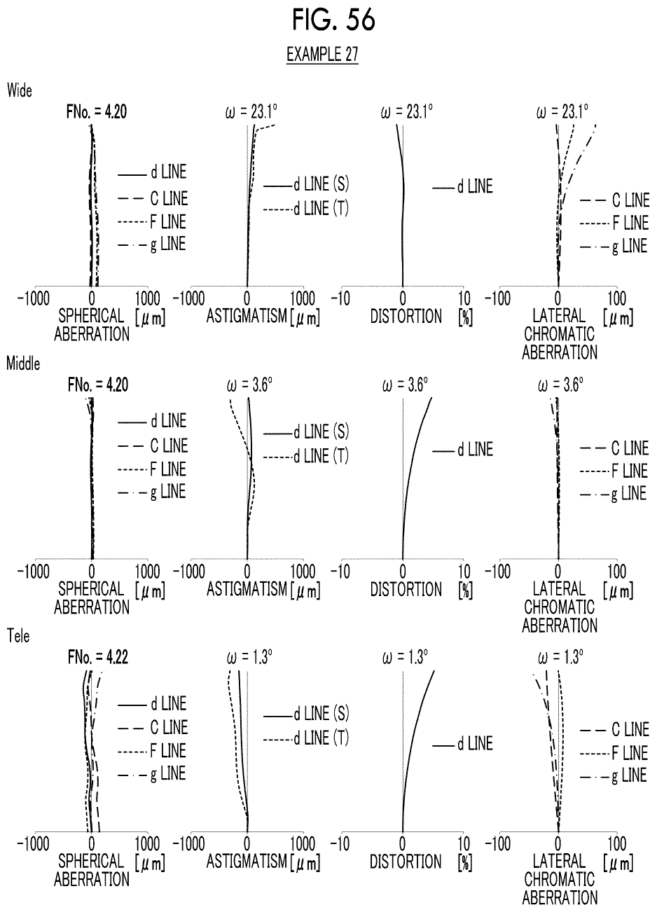

For the variable magnification optical system of Example 27, Tables 74A and 74B show basic lens data, Table 75 shows specifications and variable surface spacings, Table 76 shows aspherical coefficients, and FIG. 56 shows each aberration diagram.

TABLE 74A
Example 27

| Sn | R | D | Nd | νd | θgF | Material | ED |
|---|---|---|---|---|---|---|---|
| 1 | 208.8334 | 2.8002 | 1.72825 | 28.32 | 0.60590 | E-FD10.HOYA | 96.00 |
| 2 | 136.6973 | 11.6587 | 1.49700 | 81.61 | 0.53887 | FCD1.HOYA | 94.86 |
| 3 | −620.5788 | 0.1001 | | | | | 94.70 |
| 4 | 120.3736 | 15.4800 | 1.49700 | 81.61 | 0.53887 | FCD1.HOYA | 91.88 |
| 5 | −260.4651 | 2.4001 | 1.78800 | 47.37 | 0.55598 | S-LAH64.OHARA | 90.83 |
| 6 | −2210.0801 | DD[6] | | | | | 89.04 |
| 7 | 125.0137 | 3.5413 | 1.49700 | 81.61 | 0.53887 | FCD1.HOYA | 48.03 |
| 8 | 5945.6309 | 0.1002 | | | | | 46.65 |
| *9 | 42.4465 | 1.0289 | 1.64850 | 53.02 | 0.55487 | S-BSM71.OHARA | 41.00 |
| *10 | 21.4554 | 9.3145 | | | | | 34.85 |
| 11 | −78.0122 | 3.7101 | 2.30909 | 17.89 | 0.6452 | N231.Glass | 34.67 |
| 12 | −36.6892 | 1.0100 | 1.80440 | 39.58 | 0.57623 | S-LAH63Q.OHARA | 34.64 |
| 13 | 106.1482 | DD[13] | | | | | 32.36 |
| 14 | −134.4457 | 1.0100 | 1.72342 | 37.99 | 0.58202 | BAFD8.HOYA | 29.46 |
| 15 | 20.0747 | 6.3012 | 1.91082 | 35.25 | 0.58224 | TAFD35.HOYA | 28.54 |
| 16 | 66.2520 | DD[16] | | | | | 28.00 |
| 17 | −46.8815 | 1.0102 | 1.83481 | 42.74 | 0.56490 | S-LAH55VS.OHARA | 19.00 |
| 18 | 64.2660 | 1.9701 | 2.16217 | 21.24 | 0.6276 | N216.Glass | 19.61 |
| 19 | 255.8914 | DD[19] | | | | | 19.81 |
| 20 | 120.4423 | 3.7902 | 1.49700 | 81.61 | 0.53887 | FCD1.HOYA | 23.29 |
| 21 | −42.6996 | 2.0001 | | | | | 23.46 |
| 22 (St) | ∞ | 2.0001 | | | | | 23.00 |
| 23 | 49.0394 | 4.5162 | 1.49700 | 81.61 | 0.53887 | FCD1.HOYA | 23.75 |
| 24 | −50.9271 | 1.0002 | 1.90366 | 31.31 | 0.59481 | TAFD25.HOYA | 23.71 |
| 25 | −85.5037 | 0.1001 | | | | | 23.84 |
| 26 | 46.3845 | 8.8958 | 1.49700 | 81.61 | 0.53887 | FCD1.HOYA | 23.60 |
| 27 | −38.3651 | 2.5001 | | | | | 22.24 |
| 28 | −24.4553 | 1.0002 | 1.90043 | 37.37 | 0.57668 | TAFD37A.HOYA | 20.93 |
| 29 | −70.9031 | 1.3355 | | | | | 21.23 |

TABLE 74B
Example 27

| Sn | R | D | Nd | νd | θgF | Material | ED |
|---|---|---|---|---|---|---|---|
| 30 | −35.4601 | 1.0002 | 1.76634 | 35.82 | 0.57931 | S-NBH59.OHARA | 21.20 |
| 31 | −73.0441 | 0.1002 | | | | | 21.64 |
| 32 | 66.6642 | 1.0001 | 1.51742 | 52.15 | 0.55896 | E-CF6.HOYA | 22.00 |
| 33 | 44.0886 | 1.0252 | | | | | 22.02 |
| 34 | 75.8913 | 1.0001 | 1.59410 | 60.47 | 0.55516 | FCD600.HOYA | 22.15 |
| 35 | 50.8408 | 1.4096 | | | | | 22.25 |
| 36 | 241.4097 | 5.6098 | 1.51742 | 52.15 | 0.55896 | E-CF6.HOYA | 22.43 |
| 37 | −21.6677 | 0.1002 | | | | | 22.90 |
| 38 | 77.9173 | 3.5742 | 1.59410 | 60.47 | 0.55516 | FCD600.HOYA | 21.62 |
| 39 | −48.9827 | 0.0614 | | | | | 21.12 |
| 40 | −50.1173 | 1.0001 | 1.77250 | 49.62 | 0.55038 | TAF1.HOYA | 21.04 |
| 41 | 6458.0334 | 9.3535 | | | | | 20.56 |
| 42 | −25.3701 | 1.7908 | 1.80610 | 33.27 | 0.58845 | NBFD15-W.HOYA | 17.40 |
| 43 | −19.2809 | 0.1001 | | | | | 17.54 |
| *44 | −257.9113 | 1.0002 | 1.69680 | 55.46 | 0.54260 | LAC14.HOYA | 16.04 |
| *45 | 21.9165 | 1.0392 | | | | | 15.24 |
| 46 | 32.1827 | 5.0098 | 1.62004 | 36.30 | 0.58729 | E-F2.HOYA | 15.21 |
| 47 | −13.9162 | 1.0000 | 1.85033 | 42.70 | 0.56458 | TAFD34.HOYA | 14.79 |
| 48 | 338.0227 | 10.0002 | | | | | 14.71 |
| 49 | ∞ | 1.0000 | 1.51680 | 64.20 | 0.53430 | BSC7.HOYA | 14.64 |
| 50 | ∞ | 7.0085 | | | | | 14.63 |
| 51 | −17.7000 | 1.0002 | 1.91082 | 35.25 | 0.58335 | TAFD35L.HOYA | 14.59 |
| 52 | 23.1399 | 4.7014 | 1.67270 | 32.17 | 0.59633 | E-FD5.HOYA | 16.29 |
| 53 | −32.8886 | 0.1002 | | | | | 17.53 |
| 54 | 41.4976 | 4.9298 | 1.51742 | 52.43 | 0.55649 | S-NSL36.OHARA | 19.11 |
| 55 | −25.2699 | 6.0500 | | | | | 19.56 |

TABLE 75
Example 27

| | Wide | Middle | Tele |
|---|---|---|---|
| Zr | 1.0 | 6.6 | 19.3 |
| f | 20.50 | 134.87 | 395.73 |
| Bf | 6.0500 | 6.0500 | 6.0500 |
| FNo. | 4.20 | 4.20 | 4.22 |
| 2ω [°] | 46.2 | 7.2 | 2.6 |
| DD[6] | 2.0002 | 85.8307 | 107.1394 |
| DD[13] | 9.7930 | 9.5151 | 4.0026 |
| DD[16] | 100.6671 | 9.3885 | 8.0644 |
| DD[19] | 13.0238 | 20.7497 | 6.2778 |

TABLE 76
Example 27

| Sn | 9 | 10 | 44 | 45 |
|---|---|---|---|---|
| KA | 1.0000000E+00 | 1.0000000E+00 | 1.0000000E+00 | 1.0000000E+00 |
| A3 | −2.3250113E−06 | 6.6205678E−07 | 7.5047107E−07 | 1.2650171E−05 |
| A4 | −8.7032894E−05 | −9.7669688E−05 | 1.0057513E−04 | 9.9558181E−05 |
| A5 | 5.9231142E−06 | 9.1464886E−06 | 9.5471139E−06 | 4.3095524E−05 |
| A6 | −3.3090551E−07 | −8.3529838E−07 | −3.0751359E−06 | −2.4145415E−05 |
| A7 | 6.8969862E−08 | 8.2572684E−08 | −7.5145483E−07 | 6.4925112E−06 |
| A8 | −3.5488914E−10 | 4.2895163E−09 | 1.2282357E−07 | −1.1361221E−06 |
| A9 | −5.9632479E−10 | −7.0260223E−10 | 3.1102089E−09 | 5.5751606E−08 |
| A10 | 1.2725445E−11 | −4.2527877E−11 | 7.1243166E−10 | 1.2846366E−08 |
| A11 | 1.3356203E−12 | 5.6022672E−12 | −3.6139262E−10 | −2.7076446E−11 |
| A12 | 4.3728006E−14 | −5.8100031E−14 | 8.4240858E−12 | −5.6196993E−10 |
| A13 | −3.6814185E−15 | −8.5821080E−16 | 2.2579529E−12 | 5.3099211E−11 |
| A14 | −3.4735287E−16 | −4.5936719E−16 | 1.4937793E−13 | 3.1357786E−12 |
| A15 | 1.2807141E−17 | 1.4828509E−17 | −3.1057202E−14 | −2.1228747E−13 |
| A16 | 7.3149386E−19 | −1.8966349E−20 | −1.2396488E−15 | −9.4307303E−14 |
| A17 | −2.1454425E−20 | 4.0138947E−20 | 2.4987243E−16 | 8.7172029E−15 |
| A18 | −1.0521654E−21 | −4.7132727E−21 | 3.4630610E−18 | 3.6796661E−16 |
| A19 | 4.2529419E−23 | 2.3727040E−22 | −1.3484495E−18 | −7.2021786E−17 |
| A20 | −3.5630226E−25 | −4.5633773E−24 | 4.4108042E−20 | 2.3899835E−18 |

### Example 28

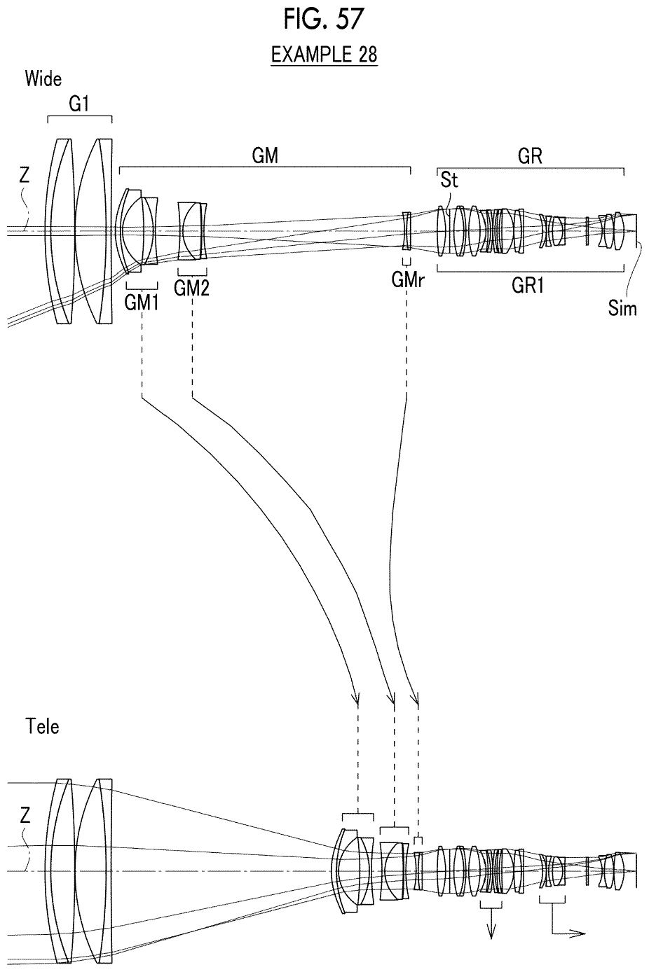

A configuration and a moving trajectory of a variable magnification optical system of Example 28 are shown in FIG. 57. The variable magnification optical system of Example 28 consists of, in order from the object side to the image side, the first lens group G1 having positive refractive power, the intermediate group GM, and the subsequent group GR. The intermediate group GM consists of, in order from the object side to the image side, three lens groups including the M1 lens group GM1 having negative refractive power, the M2 lens group GM2 having negative refractive power, and the Mr lens group GMr having negative refractive power. The M2 lens group GM2 having negative refractive power corresponds to the above M2n lens group. The subsequent group GR consists of one lens group that is the R1 lens group GR1 having positive refractive power.

During changing the magnification from the wide angle end to the telephoto end, the first lens group G1 and the R1 lens group GR1 remain stationary with respect to the image plane Sim, and other lens groups move along the optical axis Z by changing a spacing with respect to an adjacent lens group. The vibration-proof group consists of four lenses that are the fifth to eighth lenses in the R1 lens group GR1 from the object side. The focus group consists of four lenses that are the twelfth to fifteenth lenses in the R1 lens group GR1 from the object side. During focusing from the infinite distance object to the nearest object, the focus group moves to the image side.

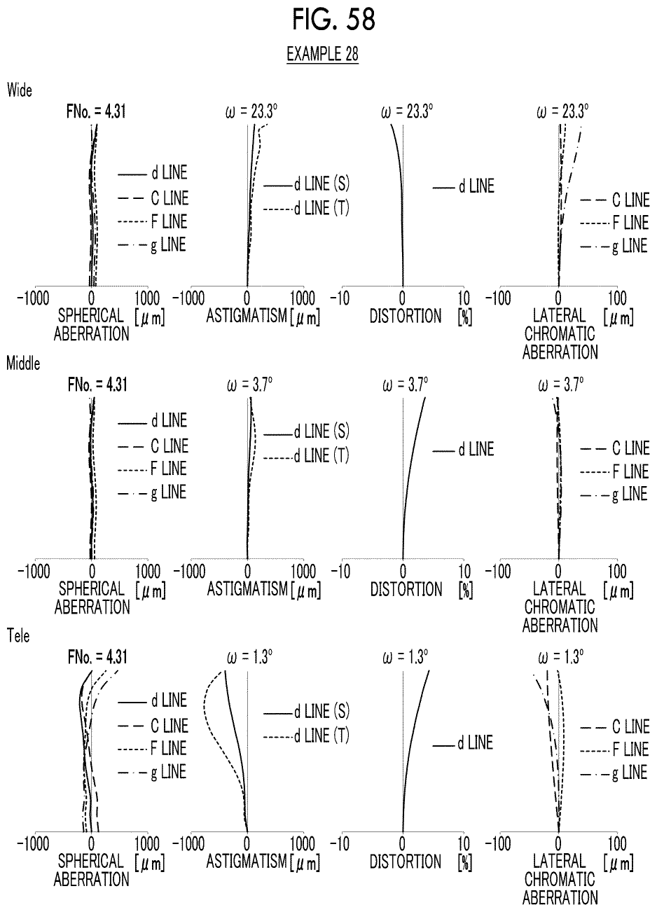

For the variable magnification optical system of Example 28, Tables 77A and 77B show basic lens data, Table 78 shows specifications and variable surface spacings, Table 79 shows aspherical coefficients, and FIG. 58 shows each aberration diagram.

TABLE 77A
Example 28

| Sn | R | D | Nd | νd | θgF | Material | ED |
|---|---|---|---|---|---|---|---|
| 1 | 199.1825 | 2.8002 | 1.72825 | 28.32 | 0.60590 | E-FD10.HOYA | 96.00 |
| 2 | 136.2872 | 11.6198 | 1.49700 | 81.61 | 0.53887 | FCD1.HOYA | 94.85 |
| 3 | −638.7174 | 0.1002 | | | | | 94.68 |
| 4 | 113.8022 | 15.0827 | 1.49700 | 81.61 | 0.53887 | FCD1.HOYA | 91.57 |
| 5 | −341.4863 | 2.4002 | 1.79952 | 42.22 | 0.56727 | S-LAH52.OHARA | 90.42 |
| 6 | 2904.2426 | DD[6] | | | | | 88.50 |
| *7 | 42.7745 | 2.5015 | 1.54814 | 45.78 | 0.56859 | S-TIL1.OHARA | 44.19 |
| 8 | 60.1703 | 1.0002 | 1.60311 | 60.64 | 0.54148 | S-BSM14.OHARA | 42.80 |
| 9 | 21.8413 | 10.2483 | | | | | 35.28 |
| 10 | −161.0348 | 4.6283 | 1.92286 | 18.90 | 0.64960 | S-NPH2.OHARA | 35.07 |
| 11 | −38.5664 | 1.0102 | 1.80610 | 40.93 | 0.57019 | S-LAH53.OHARA | 34.78 |
| 12 | 131.0764 | DD[12] | | | | | 33.02 |
| 13 | −120.7879 | 1.3969 | 1.72047 | 34.71 | 0.58350 | S-NBH8.OHARA | 30.05 |
| 14 | 20.6114 | 8.8497 | 1.90525 | 35.04 | 0.58486 | S-LAH93.OHARA | 29.46 |
| 15 | −213.4693 | 0.3131 | | | | | 28.92 |
| 16 | −211.5906 | 1.0002 | 1.88300 | 40.80 | 0.56557 | TAFD30.HOYA | 28.72 |
| 17 | 73.6204 | DD[17] | | | | | 28.00 |
| 18 | −47.1312 | 1.0102 | 1.83481 | 42.74 | 0.56490 | S-LAH55VS.OHARA | 19.00 |
| 19 | 67.0652 | 1.8663 | 1.92286 | 20.88 | 0.63900 | E-FDS1-W.HOYA | 19.42 |
| 20 | 3550.7591 | DD[20] | | | | | 19.58 |
| 21 | 100.2644 | 4.0324 | 1.49700 | 81.61 | 0.53887 | FCD1.HOYA | 23.31 |
| 22 | −45.4083 | 2.0001 | | | | | 23.47 |
| 23 (St) | ∞ | 2.0001 | | | | | 23.00 |
| 24 | 50.6465 | 4.8274 | 1.49700 | 81.61 | 0.53887 | FCD1.HOYA | 23.68 |
| 25 | −41.7809 | 1.0001 | 2.00266 | 31.67 | 0.5851 | N200.Glass | 23.63 |
| 26 | −61.3998 | 1.3569 | | | | | 23.83 |
| 27 | 47.5932 | 5.5059 | 1.49700 | 81.61 | 0.53887 | FCD1.HOYA | 23.27 |
| 28 | −40.6353 | 2.5862 | | | | | 22.62 |

TABLE 77B
Example 28

| Sn | R | D | Nd | νd | θgF | Material | ED |
|---|---|---|---|---|---|---|---|
| 29 | −24.2939 | 1.0002 | 1.90043 | 37.37 | 0.57668 | TAFD37A.HOYA | 21.32 |
| 30 | −68.4146 | 1.2171 | | | | | 21.64 |
| 31 | −35.8775 | 1.0002 | 1.76634 | 35.82 | 0.57931 | S-NBH59.OHARA | 21.62 |
| 32 | −70.0527 | 0.1001 | | | | | 22.05 |
| 33 | 69.3890 | 1.0001 | 1.51742 | 52.15 | 0.55896 | E-CF6.HOYA | 22.39 |
| 34 | 43.6292 | 1.0235 | | | | | 22.40 |
| 35 | 78.5312 | 1.0002 | 1.59410 | 60.47 | 0.55516 | FCD600.HOYA | 22.51 |
| 36 | 50.7472 | 1.3271 | | | | | 22.62 |
| 37 | 256.7418 | 5.7421 | 1.51742 | 52.15 | 0.55896 | E-CF6.HOYA | 22.74 |
| 38 | −21.2346 | 0.1001 | | | | | 23.21 |
| 39 | 79.0699 | 3.6126 | 1.59410 | 60.47 | 0.55516 | FCD600.HOYA | 21.77 |
| 40 | −47.4572 | 0.0102 | | | | | 21.25 |
| 41 | −50.4562 | 1.0000 | 1.77250 | 49.62 | 0.55038 | TAF1.HOYA | 21.17 |
| 42 | 6154.0253 | 9.2782 | | | | | 20.64 |
| 43 | −25.1413 | 1.7810 | 1.80610 | 33.27 | 0.58845 | NBFD15-W.HOYA | 17.20 |
| 44 | −18.8556 | 0.1001 | | | | | 17.32 |
| *45 | −201.1862 | 1.0002 | 1.69680 | 55.46 | 0.54260 | LAC14.HOYA | 15.81 |
| *46 | 21.3145 | 1.8522 | | | | | 15.05 |
| 47 | 32.5112 | 5.0098 | 1.62004 | 36.30 | 0.58729 | E-F2.HOYA | 14.91 |
| 48 | −12.5628 | 1.0002 | 1.85033 | 42.70 | 0.56458 | TAFD34.HOYA | 14.47 |
| 49 | 224.2421 | 10.3231 | | | | | 14.39 |
| 50 | ∞ | 1.0000 | 1.51680 | 64.20 | 0.53430 | BSC7.HOYA | 14.47 |
| 51 | ∞ | 6.7324 | | | | | 14.48 |
| 52 | −16.8337 | 1.0002 | 1.91082 | 35.25 | 0.58335 | TAFD35L.HOYA | 14.52 |
| 53 | 27.0568 | 4.5495 | 1.67270 | 32.17 | 0.59633 | E-FD5.HOYA | 16.28 |
| 54 | −29.9781 | 0.1002 | | | | | 17.53 |
| 55 | 51.5307 | 4.9054 | 1.51742 | 52.43 | 0.55649 | S-NSL36.OHARA | 19.00 |
| 56 | −22.9722 | 6.0482 | | | | | 19.50 |

TABLE 78
Example 28

| | Wide | Middle | Tele |
|---|---|---|---|
| Zr | 1.0 | 6.6 | 19.3 |
| f | 20.55 | 135.14 | 396.52 |
| Bf | 6.0482 | 6.0482 | 6.0482 |
| FNo. | 4.31 | 4.31 | 4.31 |
| 2ω [°] | 46.6 | 7.4 | 2.6 |
| DD[6] | 2.0002 | 85.5694 | 106.2427 |
| DD[12] | 11.6276 | 7.4631 | 5.0970 |
| DD[17] | 97.0995 | 9.6352 | 4.9725 |
| DD[20] | 12.9003 | 20.9599 | 7.3154 |

TABLE 79
Example 28

| Sn | 7 | 45 | 46 |
|---|---|---|---|
| KA | 1.0000000E+00 | 1.0000000E+00 | 1.0000000E+00 |
| A3 | 7.1484554E−06 | 8.3862472E−07 | 8.0207521E−07 |
| A4 | −8.3860204E−06 | 1.1795814E−05 | 3.5428165E−05 |
| A5 | 2.5702925E−06 | 9.9343572E−06 | 9.9721551E−06 |
| A6 | −5.0849120E−07 | 6.5002986E−07 | −4.1840658E−07 |
| A7 | 5.4709352E−08 | −9.4995236E−07 | −2.0823093E−07 |
| A8 | −3.3152229E−09 | −5.9725121E−09 | −2.6952116E−07 |
| A9 | 1.0816684E−10 | 1.6406245E−08 | 6.6703537E−08 |
| A10 | −1.1101361E−12 | 2.3150489E−09 | −4.1920449E−09 |
| A11 | −5.7113640E−17 | −6.1940814E−10 | 2.0768760E−10 |
| A12 | −1.0940617E−14 | 1.5280520E−11 | −7.4530158E−11 |
| A13 | 6.9152782E−16 | 1.1184564E−12 | 1.5032232E−12 |
| A14 | 2.6803228E−17 | 3.8392343E−13 | 1.6251672E−12 |
| A15 | −2.4522904E−18 | −3.6704784E−14 | −1.0554010E−13 |
| A16 | −3.5554000E−20 | −1.1008990E−15 | −9.9447222E−15 |
| A17 | 2.0930652E−21 | −1.2079283E−16 | −2.3845084E−16 |
| A18 | 2.9195168E−22 | 6.1934587E−17 | 3.1168382E−16 |
| A19 | −1.5898609E−23 | −4.9758282E−18 | −2.8567490E−17 |
| A20 | 2.2191470E−25 | 1.2834672E−19 | 8.1631305E−19 |

### Example 29

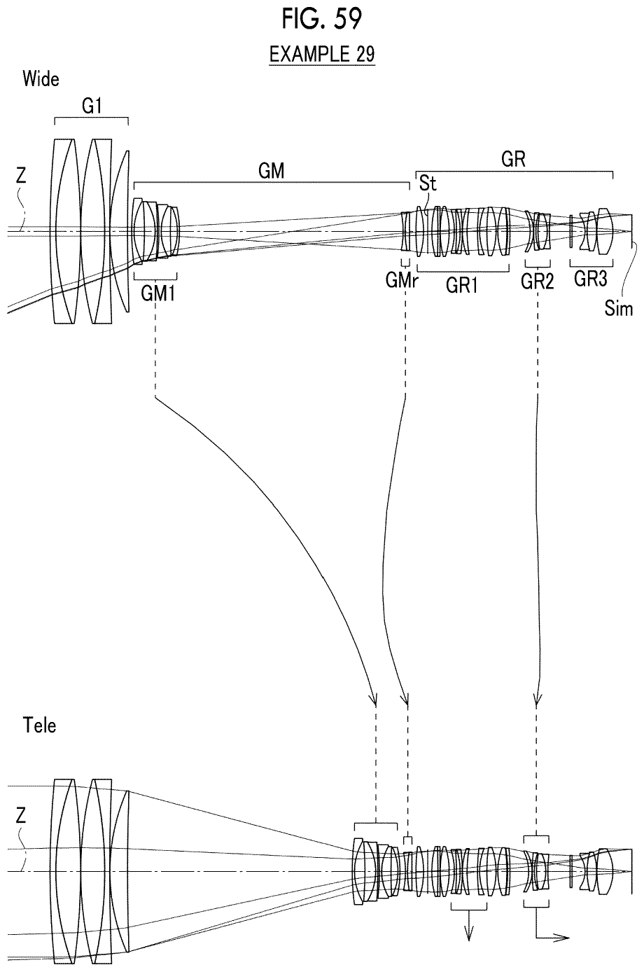

A configuration and a moving trajectory of a variable magnification optical system of Example 29 are shown in FIG. 59. The variable magnification optical system of Example 29 consists of, in order from the object side to the image side, the first lens group G1 having positive refractive power, the intermediate group GM, and the subsequent group GR. The intermediate group GM consists of, in order from the object side to the image side, two lens groups including the M1 lens group GM1 having negative refractive power and the Mr lens group GMr having negative refractive power. The subsequent group GR consists of, in order from the object side to the image side, three lens groups including the R1 lens group GR1 having positive refractive power, an R2 lens group GR2 having negative refractive power, and an R3 lens group GR3 having negative refractive power.

During changing the magnification from the wide angle end to the telephoto end, the first lens group G1, the R1 lens group GR1, and the R3 lens group GR3 remain stationary with respect to the image plane Sim, and other lens groups move along the optical axis Z by changing a spacing with respect to an adjacent lens group. The vibration-proof group consists of four lenses that are the fifth to eighth lenses in the R1 lens group GR1 from the object side. The focus group consists of the R2 lens group GR2. During focusing from the infinite distance object to the nearest object, the focus group moves to the image side.

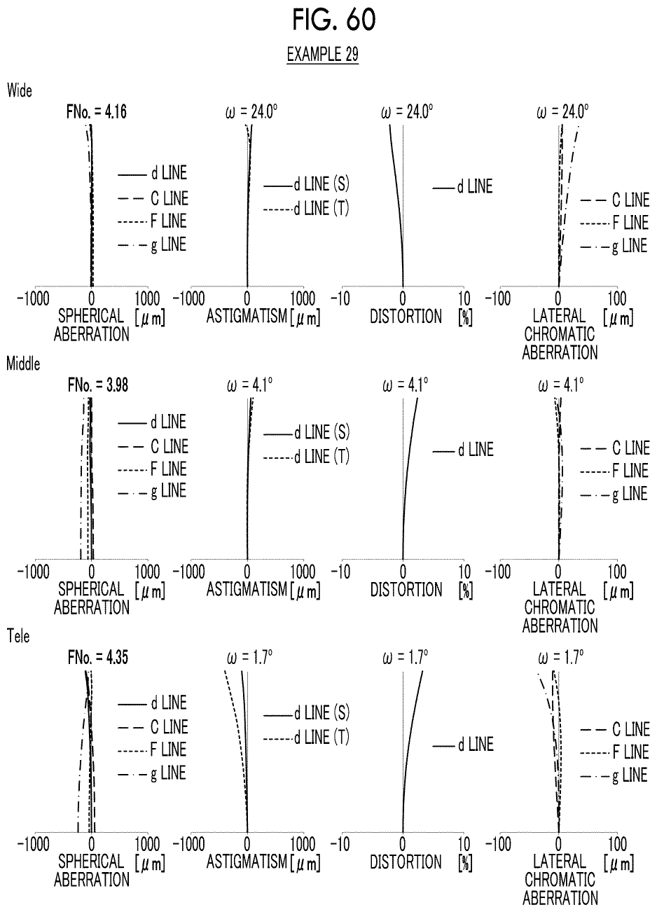

For the variable magnification optical system of Example 29, Tables 80A and 80B show basic lens data, Table 81 shows specifications and variable surface spacings, Table 82 shows aspherical coefficients, and FIG. 60 shows each aberration diagram.

TABLE 80A
Example 29

| Sn | R | D | Nd | νd | θgF | Material | ED |
|---|---|---|---|---|---|---|---|
| 1 | 528.3878 | 2.8200 | 1.54814 | 45.78 | 0.56859 | S-TIL1.OHARA | 96.00 |
| 2 | 151.4883 | 11.9384 | 1.49700 | 81.61 | 0.53887 | FCD1.HOYA | 94.25 |
| 3 | −379.8980 | 0.1000 | | | | | 93.95 |
| 4 | 206.0977 | 11.6281 | 1.49700 | 81.61 | 0.53887 | FCD1.HOYA | 90.45 |
| 5 | −239.7378 | 2.4001 | 1.83481 | 42.74 | 0.56490 | S-LAH55VS.OHARA | 89.40 |
| 6 | 1225.0537 | 0.1000 | | | | | 87.33 |
| 7 | 112.7422 | 8.5429 | 1.49700 | 81.61 | 0.53887 | FCD1.HOYA | 84.00 |
| 8 | 1325.2251 | DD[8] | | | | | 83.57 |
| 9 | 138.5853 | 1.1068 | 1.88100 | 40.14 | 0.57010 | TAFD33.HOYA | 34.50 |
| 10 | 33.4207 | 5.0499 | | | | | 31.35 |
| 11 | −186.3236 | 5.2027 | 1.85451 | 25.15 | 0.61031 | NBFD25.HOYA | 31.05 |
| 12 | −31.4162 | 1.0100 | 1.57144 | 71.61 | 0.54193 | FCD615.HOYA | 30.63 |
| 13 | −237.0013 | 0.7759 | | | | | 28.31 |
| 14 | −137.1391 | 1.1293 | 1.80518 | 25.46 | 0.61572 | FD60-W.HOYA | 27.85 |
| 15 | 27.9995 | 4.4416 | 1.92286 | 18.90 | 0.64960 | S-NPH2.OHARA | 25.95 |
| 16 | 239.7532 | 3.3874 | | | | | 25.29 |
| 17 | −31.5025 | 1.0000 | 2.00266 | 31.67 | 0.5851 | N200.Glass | 24.94 |
| 18 | −62.1393 | DD[18] | | | | | 25.20 |
| 19 | −52.1968 | 1.0100 | 1.83400 | 37.16 | 0.57759 | S-LAH60.OHARA | 19.00 |
| 20 | 58.5806 | 2.0916 | 1.92286 | 20.88 | 0.63900 | E-FDS1-W.HOYA | 19.87 |
| 21 | 2779.7416 | DD[21] | | | | | 20.23 |
| 22 | 115.7553 | 3.6740 | 1.49700 | 81.61 | 0.53887 | FCD1.HOYA | 23.10 |
| 23 | −46.5377 | 2.0000 | | | | | 23.29 |
| 24 (St) | ∞ | 2.0000 | | | | | 23.00 |
| 25 | 52.3656 | 2.9606 | 1.49700 | 81.61 | 0.53887 | FCD1.HOYA | 23.89 |
| 26 | −376.8893 | 1.0000 | 1.64769 | 33.84 | 0.59243 | E-FD2.HOYA | 23.91 |
| 27 | 4662.3135 | 0.1000 | | | | | 23.93 |
| 28 | 59.1836 | 4.3403 | 1.49700 | 81.61 | 0.53887 | FCD1.HOYA | 23.98 |
| 29 | −47.7336 | 2.5000 | | | | | 23.80 |

TABLE 80B
Example 29

| Sn | R | D | Nd | νd | θgF | Material | ED |
|---|---|---|---|---|---|---|---|
| 30 | −41.1904 | 1.0000 | 1.88100 | 40.14 | 0.57010 | TAFD33.HOYA | 22.73 |
| 31 | −169.1361 | 1.8274 | | | | | 22.83 |
| 32 | −38.5903 | 1.0000 | 1.72342 | 37.99 | 0.58202 | BAFD8.HOYA | 22.81 |
| 33 | −100.7012 | 0.1002 | | | | | 23.29 |
| 34 | 37.8108 | 2.2509 | 1.49700 | 81.61 | 0.53887 | FCD1.HOYA | 23.95 |
| 35 | 73.9844 | 5.0599 | | | | | 23.86 |
| 36 | 116.6497 | 1.0001 | 1.60738 | 56.71 | 0.54817 | BACD2.HOYA | 24.16 |
| 37 | 34.2822 | 3.4938 | | | | | 24.06 |
| 38 | 97.1488 | 4.4493 | 1.51742 | 52.15 | 0.55896 | E-CF6.HOYA | 24.95 |
| 39 | −39.5559 | 0.8781 | | | | | 25.23 |
| 40 | 38.3092 | 4.3570 | 1.59410 | 60.47 | 0.55516 | FCD600.HOYA | 24.86 |
| 41 | −104.8393 | 0.3467 | | | | | 24.39 |
| 42 | −85.5110 | 1.1499 | 1.94595 | 17.98 | 0.65460 | FDS18-W.HOYA | 24.27 |
| 43 | −161.5064 | DD[43] | | | | | 24.00 |
| *44 | −25.2745 | 1.6271 | 1.80610 | 33.27 | 0.58845 | NBFD15-W.HOYA | 21.01 |
| *45 | −21.9987 | 0.1343 | | | | | 21.29 |
| 46 | 113.4006 | 1.0000 | 1.69680 | 55.46 | 0.54260 | LAC14.HOYA | 19.45 |
| 47 | 30.3732 | 1.0509 | | | | | 18.65 |
| 48 | 48.7071 | 4.4860 | 1.61293 | 36.96 | 0.58507 | E-F3.HOYA | 18.54 |
| 49 | −23.0015 | 1.0000 | 1.83481 | 42.72 | 0.56477 | TAFD5G.HOYA | 18.04 |
| 50 | 82.7391 | DD[50] | | | | | 17.58 |
| 51 | ∞ | 1.0000 | 1.51680 | 64.20 | 0.53430 | BSC7.HOYA | 16.79 |
| 52 | ∞ | 6.2844 | | | | | 16.74 |
| 53 | −14.9911 | 1.0000 | 1.88100 | 40.14 | 0.57010 | TAFD33.HOYA | 16.44 |
| 54 | 40.0770 | 4.5929 | 1.64769 | 33.84 | 0.59243 | E-FD2.HOYA | 18.96 |
| 55 | −33.6390 | 0.1466 | | | | | 20.32 |
| 56 | 58.2035 | 7.7520 | 1.51742 | 52.15 | 0.55896 | E-CF6.HOYA | 22.53 |
| 57 | −24.8166 | 9.1613 | | | | | 23.75 |

TABLE 81
Example 29

| | Wide | Middle | Tele |
|---|---|---|---|
| Zr | 1.0 | 6.6 | 19.3 |
| f | 20.11 | 132.30 | 388.20 |
| Bf | 9.1613 | 9.1613 | 9.1613 |
| FNo. | 4.16 | 3.98 | 4.35 |
| 2ω [°] | 48.0 | 8.2 | 3.4 |
| DD[8] | 2.0002 | 87.3646 | 108.4591 |
| DD[18] | 107.9981 | 11.6200 | 2.6629 |
| DD[21] | 3.1051 | 14.1188 | 1.9814 |
| DD[43] | 9.7753 | 10.3017 | 9.0617 |
| DD[50] | 10.0000 | 9.4736 | 10.7136 |

TABLE 82
Example 29

| Sn | 44 | 45 |
|---|---|---|
| KA | 1.0000000E+00 | 1.0000000E+00 |
| A3 | 2.3319480E−05 | 2.0720076E−05 |
| A4 | −7.2013587E−05 | −6.1065260E−05 |
| A5 | 4.4581598E−05 | 4.0449002E−05 |
| A6 | −2.0213318E−05 | −1.8044651E−05 |
| A7 | 5.9938403E−06 | 5.3061850E−06 |
| A8 | −1.1293686E−06 | −9.9737657E−07 |
| A9 | 1.3244379E−07 | 1.1707644E−07 |
| A10 | −9.8293750E−09 | −8.7035795E−09 |
| A11 | 5.6418885E−10 | 4.9886009E−10 |
| A12 | −3.2797050E−11 | −2.8957634E−11 |
| A13 | 1.2953939E−12 | 1.1568655E−12 |
| A14 | −1.5470515E−13 | −1.3743147E−13 |
| A15 | 4.0675065E−14 | 3.5933808E−14 |
| A16 | −3.5424634E−15 | −3.1379699E−15 |
| A17 | −1.9211815E−17 | −1.6357219E−17 |
| A18 | 2.0149375E−17 | 1.7851803E−17 |
| A19 | −1.1496755E−18 | −1.0214860E−18 |
| A20 | 2.1284588E−20 | 1.8947279E−20 |

### Example 30

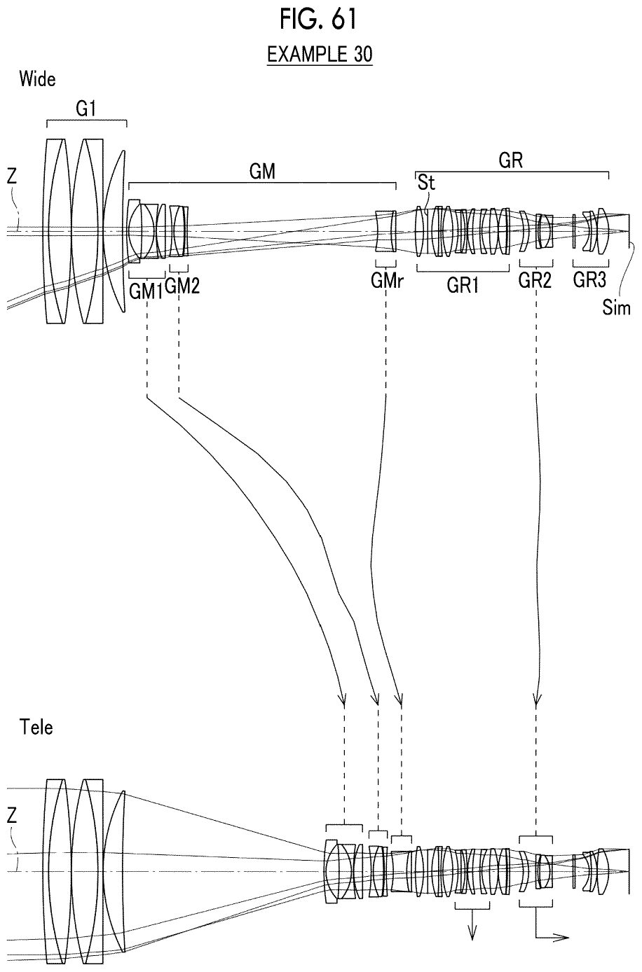

A configuration and a moving trajectory of a variable magnification optical system of Example 30 are shown in FIG. 61. The variable magnification optical system of Example 30 consists of, in order from the object side to the image side, the first lens group G1 having positive refractive power, the intermediate group GM, and the subsequent group GR. The intermediate group GM consists of, in order from the object side to the image side, three lens groups including the M1 lens group GM1 having negative refractive power, the M2 lens group GM2 having negative refractive power, and the Mr lens group GMr having negative refractive power. The M2 lens group GM2 having negative refractive power corresponds to the above M2n lens group. The subsequent group GR consists of, in order from the object side to the image side, three lens groups including the R1 lens group GR1 having positive refractive power, the R2 lens group GR2 having negative refractive power, and the R3 lens group GR3 having positive refractive power.

During changing the magnification from the wide angle end to the telephoto end, the first lens group G1, the R1 lens group GR1, and the R3 lens group GR3 remain stationary with respect to the image plane Sim, and other lens groups move along the optical axis Z by changing a spacing with respect to an adjacent lens group. The vibration-proof group consists of four lenses that are the fifth to eighth lenses in the R1 lens group GR1 from the object side. The focus group consists of the R2 lens group GR2. During focusing from the infinite distance object to the nearest object, the focus group moves to the image side.

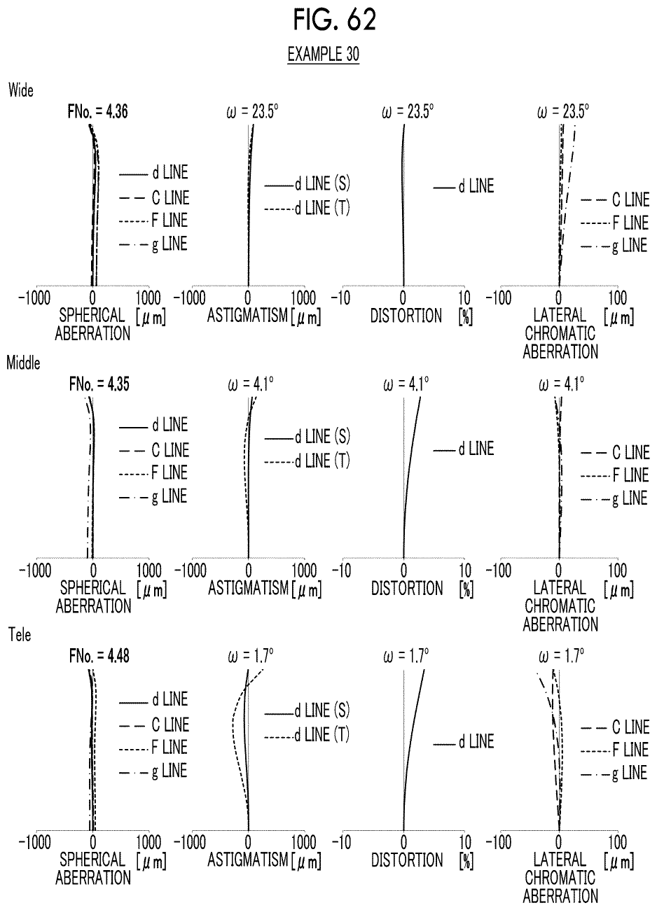

For the variable magnification optical system of Example 30, Tables 83A and 83B show basic lens data, Table 84 shows specifications and variable surface spacings, Table 85 shows aspherical coefficients, and FIG. 62 shows each aberration diagram.

TABLE 83A
Example 30

| Sn | R | D | Nd | νd | θgF | Material | ED |
|---|---|---|---|---|---|---|---|
| 1 | 582.2743 | 2.8201 | 1.61340 | 44.27 | 0.56340 | S-NBM51.OHARA | 96.00 |
| 2 | 173.6722 | 10.9377 | 1.49700 | 81.61 | 0.53887 | FCD1.HOYA | 94.53 |
| 3 | −371.3345 | 0.1000 | | | | | 94.29 |
| 4 | 202.1818 | 12.8650 | 1.49700 | 81.61 | 0.53887 | FCD1.HOYA | 91.03 |
| 5 | −194.6820 | 2.4000 | 1.79950 | 42.34 | 0.56498 | NBFD12.HOYA | 90.03 |
| 6 | −20272.6734 | 0.1000 | | | | | 88.14 |
| 7 | 98.0940 | 9.3664 | 1.49700 | 81.61 | 0.53887 | FCD1.HOYA | 84.00 |
| 8 | 765.9863 | DD[8] | | | | | 83.51 |
| 9 | 125.7529 | 1.0001 | 1.77047 | 29.74 | 0.59514 | NBFD29.HOYA | 32.96 |
| 10 | 21.5907 | 6.3323 | | | | | 28.46 |
| 11 | −188.1983 | 5.9587 | 1.85896 | 22.73 | 0.62844 | S-NPH5.OHARA | 28.33 |
| 12 | −23.3574 | 1.0100 | 1.85033 | 42.70 | 0.56458 | TAFD34.HOYA | 28.19 |
| 13 | 100.0319 | 0.0999 | | | | | 27.85 |
| 14 | 37.1849 | 4.2655 | 1.61293 | 36.96 | 0.58507 | E-F3.HOYA | 28.16 |
| 15 | −7306.0596 | DD[15] | | | | | 27.86 |
| 16 | −81.6501 | 1.0100 | 1.72916 | 54.54 | 0.54535 | TAC8P.HOYA | 26.47 |
| 17 | 33.7933 | 4.9569 | 1.90366 | 31.34 | 0.59636 | S-LAH95.OHARA | 26.04 |
| 18 | −109.1172 | 0.3912 | | | | | 25.79 |
| 19 | −113.9162 | 0.9999 | 1.92286 | 20.88 | 0.63900 | E-FDS1-W.HOYA | 25.55 |
| 20 | 177.3783 | DD[20] | | | | | 25.20 |
| 21 | −48.9855 | 6.5281 | 1.83400 | 37.34 | 0.57908 | NBFD10.HOYA | 19.00 |
| 22 | 50.3803 | 2.2203 | 1.92286 | 20.88 | 0.63900 | E-FDS1-W.HOYA | 21.00 |
| 23 | 545.5000 | DD[23] | | | | | 21.25 |
| 24 | 88.9335 | 3.9579 | 1.49700 | 81.61 | 0.53887 | FCD1.HOYA | 23.38 |
| 25 | −47.1833 | 2.0000 | | | | | 23.51 |
| 26 (St) | ∞ | 2.0000 | | | | | 23.00 |
| 27 | 42.6461 | 3.3531 | 1.49700 | 81.61 | 0.53887 | FCD1.HOYA | 23.90 |
| 28 | −359.0358 | 1.0807 | 1.56883 | 56.36 | 0.54890 | S-BAL14.OHARA | 23.85 |
| 29 | 131.5658 | 0.8943 | | | | | 23.80 |
| 30 | 42.7378 | 4.8395 | 1.49700 | 81.61 | 0.53887 | FCD1.HOYA | 23.91 |
| 31 | −50.0121 | 2.5491 | | | | | 23.64 |

TABLE 83B
Example 30

| Sn | R | D | Nd | νd | θgF | Material | ED |
|---|---|---|---|---|---|---|---|
| 32 | −44.3853 | 1.4998 | 1.88100 | 40.14 | 0.57010 | TAFD33.HOYA | 22.38 |
| 33 | −276.9652 | 1.8816 | | | | | 22.36 |
| 34 | −40.6181 | 0.9998 | 1.72342 | 37.99 | 0.58202 | BAFD8.HOYA | 22.31 |
| 35 | −120.3365 | 0.2689 | | | | | 22.70 |
| 36 | 32.5318 | 2.4065 | 1.49700 | 81.61 | 0.53887 | FCD1.HOYA | 23.26 |
| 37 | 64.1984 | 3.5005 | | | | | 23.10 |
| 38 | 84.4040 | 1.0002 | 1.60738 | 56.71 | 0.54817 | BACD2.HOYA | 23.06 |
| 39 | 28.2573 | 3.7021 | | | | | 22.77 |
| 40 | 97.4362 | 4.1410 | 1.51742 | 52.15 | 0.55896 | E-CF6.HOYA | 23.54 |
| 41 | −41.2662 | 0.1000 | | | | | 23.80 |
| 42 | 35.8831 | 3.9606 | 1.59410 | 60.47 | 0.55516 | FCD600.HOYA | 23.54 |
| 43 | −199.1172 | 0.4302 | | | | | 23.05 |
| 44 | −101.9230 | 1.0991 | 1.94595 | 17.98 | 0.65460 | FDS18-W.HOYA | 22.99 |
| 45 | −317.6434 | DD[45] | | | | | 22.74 |
| *46 | −29.1171 | 2.6332 | 1.80610 | 33.27 | 0.58845 | NBFD15-W.HOYA | 20.73 |
| *47 | −25.2529 | 3.4190 | | | | | 21.00 |
| 48 | 398.9558 | 0.9999 | 1.69680 | 55.46 | 0.54260 | LAC14.HOYA | 17.80 |
| 49 | 27.3595 | 0.8887 | | | | | 17.03 |
| 50 | 48.9866 | 5.0101 | 1.62004 | 36.26 | 0.58800 | S-TIM2.OHARA | 17.00 |
| 51 | −15.0932 | 1.0000 | 1.85033 | 42.70 | 0.56458 | TAFD34.HOYA | 16.63 |
| 52 | 144.2970 | DD[52] | | | | | 16.58 |
| 53 | ∞ | 1.0000 | 1.51680 | 64.20 | 0.53430 | BSC7.HOYA | 17.32 |
| 54 | ∞ | 6.8865 | | | | | 17.37 |
| 55 | −14.1600 | 1.0000 | 1.83481 | 42.74 | 0.56490 | S-LAH55VS.OHARA | 17.65 |
| 56 | −75.1849 | 2.7308 | 1.67300 | 38.26 | 0.57580 | S-NBH52V.OHARA | 20.10 |
| 57 | −25.9208 | 0.1000 | | | | | 20.99 |
| 58 | 80.2227 | 5.5955 | 1.51742 | 52.15 | 0.55896 | E-CF6.HOYA | 23.15 |
| 59 | −25.4229 | 9.9070 | | | | | 23.73 |

TABLE 84
Example 30

| | Wide | Middle | Tele |
|---|---|---|---|
| Zr | 1.0 | 6.6 | 19.3 |
| f | 20.11 | 132.29 | 388.14 |
| Bf | 9.9070 | 9.9070 | 9.9070 |
| FNo. | 4.36 | 4.35 | 4.48 |
| 2ω [°] | 47.0 | 8.2 | 3.4 |
| DD[8] | 2.0002 | 79.3651 | 97.2505 |
| DD[15] | 3.2478 | 3.0490 | 4.2053 |
| DD[20] | 91.9836 | 8.7185 | 3.3508 |
| DD[23] | 9.4966 | 15.5956 | 1.9217 |
| DD[45] | 6.7228 | 7.1617 | 6.5663 |
| DD[52] | 10.0002 | 9.5613 | 10.1567 |

TABLE 85
Example 30

| Sn | 46 | 47 |
|---|---|---|
| KA | 1.0000000E+00 | 1.0000000E+00 |
| A3 | −6.9945512E−06 | −6.1543830E−06 |
| A4 | 1.3224921E−05 | 1.1885126E−05 |
| A5 | −1.3408861E−05 | −1.2202541E−05 |
| A6 | 6.3128743E−06 | 5.5409077E−06 |
| A7 | −1.7621329E−06 | −1.4902716E−06 |
| A8 | 3.2005932E−07 | 2.6601572E−07 |
| A9 | −3.7572972E−08 | −3.1398638E−08 |
| A10 | 2.8510124E−09 | 2.4111771E−09 |
| A11 | −1.6288279E−10 | −1.3568460E−10 |
| A12 | 9.1875490E−12 | 7.5470452E−12 |
| A13 | −4.0021938E−13 | −3.5747114E−13 |
| A14 | 4.7204725E−14 | 4.0095298E−14 |
| A15 | −1.1569105E−14 | −9.5630559E−15 |
| A16 | 1.0218851E−15 | 8.7138818E−16 |
| A17 | 4.0442995E−18 | 1.9548848E−18 |
| A18 | −5.8318856E−18 | −5.0094407E−18 |
| A19 | 3.3948367E−19 | 2.9835034E−19 |
| A20 | −6.3625113E−21 | −5.6691102E−21 |

### Example 31

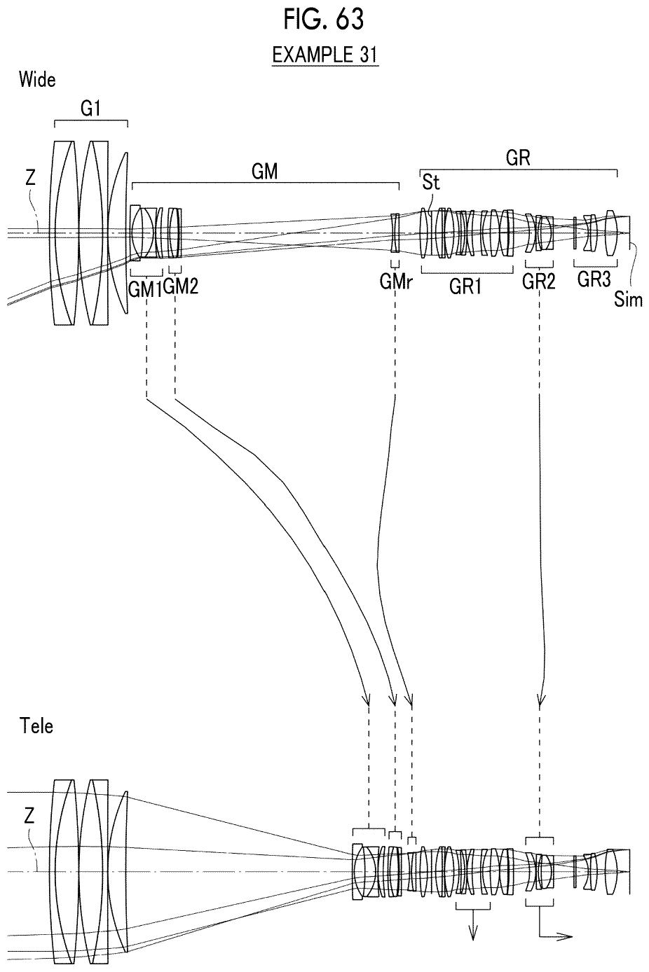

A configuration and a moving trajectory of a variable magnification optical system of Example 31 are shown in FIG. 63. The variable magnification optical system of Example 31 consists of, in order from the object side to the image side, the first lens group G1 having positive refractive power, the intermediate group GM, and the subsequent group GR. The intermediate group GM consists of, in order from the object side to the image side, three lens groups including the M1 lens group GM1 having negative refractive power, the M2 lens group GM2 having positive refractive power, and the Mr lens group GMr having negative refractive power. The M2 lens group GM2 having positive refractive power corresponds to the above M2p lens group. The subsequent group GR consists of, in order from the object side to the image side, three lens groups including the R1 lens group GR1 having positive refractive power, the R2 lens group GR2 having negative refractive power, and the R3 lens group GR3 having negative refractive power.

During changing the magnification from the wide angle end to the telephoto end, the first lens group G1, the R1 lens group GR1, and the R3 lens group GR3 remain stationary with respect to the image plane Sim, and other lens groups move along the optical axis Z by changing a spacing with respect to an adjacent lens group. The vibration-proof group consists of four lenses that are the fifth to eighth lenses in the R1 lens group GR1 from the object side. The focus group consists of the R2 lens group GR2. During focusing from the infinite distance object to the nearest object, the focus group moves to the image side.

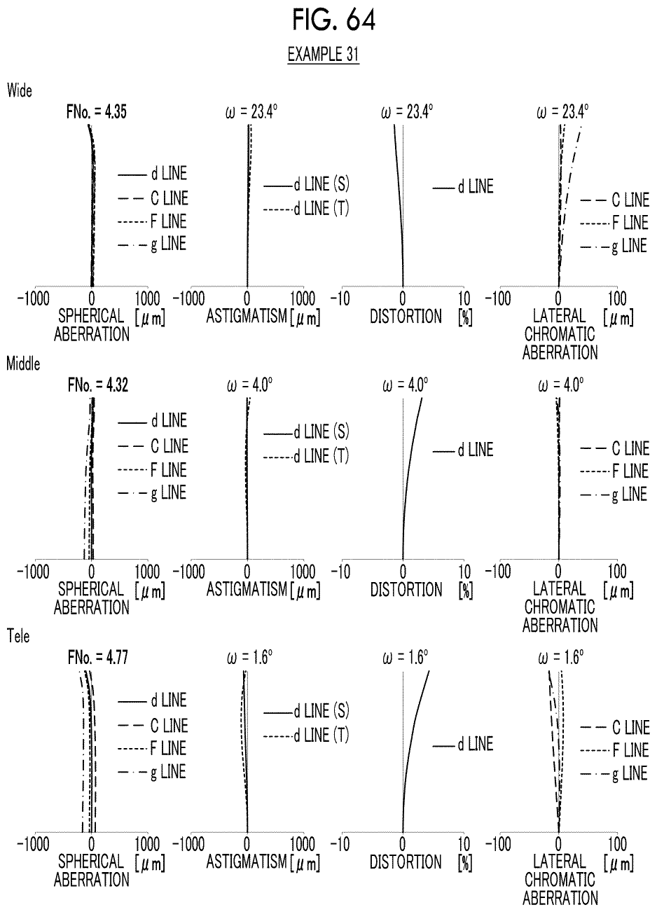

For the variable magnification optical system of Example 31, Tables 86A and 86B show basic lens data, Table 87 shows specifications and variable surface spacings, Table 88 shows aspherical coefficients, and FIG. 64 shows each aberration diagram.

TABLE 86A
Example 31

| Sn | R | D | Nd | νd | θgF | Material | ED |
|---|---|---|---|---|---|---|---|
| 1 | 464.2276 | 2.8200 | 1.62205 | 41.08 | 0.56917 | S-NBM52.OHARA | 95.25 |
| 2 | 147.8831 | 11.4196 | 1.49700 | 81.61 | 0.53887 | FCD1.HOYA | 93.51 |
| 3 | −496.5093 | 0.1000 | | | | | 93.21 |
| 4 | 212.7462 | 11.5053 | 1.49700 | 81.61 | 0.53887 | FCD1.HOYA | 90.54 |
| 5 | −236.8488 | 2.4001 | 1.80420 | 46.50 | 0.55727 | TAF3D.HOYA | 89.61 |
| 6 | 7854.7681 | 0.1000 | | | | | 87.89 |
| 7 | 107.6184 | 8.7189 | 1.49700 | 81.61 | 0.53887 | FCD1.HOYA | 84.00 |
| 8 | 981.1516 | DD[8] | | | | | 83.55 |
| 9 | 358.1668 | 1.0000 | 1.80610 | 33.27 | 0.58845 | NBFD15-W.HOYA | 29.12 |
| 10 | 23.4496 | 5.1838 | | | | | 25.96 |
| 11 | −100.4978 | 5.2083 | 1.85896 | 22.73 | 0.62844 | S-NPH5.OHARA | 25.86 |
| 12 | −21.5687 | 1.0000 | 1.88100 | 40.14 | 0.57010 | TAFD33.HOYA | 25.86 |
| 13 | 136.4884 | 0.1002 | | | | | 25.98 |
| 14 | 42.7369 | 2.5369 | 1.63980 | 34.57 | 0.59174 | E-FD7.HOYA | 26.30 |
| 15 | 103.2560 | DD[15] | | | | | 26.14 |
| 16 | 153.7759 | 1.0101 | 1.65100 | 56.24 | 0.54210 | S-LAL54Q.OHARA | 26.00 |
| 17 | 46.9757 | 4.0630 | 1.85451 | 25.15 | 0.61031 | NBFD25.HOYA | 25.79 |
| 18 | −109.2738 | 0.4673 | | | | | 25.56 |
| 19 | −110.2249 | 1.0000 | 2.30909 | 17.89 | 0.6452 | N231.Glass | 25.32 |
| 20 | −4702.1372 | DD[20] | | | | | 25.20 |
| 21 | −54.9634 | 1.0100 | 1.83400 | 37.34 | 0.57908 | NBFD10.HOYA | 19.00 |
| 22 | 59.2837 | 2.0791 | 1.92286 | 20.88 | 0.63900 | E-FDS1-W.HOYA | 19.84 |
| 23 | 2518.7174 | DD[23] | | | | | 20.19 |
| 24 | 97.5215 | 3.5969 | 1.49700 | 81.61 | 0.53887 | FCD1.HOYA | 23.39 |
| 25 | −52.4255 | 2.0000 | | | | | 23.48 |
| 26 (St) | ∞ | 2.0000 | | | | | 23.00 |
| 27 | 45.0997 | 3.2338 | 1.49700 | 81.61 | 0.53887 | FCD1.HOYA | 23.92 |
| 28 | −369.2984 | 1.0100 | 1.58913 | 61.13 | 0.54067 | S-BAL35.OHARA | 23.89 |
| 29 | 227.2404 | 0.1000 | | | | | 23.88 |
| 30 | 51.6486 | 4.4963 | 1.49700 | 81.61 | 0.53887 | FCD1.HOYA | 23.93 |
| 31 | −49.4416 | 2.5000 | | | | | 23.71 |

TABLE 86B
Example 31

| Sn | R | D | Nd | νd | θgF | Material | ED |
|---|---|---|---|---|---|---|---|
| 32 | −43.5537 | 1.0000 | 1.88100 | 40.14 | 0.57010 | TAFD33.HOYA | 22.58 |
| 33 | −195.4322 | 1.8002 | | | | | 22.63 |
| 34 | −40.8363 | 1.0001 | 1.72342 | 37.99 | 0.58202 | BAFD8.HOYA | 22.59 |
| 35 | −100.8722 | 0.1000 | | | | | 22.98 |
| 36 | 34.9199 | 2.4260 | 1.49700 | 81.61 | 0.53887 | FCD1.HOYA | 23.49 |
| 37 | 71.2065 | 4.1476 | | | | | 23.33 |
| 38 | 94.4370 | 1.0000 | 1.60738 | 56.71 | 0.54817 | BACD2.HOYA | 23.29 |
| 39 | 29.6870 | 3.6833 | | | | | 23.03 |
| 40 | 97.2230 | 4.4527 | 1.51742 | 52.15 | 0.55896 | E-CF6.HOYA | 23.81 |
| 41 | −37.9399 | 0.1391 | | | | | 24.08 |
| 42 | 39.0366 | 4.0318 | 1.59410 | 60.47 | 0.55516 | FCD600.HOYA | 23.64 |
| 43 | −136.5472 | 0.4611 | | | | | 23.12 |
| 44 | −89.7457 | 2.2158 | 1.94595 | 17.98 | 0.65460 | FDS18-W.HOYA | 22.99 |
| 45 | −241.6177 | DD[45] | | | | | 22.53 |
| *46 | −27.5353 | 3.0097 | 1.80610 | 33.27 | 0.58845 | NBFD15-W.HOYA | 19.65 |
| *47 | −22.2642 | 0.2397 | | | | | 19.97 |
| 48 | 596.8733 | 1.0000 | 1.69680 | 55.46 | 0.54260 | LAC14.HOYA | 18.29 |
| 49 | 25.9137 | 1.3846 | | | | | 17.37 |
| 50 | 62.7654 | 5.0100 | 1.62004 | 36.26 | 0.58800 | S-TIM2.OHARA | 17.30 |
| 51 | −15.6865 | 1.0000 | 1.85033 | 42.70 | 0.56458 | TAFD34.HOYA | 16.92 |
| 52 | −935.6861 | DD[52] | | | | | 16.89 |
| 53 | ∞ | 1.0000 | 1.51680 | 64.20 | 0.53430 | BSC7.HOYA | 16.59 |
| 54 | ∞ | 5.9953 | | | | | 16.57 |
| 55 | −16.4572 | 1.0000 | 1.83481 | 42.74 | 0.56490 | S-LAH55VS.OHARA | 16.45 |
| 56 | 80.2339 | 3.3086 | 1.67300 | 38.26 | 0.57580 | S-NBH52V.OHARA | 18.28 |
| 57 | −38.1389 | 3.8425 | | | | | 19.16 |
| 58 | 59.7870 | 5.8574 | 1.51742 | 52.15 | 0.55896 | E-CF6.HOYA | 22.86 |
| 59 | −32.7459 | 6.0701 | | | | | 23.47 |

TABLE 87
Example 31

| | Wide | Middle | Tele |
|---|---|---|---|
| Zr | 1.0 | 6.6 | 19.3 |
| f | 20.54 | 135.08 | 396.35 |
| Bf | 6.0701 | 6.0701 | 6.0701 |
| FNo. | 4.35 | 4.32 | 4.77 |
| 2ω [°] | 46.8 | 8.0 | 3.2 |
| DD[8] | 2.0000 | 89.0537 | 109.5818 |
| DD[15] | 3.3383 | 2.2913 | 2.2724 |
| DD[20] | 102.3293 | 8.9167 | 3.9733 |
| DD[23] | 10.1390 | 17.5449 | 1.9792 |
| DD[45] | 7.6315 | 8.9540 | 7.7686 |
| DD[52] | 10.0000 | 8.6775 | 9.8629 |

TABLE 88
Example 31

| Sn | 46 | 47 |
|---|---|---|
| KA | 1.0000000E+00 | 1.0000000E+00 |
| A3 | −1.4786838E−06 | −2.1096355E−06 |
| A4 | −8.7778917E−06 | −1.5254514E−06 |
| A5 | −1.6860205E−06 | −2.9674826E−06 |
| A6 | 1.2761953E−06 | 1.6591577E−06 |
| A7 | −1.8624472E−07 | −2.1889236E−07 |
| A8 | −2.3514425E−08 | −3.3099855E−08 |
| A9 | 1.1262019E−08 | 1.4743967E−08 |
| A10 | −1.5403314E−09 | −2.0615533E−09 |
| A11 | 8.3520800E−11 | 1.1960062E−10 |
| A12 | 1.7678148E−12 | 2.1267329E−12 |
| A13 | −3.5174353E−13 | −5.2028878E−13 |
| A14 | −2.5194421E−15 | −6.4812240E−15 |
| A15 | 1.5287581E−16 | 9.9927209E−16 |
| A16 | 4.8944783E−17 | 6.8586359E−17 |
| A17 | 3.6861057E−17 | 4.6278524E−17 |
| A18 | −6.2505694E−18 | −8.5312653E−18 |
| A19 | 3.5995804E−19 | 5.0755063E−19 |
| A20 | −7.2932552E−21 | −1.0456475E−20 |

### Example 32

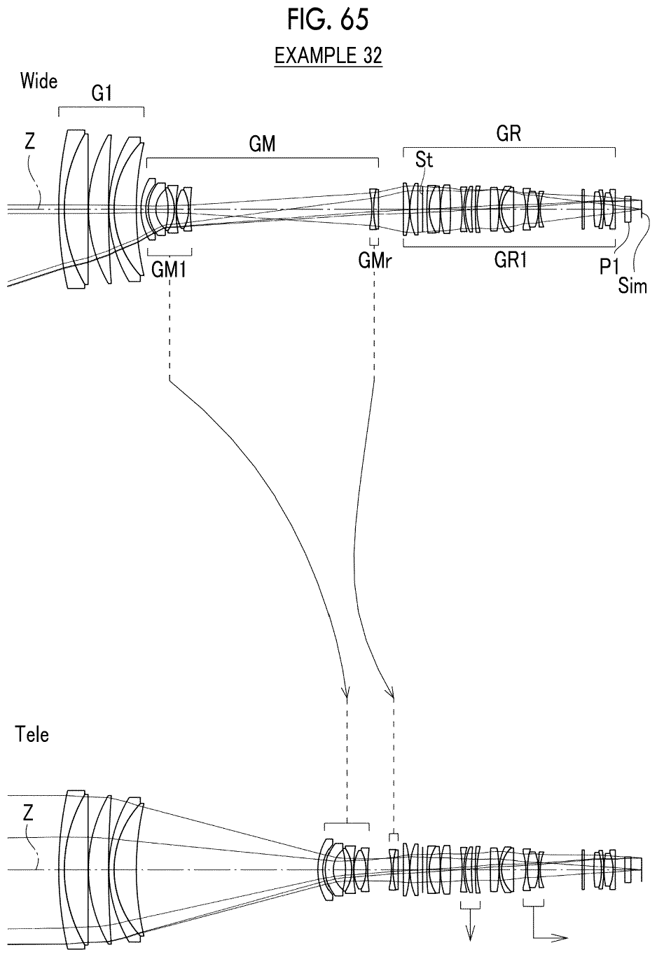

A configuration and a moving trajectory of a variable magnification optical system of Example 32 are shown in FIG. 65. The variable magnification optical system of Example 32 consists of, in order from the object side to the image side, the first lens group G1 having positive refractive power, the intermediate group GM, and the subsequent group GR. The intermediate group GM consists of, in order from the object side to the image side, two lens groups including the M1 lens group GM1 having negative refractive power and the Mr lens group GMr having negative refractive power. The subsequent group GR consists of one lens group that is the R1 lens group GR1 having positive refractive power. FIG. 65 shows an example in which an optical member P1 is disposed between the subsequent group GR and the image plane Sim. The optical member P1 is a parallel flat plate-shaped member not having refractive power, such as various filters and/or a cover glass.

During changing the magnification from the wide angle end to the telephoto end, the first lens group G1 and the R1 lens group GR1 remain stationary with respect to the image plane Sim, and other lens groups move along the optical axis Z by changing a spacing with respect to an adjacent lens group. The vibration-proof group consists of three lenses that are the sixth to eighth lenses in the R1 lens group GR1 from the object side. The focus group consists of three lenses that are the twelfth to fourteenth lenses in the R1 lens group GR1 from the object side. During focusing from the infinite distance object to the nearest object, the focus group moves to the image side.

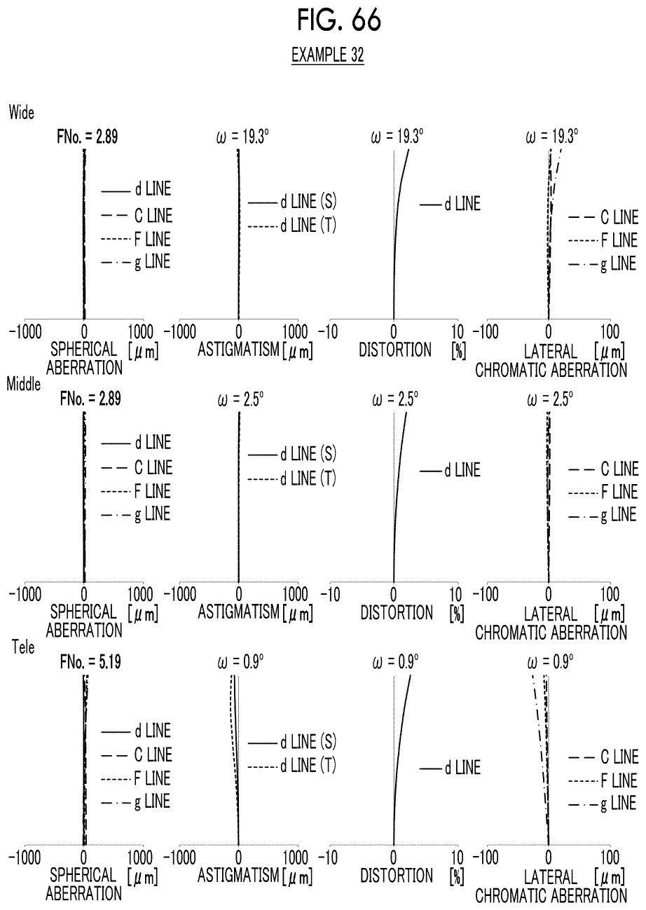

For the variable magnification optical system of Example 32, Tables 89A and 89B show basic lens data, Table 90 shows specifications and variable surface spacings, and FIG. 66 shows each aberration diagram.

TABLE 89A
Example 32

| Sn | R | D | Nd | νd | θgF | Material | ED |
|---|---|---|---|---|---|---|---|
| 1 | 194.4970 | 2.6000 | 1.69680 | 55.53 | 0.54420 | H-LAK51A.CDGM | 75.00 |
| 2 | 80.2579 | 11.1100 | 1.49700 | 81.55 | 0.53837 | H-FK61.NHG | 73.82 |
| 3 | ∞ | 0.2000 | | | | | 73.75 |
| 4 | 80.2621 | 9.4000 | 1.49700 | 81.55 | 0.53837 | H-FK61.NHG | 73.29 |
| 5 | 546.7212 | 0.2000 | | | | | 72.66 |
| 6 | 75.3383 | 2.4000 | 1.83481 | 42.72 | 0.56434 | H-ZLAF55D.CDGM | 69.10 |
| 7 | 51.6908 | 10.3900 | 1.43875 | 94.66 | 0.53402 | S-FPL55.OHARA | 65.08 |
| 8 | 157.4387 | DD[8] | | | | | 64.00 |
| 9 | 32.7896 | 2.2700 | 1.53775 | 74.70 | 0.53936 | S-FPM3.OHARA | 28.04 |
| 10 | 20.3396 | 1.2200 | | | | | 24.34 |
| 11 | 21.9771 | 3.4900 | 1.75500 | 52.35 | 0.54815 | H-LAK53B.NHG | 23.69 |
| 12 | 13.4807 | 5.7300 | | | | | 19.17 |
| 13 | −43.1844 | 2.9500 | 1.89286 | 20.36 | 0.63944 | S-NPH4.OHARA | 18.76 |
| 14 | −20.7891 | 0.8200 | 1.84850 | 43.79 | 0.56197 | J-LASFH22.HIKARI | 18.62 |
| 15 | 80.1918 | 0.2000 | | | | | 18.25 |
| 16 | 22.3660 | 5.6600 | 1.63980 | 34.46 | 0.59245 | H-F51.CDGM | 18.25 |
| 17 | −22.3660 | 0.8000 | 1.90043 | 37.37 | 0.57668 | TAFD37A.HOYA | 17.60 |
| 18 | 94.7010 | DD[18] | | | | | 17.10 |
| 19 | −40.6367 | 0.8200 | 1.84850 | 43.79 | 0.56197 | J-LASFH22.HIKARI | 16.70 |
| 20 | 43.0029 | 2.3200 | 1.92119 | 23.96 | 0.61848 | H-ZLAF79.NHG | 17.35 |
| 21 | ∞ | DD[21] | | | | | 17.68 |
| 22 | ∞ | 2.9000 | 1.80100 | 34.97 | 0.58772 | H-ZLAF66.CDGM | 23.71 |
| 23 | −54.9581 | 0.2000 | | | | | 24.03 |
| 24 | 36.7160 | 3.6100 | 1.49700 | 81.55 | 0.53837 | H-FK61.NHG | 24.05 |
| 25 | 413.1305 | 2.3000 | | | | | 23.66 |
| 26 (St) | ∞ | 2.0000 | | | | | 23.00 |
| 27 | 148.1435 | 1.1000 | 1.85896 | 22.73 | 0.62844 | S-NPH5.OHARA | 22.57 |
| 28 | 24.2750 | 5.1100 | 1.49700 | 81.60 | 0.53774 | H-FK61B.CDGM | 21.97 |
| 29 | −167.6094 | 0.2000 | | | | | 22.00 |
| 30 | 46.7552 | 4.6900 | 1.49700 | 81.60 | 0.53774 | H-FK61B.CDGM | 21.95 |
| 31 | −209.9516 | 5.4300 | | | | | 21.40 |

TABLE 89B
Example 32

| Sn | R | D | Nd | νd | θgF | Material | ED |
|---|---|---|---|---|---|---|---|
| 32 | −75.2776 | 0.8100 | 1.79952 | 42.25 | 0.56779 | H-LAF54.CDGM | 19.95 |
| 33 | 45.0905 | 0.6900 | | | | | 19.75 |
| 34 | 32.9086 | 2.9000 | 1.84666 | 23.78 | 0.62076 | H-ZF52.CDGM | 20.00 |
| 35 | 137.2769 | 1.8000 | | | | | 19.87 |
| 36 | 196.3802 | 0.8100 | 1.80400 | 46.57 | 0.55756 | H-ZLAF50E.CDGM | 19.84 |
| 37 | 47.0384 | 6.2000 | | | | | 19.75 |
| 38 | 322.5426 | 4.0000 | 1.90366 | 31.31 | 0.59481 | TAFD25.HOYA | 19.91 |
| 39 | −71.8560 | 0.2000 | | | | | 20.00 |
| 40 | 26.7441 | 1.0800 | 1.85883 | 30.00 | 0.59793 | NBFD30.HOYA | 20.18 |
| 41 | 15.8683 | 5.6400 | 1.61800 | 63.36 | 0.53931 | H-PK62A.NHG | 19.37 |
| 42 | ∞ | 5.6900 | | | | | 18.97 |
| 43 | −31.9430 | 0.7700 | 1.77250 | 49.60 | 0.55165 | H-LAF50B.CDGM | 16.58 |
| 44 | 39.9755 | 5.1100 | 1.67270 | 32.17 | 0.59825 | H-ZF2.CDGM | 16.65 |
| 45 | −27.7176 | 0.2000 | | | | | 16.80 |
| 46 | 196.0002 | 0.7000 | 1.49700 | 81.60 | 0.53774 | H-FK61B.CDGM | 16.25 |
| 47 | 25.2567 | 19.6000 | | | | | 15.80 |
| 48 | ∞ | 1.0000 | 1.51633 | 64.14 | 0.53531 | S-BSL7.OHARA | 15.02 |
| 49 | ∞ | 4.5000 | | | | | 15.01 |
| 50 | 75.9621 | 3.6100 | 1.65160 | 58.40 | 0.54123 | H-LAK50A.CDGM | 14.92 |
| 51 | −32.9824 | 0.9900 | 1.85896 | 22.73 | 0.62844 | S-NPH5.OHARA | 14.71 |
| 52 | −78.8485 | 0.2000 | | | | | 14.67 |
| 53 | 49.0504 | 4.2100 | 1.55200 | 70.70 | 0.54219 | S-FPM5.OHARA | 14.44 |
| 54 | −24.2750 | 1.0000 | 1.90069 | 37.05 | 0.57804 | H-ZLAF78B.CDGM | 13.80 |
| 55 | 832.6487 | 4.5000 | | | | | 13.63 |
| 56 | ∞ | 2.8500 | 1.51633 | 64.14 | 0.53531 | S-BSL7.OHARA | |
| 57 | ∞ | 5.0273 | | | | | |

TABLE 90
Example 32

| | Wide | Middle | Tele |
|---|---|---|---|
| Zr | 1.0 | 8.9 | 31.0 |
| f | 12.53 | 111.53 | 388.99 |
| Bf | 11.4068 | 11.4068 | 11.4068 |
| FNo. | 2.89 | 2.89 | 5.19 |
| 2ω [°] | 38.6 | 5.0 | 1.8 |
| DD[8] | 2.2000 | 71.5387 | 85.0713 |
| DD[18] | 84.7700 | 6.2266 | 11.0507 |
| DD[21] | 11.6300 | 20.8347 | 2.4780 |

Tables 91 to 97 show the corresponding values of Conditional Expressions (1) to (11) and (15) to (21) of the variable magnification optical systems of Examples 1 to 32. Table 98 shows the corresponding values of Conditional Expressions (12) to (14) for “N231.Glass”, “N216.Glass”, and “N200.Glass” used in the above examples. Preferable ranges of the conditional expressions may be set using the corresponding values of the examples shown in Tables 91 to 98 as the upper limit values and the lower limit values of the conditional expressions.

TABLE 91

| Expression | | | | | | |
|---|---|---|---|---|---|---|
| Number | | Example 1 | Example 2 | Example 3 | Example 4 | Example 5 |
| (1) | (−fM1)/f1 | 0.1811 | 0.1562 | 0.1534 | 0.1584 | 0.1549 |
| (2) | fR1/f1 | 0.2489 | 0.2190 | 0.2851 | 0.2121 | 0.2013 |
| (3) | fMr/fM1 | 2.1487 | 2.7423 | 2.7508 | 2.8619 | 2.8082 |
| (4) | DG1/Dsum | 0.1572 | 0.1376 | 0.1399 | 0.1323 | 0.1340 |
| (5) | fw/f1 | 0.1375 | 0.1517 | 0.1542 | 0.1509 | 0.1533 |
| (6) | fw/fM1 | −0.7590 | −0.9714 | −1.0053 | −0.9531 | −0.9894 |
| (7) | fw/fR1 | 0.5523 | 0.6927 | 0.5409 | 0.7116 | 0.7615 |
| (8) | f1/(fw × ft)^{1/2} | 1.9519 | 1.8359 | 1.7835 | 1.8303 | 1.7953 |
| (9) | ft/fw | 19.2957 | 19.2975 | 19.3046 | 19.3009 | 19.2989 |
| (10) | fw/\|fois\| | 0.7706 | 0.7254 | 0.6745 | 0.3378 | 0.3222 |
| (11) | (fw × tan ωw)/(ft × tan ωt) | 0.7412 | 0.7913 | 0.7948 | 0.7912 | 0.7912 |
| (15) | EDL/(2 × ft × tan ωt) | — | — | — | — | — |
| (16) | ν1pave | 81.61 | 81.54 | 81.54 | 90.29 | 90.29 |
| (17) | fR1/(−fRnf) | — | — | — | — | — |
| (18) | fR1/(−fRnr) | — | — | — | — | — |
| (19) | fM2p/(−fMr) | — | — | — | — | — |
| (20) | (−fMr)/fR1 | 1.5636 | 1.9555 | 1.4801 | 2.1367 | 2.1614 |
| (21) | fM2n/fM1 | — | — | — | — | — |

TABLE 92

| Expression | | | | | | |
|---|---|---|---|---|---|---|
| Number | | Example 6 | Example 7 | Example 8 | Example 9 | Example 10 |
| (1) | (−fM1)/f1 | 0.1558 | 0.1588 | 0.1588 | 0.1623 | 0.1569 |
| (2) | fR1/f1 | 0.1915 | 0.2038 | 0.2035 | 0.1580 | 0.2166 |
| (3) | fMr/fM1 | 2.7738 | 2.3526 | 2.4056 | 2.1203 | 2.8290 |
| (4) | DG1/Dsum | 0.1332 | 0.0993 | 0.1004 | 0.0989 | 0.1325 |
| (5) | fw/f1 | 0.1527 | 0.1247 | 0.1268 | 0.1250 | 0.1523 |
| (6) | fw/fM1 | −0.9805 | −0.7851 | −0.7983 | −0.7703 | −0.9710 |
| (7) | fw/fR1 | 0.7976 | 0.6118 | 0.6230 | 0.7915 | 0.7031 |
| (8) | f1/(fw × ft)^{1/2} | 1.7991 | 2.1757 | 2.1400 | 2.1696 | 1.8120 |
| (9) | ft/fw | 19.2999 | 19.2960 | 19.3035 | 19.3045 | 19.2989 |
| (10) | fw/\|fois\| | 0.3236 | 0.2514 | 0.2494 | 0.2515 | 0.3123 |
| (11) | (fw × tan ωw)/(ft × tan ωt) | 0.7912 | 0.7990 | 0.7987 | 0.7987 | 0.7951 |
| (15) | EDL/(2 × ft × tan ωt) | — | — | — | — | 1.0644 |
| (16) | ν1pave | 90.29 | 88.14 | 88.14 | 88.14 | 90.29 |
| (17) | fR1/(−fRnf) | — | — | — | — | — |
| (18) | fR1/(−fRnr) | — | — | — | — | — |
| (19) | fM2p/(−fMr) | — | — | — | — | — |
| (20) | (−fMr)/fR1 | 2.2565 | 1.8333 | 1.8773 | 2.1785 | 2.0484 |
| (21) | fM2n/fM1 | — | — | — | — | — |

TABLE 93

| Expression | | | | | | |
|---|---|---|---|---|---|---|
| Number | | Example 11 | Example 12 | Example 13 | Example 14 | Example 15 |
| (1) | (−fM1)/f1 | 0.1569 | 0.1418 | 0.1361 | 0.1428 | 0.2973 |
| (2) | fR1/f1 | 0.2674 | 0.2358 | 0.1866 | 0.2284 | 0.2657 |
| (3) | fMr/fM1 | 2.8147 | 2.8361 | 2.4007 | 2.7542 | 1.3756 |
| (4) | DG1/Dsum | 0.1322 | 0.1575 | 0.1200 | 0.1416 | 0.1411 |
| (5) | fw/f1 | 0.1515 | 0.1351 | 0.1214 | 0.1325 | 0.1439 |
| (6) | fw/fM1 | −0.9657 | −0.9533 | −0.8915 | −0.9279 | −0.4839 |
| (7) | fw/fR1 | 0.5666 | 0.5731 | 0.6505 | 0.5802 | 0.5414 |
| (8) | f1/(fw × ft)^{1/2} | 1.8207 | 1.9834 | 2.1810 | 2.0346 | 1.9061 |
| (9) | ft/fw | 19.3035 | 19.2966 | 19.2962 | 19.2956 | 19.2964 |
| (10) | fw/\|fois\| | 0.3085 | 0.7634 | 0.6234 | 0.7730 | 0.8037 |
| (11) | (fw × tan ωw)/(ft × tan ωt) | 0.7949 | 0.9044 | 0.9308 | 0.8870 | 0.7647 |
| (15) | EDL/(2 × ft × tan ωt) | 1.0939 | 1.1512 | 1.2793 | 1.2348 | — |
| (16) | ν1pave | 90.29 | 81.61 | 88.36 | 81.61 | 81.61 |
| (17) | fR1/(−fRnf) | — | — | — | — | — |
| (18) | fR1/(−fRnr) | — | — | — | — | — |
| (19) | fM2p/(−fMr) | — | 3.0988 | 3.7199 | 2.2148 | — |
| (20) | (−fMr)/fR1 | 1.6516 | 1.7050 | 1.7516 | 1.7219 | 1.5390 |
| (21) | fM2n/fM1 | — | — | — | — | 2.0644 |

TABLE 94

| Expression | | | | | | |
|---|---|---|---|---|---|---|
| Number | | Example 16 | Example 17 | Example 18 | Example 19 | Example 20 |
| (1) | (−fM1)/f1 | 0.2966 | 0.2831 | 0.2986 | 0.2911 | 0.2769 |
| (2) | fR1/f1 | 0.2656 | 0.2483 | 0.2761 | 0.2326 | 0.2440 |
| (3) | fMr/fM1 | 1.3804 | 1.4286 | 1.3376 | 1.2021 | 1.2510 |
| (4) | DG1/Dsum | 0.1309 | 0.1278 | 0.1296 | 0.1179 | 0.1164 |
| (5) | fw/f1 | 0.1402 | 0.1404 | 0.1395 | 0.1208 | 0.1217 |
| (6) | fw/fM1 | −0.4727 | −0.4959 | −0.4671 | −0.4149 | −0.4393 |
| (7) | fw/fR1 | 0.5279 | 0.5653 | 0.5052 | 0.5194 | 0.4986 |
| (8) | f1/(fw × ft)^{1/2} | 1.9300 | 1.9303 | 1.9296 | 2.2111 | 2.2173 |
| (9) | ft/fw | 19.3046 | 19.2963 | 19.2987 | 19.3000 | 19.2973 |
| (10) | fw/\|fois\| | 0.6335 | 0.6555 | 0.5992 | 0.6853 | 0.8627 |
| (11) | (fw × tan ωw)/(ft × tan ωt) | 0.7834 | 0.7799 | 0.7684 | 0.9572 | 0.9693 |
| (15) | EDL/(2 × ft × tan ωt) | — | — | — | — | — |
| (16) | ν1pave | 81.61 | 81.61 | 81.61 | 81.61 | 81.61 |
| (17) | fR1/(−fRnf) | — | — | — | — | — |
| (18) | fR1/(−fRnr) | — | — | — | — | — |
| (19) | fM2p/(−fMr) | — | — | — | — | — |
| (20) | (−fMr)/fR1 | 1.5415 | 1.6286 | 1.4468 | 1.5048 | 1.4198 |
| (21) | fM2n/fM1 | 2.0752 | 2.8490 | 2.0495 | 1.9528 | 2.1089 |

TABLE 95

| Expression | | | | | | |
|---|---|---|---|---|---|---|
| Number | | Example 21 | Example 22 | Example 23 | Example 24 | Example 25 |
| (1) | (−fM1)/f1 | 0.2578 | 0.2670 | 0.3100 | 0.2666 | 0.3134 |
| (2) | fR1/f1 | 0.2504 | 0.2094 | 0.2952 | 0.2488 | 0.2655 |
| (3) | fMr/fM1 | 1.3838 | 1.4970 | 1.2692 | 1.4857 | 1.2567 |
| (4) | DG1/Dsum | 0.1142 | 0.1457 | 0.1258 | 0.1266 | 0.1235 |
| (5) | fw/f1 | 0.1223 | 0.1340 | 0.1356 | 0.1358 | 0.1382 |
| (6) | fw/fM1 | −0.4744 | −0.5017 | −0.4374 | −0.5095 | −0.4411 |
| (7) | fw/fR1 | 0.4885 | 0.6399 | 0.4594 | 0.5459 | 0.5206 |
| (8) | f1/(fw × ft)^{1/2} | 2.1898 | 1.9989 | 1.9871 | 1.9873 | 1.9528 |
| (9) | ft/fw | 19.2970 | 19.3045 | 19.3044 | 19.2954 | 19.2981 |
| (10) | fw/\|fois\| | 0.8957 | 0.7925 | 0.7680 | 0.7163 | 0.6578 |
| (11) | (fw × tan ωw)/(ft × tan ωt) | 0.9740 | 0.7409 | 0.7949 | 0.7837 | 0.7760 |
| (15) | EDL/(2 × ft × tan ωt) | — | 0.9071 | 1.4205 | 1.4423 | 1.5476 |
| (16) | ν1pave | 81.61 | 81.61 | 81.61 | 81.61 | 81.61 |
| (17) | fR1/(−fRnf) | — | — | — | — | — |
| (18) | fR1/(−fRnr) | — | — | — | — | — |
| (19) | fM2p/(−fMr) | — | — | — | — | — |
| (20) | (−fMr)/fR1 | 1.4248 | 1.9094 | 1.3329 | 1.5920 | 1.4832 |
| (21) | fM2n/fM1 | 2.6945 | 2.5571 | 2.3365 | 3.4542 | 1.7883 |

TABLE 96

| Expression | | | | | | |
|---|---|---|---|---|---|---|
| Number | | Example 26 | Example 27 | Example 28 | Example 29 | Example 30 |
| (1) | (−fM1)/f1 | 0.2657 | 0.2733 | 0.2579 | 0.1646 | 0.2940 |
| (2) | fR1/f1 | 0.2247 | 0.2397 | 0.2470 | 0.2135 | 0.2374 |
| (3) | fMr/fM1 | 1.3277 | 1.2564 | 1.3859 | 2.5698 | 1.3949 |
| (4) | DG1/Dsum | 0.1174 | 0.1167 | 0.1145 | 0.1379 | 0.1410 |
| (5) | fw/f1 | 0.1186 | 0.1218 | 0.1223 | 0.1258 | 0.1400 |
| (6) | fw/fM1 | −0.4463 | −0.4456 | −0.4743 | −0.7642 | −0.4763 |
| (7) | fw/fR1 | 0.5277 | 0.5081 | 0.4953 | 0.5891 | 0.5898 |
| (8) | f1/(fw × ft)^{1/2} | 2.2538 | 2.2061 | 2.1930 | 2.1261 | 1.9018 |
| (9) | ft/fw | 19.2994 | 19.3039 | 19.2954 | 19.3038 | 19.3008 |
| (10) | fw/\|fois\| | 0.7618 | 0.9105 | 0.9075 | 0.7320 | 0.7596 |
| (11) | (fw × tan ωw)/(ft × tan ωt) | 0.9796 | 0.9737 | 0.9835 | 0.7771 | 0.7591 |
| (15) | EDL/(2 × ft × tan ωt) | 1.8506 | 1.9302 | 1.3241 | 1.0936 | — |
| (16) | ν1pave | 81.61 | 81.61 | 81.61 | 81.61 | 81.61 |
| (17) | fR1/(−fRnf) | — | — | — | 0.6362 | 0.9481 |
| (18) | fR1/(−fRnr) | — | — | — | 0.0668 | — |
| (19) | fM2p/(−fMr) | — | — | — | — | — |
| (20) | (−fMr)/fR1 | 1.5699 | 1.4327 | 1.4473 | 1.9811 | 1.7274 |
| (21) | fM2n/fM1 | 2.6143 | 2.2581 | 2.6484 | — | 2.6846 |

TABLE 97

| Expression | | | |
|---|---|---|---|
| Number | | Example 31 | Example 32 |
| (1) | (−fM1)/f1 | 0.1585 | 0.1366 |
| (2) | fR1/f1 | 0.2179 | 0.3519 |
| (3) | fMr/fM1 | 2.8915 | 2.8173 |
| (4) | DG1/Dsum | 0.1347 | 0.1394 |
| (5) | fw/f1 | 0.1322 | 0.0924 |
| (6) | fw/fM1 | −0.8337 | −0.6768 |
| (7) | fw/fR1 | 0.6066 | 0.2627 |
| (8) | f1/(fw × ft)^{1/2} | 2.0448 | 2.3228 |
| (9) | ft/fw | 19.2965 | 31.0447 |
| (10) | fw/\|fois\| | 0.7252 | 0.2757 |
| (11) | (fw × tan ωw)/ | 0.8029 | 0.7181 |
| | (ft × tan ωt) | | |
| (15) | EDL/(2 × ft × tan ωt) | 1.1437 | — |
| (16) | ν1pave | 81.61 | 85.92 |
| (17) | fR1/(−fRnf) | 0.7628 | — |
| (18) | fR1/(−fRnr) | 0.0242 | — |
| (19) | fM2p/(−fMr) | — | — |
| (20) | (−fMr)/fR1 | 2.1039 | 1.0934 |
| (21) | fM2n/fM1 | — | — |

TABLE 98

| Expression | | | | |
|---|---|---|---|---|
| Number | | N231.Glass | N216.Glass | N200.Glass |
| (12) | Nd + 0.01425 × νd | 2.564 | 2.465 | 2.454 |
| (13) | νd | 17.89 | 21.24 | 31.67 |
| (14) | θgF + 0.00316 × νd | 0.702 | 0.695 | 0.685 |

The variable magnification optical systems of Examples 1 to 32 have a zoom ratio of 18× or more and thus, implement a high zoom ratio. In the variable magnification optical systems of Examples 1 to 32, various types of aberration are favorably corrected in the whole magnification range, and high optical performance is maintained.

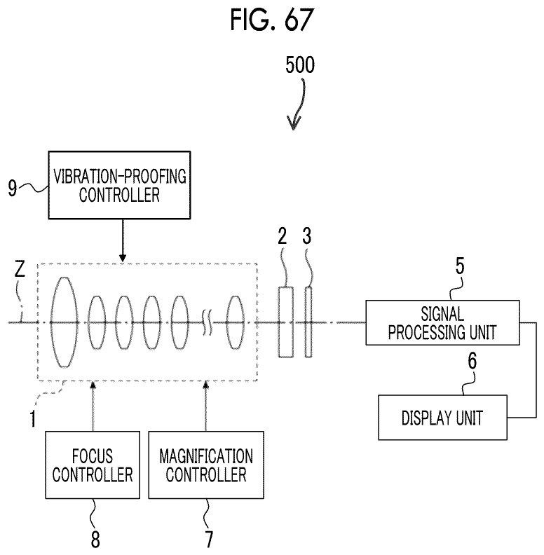

Next, an imaging apparatus according to the embodiment of the present disclosure will be described. FIG. 67 is a schematic configuration diagram showing an imaging apparatus 500 according to one embodiment of the present disclosure. Examples of the imaging apparatus 500 include a surveillance camera, a movie imaging camera, a broadcasting camera, a digital camera, a film camera, a video camera, a factory automation (FA) camera, and a machine vision (MV) camera.

The imaging apparatus 500 comprises a variable magnification optical system 1 according to one embodiment of the present disclosure, a filter 2 disposed on the image side with respect to the variable magnification optical system 1, and an imaging element 3 disposed on the image side with respect to the filter 2. FIG. 67 schematically shows a plurality of lenses comprised in the variable magnification optical system 1.

The imaging element 3 converts an optical image formed by the variable magnification optical system 1 into an electrical signal. For example, a charge coupled device (CCD) or a complementary metal oxide semiconductor (CMOS) can be used as the imaging element 3. The imaging element 3 is disposed such that an imaging surface thereof matches an image plane of the variable magnification optical system 1.

The imaging apparatus 500 also comprises a signal processing unit 5, a display unit 6, a magnification controller 7, a focus controller 8, and a vibration-proofing controller 9. The signal processing unit 5 performs operation processing on an output signal from the imaging element 3. The display unit 6 displays an image formed by the signal processing unit 5. The magnification controller 7 controls magnification of the variable magnification optical system 1. The focus controller 8 controls focusing of the variable magnification optical system 1. The vibration-proofing controller 9 controls vibration-proofing of the variable magnification optical system 1. While FIG. 67 shows only one imaging element 3, a so-called three-plate type imaging apparatus including three imaging elements may also be used.

While the disclosed technology is described above using the embodiment and the examples, the disclosed technology is not limited to the embodiment and the examples, and various modifications can be made. For example, the curvature radius, the surface spacing, the refractive index, the Abbe number, and the aspherical coefficients of each lens are not limited to the values shown in each example and may have other values.

The following appendices are further disclosed with respect to the embodiment and the examples described above.

### Appendix 1

A variable magnification optical system consisting of, in order from an object side to an image side, a first lens group having positive refractive power, an intermediate group, and a subsequent group,
in which an M1 lens group having negative refractive power is disposed closest to the object side in the intermediate group,
an Mr lens group having negative refractive power is disposed closest to the image side in the intermediate group,
the intermediate group consists of three or fewer lens groups having refractive power, including the M1 lens group and the Mr lens group,
an R1 lens group having positive refractive power is disposed closest to the object side in the subsequent group,
during changing magnification, the first lens group remains stationary with respect to an image plane, and all spacings between adjacent lens groups change, and
in a case where a focal length of the M1 lens group is denoted by fM1, and
a focal length of the first lens group is denoted by f1,
Conditional Expression (1) is satisfied, which is represented by

$$0.05 < ( - fM 1 ) / f 1 < 0.8 . \qquad ( 1 )$$

### Appendix 2

The variable magnification optical system according to Appendix 1,
in which in a case where a focal length of the R1 lens group is denoted by fR1,
Conditional Expression (2) is satisfied, which is represented by

$$0.05 < fR 1 / f 1 < 0.85 . \qquad ( 2 )$$

### Appendix 3

The variable magnification optical system according to Appendix 1 or 2,
in which in a case where a focal length of the Mr lens group is denoted by fMr,
Conditional Expression (3) is satisfied, which is represented by

$$0.8 < fMr / fM 1 < 7. \qquad ( 3 )$$

### Appendix 4

The variable magnification optical system according to any one of Appendices 1 to 3,
in which in a case where a distance on an optical axis from a surface closest to the object side in the first lens group to a surface closest to the image side in the first lens group is denoted by DG1, and
a distance on the optical axis from the surface closest to the object side in the first lens group to a surface closest to the image side in the subsequent group in a state where an infinite distance object is in focus at a wide angle end is denoted by Dsum,
Conditional Expression (4) is satisfied, which is represented by

$$0.012 < DG 1 / Dsum < 0.25 . \qquad ( 4 )$$

### Appendix 5

The variable magnification optical system according to any one of Appendices 1 to 4,
in which in a case where a focal length of a whole variable magnification optical system in a state where an infinite distance object is in focus at a wide angle end is denoted by fw,
Conditional Expression (5) is satisfied, which is represented by

$$0.08 < fw / f 1 < 0.3 . \qquad ( 5 )$$

### Appendix 6

The variable magnification optical system according to any one of Appendices 1 to 5,
in which in a case where a focal length of a whole variable magnification optical system in a state where an infinite distance object is in focus at a wide angle end is denoted by fw,
Conditional Expression (6) is satisfied, which is represented by

$$- 3 < fw / fM 1 < - 0.2 . \qquad ( 6 )$$

### Appendix 7

The variable magnification optical system according to any one of Appendices 1 to 6.
in which in a case where a focal length of a whole variable magnification optical system in a state where an infinite distance object is in focus at a wide angle end is denoted by fw, and
a focal length of the R1 lens group is denoted by fR1,
Conditional Expression (7) is satisfied, which is represented by

$$0.1 < fw / fR 1 < 1.4 . \qquad ( 7 )$$

### Appendix 8

The variable magnification optical system according to any one of Appendices 1 to 7,
in which in a case where a focal length of a whole variable magnification optical system in a state where an infinite distance object is in focus at a wide angle end is denoted by fw, and
a focal length of the whole variable magnification optical system in a state where the infinite distance object is in focus at a telephoto end is denoted by ft,
Conditional Expression (8) is satisfied, which is represented by

$$0.6 < f 1 / {( fw \times f t )}^{1 / 2} < 4. \qquad ( 8 )$$

### Appendix 9

The variable magnification optical system according to any one of Appendices 1 to 8,
in which in a case where a focal length of a whole variable magnification optical system in a state where an infinite distance object is in focus at a wide angle end is denoted by fw, and
a focal length of the whole variable magnification optical system in a state where the infinite distance object is in focus at a telephoto end is denoted by ft,
Conditional Expression (9) is satisfied, which is represented by

$$9 < f t / fw < 60. \qquad ( 9 )$$

### Appendix 10

The variable magnification optical system according to any one of Appendices 1 to 9,
in which the subsequent group includes a vibration-proof group that moves in a direction intersecting with an optical axis during image shake correction, and
in a case where a focal length of a whole variable magnification optical system in a state where an infinite distance object is in focus at a wide angle end is denoted by fw, and
a focal length of the vibration-proof group is denoted by fois,
Conditional Expression (10) is satisfied, which is represented by

$$0.1 < fw / \vert fois \vert < 1.5 . \qquad ( 10 )$$

### Appendix 11

The variable magnification optical system according to Appendix 10,
in which in a case where a focal length of the whole variable magnification optical system in a state where the infinite distance object is in focus at a telephoto end is denoted by ft,
a maximum half angle of view in a state where the infinite distance object is in focus at the wide angle end is denoted by ww, and
a maximum half angle of view in a state where the infinite distance object is in focus at the telephoto end is denoted by ωt,
Conditional Expression (11) is satisfied, which is represented by

$$0.6 < ( f w \times tan ω w ) / ( f t \times tan ω t ) < 0 \text{.98} . \qquad ( 11 )$$

### Appendix 12

The variable magnification optical system according to any one of Appendices 1 to 11,
in which in a case where a refractive index at a d line for a lens included in the variable magnification optical system is denoted by Nd, and
an Abbe number based on the d line for the lens included in the variable magnification optical system is denoted by vd,
the variable magnification optical system includes at least one specific lens that is a lens satisfying Conditional Expressions (12) and (13) represented by

$$2.435 < Nd + 0.01425 \times v d < 2.75 , and \qquad ( 12 )$$

$$15 < vd < 39. \qquad ( 13 )$$

### Appendix 13

The variable magnification optical system according to Appendix 12,
in which in a case where a partial dispersion ratio between a g line and an F line for the lens included in the variable magnification optical system is denoted by θgF,
the specific lens satisfies Conditional Expression (14) represented by

$$0.65 < θ gF + 0.00316 \times v d < 0 \text{.85} . \qquad ( 14 )$$

### Appendix 14

The variable magnification optical system according to Appendix 12 or 13,
in which in a case where a maximum effective diameter of a specific lens having the maximum effective diameter among the specific lenses included in the variable magnification optical system is denoted by EDL,
a focal length of a whole variable magnification optical system in a state where an infinite distance object is in focus at a telephoto end is denoted by ft, and
a maximum half angle of view in a state where the infinite distance object is in focus at the telephoto end is denoted by ωt,
Conditional Expression (15) is satisfied, which is represented by

$$0.1 < EDL / ( 2 \times ft \times tan ω t ) < 2. \qquad ( 15 )$$

### Appendix 15

The variable magnification optical system according to any one of Appendices 12 to 14,
in which the intermediate group includes at least one specific lens.

### Appendix 16

The variable magnification optical system according to any one of Appendices 12 to 15,
in which the subsequent group includes at least one specific lens.

### Appendix 17

The variable magnification optical system according to any one of Appendices 12 to 16,
in which the variable magnification optical system includes at least one cemented lens, and
the at least one cemented lens of the variable magnification optical system includes the specific lens.

### Appendix 18

The variable magnification optical system according to any one of Appendices 1 to 17,
in which the intermediate group consists of three lens groups.

### Appendix 19

The variable magnification optical system according to any one of Appendices 1 to 18,
in which the M1 lens group includes two or more positive lenses and three or more negative lenses.

### Appendix 20

An imaging apparatus comprising the variable magnification optical system according to any one of Appendices 1 to 19.

What is claimed is:

1. A variable magnification optical system consisting of, in order from an object side to an image side, a first lens group having positive refractive power, an intermediate group, and a subsequent group,
wherein an M1 lens group having negative refractive power is disposed closest to the object side in the intermediate group,
an Mr lens group having negative refractive power is disposed closest to the image side in the intermediate group,
the intermediate group consists of three or fewer lens groups having refractive power, including the M1 lens group and the Mr lens group,
an R1 lens group having positive refractive power is disposed closest to the object side in the subsequent group,
during changing magnification, the first lens group remains stationary with respect to an image plane, and all spacings between adjacent lens groups change, and
in a case where a focal length of the M1 lens group is denoted by fM1, and
a focal length of the first lens group is denoted by f1,
Conditional Expression (1) is satisfied, which is represented by
$$0.05 < ( - fM 1 ) / fl < 0.8 . \qquad ( 1 )$$

2. The variable magnification optical system according to claim 1,
wherein in a case where a focal length of the R1 lens group is denoted by fR1,
Conditional Expression (2) is satisfied, which is represented by
$$0.05 < fR 1 / fl < 0.85 . \qquad ( 2 )$$

3. The variable magnification optical system according to claim 1,
wherein in a case where a focal length of the Mr lens group is denoted by fMr,
Conditional Expression (3) is satisfied, which is represented by
$$0.8 < fMr / fM 1 < 7. \qquad ( 3 )$$

4. The variable magnification optical system according to claim 1,
wherein in a case where a distance on an optical axis from a surface closest to the object side in the first lens group to a surface closest to the image side in the first lens group is denoted by DG1, and
a distance on the optical axis from the surface closest to the object side in the first lens group to a surface closest to the image side in the subsequent group in a state where an infinite distance object is in focus at a wide angle end is denoted by Dsum,
Conditional Expression (4) is satisfied, which is represented by
$$0.012 < DG 1 / Dsum < 0.25 . \qquad ( 4 )$$

5. The variable magnification optical system according to claim 1,
wherein in a case where a focal length of a whole variable magnification optical system in a state where an infinite distance object is in focus at a wide angle end is denoted by fw,
Conditional Expression (5) is satisfied, which is represented by
$$0.08 < fw / fl < 0.3 . \qquad ( 5 )$$

6. The variable magnification optical system according to claim 1,
wherein in a case where a focal length of a whole variable magnification optical system in a state where an infinite distance object is in focus at a wide angle end is denoted by fw,
Conditional Expression (6) is satisfied, which is represented by
$$- 3 < fw / fM 1 < - 0.2 . \qquad ( 6 )$$

7. The variable magnification optical system according to claim 1,
wherein in a case where a focal length of a whole variable magnification optical system in a state where an infinite distance object is in focus at a wide angle end is denoted by fw, and
a focal length of the R1 lens group is denoted by fR1,
Conditional Expression (7) is satisfied, which is represented by
$$0.1 < fw / fR 1 < 1.4 . \qquad ( 7 )$$

8. The variable magnification optical system according to claim 1,
wherein in a case where a focal length of a whole variable magnification optical system in a state where an infinite distance object is in focus at a wide angle end is denoted by fw, and
a focal length of the whole variable magnification optical system in a state where the infinite distance object is in focus at a telephoto end is denoted by ft,
Conditional Expression (8) is satisfied, which is represented by
$$0.6 < fl / {( fw \times ft )}^{1 / 2} < 4. \qquad ( 8 )$$

9. The variable magnification optical system according to claim 1,
wherein in a case where a focal length of a whole variable magnification optical system in a state where an infinite distance object is in focus at a wide angle end is denoted by fw, and
a focal length of the whole variable magnification optical system in a state where the infinite distance object is in focus at a telephoto end is denoted by ft,
Conditional Expression (9) is satisfied, which is represented by
$$9 < ft / fw < 60. \qquad ( 9 )$$

10. The variable magnification optical system according to claim 1,
wherein the subsequent group includes a vibration-proof group that moves in a direction intersecting with an optical axis during image shake correction, and
in a case where a focal length of a whole variable magnification optical system in a state where an infinite distance object is in focus at a wide angle end is denoted by fw, and
a focal length of the vibration-proof group is denoted by fois,
Conditional Expression (10) is satisfied, which is represented by
$$0.1 < fw / \vert fois \vert < 1.5 . \qquad ( 10 )$$

11. The variable magnification optical system according to claim 10,
wherein in a case where a focal length of the whole variable magnification optical system in a state where the infinite distance object is in focus at a telephoto end is denoted by ft.,
a maximum half angle of view in a state where the infinite distance object is in focus at the wide angle end is denoted by ww, and
a maximum half angle of view in a state where the infinite distance object is in focus at the telephoto end is denoted by ωt,
Conditional Expression (11) is satisfied, which is represented by
$$0.6 < ( fw \times tan ω w ) / ( ft \times tan ω t ) < 0 \text{.98} . \qquad ( 11 )$$

12. The variable magnification optical system according to claim 1,
wherein in a case where a refractive index at a d line for a lens included in the variable magnification optical system is denoted by Nd, and
an Abbe number based on the d line for the lens included in the variable magnification optical system is denoted by vd,
the variable magnification optical system includes at least one specific lens that is a lens satisfying Conditional Expressions (12) and (13) represented by
$$2.435 < Nd + 0.01425 \times v d < 2.75 , and \qquad ( 12 )$$
$$15 < v d < 39. \qquad ( 13 )$$

13. The variable magnification optical system according to claim 12,
wherein in a case where a partial dispersion ratio between a g line and an F line for the lens included in the variable magnification optical system is denoted by θgF,
the specific lens satisfies Conditional Expression (14) represented by
$$0.65 < θ g F + 0.00316 \times vd < 0.85 . \qquad ( 14 )$$

14. The variable magnification optical system according to claim 12,
wherein in a case where a maximum effective diameter of a specific lens having the maximum effective diameter among the specific lenses included in the variable magnification optical system is denoted by EDL,
a focal length of a whole variable magnification optical system in a state where an infinite distance object is in focus at a telephoto end is denoted by ft, and
a maximum half angle of view in a state where the infinite distance object is in focus at the telephoto end is denoted by ωt,
Conditional Expression (15) is satisfied, which is represented by
$$0.1 < EDL / ( 2 \times ft \times tan ω t ) < 2. \qquad ( 15 )$$

15. The variable magnification optical system according to claim 12,
wherein the intermediate group includes at least one specific lens.

16. The variable magnification optical system according to claim 12,
wherein the subsequent group includes at least one specific lens.

17. The variable magnification optical system according to claim 12,
wherein the variable magnification optical system includes at least one cemented lens, and
the at least one cemented lens of the variable magnification optical system includes the specific lens.

18. The variable magnification optical system according to claim 1,
wherein the intermediate group consists of three lens groups.

19. The variable magnification optical system according to claim 1,
wherein the M1 lens group includes two or more positive lenses and three or more negative lenses.

20. An imaging apparatus comprising:
the variable magnification optical system according to claim 1.
